(19) United States
(12) Patent Application Publication
(10) Pub. No.: US 2024/0116965 A1
(43) Pub. Date: Apr. 11, 2024

(54) ORGANOMETALLIC COMPOUNDS

(71) Applicant: Umicore AG & Co. KG, Hanau-Wolfgang (DE)

(72) Inventors: Angelino DOPPIU, Seligenstadt (DE); Ralf KARCH, Kleinostheim (DE); Eileen WOERNER, Nidderau (DE); Andreas RIVAS NASS, Bensheim (DE)

(21) Appl. No.: 18/268,996

(22) PCT Filed: Dec. 15, 2021
(86) PCT No.: PCT/EP2021/085873

§ 371 Date: Jun. 22, 2023

(30) Foreign Application Priority Data
Dec. 23, 2020 (EP) 20020647.2
Feb. 22, 2021 (EP) 21158557.5
Jul. 22, 2021 (EP) 21187170.2
Jul. 30, 2021 (EP) 21188842.5

(51) Int. Cl. C07F 15/00

(52) U.S. Cl. CPC C07F 15/0066

(57) ABSTRACT

The invention relates to new processes for preparing palladium complexes, allowing preparation of known products with high purity and in good yields and also allowing preparation of new palladium complexes. The invention also relates to new palladium complexes that are suitable as precatalysts and/or catalysts, in particular for coupling reactions.

Palladium catalysis is used in organic synthetic chemistry to produce a wide variety of compounds. The most prominent palladium-catalyzed reactions include C—C bond-forming reactions and C-heteroatom bond-forming reactions, commonly referred to as cross-coupling reactions.

Inter alia, homoleptic Pd(0) complexes of general formula [Pd(phosphine)₂] and heteroleptic Pd(0) complexes of general formula [Pd(dvds)(ligand)], wherein dvds=1,3-divinyl-1,1,3,3-tetramethyldisiloxane and ligand=phosphine or NHC, are used as cross-coupling catalysts. One of the best third-generation cross-coupling catalysts—for both carbon-carbon coupling reactions and carbon-heteroatom coupling reactions—is the Pd(I) dimer di-μ-bromo-bis(tri-tert-butylphosphine)-dipalladium(1) ([Pd(μ-Br)(PtBu₃)]₂). Among the most widely used classes of precatalysts for coupling reactions are π-allylpalladium chloride complexes.

Homoleptic palladium(0) complexes of the [Pd(phosphine)₂] type are generally synthesized by reacting [Pd(η³—C₃H₅)-(η⁵—C₅H₅)] with the free phosphine. (T. Yoshida, S. Otsuka, D. G. Jones, J. L. Spencer, P. Binger, A. Brinkmann, P. Wedemann, in: Inorg. Synth., John Wiley & Sons, Inc., Hoboken, NJ, USA, 2007, 101-107; S. Otsuka, T. Yoshida, M. Matsumoto, K. Nakatsu, J. Am. Chem. Soc. 1976, 98 (19), 5850-5858). Various ligands have been tested for this type of reaction, including PPh(tBu)₂, PCy₃, P(tBu)₃, P(tBu)₂Me, P(1-Ad)₂Bu. (H. Urata, H. Suzuki, Y. Moro-oka, T. Ikawa, J. Organomet. Chem. 1989, 364, 235-244; A. G. Sergeev, A. Zapf, A. Spannenberg, M. Beller, Organometallics 2008, 27, 297-300). The disadvantages of this synthesis route are, in particular, the instability and the high volatility of [Pd(η³—C₃H₅)-(η⁵—C₅H₅)]. In 2007, Mitchell and Baird reported the preparation of the less volatile [Pd(η³-1-PhC₃H₄)-(η⁵—C₅H₅)] complex and the use thereof as a reactant for the preparation of [Pd(phosphine)₂] complexes, wherein phosphine=PPh₃, PMePh₂, PCy₃, P(tBu)₂Me and PtBu₃. (E. A. Mitchell, M. C. Baird, Organometallics 2007, 26, 5230-5238). Alternatively, the palladium(II) compound [Pd(cod)(CH₂SiMe₃)₂] (A. L. Chan, J. Estrada, C. E. Kefalidis, V. Lavallo, Organometallics 2016, 35 (19), 3257-3260) was used as a reactant. However, this is a relatively expensive palladium(0) precursor compound.

Other approaches to the synthesis of this class of compounds start from various Pd(II) precursors, which are reduced in the presence of the free phosphine to the corresponding [Pd(phosphine)₂] complex. (C. S. Wei, G. H. M. Davies, O. Soltani, J. Albrecht, Q. Gao, C. Pathirana, Y. Hsiao, S. Tummala, M. D. Eastgate, Angew. Chem. Int. Ed. 2013, 52, 5822-5826; V. V. Grushin, C. Bensimon, H. Alper, Inorg. Chem. 1994, 33, 4804-4806). Examples are the reduction of (PCy₃)₂PdCl₂ with KOH in the presence of PCy₃, but also other methods which dispense with the use of additional phosphine. Various reducing agents have been tested for the reduction of [(PCy₃)₂Pd(OAc)₂], with bis(pinacolato)diboron (B₂pin₂) proving to be the most efficient.

A disadvantage of the previously known methods for preparing homoleptic palladium(0) complexes of the [Pd(phosphine)₂] type is that either expensive and/or difficult-to-handle reactants are used or, for example, an excess of the phosphine is required. Consequently, all of the methods from the prior art described here should be regarded as unsatisfactory from an economical (in terms of atoms) and/or ecological perspective.

Furthermore, the preparation of heteroleptic Pd(0) complexes having the general formula [Pd(dvds)(phosphine)] is described in the prior art, wherein dvds=1,3-divinyl-1,1,3,3-tetramethyldisiloxane. The reaction of [(tmeda)Pd(CH₃)₂] (tmeda=N,N,N′,N′-tetramethylethylenediamine) with a free phosphine in the presence of the corresponding diolefin solution, i.e. an excess of the diolefin dvds, yields the heteroleptic Pd(0) complex [Pd(dvds)(phosphine)]. (M. J.-L. Tschan, E. J. Garcia-Suerez, Z. Freixa, H. Launay, H. Hagen, J. Benet-Buchholz, P. W. N. M. van Leeuwen, J. Am. Chem. Soc. 2010, 132, 6463-6473; M. G. Andreu, A. Zapf, M. Beller, Chem. Commun. 2000, 2475-2476) Various phosphine-substituted complexes of this type have been prepared, both with simple phosphines such as PCy₃ and also with more sterically demanding phosphines. In a publication from 1999 (K.-R. Porschke et al., J. Am. Chem. Soc. 1999, 121, 9807-9823) various synthesis routes for the preparation of heteroleptic complexes according to general formula [Pd(dvds)(phosphine)] are described. The majority of the syntheses described are carried out starting from complexes according to general formula [Pd(1,6-diene)(phosphine)] or [(tmeda)Pd(CH₃)₂]. The authors also describe a synthesis starting from [Pd₂(dvds)₃], namely the preparation of the heteroleptic palladium(0) complex [(tBu₃P)Pd(dvds)], which is unstable at least in solution, by reacting [Pd₂(dvds)₃] with PtBu₃ at −30° C., wherein the molar ratio of the reactants is 1:2. A dvds/Et₂O mixture (volumetric ratio 1:2) is selected as the reaction medium. The Pd(0) compound [(tBu₃P)Pd(dvds)] was obtained in a yield of 66%. The authors state that, in a solution of the Pd(0) complex [(tBu₃P)Pd(dvds)], ligand redistribution takes place, forming [Pd(PtBu₃)₂] and [Pd(dvds)₂].

The above methods for preparing heteroleptic Pd(0) complexes having the general formula [Pd(dvds)(phosphine)] are disadvantageous due to the use of relatively expensive palladium precursors and/or because an excess of the diolefin dvds is required and in some cases diethyl ether is used as a further solvent. In particular, it cannot be ruled out that the end products will contain contamination from dvds and/or ether. This is particularly disadvantageous with regard to the use of these compounds as catalysts. The use of a diolefin excess is also disadvantageous from an economical (in terms of atoms) and ecological perspective.

For the preparation of [Pd(μ-Br)(PtBu₃)]₂, various alternatives, in particular comproportionation reactions, are discussed in the prior art, inter alia by Mingos et al. and by Vilar et al. In a first variant (R. Vilar, D. M. P. Mingos et al., J. Chem. Soc., Dalton Trans. 1996, 4313-4314), the palladium(0) complex [Pd₂(dba)₃]×C₆H₆ (dba=dibenzylideneacetone) is provided as Pd source, and is reacted with two molar equivalents of PtBu₃ and 0.5 molar equivalents of CHBr₃. However, the desired Pd(I) dimer is only obtained in a low yield (18%), meaning this route is unsuitable for industrial-scale production. In a second variant (V. Durá-Vilá, D. M. P. Mingos, R. Vilar et al., J. Organomet. Chem. 2000, 600, 198-205), in addition to the palladium(0) complex [Pd₂(dba)₃]×C₆H₆, the palladium(II) compound [PdBr₂(cod)] (cod=1,5-cyclooctadiene) is used as Pd source. Higher yields (60%) are achieved in this case. However, firstly, the additional use of the reactant [PdBr₂(cod)], which is expensive and difficult to handle, in particular difficult to store, is necessary. In addition, secondly, the crystallization of the reactant [Pd₂(dba)₃]×C₆H₆, and the resultant contamination of the end product, can occur during the synthesis.

The Schoenebeck group describes two comproportionation reactions in which the palladium(0) compound [Pd(P(iPr)(tBu)₂)₂] is reacted either with Pdl₂ or with CuI to give the complex [Pd(μ-I)(P(iPr)(tBu)₂]₂. (F. Schoenebeck et al., Organometallics 2014, 33, 6879-6884). Both the use of Pdl₂ and the use of CuI is disadvantageous. This is because Pdl₂—just like PdBr₂—is firstly expensive and secondly usually has to be initially activated before it is used. CuI is relatively inexpensive. However, it cannot be ruled out that the desired target compound contains traces of CuI or another copper species. This is particularly disadvantageous with a view to using the [Pd(μ-I)(P(iPr)(tBu)₂]₂ complex as a catalyst or precatalyst.

EP 2 726 202 A1 discloses a method for preparing [Pd(μ-Br)(PtBu₃)]₂, which also makes use of a comproportionation reaction. In an aliphatic or aromatic solvent, the palladium(II) compound PdBr₂ and the palladium(0) compound [Pd(PtBu₃)₂] are reacted to give the desired target compound. Disadvantageously, PdBr₂ undergoes an aging process during storage over a relatively long period of time. Therefore, in a preferred variant embodiment of this method, before the above-mentioned reaction an additional work step is carried out, namely the activation of PdBr₂ by treating, e.g. dispersing, in a solvent. Depending on the degree of activation of PdBr₂, yields in the range of 70% to almost 90% are achieved. A disadvantage of this method is constituted by the additional time, cost and resources required because of the activation of the reactant PdBr₂. In addition, it cannot be ruled out that the end product will contain traces of PdBr₂.

According to WO 2011/012889 A1, the [Pd(μ-Br)(PtBu₃)]₂ complex is prepared using a mixture of [PdBr₂(diolefin)] and PtBu₃ in a solvent in the presence of an alkali metal hydroxide. 1,5-cyclooctadiene (COD) is mentioned as a preferred diolefin, in addition to 2,5-norbornadiene (NBD). However, both [PdBr₂(COD)] and [PdBr₂(NBD)] are difficult to handle. In particular, the compounds must be stored under an inert gas atmosphere at low temperatures. Another disadvantage is that these reactants are prepared from the respective chlorine derivative by halogen substitution with potassium bromide. Due to the associated high costs and the considerable noble metal losses, this is disadvantageous, particularly with regard to large-scale application. In addition, the target compound [Pd(μ-Br)(PtBu₃)]₂ can be contaminated by organic residues from the diolefin-containing reactant in question, which is particularly disadvantageous with regard to use as a catalyst or precatalyst.

Another possibility for preparing [Pd(μ-Br)(PtBu₃)]₂ is the autocatalytic oxidative addition of bromobenzene to [Pd(PtBu₃)₂]. However, in this case the target compound is only obtained in low yields of up to 16%, namely in a mixture with other palladium compounds such as (PtBu₃)Pd(Ph)Br and (PtBu₃)₂Pd(H)Br. (J. F. Hartwig et al., J. Am. Chem Soc. 2008, 130, 5842-5843)

WO 2018/073559 A1 describes, inter alia, a method for preparing [Pd(μ-Br)(PtBu₃)]₂, comprising the reaction of [Pd(diolefin)X₂] or PdX₂ in the absence of a base, wherein X is a halide.

π-allylpalladium chloride complexes can be obtained starting from both Pd(II) and Pd(0) by reaction with an organic substance having at least one double bond.

Friesen, R. W., Science of Synthesis: Product subclass 2: palladium—allyl complexes, Lautens, M., Eds.; Thieme: Stuttgart, (2001); vol. 1, p 113-264 gives some general methods for preparing π-allylpalladium chloride complexes: 1) transmetalations; 2) allylic hydrogen abstraction; 3) oxidative addition.

Preparation of the complexes via transmetalation can be effected via reaction of palladium(II) halides or acetates. To this end, Itoh, K.; Fukui, M.; Kurachi, Y., J. Chem. Soc., Chem. Commun., 1977, shows 500 corresponding reactions with allyl silanes, Watanabe, S.; Ogoshi, S.; Kakiuchi, K.; Kurosawa, H., J. Organomet. Chem., 1994, 481, shows 19 reactions with allyl stannanes, Henc, B.; et al., J. Organomet. Chem., 1980, 191, shows 425 reactions with allyl Grignard compounds and Nesmeyanov, A. N.; Rubezhov, A. Z., J. Organomet. Chem., 1979, 164, shows 259 with allyl mercury compounds.

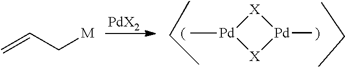

Several methods for the synthesis of the complexes via allylic hydrogen abstraction from alkenes using palladium(II) salts in combination with a base (usually acetate) are known. However, such reactions are often only applicable to a limited number of reaction partners, and stereoselectivity and regioselectivity can be a problem, as shown for example by Huttel, R.; Christ, H., Chem. Ber., 1963, 96, 3101.

A more generally applicable method with broad applicability is to treat 2:1 mixtures of alkene/palladium(II) chloride with sodium chloride, sodium acetate, and the weak oxidizing agent copper(II) chloride in glacial acetic acid, as shown by Huttel, R.; Christ, H., Chem. Ber., 1964, 97, 1439.

The use of copper(II) chloride increases the reproducibility of the reaction and improves the stereoselectivity and regioselectivity by favoring the abstraction of an allylic hydrogen at the more highly substituted end of the alkene.

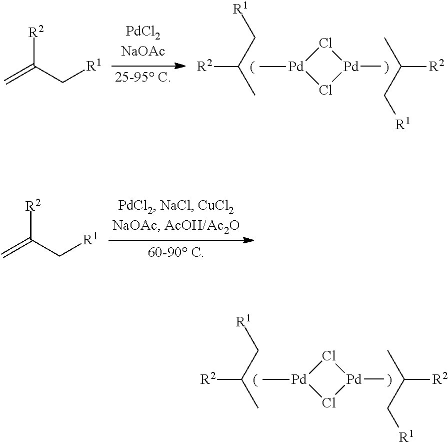

π-allylpalladium chloride complexes can also be obtained by inserting palladium(0) into allyl halides. This reaction can generally be achieved using tris(dibenzylideneacetone)dipalladium(0) ([Pd₂(dba)₃]) or palladium(II) chloride together with a reducing agent such as carbon monoxide/water (Dent, W. T.; Long, R.; Wilkinson, A. J., J. Chem. Soc., 1964, 1585), carbon monoxide/primary amine (Tsuji, J.; Iwamoto, N., Chem. Commun., 1966, 828), ethene/water (Hartley, F. R.; Jones, S. R., J. Organomet. Chem., 1974, 66, 465) or tin(II) chloride (Sakakibara, M.; Takahashi, Y.; Sakai, S.; Ishii, Y., Chem. Commun., 1969, 396).

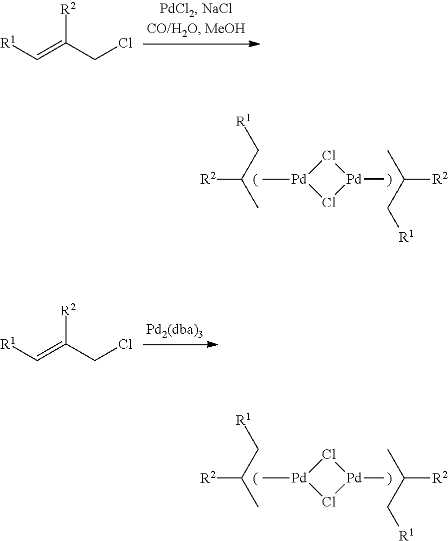

Several methods for preparing π-allylpalladium chloride complexes are available, while the preparation of η³-benzylpalladium halides (Roberts, J. S.; Klabunde, K. J., J. Organomet. Chem., 1975, 85, C13 and Roberts, J. S.; Klabunde, K. J., J. Am. Chem. Soc., 1977, 99, 2509) and arylpalladium halides (Klabunde, K. J., Angew. Chem., 1975, 87, 309) is restricted to the use of palladium vapor. In addition, to date it has only been possible to isolate pentafluorophenylpalladium halides at 25° C., while phenylpalladium halides decompose at temperatures higher than −116° C.

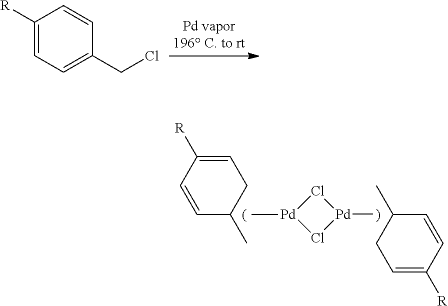

The object of the invention is therefore to overcome these and further disadvantages of the prior art and to provide a method by means of which homoleptic Pd(0)-phosphine complexes can be prepared with high purity and at good yields in a simple, reproducible and comparatively inexpensive manner. In particular, the purity of these compounds should meet the requirements placed on catalyst compounds. In addition, a method is to be provided by means of which heteroleptic Pd(0) complexes which have a phosphine ligand and a dvds ligand can be prepared with high purity and at good yields in a simple, reproducible and comparatively inexpensive manner. The purity of these Pd(0) compounds should, in particular, meet the requirements placed on catalyst compounds. In addition, new homoleptic Pd(0)-phosphine complexes and heteroleptic Pd(0) complexes which have a phosphine ligand and a dvds ligand are to be provided which are suitable as catalysts, in particular for organic coupling reactions. In addition, the object of the present invention is to provide a method by means of which compounds according to general formula [Pd(μ-X)(PR^{A}R^{B}R^{C})]₂ can be prepared with high purity and at good yields in a simple, reproducible and comparatively inexpensive manner. In particular, the purity of these compounds should meet the requirements placed on catalyst compounds. In addition, new compounds of the type [Pd(μ-X)(PR^{A}R^{B}R^{C})]₂ are to be provided which are suitable as catalysts, in particular for organic coupling reactions. Furthermore, an object of the present invention is to provide a new, simple method for preparing π-allylpalladium halide complexes that overcomes the disadvantages of the prior art. In particular, a method with higher yields, improved product quality and simplified access to η³-benzylpalladium halides or arylpalladium halides would be desirable. Moreover, new π-allylpalladium halide complexes are provided which are suitable as catalysts, in particular for organic coupling reactions. In particular, catalysts with higher yields, improved product quality and η³-benzylpalladium halides or arylpalladium halides would be desirable. The present invention also relates to the use of the palladium complexes provided.

The main features of the invention are defined in the claims.

The object is achieved by a method for preparing a compound according to general formula [PdZ^{A}Z^{B}] (I), wherein the phosphine ligands Z^{A} and Z^{B} are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp), comprising the steps of:
A. providing
i. a mononuclear or multinuclear palladium compound, in particular a palladium(0) compound, wherein at least one palladium center bears a ligand L_{S}, which is an organosilicon compound,
and
ii. in each case one phosphine ligand Z^{A} and Z^{B}, wherein
Z^{A} and Z^{B} are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp),
B. reacting the palladium compound and the monophosphine ligand and/or the bisphosphine ligand from step A. in a non-ethereal solvent S_{C},
and
C. optionally isolating, according to general formula [PdZ^{A}Z^{B}] (I), the compound prepared in step B.

According to the present invention, organosilicon compound means an alkyl or aryl derivative of silicon having one or more Si-heteroatom bonds selected from the group consisting of Si—C bonds, Si—N bonds, Si—O bonds. Apart from the metalloid silicon, the molecular formula of the organosilicon compound contains no metals or semi-metals, i.e. only non-metals. The organosilicon compound can also be a mixture of several different organosilicon compounds. For example, it can be a mixture consisting of different siloxanes. Alternatively, the organosilicon compound can also comprise a siloxane and a silazane, for example, or consist of these two organosilicon compounds.

The palladium compound to be provided in step A., which is in particular a palladium(0) compound, can be present in mononuclear or multinuclear, in particular dinuclear, form, as a monomer or oligomer, in particular dimer, or as a solvent adduct. The phosphine ligands Z^{A} and Z^{B} can each independently be monophosphine or bisphosphine ligands. In addition, they can be provided independently as a solid, liquid, solution or suspension, advantageously as a solution in one or more aromatic hydrocarbons, e.g. toluene, benzene, o-xylene, m-xylene, p-xylene, mesitylene, and mixtures and combinations thereof.

By means of the method described here, the preparation of homoleptic palladium(0) complexes such as [Pd(PtBu₃)₂] and [Pd(dppe)₂] (dppe=1,2-Bis(diphenylphosphino)ethane) is particularly simple, reproducible and comparatively inexpensive. The use of palladium(0) precursors provided in the prior art, some of which are expensive and/or difficult to handle, can be dispensed with. The target compounds of the type [PdZ^{A}Z^{B}] (I) are obtained with high purity, in particular high NMR purity, advantageously free from ether, and in satisfactory yields. In most cases, the yields achieved are at least comparable with the values given in the literature.

Due to the use of a non-ethereal solvent, contamination of the end products in the form of traces of oxygen (in the ppm range), in particular in the form of oxygen-containing solvents such as ethers, can be largely ruled out. In addition, it was surprisingly found that the target compounds of the type [PdZ^{A}Z^{B}] (I) do not contain impurities due to palladium-containing by-products that are difficult or impossible to separate, in particular due to their solubility behavior, for example [Pd(dvds)PtBu₃)], or only contain traces of said impurities (≤1000 ppm). The high purity of the end products according to formula I is particularly advantageous in view of possible uses, for example as catalysts, particularly in coupling reactions.

In contrast to the previously known synthesis strategies, palladium(0)-1,3-divinyl-1,1,3,3-tetramethyldisiloxane ([Pd₂(dvds)₃])—in the context of the present invention also abbreviated to [Pd(dvds)], Pd(vs), Pd—VS or palladium-VS—which is relatively easy to access and handle, and also comparatively inexpensive, can be used as reactant in the context of the method claimed herein. In addition, in the case of the method described herein, both the provision of the palladium compound in step A. and the reaction in step B. can take place without the addition of an olefin, for example an alkene or polyene. Here, polyene means in particular a diene, for example a 1,6-diene. The fact that the presence of an olefin, e.g. a 1,6-diene, can be dispensed with, surprisingly also applies when the palladium compound provided in step A. is [Pd₂(dvds)₃]. This is particularly advantageous, especially since the authors of a publication from 1999 (K.-R. Porschke et al., J. Am. Chem. Soc. 1999, 121, 9807-9823) state that even in a 1,3-divinyl-1,1,3,3-tetramethyldisiloxane solution of [Pd₂(dvds)₃], i.e. in the presence of an excess of dvds, the equilibrium lies on the side of the dinuclear complex [Pd₂(dvds)₃], i.e. only small amounts of the mononuclear complex [Pd(dvds)₂] are formed. Therefore, for the reaction of [Pd₂(dvds)₃] with PtBu₃ to give the heteroleptic palladium(0) complex [(tBu₃P)Pd(dvds)], wherein the molar ratio was 1:2, the authors used a dvds/Et₂O mixture as reaction medium (volumetric ratio 1:2).

The fact that, in the method described here, the presence of an olefin, e.g. a 1,6-diene, in particular when using a reactant such as [Pd₂(dvds)₃], is not required, represents an advantage, particularly from an economical (in terms of atoms) and ecological perspective. In addition, this reduces the number of possible impurities in the end product according to general formula I.

In an advantageous embodiment of the method described here for preparing compounds according to general formula [PdZ^{A}Z^{B}] (I), the ligand L_{S} is an organosilicon compound. According to an alternative or additional variant, the ligand L_{S} contains at least one terminal, in particular vinyl, double bond. It is even more advantageous if the ligand L_{S} contains two terminal double bonds. Alternatively or additionally, the ligand L_{S} is a cyclic or acyclic siloxane. It is particularly advantageous if the ligand L_{S} is a cyclic or acyclic siloxane selected from the group consisting of 1,1,3,3-tetramethyl-1,3-divinyldisiloxane, 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. In particular, the ligand L_{S} is 1,1,3,3-tetramethyl-1,3-divinyldisiloxane. The palladium compound to be provided in step A. can then be, for example, palladium(0)-1,3-divinyl-1,1,3,3-tetramethyldisiloxane ([Pd₂(dvds)₃]).

According to another embodiment of the method claimed here, a molar ratio of palladium:phosphine ligand Z^{A} and a molar ratio of palladium phosphine ligand Z^{B}, independently, is at least 1.0:1.0, for example 1.00:1.05 or 1.00:1.10 or 1.00:1.15 or 1.00:1.20 or 1.00:1.25 or 1.00:1.30 or 1.00:1.35 or 1.00:1.40 or 1.00:1.45 or 1.00:1.50, in particular in each case 1.0:1.0.

The solvent S_{C} may also be a mixture of solvents. The solvent or mixture of solvents S_{C} comprises or is, in particular, a solvent selected from the group consisting of aromatic hydrocarbons, ketones, e.g. acetone, and alcohols, e.g. methanol, ethanol or isopropanol, and mixtures thereof. The at least one aromatic hydrocarbon can be selected, for example, from the group consisting of benzene, toluene, o-xylene, m-xylene, p-xylene, mesitylene, and mixtures or combinations thereof.

The method can generally be carried out at reaction temperatures of 0° C. to 50° C., in particular 15° C. to 45° C. or 20° C. to 30° C.

The reaction times can be 10 minutes to 48 hours, in particular 1 hour to 36 hours or 2 hours to 24 hours or 3 hours to 12 hours.

Surprisingly, it was found that, by means of the method claimed here, in particular by the reaction of 1,3-divinyl-1,1,3,3-tetramethyldisiloxanepalladium(0) ([Pd₂(dvds)₃]) with tri-tert-butylphosphine, under the reaction conditions described above, Fu catalyst of the following formula (I.1) can usually be obtained in yields of mostly more than 90%, often more than 97%, in particular more than 99%, i.e. practically quantitatively:

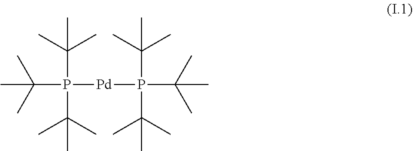

Another embodiment of the method provides that the phosphine ligands Z^{A} and Z^{B} are different or identical. In an advantageous variant embodiment, the phosphine ligands Z^{A} and Z^{B} are identical, i.e. Z^{A}=Z^{B}. Then, a molar ratio of palladium:phosphine ligand Z^{A} is at least 1.0:2.0, for example 1.00:2.05 or 1.00:2.10 or 1.00:2.15 or 1.00:2.20 or 1.00:2.25 or 1.00:2.30 or 1.00:2.35 or 1.00:2.40 or 1.00:2.45 or 1.00:2.50, in particular 1.0:2.0.

In a further method variant, the palladium compound in step A. is prepared by reacting a palladium(II) compound, which consists in particular of a palladium(II) cation and two monovalent anions or a divalent anion, with a ligand L_{S}, which is an organosilicon compound, in particular a cyclic or acyclic siloxane, in the presence of a base in situ in a solvent S_{D}.

In the present invention, the phrase “prepared in situ” or “produced in situ” means that the reactants required for the synthesis of a compound to be prepared in this way are reacted in a suitable stoichiometry in a solvent or mixture of solvents and the resulting product is not isolated. Instead, the solution or the suspension, which comprises the compound produced in situ, is generally reused directly, i.e. without isolation and/or further purification. The in situ production/preparation of a compound can take place in the reaction container provided for its further use or in a different reaction vessel.

The terms “reaction container” and “reaction vessel” in the context of the present invention are used synonymously and are not limited to a volume, material composition, equipment, or form. Suitable reaction vessels include, for example, glass flasks, enameled reactors, stirred tank reactors, pressure vessels, tube reactors, microreactors, and flow reactors.

The palladium(II) compound which is to be used as a reactant for the in situ production of the palladium compound to be provided in step A. may have two different or two identical monovalent anions or one divalent anion. A neutral ligand, for example COD, is not provided. Consequently, inexpensive commercially available palladium(II) compounds, such as PdCl₂, can advantageously be used. It is therefore possible to dispense with a time-consuming and costly preparation of a palladium(II) compound of the type [Pd(ligand)Y₂], wherein e.g. ligand=COD and Y═Cl, as a reactant for the in situ production of the palladium compound which is provided in step A. This is particularly advantageous from an economical (in terms of atoms) and ecological perspective. In addition, this reduces the number of possible impurities in the end product according to general formula I.

In a further advantageous embodiment, the palladium(II) compound to be used as reactant in the context of the above-mentioned in situ preparation comprises two identical monovalent anions which are in particular selected from the group consisting of halides and monovalent weakly coordinating anions.

The term “weakly coordinating” also covers the terms “very weakly coordinating” and “moderately strongly coordinating”. Chloride, bromide or iodide can advantageously be used as halide anions, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

In the context of the reaction described here, the term “bases” means inorganic and organic bases, in particular inorganic bases, but not organometallic bases. The bases should not decompose in water. Suitable bases are e.g. salts of Brønsted acids. Carbonates, hydrogen carbonates, acetates, formates, ascorbates, oxalates and hydroxides are advantageously used. These can be used in the form of their ammonium salts (Brønsted acid)NR₄, wherein R is for example H or alkyl, alkali metal salts, for example sodium or potassium salts, and alkaline-earth metal salts.

In particular, the solvent S_{C} and the solvent S_{D} are miscible or identical. There is then no need to change solvent, which is particularly advantageous from an economical and ecological perspective.

In the context of the present invention, two solvents are referred to as miscible if they are miscible at least during the respective reaction, that is, are not present as two phases.

A further variant of the method claimed here provides for the addition of a precipitating agent before and/or during and/or after step B., advantageously during and/or after step B., in particular after step B. The precipitating agent is advantageously a polar solvent which is miscible with the reaction medium from step B., in particular the solvent S_{C}. In particular, the polar solvent is an alcohol, e.g. selected from the group consisting of methanol, ethanol and isopropanol, and mixtures thereof.

According to another embodiment of the method, after the reaction in step B., a step C. is carried out which comprises isolation of the compound prepared in step B. according to general formula [PdZ^{A}Z^{B}] (I):
as a preparation which comprises [PdZ^{A}Z^{B}] (I) and a non-ethereal solvent, or
as a substance, advantageously as a solid.

Here and hereinafter, the term “preparation” means a solution, a suspension, a dispersion or a gel. The preparation can therefore be in the form of a solution, suspension, dispersion or gel, in particular depending on the non-ethereal solvent present and/or on the compound according to formula I present. The solvent can also be a mixture of solvents. In particular, the solvent comprises or is a solvent which is miscible with or identical to the solvent used, S_{C}. The preparation is then usually in the form of a solution or suspension.

In a further variant of the method, the isolation comprises a filtration step and/or decanting and/or centrifugation. The above-mentioned measures can also be carried out several times. Optionally, one or more filtrations over a cleaning medium, for example activated carbon or silica, e.g. Celite®, can take place. Advantageously, the filtrate, centrifugate, or decantate or the solid may be subjected to purification and/or isolation steps which may be carried out rapidly and without complication and without special effort in terms of preparation.

The isolation of the compound according to general formula [PdZ^{A}Z^{B}](1) may comprise further method steps, for example the reduction of the mother liquor volume, i.e. concentrating it, for example by means of “bulb-to-bulb,” the addition of a solvent and/or a solvent exchange in order to precipitate the product from the mother liquor and/or to remove impurities and/or reactants, crystallization, sublimation, washing, e.g. with an alcohol such as ethanol, methanol or isopropanol, and mixtures thereof, and drying of the product. The aforementioned steps may each be provided in different orders and frequencies.

Overall, the purification and/or isolation of the target compound according to general formula [PdZ^{A}Z^{B}] (I) is relatively simple and inexpensive.

In general, the end product may still contain residues of solvents or for example impurities from the reactants. Isolated compounds of the type [PdZ^{A}Z^{B}] (I) have a purity of at least 97%, advantageously more than 97%, in particular more than 98% or 99%. Even in the case of scaling up toward an industrial scale, the reproducible yield is usually 50%, in particular depending on the choice of reactant and of solvent or mixture of solvents.

The object is also achieved by a compound according to general formula [PdZ^{A}Z^{B}] (I), obtained or obtainable by a method for preparing such compounds according to one of the exemplary embodiments described above, with the exception of the compounds [Pd(P(iPr)tBu₂)₂] and [Pd(P(1-Ad)tBu₂)₂].

The palladium(0) compounds of general formula [PdZ^{A}Z^{B}] (I) can also be present in mononuclear or multinuclear, in particular dinuclear, form, as a monomer or oligomer, in particular dimer, or as a solvent adduct. For example, they can be used as catalysts, in particular as catalysts in palladium-catalyzed cross-coupling reactions.

In particular, the compounds [Pd(PtBu₃)₂], [Pd(PtBu₃)(P(1-Ad)tBu₂)], [Pd(PtBu₃)(P(1-Ad)iPr₂)], [Pd(P(1-Ad)₂tBu)₂], [Pd(P(1-Ad)₂iPr)₂], [Pd(P(1-Ad)tBu₂)(P(1-Ad)iPr₂)], [Pd(P(1-Ad)iPr₂)₂], [Pd(P(iPr)₂tBu)₂], [Pd(dppe)₂] and [Pd(dppp)₂] can be obtained by means of the method described above.

The object is also achieved by new compounds according to general formula [PdZ^{A}Z^{B}] (I), wherein these are the compounds [Pd(PtBu₃)(P(1-Ad)tBu₂)], [Pd(PtBu₃)(P(1-Ad)iPr₂)], [Pd(P(1-Ad)₂tBu)₂], [Pd(P(1-Ad)₂iPr)₂], [Pd(P(1-Ad)tBu₂)(P(1-Ad)iPr₂)], [Pd(P(1-Ad)iPr₂)₂], [Pd(P(iPr)₂tBu)₂], [Pd(dppe)₂] and [Pd(dppp)₂]. These are suitable as catalysts for the reactions given below.

Furthermore, the object is achieved by a preparation containing
i. a compound according to general formula [PdZ^{A}Z^{B}] (I), wherein Z^{A} and Z^{B} are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp),
and
ii. at least one organosilicon compound.

A definition of the term organosilicon compound has already been given above.

In one embodiment of the claimed preparation, the compound contained therein according to general formula [PdZ^{A}Z^{B}] (I), or the preparation itself, is in particular obtained or obtainable by a method for preparing such a compound according to one of the exemplary embodiments described above.

According to one embodiment of the preparation, a silicon content, which is present in particular in the form of the at least one organosilicon compound, is ≥100 ppm and ≤1000 ppm, advantageously ≥110 ppm and ≤900 ppm, in particular ≥120 ppm and ≤800 ppm. The silicon content, which is present in particular in the form of the at least one organosilicon compound, can be determined using analysis methods which are known to those skilled in the art, in particular using quantitative ¹H NMR spectroscopy and/or atomic emission spectrometry with inductively coupled plasma (Inductively Coupled Plasma Atomic Emission Spectrometers, ICP-AES).

In an alternative or supplementary embodiment of the preparation claimed here, the preparation contains a solvent S_{Z}, in particular a non-ethereal solvent.

The preparation can be in the form of a solution, suspension, dispersion or gel, in particular depending on the organosilicon compound present and/or on the solvent S_{Z} used. The solvent S_{Z} can also be a mixture of solvents. It is advantageously selected from the group consisting of alkanes, aromatic hydrocarbons and polar solvents, advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited. In particular, if the solvent S_{Z} comprises or is a solvent selected from the group consisting of aromatic hydrocarbons, ketones, e.g. acetone, and alcohols, e.g. methanol, ethanol or isopropanol, and mixtures thereof, the preparation is in the form of a solution or suspension. In this case, the at least one aromatic hydrocarbon can be selected, for example, from the group consisting of benzene, toluene, o-xylene, m-xylene, p-xylene, mesitylene, and mixtures or combinations thereof.

Another variant of the preparation provides that the solvent S_{Z} is miscible with or identical to the solvent S_{C}, which is used in the method for preparing the compound according to formula I.

According to a variant of the claimed preparation, the at least one organosilicon compound contains at least one terminal, in particular vinyl, double bond. In particular, the at least one organosilicon compound comprises or is a cyclic or an acyclic siloxane. According to an alternative or supplementary embodiment of the preparation, the preparation contains, in addition to the palladium compound according to general formula [PdZ^{A}Z^{B}] (I), at least one palladium compound according to general formula [L_{S}PdZ] (II) and/or at least one palladium compound according to general formula [Pd(L_{S})₂](III), wherein
the ligand L_{S} is in particular identical to the at least one organosilicon compound, in particular a cyclic or an acyclic siloxane, and wherein the at least one organosilicon compound contains at least one terminal double bond,
and
Z is selected from the group consisting of tri-tert-butylphosphine (PtBu₃), di-tert-butyl(isopropyl)phosphine (P(iPr)tBu₂), tert-butyl-di(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), di(1-adamantyl)-isopropylphosphine (P(1-Ad)₂iPr), 1-adamantyl-di(isopropyl)phosphine (P(1-Ad)iPr₂), 1,2-bis(diphenylphosphino)ethane (dppe) and 1,3-bis-(diphenylphosphino)-propane (dppp).

In particular, the ligand L_{S} is identical to the organosilicon compound, wherein the ligand L_{S} is in particular a cyclic or an acyclic siloxane which has at least one terminal, in particular vinyl, double bond. The ligand L_{S} is then advantageously coordinated or bonded via at least one pi-directed bond to the palladium center of the compound according to general formula [L_{S}PdZ] (II) or [Pd(L_{S})₂] (III).

Yet another variant embodiment of the claimed preparation provides that one of the organosilicon compounds comprises or is a cyclic or an acyclic siloxane and/or one of the ligands L_{S} is a cyclic or an acyclic siloxane selected from the group consisting of 1,1,3,3-tetramethyl-1,3-divinyldisiloxane, 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. Advantageously, one of the organosilicon compounds comprises or is 1,1,3,3-tetramethyl-1,3-divinyldisiloxane (dvds) and/or one of the ligands L_{S} is 1,1,3,3-tetramethyl-1,3-divinyldisiloxane (dvds). In particular, one of the organosilicon compounds and/or one of the ligands L_{S} is dvds.

In addition, the object is achieved by new compounds according to general formula [PdZ^{A}Z^{B}] (I), wherein Z^{A} and Z^{B} are independently selected from the group consisting of 1,2-bis(diphenylphosphino)ethane (dppe) and 1,3-bis(diphenylphosphino)propane (dppp). For example, these compounds can be used as catalysts, in particular as catalysts in palladium-catalyzed cross-coupling reactions.

The object is furthermore achieved by a method for preparing a compound according to general formula [LPd(dvds)] (IV)

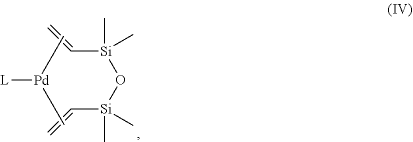

wherein L is a phosphine ligand
and excluding compounds according to general formula IV in which L is selected from the group consisting of tri-tert-butylphosphine (PtBu₃), di-tert-butyl(isopropyl)phosphine (P(iPr)tBu₂), tert-butyl-di-(isopropyl)phosphine (P(iPr₂)tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)-isopropylphosphine (P(1-Ad)₂iPr), 1,2-bis(diphenylphosphino)ethane (dppe) and 1,3-bis-(diphenylphosphino)propane (dppp), comprising the steps of:
A. providing
i. a mononuclear or multinuclear palladium compound, in particular a palladium(0) compound, wherein at least one palladium center bears a 1,3-divinyl-1,1,3,3-tetramethyldisiloxane ligand, and
ii. a phosphine ligand L, with the exception of phosphine ligands selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp),
B. reacting the palladium compound and the phosphine ligand L from step A. in a non-ethereal solvent SE, and
C. optionally isolating the compound according to general formula [LPd(dvds)](IV) prepared in step B.

The palladium compound to be provided in step A., which is in particular a palladium(0) compound, can be present in mononuclear or multinuclear, in particular dinuclear, form, as a monomer or oligomer, in particular dimer, or as a solvent adduct. The provision of the palladium compound in step A. and the reaction in step B. take place without the addition of an olefin, for example an alkene or polyene. Here, polyene means in particular a diene, for example a 1,6-diolefin. The phosphine ligand can be provided as a solid, liquid, solution or suspension, in particular as a solution in one or more aromatic hydrocarbons, e.g. toluene, benzene, o-xylene, m-xylene, p-xylene, mesitylene, and mixtures or combinations thereof.

According to one embodiment of the method claimed here for preparing compounds according to formula IV, the phosphine ligand L is
a tertiary phosphine according to general formula P—R10R20R30, wherein R10 and R20 are independently selected from the group consisting of substituted and unsubstituted straight-chain alkyl radicals, substituted and unsubstituted branched alkyl radicals, substituted and unsubstituted cycloalkyl radicals, substituted and unsubstituted aryl radicals, and substituted and unsubstituted heteroaryl radicals, wherein the heteroatoms are selected from the group consisting of sulfur, nitrogen and oxygen, and R30 is defined as R10 and R20 or is a metallocenyl radical, or
selected from the group consisting of 2-(dicyclohexylphosphino)-2′-(N,N-dimethylamino))-1,1′-biphenyl (DavePhos), 2-(dicyclohexylphosphino)-2′,4′,6′-triisopropyl-1,1′-biphenyl (XPhos), 2-dicyclohexylphosphino-2′,6′-dimethoxy-1,1′-biphenyl (SPhos), 2-dicyclohexylphosphino-2′,6′-diisopropoxy-1,1′-biphenyl (RuPhos), 2-(dicyclohexylphosphino)-3,6-dimethoxy-2′,4′,6′-triisopropyl-1,1′-biphenyl (BrettPhos), [4-(N,N-dimethylamino)phenyl]di-tert-butylphosphine (Amphos), 9,9-dimethyl-4,5-bis(diphenylphosphino)xanthene (Xantphos), 2-dicyclohexylphosphino-2′,6′-bis(dimethylamino)-1,1′-biphenyl (CPhos), tricyclohexylphosphine (PCy₃), di-(1-adamantyl)-n-butylphosphine (cataCXium® A), 2-di-tert-butylphosphino-2′,4′,6′-triisopropyl-1,1′-biphenyl (t-BuXPhos), 2-(di-tert-butylphosphino)-3,6-dimethoxy-2′,4′,6′-triisopropyl-1,1′-biphenyl (tert-BuBrettPhos), 2-(di-tert-butylphosphino)-3-methoxy-6-methyl-2′,4′,6′-triisopropyl-1,1′-biphenyl (RockPhos), 2-di[3,5-bis(trifluoromethyl)phenylphosphino]-3,6-dimethoxy-2′,4′,6′-triisopropyl-1,1′-biphenyl (JackiePhos), 2-(di-tert-butylphosphino)-biphenyl (JohnPhos), (R)-(−)-1-[(S)-2-(dicyclohexylphosphino)ferrocenyl]ethyldi-tert-butylphosphine, di-tert-butyl(n-butyl)phosphine, 2-(di-1-adamantylphosphino)-3,6-dimethoxy-2′,4′,6′-triisopropyl-1,1′-biphenyl (AdBrettPhos), 2-diethylphosphino-2′,6′-bis(dimethylamino)-1,1′-biphenyl, racemic 2-di-tert-butylphosphino-1,1′-binaphthyl (TrixiePhos), triisopropylphosphine (PiPr3), 1,3,5,7-tetramethyl-8-phenyl-2,4,6-trioxa-8-phosphaadamantane (MeCgPPh), N-[2-(di-1-adamantylphosphino)phenyl]morpholine (MorDalPhos), 4,6-bis(diphenylphosphino)phenoxazine (NiXantphos), 1,1′-bis(diphenylphosphino)ferrocene (dppf), 2-di-tert-butylphosphino-2′-(N,N-dimethylamino))-1,1′-biphenyl (tBuDavePhos), racemic 2,2′-bis(diphenylphosphino)-1,1′-binaphthyl (rac-BINAP), 1,1′-bis(di-tert-butylphosphino)ferrocene (DTBPF), 2-di-tert-butylphosphino-3,4,5,6-tetramethyl-2′,4′,6′-triisopropyl)-1,1′-biphenyl (Me₄t-BuXPhos), 2-dicyclohexylphosphino-4-(N,N-dimethylamino)-1,1′-biphenyl, trimethylphosphine (PMe₃), tris-p-tolylphosphine (P(p-tolyl)₃), tris-o-tolylphosphine (P(o-tolyl)₃), methyldiphenylphosphine, triphenylphosphine (PPh₃), tris-(pentafluorophenyl)-phosphine (P(C₆F₅)₃), trifluorophosphine, tert-butyldiphenylphosphine (P(tBu)Ph₂), phenyl-di-tert-butylphosphine, di-tert-butyl-neopentylphosphine, 1,2,3,4,5-pentaphenyl-1′-(di-tert-butylphosphino)ferrocene, tris(p-methoxyphenyl)phosphine, tris(p-trifluoromethylphenyl)phosphine, tris(2,4,6-trimethoxyphenyl)phosphine, tris(2,4,6,-trimethyl)phosphine, tris(2,6-dimethylphenyl)phosphine, benzyldi-1-adamantylphosphine, cyclohexyldi-tert-butylphosphine, cyclohexyldiphenylphosphine, 2-di-tert-butylphosphino-1,1′-binaphthyl, 2-(di-tert-butylphosphino)biphenyl, 2-di-tert-butylphosphino-2′-methylbiphenyl, 2-di-tert-butylphosphino-2′,4′,6′-triisopropyl-1,1′-biphenyl, 2-di-tert-butylphosphino-3,4,5,6-tetramethyl-2′,4′,6′-triisopropylbiphenyl, 2-(dicyclohexylphosphino)biphenyl (Cyclohexyl-JohnPhos), 2-(dicyclohexylphosphino)-2′,6′-dimethoxy-1,1′-biphenyl, 2-di-tert-cyclohexylphosphino-2′-(N,N-dimethylamino)biphenyl, 2-di-tert-cyclohexylphosphino-2′,6′-diisopropoxy-1,1′-biphenyl, 2-(dicyclohexylphosphino)-2′,4′,6′-triisopropyl-1,1′-biphenyl, 2-di-cyclohexylphosphino-2′-methylbiphenyl, 2-diphenylphosphino-2′-(N,N-dimethylamino)biphenyl, (4-dimethylaminophenyl)(tert-butyl)₂-phosphine, 1,2-bis(di-tert-butylphosphinomethyl)benzene, 1,3-bis(di-tert-butylphosphinomethyl)propane, 1,2-bis(diphenylphosphinomethyl)benzene, 1,2-bis(di-phenylphosphino)ethane, 1,2-bis(diphenylphosphino)propane, 1,2-bis(diphenylphosphino)butane, N-(2-methoxyphenyl)-2-(di-tert-butylphosphino)pyrrole, 1-(2-methoxyphenyl)-2-(di-cyclohexylphosphino)pyrrole, N-phenyl-2-(di-tert-butylphosphino)indole, N-phenyl-2-(di-tert-butylphosphino)pyrrole, N-phenyl-2-(dicyclohexylphosphino)indole, N-phenyl-2-(dicyclohexylphosphino)pyrrole, 1-(2,4,6-trimethylphenyl)-2(dicyclohexylphosphino)imidazole and (S)-7,7′-bis(diphenylphosphino)-3,3′,4,4′-tetrahydro-4,4′-dimethyl-8,8′-bi(2H-1,4-benzoxazine) (Solphos).

In the tertiary phosphine according to general formula P—R10R20R30, R10 and R20 can independently be substituted and unsubstituted branched or straight-chain alkyl groups, for example methyl, ethyl, n-propyl, isopropyl, n-butyl, isobutyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantyl, or aryl groups such as phenyl, naphthyl or anthracyl.

In one embodiment, the alkyl groups of the tertiary phosphine according to general formula P—R10R20R30 can be optionally substituted with one or more substituents such as halide (F, Cl, Br or I) or alkoxy groups, e.g. methoxy, ethoxy or propoxy. The aryl groups may be optionally substituted with one or more (e.g. 1, 2, 3, 4 or 5) substituents such as halide (F, Cl, Br or I), straight-chain or branched alkyl groups (e.g. C1-C10 alkyl), alkoxy (e.g. C1-C10 alkoxy), straight-chain or branched (dialkyl)amino groups (e.g. C1-C10 dialkylamino), heterocycloalkyl (e.g. C3-C10 heterocycloalkyl groups such as morpholinyl and piperadinyl) or trihalomethyl (e.g. trifluoromethyl). Suitable substituted aryl groups include, but are not limited to, 4-dimethylaminophenyl, 4-methylphenyl, 3,5-dimethylphenyl, 4-methoxyphenyl, and 4-methoxy-3,5-dimethylphenyl. Substituted and unsubstituted heteroaryl groups such as pyridyl, furanyl, thiophenyl, pyrrolyl, or quinolinyl can also be used. In an alternative embodiment, R10 and R20 of the tertiary phosphine according to general formula P—R10R20R30 are joined together and form a ring structure with the phosphorus atom, in particular a four- to seven-membered ring. In particular, R10 and R20 are the same and are tert-butyl, cyclohexyl, phenyl or substituted phenyl groups. In particular, R10 and R20 are tert-butyl. In addition, R10 and R20 may independently be alkoxy (e.g. C1-C10 alkoxy) or aryloxy (e.g. C1-C10 aryloxy). R30 is defined like R10 and R20, but can also be a metallocenyl radical.

In the latter embodiment, R30 is a substituted or unsubstituted metallocenyl group. In this case, the metallocenyl group has a first cyclopentadienyl radical and a second cyclopentadienyl radical. A number p of radicals R40 can optionally be provided on the first cyclopentadienyl radical via which the tertiary phosphine according to general formula P—R10R20R30 is bonded or coordinated to the palladium center, and a number q of radicals R41 can optionally be provided on the second cyclopentadienyl radical. R40 and R41 are independently organic groups having 1 to 20 carbon atoms. R40 and R41 can independently be defined like R10 and R20.

p can assume the values 0, 1, 2, 3 or 4 and q can assume the values 0, 1, 2, 3, 4 or 5. In one possible embodiment, q=5 and R41 is methyl or phenyl. In another embodiment, p=0.

In a specific embodiment, p=0, q=5, R10 is methyl or phenyl, and R10 and R20 are tert-butyl (QPhos), or R10 and R20 are tert-butyl and R30 is 4-dimethylaminophenyl (AmPhos), or R10 and R20 are tert-butyl and R30 is phenyl.

In another embodiment, R10, R20 and R30 are the same and are 1-adamantyl, 2-adamantyl, phenyl, ortho-tolyl, cyclohexyl, tert-butyl, or R10 and R20 are 1-adamantyl or 2-adamantyl and R30 is n-butyl.

Surprisingly, the method described here can be used to prepare a large number of compounds according to general formula IV in a relatively simple and inexpensive manner and also reproducibly and with high purity, in particular with high NMR purity, advantageously ether-free and in satisfactory yields. Thus, for example, starting from the palladium(0) complex [Pd₂(dvds)₃], it was possible to obtain the palladium(0) complex compounds [Pd(PCy₃)(dvds)], [Pd(PiPr3)(dvds)], [Pd(P(1-Ad)₂Bu)(dvds)] and [Pd(P(tBu₂)iPr)(dvds)] in yields of ≥50%, in some cases of ≥60%. Due to the use of a non-ethereal solvent, contamination of the end products in the form of traces of oxygen (in the ppm range), in particular in the form of oxygen-containing solvents such as ethers, can be largely ruled out. This is advantageous with a view to possible uses of the end products according to formula IV, for example as catalysts, in particular as catalysts in palladium-catalyzed coupling reactions.

The fact that a large number of compounds according to general formula IV can be prepared by means of the method described above is particularly surprising because the method can be carried out without the addition of an olefin, in particular without the addition of a 1,6-diene, for example 1,3-divinyl-1,1,3,3-tetramethyldisiloxane (dvds). This also applies—in contrast to the synthesis route described by Krause et al—even when the palladium compound provided in step A. is the palladium(0) complex [Pd₂(dvds)₃], which is also in particular present in dinuclear form in solution.

Dispensing with the addition of an olefin is particularly advantageous from an economical (in terms of atoms) and ecological perspective. In addition, this further reduces the number of possible impurities in the end product according to general formula IV.

According to one embodiment, a molar ratio of palladium:phosphine ligand L is at least 1.0:1.0, for example 1.00:1.05 or 1.00:1.10 or 1.00:1.15 or 1.00:1.20 or 1.00:1.25 or 1.00:1.30 or 1.00:1.35 or 1.00:1.40 or 1.00:1.45 or 1.00:1.50, in particular 1.0:1.0.

The solvent SE may also be a mixture of solvents. The solvent or mixture of solvents SE comprises or is, in particular, a solvent selected from the group consisting of aromatic hydrocarbons, ketones, e.g. acetone, and alcohols, e.g. methanol, ethanol or isopropanol, and mixtures thereof. The at least one aromatic hydrocarbon can be selected, for example, from the group consisting of benzene, toluene, o-xylene, m-xylene, p-xylene, mesitylene, and mixtures or combinations thereof.

In one variant embodiment of the claimed method for preparing compounds of the type [LPd(dvds)] (IV), the palladium compound in step A. is prepared by reacting a palladium(II) compound, which consists in particular of a palladium(II) cation and two anions, with a ligand L_{S}, which is an organosilicon compound, in particular a cyclic or acyclic siloxane, in the presence of a base in situ in a solvent SF.

In the context of the reaction described here, the term “bases” means inorganic and organic bases, in particular inorganic bases, but not organometallic bases. The bases should not decompose in water. Suitable bases are e.g. salts of Brønsted acids. Carbonates, hydrogen carbonates, acetates, formates, ascorbates, oxalates and hydroxides are advantageously used. These can be used in the form of their ammonium salts (Brønsted acid)NR₄, wherein R is for example H or alkyl, alkali metal salts, for example sodium or potassium salts, and alkaline-earth metal salts.

In particular, the solvent SE and the solvent SF are miscible or identical. There is then no need to change solvent, which is particularly advantageous from an economical and ecological perspective. In the context of the present invention, two solvents are referred to as miscible if they are miscible at least during the respective reaction, that is, are not present as two phases.

According to another embodiment of the method, after the reaction in step B., a step C. is carried out which comprises isolation of the compound prepared in step B. according to general formula [LPd(dvds)] (IV):
as a preparation which comprises a compound according to general formula [LPd(dvds)] (IV) and a non-ethereal solvent, or
as a substance, advantageously as a solid.

The preparation can therefore be in the form of a solution, suspension, dispersion or gel, in particular depending on the non-ethereal solvent present and/or on the compound according to formula [LPd(dvds)] (IV) present. The solvent can also be a mixture of solvents. In particular, the solvent comprises or is a solvent which is miscible with or identical to the solvent used, SE. The preparation is then usually in the form of a solution or suspension.

In a further variant of the method, the isolation comprises a filtration step and/or decanting and/or centrifugation. The above-mentioned measures can also be carried out several times. Optionally, one or more filtrations over a cleaning medium, for example activated carbon or silica, e.g. Celite®, can take place. Advantageously, the filtrate, centrifugate, or decantate or the solid may be subjected to purification and/or isolation steps which may be carried out rapidly and without complication and without special effort in terms of preparation.

The isolation of the compound according to general formula [LPd(dvds)](IV) may comprise further method steps, for example the reduction of the mother liquor volume, i.e. concentrating it, for example by means of “bulb-to-bulb,” the addition of a solvent and/or a solvent exchange in order to precipitate the product from the mother liquor and/or to remove impurities and/or reactants, crystallization, sublimation, washing, e.g. with an alcohol such as ethanol, methanol or isopropanol, and mixtures thereof, and drying of the product. The aforementioned steps may each be provided in different orders and frequencies.

Overall, the purification and/or isolation of the target compound according to general formula [LPd(dvds)] (IV) is relatively simple and inexpensive.

In general, the end product may still contain residues of solvents or for example impurities from the reactants. Isolated compounds of the type [LPd(dvds)] (IV) have a purity of at least 97%, advantageously more than 97%, in particular more than 98% or 99%. Even in the case of scaling up toward an industrial scale, the reproducible yield is usually ≥50%, in some cases ≥60%, in particular depending on the choice of reactant and of solvent or mixture of solvents.

The object is also achieved by a compound according to general formula [LPd(dvds)] (IV), obtained or obtainable by a method according to one of the embodiments described above, wherein L is as defined above and excluding compounds according to general formula IV in which L is selected from the group consisting of tri-tert-butylphosphine (PtBu₃), tri-iso-propylphosphine (PiPr3), trimethylphosphine (PMe₃), tricyclohexylphosphine (PCy₃), tris-o-tolylphosphine (P(o-tolyl)₃), triphenylphosphine (PPh₃), di-tert-butyl(isopropyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)-isopropylphosphine (P(1-Ad)₂iPr), 1,2-bis(diphenylphosphino)ethane (dppe) and 1,3-bis(diphenylphosphino)propane (dppp).

The palladium(0) compounds according to general formula [LPd(dvds)](IV) claimed here, obtained or obtainable by a method according to one of the embodiments described above, can be used, for example, as catalysts, in particular as catalysts in palladium-catalyzed cross-coupling reactions. Advantageously, they are suitable as catalysts for the reactions given below.

The object is also achieved by a compound according to general formula IV

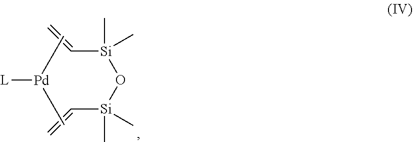

wherein L is a phosphine ligand
and excluding compounds according to general formula IV in which L is selected from the group consisting of tri-tert-butylphosphine (PtBu₃), tri-iso-propylphosphine (PiPr3), trimethylphosphine (PMe₃), tricyclohexylphosphine (PCy₃), tris-o-tolylphosphine (P(o-tolyl)₃), triphenylphosphine (PPh₃), di-tert-butyl(isopropyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)-isopropylphosphine (P(1-Ad)₂iPr), 1,2-bis(diphenylphosphino)ethane (dppe) and 1,3-bis(diphenylphosphino)propane (dppp).

The palladium(0) compounds according to general formula [LPd(dvds)](IV) claimed here can be used, for example, as catalysts, in particular as catalysts in palladium-catalyzed cross-coupling reactions.

In one embodiment of the compounds according to formula IV claimed here, the phosphine ligand L is
a tertiary phosphine according to general formula P—R10R20R30, wherein R10 and R20 are independently selected from the group consisting of substituted and unsubstituted straight-chain alkyl radicals, substituted and unsubstituted branched alkyl radicals, substituted and unsubstituted cycloalkyl radicals, substituted and unsubstituted aryl radicals, and substituted and unsubstituted heteroaryl radicals, wherein the heteroatoms are selected from the group consisting of sulfur, nitrogen and oxygen, and R30 is defined as R10 and R20 or is a metallocenyl radical, or
selected from the group consisting of 2-(dicyclohexylphosphino)-2′-(N,N-dimethylamino))-1,1′-biphenyl (DavePhos), 2-(dicyclohexylphosphino)-2′,4′,6′-tri-isopropyl-1,1′-biphenyl (XPhos), 2-dicyclohexylphosphino-2′,6′-dimethoxy-1,1′-biphenyl (SPhos), 2-dicyclohexylphosphino-2′,6′-di-isopropoxy-1,1′-biphenyl (RuPhos), 2-(dicyclohexylphosphino)-3,6-dimethoxy-2′,4′,6′-tri-isopropyl-1,1′-biphenyl (BrettPhos), [4-(N,N-dimethylamino)phenyl]di-tert-butylphosphine (Amphos), 9,9-dimethyl-4,5-bis(diphenylphosphino)xanthene (Xantphos), 2-dicyclohexylphosphino-2′,6′-bis(dimethylamino)-1,1′-biphenyl (CPhos), di-(1-adamantyl)-n-butylphosphine (cataCXium® A), 2-di-tert-butylphosphino-2′,4′,6′-tri-isopropyl-1,1′-biphenyl (t-BuXPhos), 2-(di-tert-butylphosphino)-3,6-dimethoxy-2′,4′,6′-tri-isopropyl-1,1′-biphenyl (tert-BuBrettPhos), 2-(di-tert-butylphosphino)-3-methoxy-6-methyl-2′,4′,6′-tri-isopropyl-1,1′-biphenyl (RockPhos), 2-di[3,5-bis(trifluoromethyl)phenylphosphino]-3,6-dimethoxy-2′,4′,6′-tri-isopropyl-1,1′-biphenyl (JackiePhos), 2-(di-tert-butylphosphino)-biphenyl (JohnPhos), (R)-(−)-1-[(S)-2-(dicyclohexylphosphino)ferrocenyl]ethyldi-tert-butylphosphine, di-tert-butyl(n-butyl)phosphine, 2-(di-1-adamantylphosphino)-3,6-dimethoxy-2′,4,6-tri-isopropyl-1,1′-biphenyl (AdBrettPhos), 2-diethylphosphino-2′,6′-bis(dimethylamino)-1,1′-biphenyl, racemic 2-di-tert-butylphosphino-1,1′-binaphthyl (TrixiePhos), 1,3,5,7-tetramethyl-8-phenyl-2,4,6-trioxa-8-phosphaadamantane (MeCgPPh), N-[2-(di-1-adamantylphosphino)phenyl]morpholine (MorDalPhos), 4,6-bis(diphenylphosphino)phenoxazine (NiXantphos), 1,1′-bis(diphenylphosphino)ferrocene (dppf), 2-di-tert-butylphosphino-2′-(N,N-dimethylamino))-1,1′-biphenyl (tBuDavePhos), racemic 2,2′-bis(diphenylphosphino)-1,1′-binaphthyl (rac-BINAP), 1,1′-bis(di-tert-butylphosphino)ferrocene (DTBPF), 2-di-tert-butylphosphino-3,4,5,6-tetramethyl-2′,4′,6′-tri-iso-propyl)-1,1′-biphenyl (Me₄t-BuXPhos), 2-dicyclohexylphosphino-4-(N,N-dimethylamino)-1,1′-biphenyl, methyldiphenylphosphine, tris-(pentafluorophenyl)-phosphine (P(C₆F₅)₃), trifluorophosphine, tert-butyldiphenylphosphine (P(tBu)Ph₂), phenyl-di-tert-butylphosphine, di-tert-butyl-neopentylphosphine, 1,2,3,4,5-pentaphenyl-1′-(di-tert-butylphosphino)ferrocene, tris(p-methoxyphenyl)phosphine, tris(p-trifluoromethylphenyl)phosphine, tris(2,4,6-trimethoxyphenyl)phosphine, tris(2,4,6,-trimethyl)phosphine, tris(2,6-dimethylphenyl)phosphine, benzyldi-1-adamantylphosphine, cyclohexyldi-tert-butylphosphine, cyclohexyldiphenylphosphine, 2-di-tert-butylphosphino-1,1′-binaphthyl, 2-(di-tert-butylphosphino)biphenyl, 2-di-tert-butylphosphino-2′-methylbiphenyl, 2-di-tert-butylphosphino-2′,4′,6′-tri-iso-propyl-1,1′-biphenyl, 2-di-tert-butylphosphino-3,4,5,6-tetramethyl-2′,4′,6′-tri-isopropylbiphenyl, 2-(dicyclohexylphosphino)biphenyl (Cyclohexyl-JohnPhos), 2-(dicyclohexylphosphino)-2′,6′-dimethoxy-1,1′-biphenyl, 2-di-tert-cyclohexylphosphino-2′-(N,N-dimethylamino)biphenyl, 2-di-tert-cyclohexylphosphino-2′,6′-di-isopropoxy-1,1′-biphenyl, 2-(dicyclohexylphosphino)-2′,4′,6′-tri-isopropyl-1,1′-biphenyl, 2-dicyclohexylphosphino-2′-methylbiphenyl, 2-diphenylphosphino-2′-(N,N-dimethylamino)biphenyl, (4-dimethylaminophenyl)(tert-butyl)₂-phosphine, 1,2-bis(di-tert-butylphosphinomethyl)benzene, 1,3-bis(di-tert-butylphosphinomethyl)propane, 1,2-bis(diphenylphosphinomethyl)benzene, 1,2-bis(di-phenylphosphino)ethane, 1,2-bis(diphenylphosphino)propane, 1,2-bis(diphenylphosphino)butane, N-(2-methoxyphenyl)-2-(di-tert-butylphosphino)pyrrole, 1-(2-methoxyphenyl)-2-(di-cyclohexylphosphino)pyrrole, N-phenyl-2-(di-tert-butylphosphino)indole, N-phenyl-2-(di-tert-butylphosphino)pyrrole, N-phenyl-2-(dicyclohexylphosphino)indole, N-phenyl-2-(dicyclohexylphosphino)pyrrole, 1-(2,4,6-trimethylphenyl)-2(dicyclohexylphosphino)imidazole and (S)-7,7′-bis(diphenylphosphino)-3,3′,4,4′-tetrahydro-4,4′-dimethyl-8,8′-bi(2H-1,4-benzoxazine) (Solphos).

In an advantageous embodiment of the compounds according to general formula IV claimed here, the ligand L is di-(1-adamantyl)-n-butylphosphine (cataCXium® A) and the compound has the formula

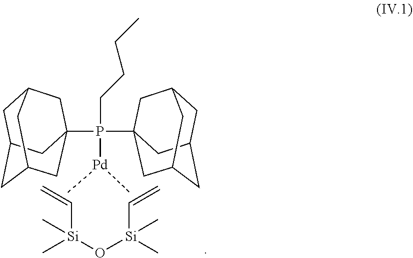

The object is also achieved by a preparation containing
i. a compound according to general formula [LPd(dvds)] (IV) and
ii. in addition to the palladium compound according to general formula [LPd(dvds)] (IV), the palladium(0) compound [Pd₂(dvds)₃].

In one embodiment of the preparation, the compound according to general formula [LPd(dvds)] (IV), or the preparation itself, is in particular obtained or obtainable by a method for preparing such a compound according to one of the other embodiments described above.

Another embodiment of the preparation claimed here provides that the preparation contains a solvent S_{Z}, in particular a non-ethereal solvent.

The preparation can be in the form of a solution, suspension, dispersion or gel, in particular depending on the solvent S_{Z} present and/or on the present. The solvent S_{Z} can also be a mixture of solvents. It is advantageously selected from the group consisting of alkanes, aromatic hydrocarbons and polar solvents, advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited. In particular, if the solvent S_{Z} comprises or is a solvent selected from the group consisting of aromatic hydrocarbons, ketones, e.g. acetone, and alcohols, e.g. methanol, ethanol or isopropanol, and mixtures thereof, the preparation is in the form of a solution or suspension. In this case, the at least one aromatic hydrocarbon can be selected, for example, from the group consisting of benzene, toluene, o-xylene, m-xylene, p-xylene, mesitylene, and mixtures or combinations thereof.

In an advantageous embodiment of the preparations described here, the preparation contains a compound according to formula

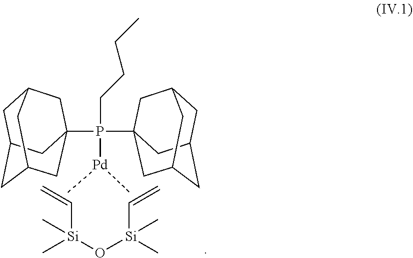

One of the best third-generation cross-coupling catalysts—both for carbon-carbon coupling reactions and carbon-heteroatom coupling reactions—is the palladium(I) dimer [Pd(μ-Br)(PtBu₃)]₂, i.e. di-μ-bromobis(tri-tert-butylphosphine)dipalladium(I). (e.g. T. J. Colacot, Platinum Metals Rev. 2009, 53 (4), 183-188)

Two methods claimed here for preparing a compound according to general formula [Pd(μ-X)(PR^{A}R^{B}R^{C})]₂ (VII) are described and explained hereinafter, which methods represent an alternative to the previously known synthesis routes described above and/or which methods are used to overcome the disadvantages of the methods from the prior art. For the sake of simplicity, the method described first is hereinafter referred to as the “first method”, and the method described thereafter as the “second method”.

The object is also achieved by a first method for preparing a compound according to general formula [Pd(μ-X)(PR^{A}R^{B}R^{C})]₂ (VII)

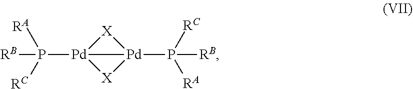

wherein
   R^{A}, R^{B} and R^{C} are independently selected from the group consisting of tert-butyl, isopropyl and 1-adamantyl,
and
   the bridging atoms X are independently bromine (Br) or iodine (I), with the exception of the compounds [Pd(μ-Br)(PiPr3)]₂ and [Pd(μ-I)(PiPr₃)]₂, comprising reacting
a mononuclear or multinuclear palladium compound, in particular a palladium(0) compound, wherein at least one palladium center bears a ligand L_{S}, which is an organosilicon compound, wherein the ligand L_{S} is in particular a cyclic or an acyclic siloxane, with
i. a phosphine ligand according to general formula PR^{A}R^{B}R^{C}, wherein R^{A}, R^{B} and R^{C} are independently selected from the group consisting of tert-butyl, isopropyl and 1-adamantyl,
excluding the phosphine ligand PiPr₃,
and
ii. a transition metal-free oxidizing agent, the molecular formula of which contains bromine (Br) or iodine (I), in a solvent S_{A}.

The term organosilicon compound has already been defined above.

The reaction scheme shown below illustrates, by way of example, the procedure of the first method claimed here for preparing complex compounds of the type [Pd(μ-X)(PR^{A}R^{B}R^{C})]₂ (VII), starting from a mononuclear or multinuclear palladium compound in which at least one palladium center bears a ligand L_{S}, which is an organosilicon compound. The palladium(0) compound [Pd₂(dvds)₃], present in dinuclear form in the solid, is provided as mononuclear or multinuclear palladium compound.

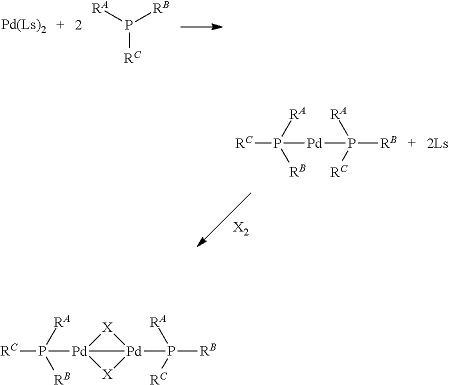

In a first step, the Pd(0) complex [Pd₂(dvds)₃] is reacted with the phosphine ligand PtBu₃ to give the homoleptic palladium(0) complex [Pd(PtBu₃)₂] and [Pd₂(dvds)₃]. In a second step, the transition metal-free oxidizing agent is added, the molecular formula of which contains bromine (Br), which reacts with the [Pd₂(dvds)₃] present in the reaction mixture to give PdBr₂. There is therefore advantageously an in situ production of PdBr₂. This is sufficiently reactive without requiring further action, and reacts with the Pd(0) compound formed in the first step [Pd(PtBu₃)₂] via a comproportionation reaction to give the desired target compound. Dvds produced as a by-product can be removed under vacuum, i.e. can readily be completely removed from the reaction vessel at reduced pressure and/or elevated temperature.

A definition of the expression “produced/prepared in situ” or “in situ production/preparation” has already been given above.

Surprisingly, it was found that the reaction of 1,3-divinyl-1,1,3,3-tetramethyldisiloxanepalladium(0) ([Pd₂(dvds)₃]) with tri-tert-butylphosphine and with the addition of elemental iodine under the reaction conditions described below made it possible to obtain a homoleptic, dimeric palladium complex of the following formula:

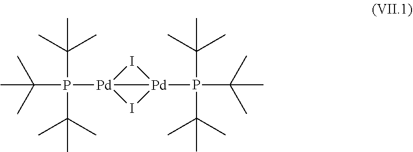

In this case, it is unimportant whether an iodine solution was added to a mixture containing phosphine and 1,3-divinyl-1,1,3,3-tetramethyldisiloxanepalladium(0)—in the context of the present invention abbreviated to [Pd₂(dvds)₃], [Pd(dvds)], Pd(vs), Pd—VS or Palladium-VS—or whether phosphine was added to a mixture containing [Pd₂(dvds)₃] and iodine.

Analogously, the preparation of the analogous bromine compound of the following formula is also possible:

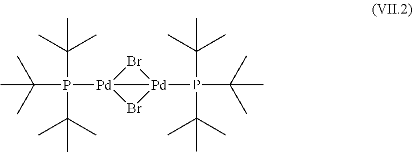

In this case, it is surprisingly particularly advantageous to add the bromine solution to a mixture containing phosphine and [Pd₂(dvds)₃] in order to obtain this complex. If phosphine is added to a mixture containing 1,3-divinyl-1,1,3,3-tetramethyldisiloxanepalladium(0)—in the context of the present invention abbreviated to [Pd₂(dvds)₃], [Pd(dvds)], Pd(vs), Pd—VS or Palladium-VS—and bromine, this complex is obtained in slightly lower, but nonetheless satisfactory, yields.

The object is also achieved by a second method for preparing a compound according to general formula [Pd(μ-X)(PR^{A}R^{B}R^{C})]₂ (VII)

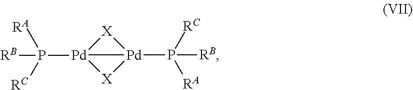

wherein
   R^{A}, R^{B} and R^{C} are independently selected from the group consisting of tert-butyl, isopropyl and 1-adamantyl, and
   the bridging atoms X are independently bromine (Br) or iodine (I), comprising reacting a palladium(II) compound, excluding palladium(II) halides, with
i. a palladium(0) compound according to general formula [Pd(PR^{A}R^{B}R^{C})₂], wherein R^{A}, R^{B} and R^{C} are independently selected from the group consisting of tert-butyl, isopropyl and 1-adamantyl,
and/or
a preparation containing
   a palladium(0) compound according to general formula [Pd(PR^{A}R^{B}R^{C})₂], wherein R^{A}, R^{B} and R^{C} are independently selected from the group consisting of tert-butyl, isopropyl and 1-adamantyl,
and
   at least one organosilicon compound,
and
ii. hydrogen bromide (HBr) and/or hydrogen iodide (HI)
in a solvent S_{B}.

The term organosilicon compound has already been defined above.

The two methods provided in the context of this invention—referred to above and below as “first method” and “second method”—for preparing complexes of the type [Pd(μ-X)(PR^{A}R^{B}R^{C})]₂ (VII) are particularly advantageous compared to the prior art methods described above. In particular, both bromine and iodine derivatives according to formula VII can be prepared in good yields and with good purity by means of these methods. The methods are likewise each based on a comproportionation reaction. However, this advantageously takes place between a palladium(0) compound and sufficiently reactive PdBr₂ or Pl₂ produced in situ, each of which is completely or virtually completely reacted. Thus, activation of the PdBr₂ or Pdl₂ can be dispensed with. Unreacted PdBr₂ or Pl₂ can be quantitatively separated simply by filtration, decanting and/or centrifugation and then—after an optionally provided washing step—recycled. The reactants required for the methods claimed here are easy to handle, and in particular can be stored for several months or longer without aging or decomposition processes being observed.

In addition, the reactants used are advantageously easy and relatively inexpensive to obtain. Furthermore, the preparation methods described here are simple and can be carried out under mild conditions. In addition, the advantageous selection of the reactants ensures that the compounds obtained by means of the method described here, of the type [Pd(μ-X)(PR^{A}R^{B}R^{C})]₂ (VII) do not have any impurities caused by reactant compounds which tend to crystallize, e.g. [Pd₂(dba)₃]×C₆H₆, or olefins, in particular diolefins, contained in the reaction mixture. In addition, a transition metal-free oxidizing agent is provided, and therefore contamination of the end products by other transition metals, e.g. copper, is ruled out. Yields of at least 60%, usually >80%, in some cases also >90% are achieved depending on which of the methods described here is used and on the reaction conditions selected in each case. Reaction conditions here mean, for example, the choice of the palladium compounds, of the transition metal-free oxidizing agent, of the solvent or mixture of solvents, of the reaction temperature and/or the reaction pressure, of the palladium concentration, of the batch size and of the order in which the reactants are added.

The solvent S_{A} or S_{B} can also be a mixture of solvents in each case. It is advantageously selected from the group consisting of alkanes, aromatic hydrocarbons and polar solvents such as ketones, e.g. acetone, and alcohols, e.g. advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited

In an embodiment of the first method or the second method for preparing a compound according to general formula [Pd(μ-X)(PR^{A}R^{B}R^{C})]z (VII), one of the organosilicon compounds is or comprises a cyclic or an acyclic siloxane selected from the group consisting of 1,1,3,3-tetramethyl-1,3-divinyldisiloxane (dvds), 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. Advantageously, one of the organosilicon compounds comprises or is 1,1,3,3-tetramethyl-1,3-divinyldisiloxane (dvds). In particular, one of the organosilicon compounds is dvds.

According to another variant of the first method for preparing a compound according to general formula [Pd(μ-X)(PR^{A}R^{B}R^{C})]₂ (VII),
a) the transition metal-free oxidizing agent, the molecular formula of which contains bromine (Br), is selected from the group consisting of molecular bromine, hydrogen bromide, bromo-1,4-dioxane complex, bromotrichloromethane, 1,2-dibromo-1,1,2,2-tetrachloroethane, carbon tetrabromide, tetrabutylammonium tribromide, trimethylphenylammonium tribromide, benzyltrimethylammonium tribromide, pyridinium tribromide, 4-dimethylaminopyridinium tribromide, 1-butyl-3-methylimidazolium tribromide, 1,8-diazabicyclo[5.4.0]-7-undecene hydrogen tribromide, N-bromosuccinimide (NBS), acetyl bromide (H₃C(CO)Br), N-bromophthalimide, N-bromosaccharin, N-bromoacetamide, 2-bromo-2-cyano-N,N-dimethylacetamide, 1,3-dibromo-5,5-dimethylhydantoin, dibromoisocyanuric acid (DBI), sodium bromoisocyanurate hydrate, boron tribromide, phosphorus tribromide, bromodimethylsulfonium bromide, 5,5-dibromo-2,2-dimethyl-4,6-dioxy-1,3-dioxane, 2,4,4,6-tetrabromo-2,5-cyclohexadienone, bis(2,4,6-trimethylpyridine)bromonium hexafluorophosphate and trimethylsilyl bromide (TMS-Br) and
b) the transition metal-free oxidizing agent, the molecular formula of which contains iodine (I), is selected from the group consisting of molecular iodine, hydrogen iodide, iodoform, carbon tetraiodide, 1-chloro-2-iodoethane, N,N-dimethyl-N-(methylsulfanylmethylene)ammonium iodide, N-iodosuccinimide (NIS), acetyl iodide (H₃C(CO)I), N-iodosaccharin, 1,3-diiodo-5,5-dimethylhydantoin (DIH), pyridine iodine monochloride, tetramethylammonium dichloroiodate, benzyltrimethylammonium dichloroiodate, bis(pyridine)iodonium tetrafluoroborate, bis(2,4,6-trimethylpyridine)iodonium hexafluorophosphate and trimethylsilyl iodide (TMS-1).

According to an advantageous variant embodiment of the second method, the palladium(II) compound required as a reactant is palladium(II) acetylacetonate ([Pd(acac)₂]).

Another advantageous embodiment of the second method provides for the use of an in particular aqueous hydrogen bromide and/or hydrogen iodide solution.

According to a further advantageous embodiment of the second method, in situ production of the hydrogen bromide (HBr) and/or of the hydrogen iodide (HI) is provided. To this end, a first step is provided in particular, which comprises reacting the palladium(II) compound, in particular palladium(II) acetylacetonate, with an HBr donor and/or an HI donor in the presence of water and/or an alcohol. Apart from a water/alcohol mixture, it is also possible to use a mixture of several alcohols. A molar ratio of (HBr donor and/or HI donor):(water and/or alcohol) is at least 1:1. Based on the amount of substance of the HBr donor and/or HI donor, it is also possible to provide more than one molar equivalent of water or more than one molar equivalent of an alcohol. The molar ratio of (HBr donor and/or HI donor):(water and/or alcohol) can be between 1:1 and 1:5, for example 1.0:1.1 or 1.0:1.2 or 1.0:1.3 or 1.0:1.4 or 1.0:1.5 or 1.0:1.6 or 1.0:1.7 or 1.0:1.8 or 1.0:1.9 or 1.0:2.0 or 1.0:2.1 or 1.0:2.2 or 1.0:2.3 or 1.0:2.4 or 1.0:2.5 or 1.0:2.6 or 1.0:2.7 or 1.0:2.8 or 1.0:2.9 or 1.0:3.0 or 1.0:3.1 or 1.0:3.2 or 1.0:3.3 or 1.0:3.4 or 1.0:3.5 or 1.0:3.6 or 1.0:3.7 or 1.0:3.8 or 1.0:3.9 or 1.0:4.0 or 1.0:4.1 or 1.0:4.2 or 1.0:4.3 or 1.0:4.4 or 1.0:4.5 or 1.0:4.6 or 1.0:4.7 or 1.0:4.8 or 1.0:4.9.

According to the present invention, the HBr donor or HI donor is a brominated or iodinated, in particular organic, compound which has at least one H—Br bond or an H—I bond with the lowest possible dissociation energy and which, under the reaction conditions selected here, in particular in the presence of an at least identical amount of water and/or an alcohol, cleaves HBr or HI. However, no cleavage of HBr or HI should occur during prolonged storage of the HBr donor or HI donor.

The reaction scheme shown below illustrates the procedure of the second method claimed here for preparing complex compounds of the type [Pd(μ-X)(PR^{A}R^{B}R^{C})]₂ (VII), starting from a palladium(II) compound, excluding palladium(II) halides, wherein by way of example an in situ production of HBr is provided. The reactants used in this example are palladium(II) acetylacetonate, the HBr donor acetyl bromide and [Pd(PtBu₃)₂].

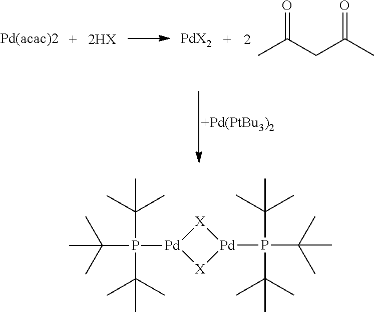

In a first step, palladium(II) acetylacetonate is reacted with acetyl bromide to form PdBr₂, acetylacetone and acetic acid. The reaction mixture must contain at least traces of water and/or alcohol. This can easily be achieved, for example, by using a solvent that has not been dried or has not been completely dried. In the presence of water and/or at least one alcohol, the HBr donor acetyl bromide cleaves hydrogen bromide (HBr), which reacts with palladium(II) acetylacetonate to give PdBr₂. Here, a molar ratio of HBr donor:(water and/or alcohol) must be at least 1:1. Advantageously, the only by-products are acetylacetone and acetic acid and/or an acetic acid ester. In a second step, the palladium(0) compound [Pd₂(dvds)₃] is added, which reacts with the PdBr₂, produced in situ and sufficiently active per se, via a comproportionation reaction to give the desired target compound.

A definition of the expression “produced/prepared in situ” or “in situ production/preparation” has already been given above.

An advantageous embodiment of the second method claimed here for preparing compounds according to formula VII, starting from a palladium(II) compound, provides that the HBr donor is acetyl bromide or trimethylsilyl bromide (TMS-Br) and the HI donor is acetyl iodide or trimethylsilyl iodide (TMS-1). The reaction mixture must then contain water and/or alcohol and the above-mentioned acetyl halides react to give hydrogen bromide or hydrogen iodide and acetic acid and/or an acetic acid ester, while TMSBr or TMSI react to give hydrogen bromide or hydrogen iodide and trimethylsilane and/or an alkoxytrimethylsilane, also referred to as alkyl trimethylsilyl ether. In principle, acetyl halides and trimethylsilyl halides are easier to handle than the corresponding hydrogen halides. A molar ratio of (HBr donor and/or HI donor) (water and/or alcohol) must be at least 1:1.

According to an embodiment of the first method for preparing a compound according to general formula [Pd(μ-X)(PR^{A}R^{B}R^{C})]₂ (VII), the reaction comprises
a) providing the mononuclear or multinuclear palladium compound, in particular palladium(0) compound, wherein at least one palladium center bears a ligand L_{S}, which is an organosilicon compound, in a solvent S_{A1} in a first step, adding the phosphine ligand according to general formula PR^{A}R^{B}R^{C} in a second step, and adding the transition metal-free oxidizing agent, the molecular formula of which contains bromine (Br) or iodine (I), in a third step
or
b) providing the mononuclear or multinuclear palladium compound, in particular palladium(0) compound, wherein at least one palladium center bears a ligand L_{S}, which is an organosilicon compound, in a solvent S_{A1} in a first step, adding the transition metal-free oxidizing agent, the molecular formula of which contains bromine (Br) or iodine (I), in a second step, and adding the phosphine ligand according to general formula PR^{A}R^{B}R^{C} in a third step.

In this case, the solvent S_{A1} is advantageously miscible with or identical to, in particular identical to, the solvent S_{A}.

The transition metal-free oxidizing agent and/or the phosphine ligand can be added as a substance, i.e. as a gas, liquid or solid, or as a solution, emulsion or suspension in a solvent that is miscible with the solvent S_{A}.

In particular in the case of preparing complexes according to general formula [Pd(μ-Br)(PR^{A}R^{B}R^{C})]₂ (VII.a), for example [Pd(μ-Br)(PtBu₃)]₂, [Pd(μ-Br)(P(iPr)tBu₂)]₂, [Pd(μ-Br)(P(1-Ad)tBu₂)]₂, [Pd(μ-Br)(P(1-Ad)₂tBu)]₂ and [Pd(μ-Br)(P(1-Ad)₂iPr)]₂, it is preferable to choose the order given under a).

This is particularly advantageous if the transition metal-free oxidizing agent is selected from the group consisting of Br₂, NBS and acetyl bromide, and mixtures thereof.

In another variant of the first method for preparing a compound according to general formula [Pd(μ-X)(PR^{A}R^{B}R^{C})]₂ (VII), the mononuclear or multinuclear palladium compound, in particular palladium(0) compound, is prepared by reacting a palladium(II) compound, which consists in particular of a palladium(II) cation and two monovalent anions or a divalent anion, with a ligand L_{S}, which is an organosilicon compound, in particular a cyclic or an acyclic siloxane, in the presence of a base, in situ in a solvent S_{Q}.

In particular, the solvent S_{A} and the solvent S_{Q} are miscible or identical. There is then no need to change solvent, which is particularly advantageous from an economical and ecological perspective. A definition of the expression “miscible solvents” has already been given above.

The expressions “produced/prepared in situ” or “in situ production/preparation” and the term “weakly coordinating” have already been defined above. In the context of the reaction described here, the term “bases” means inorganic and organic bases, in particular inorganic bases, but not organometallic bases. The bases should not decompose in water. Suitable bases are e.g. salts of Brønsted acids. Carbonates, hydrogen carbonates, acetates, formates, ascorbates, oxalates and hydroxides are advantageously used. These can be used in the form of their ammonium salts (Brønsted acid)NR₄, wherein R is for example H or alkyl, alkali metal salts, for example sodium or potassium salts, and alkaline-earth metal salts.

The palladium(II) compound can have two different or two identical monovalent anions or one divalent anion. A neutral ligand, for example COD, is not provided. Consequently, inexpensive commercially available palladium(II) compounds, such as PdCl₂, can advantageously be used. It is therefore possible to dispense with a time-consuming and costly preparation of a palladium(II) compound of the type [Pd(ligand)Y₂], wherein e.g. ligand=COD, as a reactant for the in situ production of the mononuclear or multinuclear palladium compound. This is particularly advantageous from an economical (in terms of atoms) and ecological perspective. In addition, this reduces the number of possible impurities in the end product according to general formula VII.

In a further advantageous embodiment, the palladium(II) compound to be used as reactant in the context of the above-mentioned in situ preparation comprises two identical monovalent anions which are in particular selected from the group consisting of halides and monovalent weakly coordinating anions.

According to a further embodiment of the second method for preparing a compound according to general formula [Pd(μ-X)(PR^{A}R^{B}R^{C})]₂ (VII), the reaction comprises
a) providing the palladium(II) compound in a solvent S_{B1} in a first step, adding hydrogen bromide (HBr) and/or hydrogen iodide (HI) and/or adding an HBr donor and/or an HI donor, for example selected from the group consisting of TMSBr, TMSI, acetyl bromide, acetyl iodide, and mixtures thereof, in particular acetyl bromide and/or acetyl iodide, in a second step, and adding the palladium(0) compound according to general formula [Pd(PR^{A}R^{B}R^{C})₂] and/or the preparation containing a palladium(0) compound according to general formula [Pd(PR^{A}R^{B}R^{C})₂] and at least one organosilicon compound, in a third step
or
b) providing the palladium(II) compound in a solvent S_{B1} in a first step, adding a palladium(0) compound according to general formula [Pd(PR^{A}R^{B}R^{C})₂] and/or the preparation containing a palladium(0) compound according to general formula [Pd(PR^{A}R^{B}R^{C})₂] and at least organosilicon compound, in a second step, and adding hydrogen bromide (HBr) and/or hydrogen iodide (HI) and/or adding an HBr donor and/or an HI donor, for example selected from the group consisting of TMSBr, TMSI, acetyl bromide, acetyl iodide, and mixtures thereof, in particular acetyl bromide and/or acetyl iodide, in a third step.

In particular in the case of preparing complexes according to general formula [Pd(μ-Br)(PR^{A}R^{B}R^{C})]₂ (VII.a), for example [Pd(μ-Br)(PtBu₃)]₂, [Pd(μ-Br)(P(iPr)tBu₂)]₂, [Pd(μ-Br)(P(1-Ad)tBu₂)]₂, [Pd(μ-Br)(P(1-Ad)₂tBu)]₂ and [Pd(μ-Br)(P(1-Ad)₂iPr)]₂, it is preferable to choose the order given under a).

According to a variant embodiment of the second method, the preparation provided contains a solvent S_{Z}. The preparation itself can be in the form of a solution, suspension, dispersion or gel, in particular depending on the solvent S_{Z} present and/or on the organosilicon compound present. The solvent S_{Z} can also be a mixture of solvents. It is advantageously selected from the group consisting of alkanes, aromatic hydrocarbons and polar solvents, advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited. In particular, if the solvent S_{Z} comprises or is a solvent selected from the group consisting of aromatic hydrocarbons, ketones, e.g. acetone, and alcohols, e.g. methanol, ethanol or isopropanol, and mixtures thereof, the preparation is in the form of a solution or suspension. In this case, the at least one aromatic hydrocarbon can be selected, for example, from the group consisting of benzene, toluene, o-xylene, m-xylene, p-xylene, mesitylene, and mixtures or combinations thereof. It is particularly advantageous if the solvent S_{Z} and the solvent S_{B} used in the second method are miscible or identical.

Another embodiment of the second method for preparing a compound according to the general formula [Pd(μ-X)(PR^{A}R^{B}R^{C})]₂ (VII) provides for reacting the palladium(II) compound with the preparation described above, containing a palladium(0) compound according to general formula [Pd(PR^{A}R^{B}R^{C})₂] and at least one organosilicon compound, wherein
a) the at least one organosilicon compound contains at least one terminal, in particular vinyl, double bond, in particular comprises or is a cyclic or an acyclic siloxane,
and/or
b) the preparation contains, in addition to the palladium compound according to general formula [Pd(PR^{A}R^{B}R^{C})₂], at least one palladium compound according to general formula [L_{S}Pd(PR^{A}R^{B}R^{C})] (II) and/or at least one palladium compound according to general formula [Pd(L_{S})₂] (III), wherein
   the ligand L_{S} is in particular identical to the at least one organosilicon compound, in particular a cyclic or an acyclic siloxane, and wherein the at least one organosilicon compound contains at least one terminal double bond, and
   (PR^{A}R^{B}R^{C}) is selected from the group consisting of tri-tert-butylphosphine (PtBu₃), di-tert-butyl(isopropyl)phosphine (P(iPr)tBu₂), tert-butyl-di(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), di(1-adamantyl)-isopropylphosphine (P(1-Ad)₂iPr), 1-adamantyl-di(isopropyl)phosphine (P(1-Ad)iPr₂), 1,2-bis(diphenylphosphino)ethane (dppe) and 1,3-bis-(diphenylphosphino)-propane (dppp).

In particular, the ligand L_{S} is identical to the organosilicon compound, wherein the ligand L_{S} is in particular a cyclic or an acyclic siloxane which has at least one terminal, in particular vinyl, double bond. The ligand L_{S} is then advantageously coordinated or bonded via at least one pi-directed bond to the palladium center of the compound according to general formula L_{S}Pd(PR^{A}R^{B}R^{C}) (II) or [Pd(L_{S})₂] (III).

The transition metal-free oxidizing agent and/or the palladium(0) compound according to general formula [Pd(PR^{A}R^{B}R^{C})₂] can be added in a substance, i.e. as a gas, liquid or solid, or as a solution, emulsion or suspension in a solvent that is miscible with the solvent S_{B}.

A further variant embodiment of the second method claimed here for preparing a compound according to formula VII provides that the reaction according to the second method for preparing a compound according to formula VII comprises an in situ preparation of the palladium(0) compound according to general formula [Pd(PR^{A}R^{B}R^{C})₂], in particular starting from a palladium(0) compound, wherein at least one palladium center bears a ligand L_{S}, which is an organosilicon compound, and a phosphine ligand according to general formula PR^{A}R^{B}R^{C} in the solvent chosen for the reaction according to the second method for preparing a compound according to formula VII, or a solvent miscible therewith. The radicals R^{A}, R^{B} and R^{C} are independently selected from the group consisting of tert-butyl, isopropyl and 1-adamantyl, excluding the phosphine ligand PiPr₃. According to an alternative or supplementary embodiment of the method, the preparation containing a palladium(0) compound according to general formula [Pd(PR^{A}R^{B}R^{C})₂] and at least one organosilicon compound is produced in situ, in particular starting from a mononuclear or multinuclear palladium compound, in particular a palladium(0) compound, wherein at least one palladium center bears a ligand L_{S}, which is an organosilicon compound, and in each case a phosphine ligand (PR^{A}R^{B}R^{C}). The latter are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di(isopropyl)phosphine (P(1-Ad)iPr₂), 1,2-bis(diphenylphosphino)ethane (dppe) and 1,3-bis(diphenylphosphino)propane (dppp), The in situ production of the preparation takes place in the solvent chosen for the reaction according to the second method for preparing a compound according to formula VII or a solvent miscible therewith. The choice or definition of the ligand L_{S} and the organosilicon compound corresponds to that given above.

The expression “produced/prepared in situ” or “in situ production/preparation” has already been defined above.

According to a further variant of the first method for preparing a compound according to general formula [Pd(μ-X)(PR^{A}R^{B}R^{C})]₂ (VII),
a molar ratio Pd:X is at least 1.0:0.5, advantageously between 1.0:0.5 and 1.0:2.0, more advantageously between 1.0:0.6 and 1.0:1.9, particularly advantageously between 1.0:0.7 and 1.0:1.8, in particular between 1.0:0.8 and 1.0:1.7, for example 1.0:0.9 or 1.0:1.0 or 1.0:1.1 or 1.0:1.2 or 1.0:1.3 or 1.0:1.4 or 1.0:1.5 or 1.0:1.6
and/or
a molar ratio of palladium(0) compound: PR^{A}R^{B}R^{C} is at least 1:1, advantageously between 1.0:1.0 and 1.0:2.5, more advantageously between 1.0:1.1 and 1.0:2.4, particularly advantageously between 1.0:1.2 and 1.0:2.3, in particular between 1.0:1.3 and 1.0:2.2, for example 1.0:1.4 or 1.0:1.5 or 1.0:1.6 or 1.0:1.7 or 1.0:1.8 or 1.0:1.9 or 1.0:2.0 or 1.0:2.1.

From an economical (in terms of atoms) and ecological perspective, it is particularly advantageous if the molar ratio of palladium(0) compound PR^{A}R^{B}R^{C} is 1:1.

Another embodiment of the second method for preparing a compound according to general formula [Pd(μ-X)(PR^{A}R^{B}R^{C})]₂ (VII) provides that
a molar ratio of
   palladium(II) compound: transition metal-free oxidizing agent
   or
   palladium(II) compound: bromine (Br) and/or iodine (I)
   is at least 1:2, advantageously between 1:2 to 1:3, more advantageously between 1.0:2.1 and 1.0:2.9, particularly advantageously between 1.0:2.2 and 1.0:2.8, in particular between 1.0:2.3 and 1.0:2.7, for example 1.0:2.4 or 1.0:2.5 or 1.0:2.6,
   and/or
a molar ratio of palladium(II) compound: palladium(0) compound is between 1:2 and 2:1, advantageously between 1.0:1.9 and 1.9:1.0, more advantageously between 1.1:1.8 and 1.8:1.1, in particular between 1.2:1.7 and 1.7:1.2, for example 1.0:1.8 or 1.8:1.0 or 1.0:1.7 or 1.7:1.0 or 1.0:1.6 or 1.6:1.0 or 1.0:1.5 or 1.5:1.0 or 1.0:1.4 or 1.4:1.0 or 1.0:1.3 or 1.3:1.0 or 1.0:1.2 or 1.2:1.0 or 1.0:1.1 or 1.1:1.0 or 1.0:1.0.

From an economical (in terms of atoms) and ecological perspective, it is particularly advantageous if the molar ratio of palladium(II) compound: transition metal-free oxidizing agent is 1:2 and the molar ratio of palladium(II) compound: palladium(0) compound is 1:1.

Another embodiment of the second method for preparing a compound according to general formula [Pd(μ-X)(PR^{A}R^{B}R^{C})]₂ (VII) provides that the preparation contains at least one organosilicon compound, wherein a content of silicon, which is present in particular in the form of the at least one organosilicon compound, is ≥100 ppm and ≤1000 ppm, advantageously 110 ppm and ≤900 ppm, in particular ≥120 ppm and ≤800 ppm. The silicon content, which is present in particular in the form of the at least one organosilicon compound, can be determined using analysis methods which are known to those skilled in the art, in particular using quantitative ¹H NMR spectroscopy and/or atomic emission spectrometry with inductively coupled plasma (Inductively Coupled Plasma Atomic Emission Spectrometers, ICP-AES). In the case of the second method for preparing a compound according to general formula [Pd(μ-X)(PR^{A}R^{B}R^{C})]₂ (VII), the organosilicon compound can be the ligand L_{S} or the palladium compound according to general formula [L_{S}Pd(PR^{A}R^{B}R^{C})] (II) and/or according to general formula [Pd(L_{S})₂] (III).

According to another embodiment of the first method or the second method for preparing a compound according to general formula [Pd(μ-X)(PR^{A}R^{B}R^{C})]₂ (VII), a further step is carried out after the reaction and comprises isolating the compound, prepared by means of the reaction, according to general formula [Pd(μ-X)(PR^{A}R^{B}R^{C})]₂ (VII):
as a preparation which comprises [Pd(μ-X)(PR^{A}R^{B}R^{C})]₂ (VII) and a solvent S_{A} or a solvent S_{B} and/or S_{Z}.
or
as a substance, advantageously as a solid.

Here and hereinafter, the term “preparation” means a solution, a suspension, a dispersion or a gel. The preparation can therefore, in particular depending on the solvent present and/or on the compound according to general formula [Pd(μ-X)(PR^{A}R^{B}R^{C})]₂ (VII) present, be in the form of a solution, suspension, dispersion or gel. The solvent can also be a mixture of solvents. In particular, the solvent comprises or is a solvent which is miscible with or identical to the solvent S_{A} used in the first method or the solvent S_{B} and/or S_{Z} used in the second method. The preparation is then usually in the form of a solution or suspension.

In a further variant of the first method or the second method for preparing a compound according to general formula [Pd(μ-X)(PR^{A}R^{B}R^{C})]₂ (VII), the isolation comprises a filtration step and/or decanting and/or centrifugation. The above-mentioned measures can also be carried out several times. Optionally, one or more filtrations over a cleaning medium, for example activated carbon or silica, e.g. Celite®, can take place. Advantageously, the filtrate, centrifugate, or decantate or the solid may be subjected to purification and/or isolation steps which may be carried out rapidly and without complication and without special effort in terms of preparation.

The isolation of the compound according to general formula [Pd(μ-X)(PR^{A}R^{B}R^{C})]₂ (VII) may comprise further method steps, for example the reduction of the mother liquor volume, i.e. concentrating it, for example by means of “bulb-to-bulb,” the addition of a solvent and/or a solvent exchange in order to precipitate the product from the mother liquor and/or to remove impurities and/or reactants, crystallization, sublimation, washing, e.g. with acetone, pentane or hexane, and mixtures thereof, and drying of the product. The aforementioned steps may each be provided in different orders and frequencies.

Overall, the purification and/or isolation of the target compound according to general formula [Pd(μ-X)(PR^{A}R^{B}R^{C})]₂ (VII) is relatively simple and inexpensive.

In general, the end product may still contain residues of solvents or for example impurities from the reactants. Isolated compounds of the type [Pd(μ-X)(PR^{A}R^{B}R^{C})]₂ (VII) have a purity of at least 97%, advantageously more than 97%, in particular more than 98% or 99%. Even in the case of scaling up toward an industrial scale, the reproducible yield is at least 60%, usually >80%, in some cases also >90%, in particular depending on the choice of reactants and of solvent or mixture of solvents.

The object is also achieved by a compound according to general formula

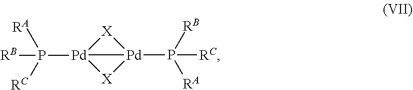

wherein
   R^{A}, R^{B} and R^{C} are independently selected from the group consisting of tert-butyl, isopropyl and 1-adamantyl, and
   the bridging atoms X are independently bromine (Br) or iodine (I),
with the exception of the compounds [Pd(μ-Br)(PtBu₃)]₂, [Pd(μ-I)(P(iPr)tBu₂)]₂ and [Pd(μ-Br)(P(1-Ad)tBu₂)]₂.

The palladium(I) compounds claimed here according to general formula[Pd(μ-X)(PR^{A}R^{B}R^{C})]₂ (VII) can in particular be obtained by a method for preparing a compound according to general formula [Pd(μ-X)(PR^{A}R^{B}R^{C})]₂ (VII) according to one of the embodiments described above. For example, they can be used as catalysts and/or precatalysts, in particular as precatalysts in palladium-catalyzed cross-coupling reactions. Advantageously, they are suitable as precatalysts for the reactions given below.

Furthermore, the object is achieved by a preparation containing
i. a compound according to general formula [Pd(μ-X)(PR^{A}R^{B}R^{C})]₂ (VII),
wherein
   R^{A}, R^{B} and R^{C} are independently selected from the group consisting of tert-butyl, isopropyl and 1-adamantyl, and
   the bridging atoms X are independently bromine (Br) or iodine (I), and
ii. at least one organosilicon compound.

A definition of the term organosilicon compound has already been given above.

In one embodiment of the claimed preparation, the compound contained therein according to general formula [Pd(μ-X)(PR^{A}R^{B}R^{C})]₂ (VII), or the preparation itself, is in particular obtained or obtainable by a method for preparing such a compound according to one of the embodiments described above.

According to another embodiment of the preparation, a silicon content, which is present in particular in the form of the at least one organosilicon compound, is ≥100 ppm and ≤1000 ppm, advantageously ≥110 ppm and ≤900 ppm, in particular ≥120 ppm and ≤800 ppm. The silicon content, which is present in particular in the form of the at least one organosilicon compound, can be determined using analysis methods which are known to those skilled in the art, in particular using quantitative ¹H NMR spectroscopy and/or atomic emission spectrometry with inductively coupled plasma (Inductively Coupled Plasma Atomic Emission Spectrometers, ICP-AES).

In an alternative or supplementary embodiment of the preparation claimed here, the preparation contains a solvent S_{Z}.

The preparation can be in the form of a solution, suspension, dispersion or gel, in particular depending on the solvent S_{Z} present and/or on the organosilicon compound present. The solvent S_{Z} can also be a mixture of solvents. It is advantageously selected from the group consisting of alkanes, aromatic hydrocarbons and polar solvents, advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited. In particular, if the solvent S_{Z} comprises or is a solvent which is selected from the group consisting of aromatic hydrocarbons such as benzene, toluene, o-xylene, m-xylene, p-xylene, mesitylene, and mixtures or combinations thereof, polar solvents such as acetone and alcohols, e.g. selected from the group consisting of methanol, ethanol and isopropanol, and mixtures thereof, and ethers, e.g. selected from the group consisting of diethyl ether, THF, 2-methyltetrahydrofuran and 1,4-dioxane, and mixtures thereof, the preparation is in the form of a solution or suspension.

In one embodiment of the preparation claimed here, the at least one organosilicon compound contains at least one terminal, in particular vinyl, double bond. In particular, the at least one organosilicon compound comprises or is a cyclic or an acyclic siloxane. According to an alternative or supplementary variant embodiment of the preparation, said preparation contains, in addition to the palladium compound according to general formula [Pd(μ-X)(PR^{A}R^{B}R^{C})]₂ (VII), a palladium compound according to general formula [L^{S}PdZ] (II) and/or a palladium compound according to general formula [Pd(L_{S})₂] (III). In this case, the ligand L_{S} is in particular identical to the at least one organosilicon compound, in particular a cyclic or an acyclic siloxane. The at least one organosilicon compound contains at least one terminal double bond and Z is selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di(isopropyl)phosphine (P(1-Ad)iPr₂), 1,2-bis(diphenylphosphino)ethane (dppe) and 1,3-bis(diphenylphosphino)propane (dppp),

A further variant embodiment of the preparation provides that at least one organosilicon compound comprises or is a cyclic or an acyclic siloxane and/or at least one ligand L_{S} is a cyclic or an acyclic siloxane selected from the group consisting of 1,1,3,3-tetramethyl-1,3-divinyldisiloxane, 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. In particular, one of the organosilicon compounds comprises or is 1,1,3,3-tetramethyl-1,3-divinyldisiloxane (dvds) and/or one of the ligands L_{S} is 1,1,3,3-tetramethyl-1,3-divinyldisiloxane (dvds).

The object is furthermore achieved by a method for preparing a compound according to general formula

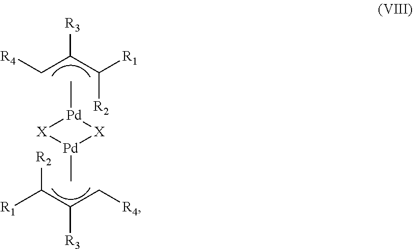

wherein
   X is an anionic ligand,
and
   the radicals R1, R2, R3 and R4 are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals
or
   two radicals of R1, R1, R3 and R4, advantageously R1 and R3 or R2 and R4, together form an unsaturated or aliphatic ring or
   two radicals of R1, R2, R3 and R4, advantageously R1 and R3 or R2 and R4, together form a first ring which is unsaturated or saturated and is fused with at least one aromatic ring,
comprising the steps of:
A. providing a palladium compound, in particular a mononuclear or multinuclear palladium(0) compound, wherein at least one palladium center bears a ligand L_{S}, which is an organosilicon compound, wherein the ligand L_{S} is in particular a cyclic or an acyclic siloxane,
B. reacting the palladium compound from step A. with a compound AH according to general formula

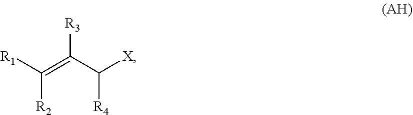

wherein
   X is an anionic ligand,
   the radicals R1, R2, R3 and R4 are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals
or
   two radicals of R1, R2, R3 and R4 together form an unsaturated or aromatic ring, advantageously R1 and R3 or R2 and R4 or
   two radicals of R1, R2, R3 and R4, advantageously R1 and R3 or R2 and R4, together form a first ring which is aromatic or unsaturated and is fused with at least one aromatic ring,
and
C. optionally isolating the compound according to formula VIII produced in step B.

The term organosilicon compound has already been defined above.

A large number of palladium(II) complex compounds of type VIII can be provided simply, relatively inexpensively and reproducibly by means of the method described here. The target compounds are usually obtained in high yields and with good purity, in particular NMR purity. It has surprisingly been found that the compounds that can be prepared by means of the method described here do not contain impurities due to palladium-containing by-products that are difficult or impossible to separate, in particular due to their solubility behavior, or only contain traces of said impurities (≤1000 ppm). The high purity of the end products is particularly advantageous in view of possible uses, for example as precatalysts and/or catalysts. In addition, the method claimed here enables simplified access to η³-benzylpalladium halides and arylpalladium halides.

Palladium(II) dimers according to formula VIII are easy-to-use catalyst precursors with excellent catalytic performance. Advantageously, they are easily accessible in one step from commercially available precursors and react unproblematically with a large number of electron donor ligands, in particular phosphine and NHC ligands, to give defined palladium(II) complexes. Consequently, the preparation, even in situ, of highly active monoligated palladium(II) precatalysts and/or palladium(II) catalysts starting from dimeric palladium(II) compounds according to formula VIII is possible in a simple and reproducible manner.

The palladium compound to be provided in step A., which is in particular a palladium(0) compound, can be present in mononuclear or multinuclear, in particular dinuclear, form, as a monomer or oligomer, in particular dimer, and/or as a solvent adduct.

In one embodiment of the method claimed here for preparing a compound according to general formula VIII, the anionic ligand X is a halide anion or a monovalent weakly coordinating anion.

The term “weakly coordinating” also covers the terms “very weakly coordinating” and “moderately strongly coordinating”. Chloride, bromide or iodide can advantageously be used as halide anions X, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

According to the present invention, the expression “unsaturated ring” means a non-aromatic carbocycle or heterocycle which has at least one double bond. The unsaturated ring can also be part of a ring system consisting of two or more fused rings, which can comprise aliphatic, aromatic and other unsaturated carbocycles and/or heterocycles. A saturated ring is formed, for example, by the radicals R1 and R3 if for example an allyl halide AH derived from phenalene or indene was used as reactant for preparing the compound according to formula VIII.

In one embodiment of the method described here, a molar ratio of Pd AH is at least 1:1, advantageously between 1.0:1.0 and 1.0:5.0, more advantageously between 1.0:1.1 and 1.0:4.0, particularly advantageously between 1.0:1.2 and 1.0:3.0, in particular between 1.0:1.3 and 1.0:2.0, for example 1.0:1.4 or 1.0:1.5 or 1.0:1.6 or 1.0:1.7 or 1.0:1.8 or 1.0:1.9 or 1.0:2.1 or 1.0:2.2 or 1.0:2.3 or 1.0:2.4 or 1.0:2.5 or 1.0:2.6 or 1.0:2.7 or 1.0:2.8 or 1.0:2.9 or 1.0:3.1 or 1.0:3.2 or 1.0:3.3 or 1.0:3.4 or 1.0:3.5 or 1.0:3.6 or 1.0:3.7 or 1.0:3.8 or 1.0:3.9 or 1.0:4.1 or 1.0:4.2 or 1.0:4.3 or 1.0:4.4 or 1.0:4.5 or 1.0:4.6 or 1.0:4.7 or 1.0:4.8 or 1.0:4.9.

A compound according to general formula VIII which can be obtained by means of the method claimed here has two identical η³-bonded allyl ligands. The allyl ligand is derived in each case from the compound AH, used as reactant, according to general formula

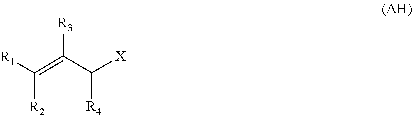

wherein X, R1, R2, R3 and R4 are as defined above.

For example, in order to prepare a compound according to formula VIII, a palladium(0) compound which in particular has a ligand L_{S} which is an organosilicon compound, in particular a cyclic or an acyclic siloxane, can be reacted with 1-naphthylmethyl chloride. For example, a molar ratio Pd:AH of at least 1:1 can be provided. A palladium(II) compound according to formula VIII which can be obtained in this way then has two identical allyl ligands derived from naphthalene, in particular η³-bonded allyl ligands. In other words: A complex according to formula VIII has no naphthyl ligands in the strict sense. This is because the electrons involved in the complexation of the palladium center are not conjugated with the ring electrons. The aromaticity of the bicyclic naphthalene is restricted to one of the two fused six-membered rings as a result of complex formation. However, for the sake of simplicity in the context of the present invention, a naphthalene-derived η¹-bonded ligand or η³-bonded allyl ligand is referred to as naphthyl ligand. The product of the above example reaction is therefore referred to as dimeric palladium(II) 1-methylnaphthyl chloride complex, wherein the chlorine atoms act as bridging ligands, i.e. two chlorine bridges are present, or as a chloride-bridged 1-methylnaphthylpalladium(II) dimer. The same applies in the present case, for example, to the designation of palladium(II) compounds according to formula VIII which are obtainable using an anthracenyl, phenanthrenyl, phenalenyl, fluorenyl, indenyl, tetracenyl or chrysenyl halide.

A further variant of the claimed method for preparing a compound according to general formula VIII provides that the radicals R1, R2, R3 and R4 of the reactant AH are independently selected from the group consisting of hydrogen (H), straight-chain alkyl radicals having one to ten carbon atoms, i.e. also having two, three, four, five, six, seven, eight or nine carbon atoms, branched alkyl radicals having one to ten carbon atoms, i.e. also having two, three, four, five, six, seven, eight or nine carbon atoms, and cyclic alkyl radicals having three to eight carbon atoms, i.e. also having four, five, six or seven carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to fourteen carbon atoms, i.e. also having seven, eight, nine, ten, eleven, twelve or thirteen carbon atoms, unsubstituted mononuclear or polynuclear heteroaryl radicals having five to thirteen carbon atoms, i.e. also having six, seven, eight, nine, ten, eleven or twelve carbon atoms, and substituted mononuclear or polynuclear heteroaryl radicals having five to thirteen carbon atoms, i.e. also having six, seven, eight, nine, ten, eleven or twelve carbon atoms.

According to another embodiment, the radicals R1, R2, R3 and R4 of the reactant AH are independently selected from the group consisting of hydrogen (H), straight-chain alkyl radicals having one to eight carbon atoms, branched alkyl radicals having one to eight carbon atoms, cyclic alkyl radicals having four, five or six carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to ten carbon atoms, unsubstituted mononuclear or polynuclear heteroaryl radicals having five to nine carbon atoms and substituted mononuclear or polynuclear heteroaryl radicals having five to nine carbon atoms.

The radicals R1, R2, R3 and R4 of the reactant AH can be independently selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof. In an alternative or supplementary embodiment of the method for preparing a compound according to formula VIII, two radicals from R1 to R4 of the reactant AH can form an unsaturated or aromatic carbocyclic ring which is substituted with one or more of the above-mentioned alkyl radicals. For example, a reactant AH can be provided, wherein the radicals R2 and R4 form a substituted, unsaturated carbocyclic five-membered ring which is fused with exactly one aromatic ring. An example of such a reactant AH is 3-(tert-butyl)-1-chloro-1H-indene (reactant for 9-Cl). For example, a reactant AH can also be provided, wherein the radicals R2 and R4 form an unsubstituted, unsaturated carbocyclic six-membered ring. An example of such a reactant AH is 3-bromocyclohexene (reactant for 6-Br).

In one embodiment of the method claimed here for preparing compounds according to formula VIII, R1 and R3 of the reactant AH together form an unsaturated carbocyclic ring having five to eight carbon atoms. In an alternative variant of the claimed method, R1 and R3 of the reactant AH together form an unsaturated carbocyclic ring or an aromatic ring having five or six carbon atoms, the unsaturated carbocyclic ring or the aromatic ring being fused with at least one aromatic ring. In this case, R1 and R3 together can be part of a naphthyl, anthracenyl, phenanthrenyl, phenalenyl, tetracenyl or chrysenyl ring system.

In another embodiment of the method claimed here for preparing compounds according to formula VIII,
the radicals R1 and R3 of the reactant AH together form the first, in particular carbocyclic, ring, which
   is aromatic or unsaturated and is fused with at least one aromatic ring, and
the radicals R1 and R2 and/or R3 and R4 form a second, in particular carbocyclic, ring, having 5 to 8 carbon atoms, which
   is aromatic or unsaturated and is fused with the first ring and/or with the at least one aromatic ring.

In this case, the second ring can be unsubstituted or can optionally be substituted with one or more radicals selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof. The first ring is in particular a carbocyclic ring having five to eight carbon atoms. Advantageously, the first and the second ring are independently selected from the group consisting of a cyclopentadienyl ring, cyclohexadienyl ring, cycloheptadienyl ring, cyclooctadienyl ring and a benzene ring.

In another embodiment of the method described here for preparing compounds according to formula VIII, R2 and R4 (apart from the required halogen atom) of the reactant AH can form a substituted or unsubstituted, in particular unsaturated or saturated, carbocyclic ring having 5 to 8 carbon atoms, which can optionally be fused with at least one aromatic ring, e.g. in the case of a reactant AH derived from fluorene or indene, in particular 3-(tert-butyl)-1-chloro-1H-indene. This carbocyclic ring is advantageously a cyclopentenyl, cyclohexenyl, cycloheptenyl or cyclooctenyl ring. Alternatively, this carbocyclic ring is a cyclopentyl, cyclohexyl, cycloheptyl or cyclooctyl ring.

In a further embodiment of the method claimed here for preparing compounds according to formula VIII, R1 and R3 of the reactant AH can together form a carbocyclic ring, in particular an aromatic or unsaturated ring, which is fused with at least one aromatic ring.

In a further embodiment of the method described here for preparing compounds according to formula VIII, R1 of the reactant AH is hydrogen (H), methyl or phenyl, or R1 together with R3 forms a phenyl ring which is fused with a benzene ring, so that R1 and R3 are part of a naphthyl ring.

In another embodiment of the method claimed here for preparing compounds according to formula VIII, R2 of the reactant AH is hydrogen (H), methyl or phenyl or, together with R4, forms a cyclohexenyl ring.

In another embodiment of the method described here for preparing compounds according to formula VIII, R3 of the reactant AH is hydrogen (H), methyl or phenyl, or R3 together with R1 forms a phenyl ring which is fused with a benzene ring, so that R1 and R3 are part of a naphthyl ring.

In yet another embodiment of the method claimed here for preparing compounds according to formula VI II, R4 of the reactant AH is hydrogen (H), methyl or phenyl or R4, together with R2, forms a cyclohexenyl ring.

In particular, R1 to R4 of the reactant AH can be the following radicals. Radicals marked with an asterisk * together form the indicated radical.

| No. | R1 | R2 | R3 | R4 |
|---|---|---|---|---|
| 1 | H | H | H | H |
| 2 | methyl | H | H | H |
| 3 | H | methyl | H | H |
| 4 | H | H | methyl | H |
| 5 | H | H | H | methyl |
| 6 | methyl | methyl | H | H |
| 7 | methyl | H | methyl | H |
| 8 | methyl | H | H | methyl |
| 9 | H | methyl | methyl | H |
| 10 | H | methyl | H | methyl |
| 11 | H | H | methyl | methyl |
| 12 | methyl | methyl | methyl | H |
| 13 | H | methyl | methyl | methyl |
| 14 | methyl | H | methyl | methyl |
| 15 | methyl | methyl | H | methyl |
| 16 | methyl | methyl | methyl | methyl |
| 17 | phenyl | H | H | H |
| 18 | phenyl | methyl | H | H |
| 19 | phenyl | H | methyl | H |
| 20 | phenyl | H | H | methyl |
| 21 | phenyl | methyl | methyl | H |
| 22 | phenyl | methyl | H | methyl |
| 23 | phenyl | H | methyl | methyl |
| 24 | phenyl | methyl | H | methyl |
| 25 | H | H | H | phenyl |
| 26 | methyl | H | H | phenyl |
| 27 | H | methyl | H | phenyl |
| 28 | H | H | methyl | phenyl |
| 29 | methyl | methyl | H | phenyl |
| 30 | methyl | H | methyl | phenyl |
| 31 | H | methyl | methyl | phenyl |
| 32 | methyl | H | methyl | phenyl |
| 33 | phenyl | methyl | H | phenyl |
| 34 | phenyl | H | methyl | phenyl |
| 35 | phenyl | methyl | methyl | phenyl |
| 36 | phenyl | H | H | phenyl |
| 37 | H | cyclohexenyl* | H | cyclohexenyl* |
| 38 | methyl | cyclohexenyl* | H | cyclohexenyl* |
| 39 | methyl | cyclohexenyl* | methyl | cyclohexenyl* |
| 40 | H | cyclohexenyl* | methyl | cyclohexenyl* |
| 41 | phenyl | cyclohexenyl* | methyl | cyclohexenyl* |
| 42 | phenyl | cyclohexenyl* | H | cyclohexenyl* |
| 43 | cyclohexenyl* | H | cyclohexenyl* | H |
| 44 | cyclohexenyl* | methyl | cyclohexenyl* | H |
| 45 | cyclohexenyl* | methyl | cyclohexenyl* | methyl |
| 46 | cyclohexenyl* | H | cyclohexenyl* | methyl |
| 47 | cyclohexenyl* | phenyl | cyclohexenyl* | methyl |
| 48 | cyclohexenyl* | phenyl | cyclohexenyl* | H |
| 49 | naphthyl*^{a)} | H | naphthyl*^{a)} | H |
| 50 | naphthyl*^{a)} | methyl | naphthyl*^{a)} | H |
| 51 | naphthyl*^{a)} | H | naphthyl*^{a)} | methyl |
| 52 | naphthyl*^{a)} | methyl | naphthyl*^{a)} | methyl |
| 53 | naphthyl*^{a)} | H | naphthyl*^{a)} | phenyl |
| 54 | naphthyl*^{a)} | methyl | naphthyl*^{a)} | phenyl |
| 55 | naphthyl*^{a)} | cyclohexenyl* | naphthyl*^{a)} | cyclohexenyl* |

^{a)}The radicals R1 and R3 together form an aromatic ring, namely a phenyl ring, the aromatic ring being fused with at least one aromatic ring, namely a benzene ring. Thus, R1 and R3 are part of a naphthyl ring. The reactant AH can then be, for example, 1-(chloromethyl)naphthalene (reactant for compound 7-Cl, see below), 2-(chloromethyl)naphthalene (reactant for compound 8-Cl, see below), 1-(bromomethyl)naphthalene (reactant for compound 7-Br, see below) or 2-(bromomethyl)naphthalene (reactant for compound 8-Br, see below).

The combinations of R1, R2, R3 and R4 listed in the table above, where R1 and/or R2 is a methyl radical, can be modified as follows: If either R1 or R2 is a methyl radical, then an ethyl radical, an n-propyl radical or an n-butyl radical can be provided instead of the methyl radical. If according to the table above R1=R2=methyl, then an ethyl radical, an n-propyl radical or an n-butyl radical can be provided instead as radical R1, while the radical R2 remains a methyl radical, or the radical R2 is an ethyl radical, an n-propyl radical or an n-butyl radical while R1=methyl. Alternatively, if according to the above table R1=R2=methyl—it can instead be provided that R1 and R2 are independently selected from the group consisting of an ethyl radical, an n-propyl radical and an n-butyl radical.

One embodiment of the method claimed here provides that the reaction in step B. is carried out in at least one solvent S_{C}. In another variant of the method, the solvent S_{C} is selected from the group consisting of alcohols, alkanes, aromatic hydrocarbons, ketones, ethers and combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, and mixtures thereof. For example, diethyl ether, MTBE (methyl tert-butyl ether), THF, 2-methyltetrahydrofuran, 1,4-dioxane, toluene, benzene, o-xylene, m-xylene, p-xylene, mesitylene, acetone, methanol, isopropanol, and mixtures thereof are well-suited.

According to yet another embodiment of the method described here for preparing a compound according to general formula VIII, the provision of the palladium compound in step A. comprises reacting a palladium(II) compound which advantageously consists of a palladium(II) cation and two monovalent anions or a divalent anion, with a ligand L_{S}, which is an organosilicon compound, advantageously a cyclic or an acyclic siloxane, in the presence of a base. The palladium compound to be provided in step A. can therefore advantageously be prepared in situ.

The palladium(II) compound can have two different or two identical monovalent anions or one divalent anion. A neutral ligand, for example COD, is not provided. Consequently, inexpensive commercially available palladium(II) compounds, such as PdCl₂, can advantageously be used. It is therefore possible to dispense with a time-consuming and costly preparation of a palladium(II) compound of the type [Pd(ligand)Y₂], wherein e.g. ligand=COD, as a reactant for the in situ production of the mononuclear or multinuclear palladium compound. This is particularly advantageous from an economical (in terms of atoms) and ecological perspective. In addition, this reduces the number of possible impurities in the end product according to general formula VIII.

In a further advantageous embodiment, the palladium(II) compound to be used as reactant in the context of the above-mentioned in situ preparation comprises two identical monovalent anions which are in particular selected from the group consisting of halides and monovalent weakly coordinating anions. The expressions “produced/prepared in situ” or “in situ production/preparation” and the term “weakly coordinating” have already been defined above.

In the context of the reaction described here, the term “bases” means inorganic and organic bases, in particular inorganic bases, but not organometallic bases. The bases should not decompose in water. Suitable bases are e.g. salts of Brønsted acids. Carbonates, hydrogen carbonates, acetates, formates, ascorbates, oxalates and hydroxides are advantageously used. These can be used in the form of their ammonium salts (Brønsted acid)NR₄, wherein R is for example H or alkyl, alkali metal salts, for example sodium or potassium salts, and alkaline-earth metal salts.

The reaction of the palladium(II) compound with a ligand L_{S}, which is an organosilicon compound, in step A. usually takes place in a solvent S_{C1}. The solvents S_{C1} are not particularly limited. Examples of possible solvents S_{C1} are polar solvents such as water, alcohols, ketones, hydrocarbons, e.g. aromatic hydrocarbons such as benzene and toluene, or aliphatic hydrocarbons such as pentane, hexane and heptane, open-chain or cyclic ethers, amides and esters. However, preference is given to water, alcohols, e.g. methanol, ethanol, propanol and butanol, and mixtures thereof, ketones e.g. acetone, and ethers, e.g. diethyl ether, MTBE (methyl tert-butyl ether), THF, 2-methyltetrahydrofuran, 1,4-dioxane, and mixtures thereof, as solvents. Mixtures of these solvents can also be used. In particular, the solvent S_{C1} provided for the provision or reaction in step A. and the solvent S_{C} provided for the reaction in step B. are miscible with or identical to one another. There is then no need to change solvent, which is particularly advantageous from an economical and ecological perspective.

A definition of the expression “two miscible solvents” has already been given above.

In one embodiment of the method claimed here for preparing a compound according to general formula VIII, one of the ligands L_{S} is a cyclic or an acyclic siloxane selected from the group consisting of 1,1,3,3-tetramethyl-1,3-divinyldisiloxane (dvds), 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. Advantageously, one of the ligands L_{S} is 1,1,3,3-tetramethyl-1,3-divinyldisiloxane (dvds). In particular, one of the ligands L_{S} is dvds. Surprisingly, it has been found that 1,3-divinyl-1,1,3,3-tetramethyldisiloxanepalladium(0)—in the context of the present invention abbreviated to [Pd₂(dvds)₃], [Pd(dvds)], Pd(vs), Pd—VS or Palladium-VS—is an excellent starting material for preparing compounds according to formula VIII, for example from π-allylpalladium halide complexes such as π-allylpalladium chloride complexes, which, in particular by means of the method described here, are usually obtained in yields of more than 90%, often more than 97%, in particular more than 99%. In addition, by means of the method claimed here, it was possible to synthesize compounds of this type which have not previously been obtained, that is to say have not been described in the prior art.

According to a further variant embodiment of the method claimed here for preparing a compound according to general formula VIII, the reaction temperature in step A. and/or step B., in particular in step B., is 10° C. to 60° C., in particular 15° C. to 45° C. or 20° C. to 30° C. An alternative or supplementary embodiment of the method provides that the reaction time in step A. and/or step B., in particular in step B., is 10 minutes to 48 hours, in particular 1 hour to 36 hours or 2 to 24 hours or 3 to 12 hours.

The object is also achieved by compounds, some of which have not previously been obtained, according to general formula

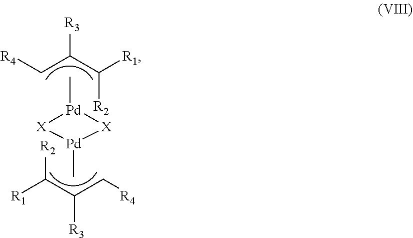

wherein
   X is an anionic ligand, and
   the radicals R1, R2, R3 and R4 are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals
or
   two radicals of R1, R1, R3 and R4, advantageously R1 and R3 or R2 and R4, together form an unsaturated or aliphatic ring
or
   two radicals of R1, R2, R3 and R4, advantageously R1 and R3 or R2 and R4, together form a first ring which is unsaturated or saturated and is fused with at least one aromatic ring,
in particular obtained or obtainable by a method for preparing such a compound according to one of the exemplary embodiments described above.

The compounds according to formula VIII claimed here, in particular according to one of the exemplary embodiments of the method described above for preparing such compounds, are generally obtainable in yields of usually more than 80%, often more than 85%, in particular more than 90%. The palladium(II) compounds according to general formula VIII can be used, for example, as catalysts and/or precatalysts, in particular as precatalysts in palladium-catalyzed cross-coupling reactions. Advantageously, they are suitable as catalysts for the reactions given below.

Palladium(II) dimers according to formula VIII are easy-to-use catalyst precursors with excellent catalytic performance. Advantageously, they are easily accessible in one step from commercially available precursors and react unproblematically with a large number of electron donor ligands, in particular phosphine and NHC ligands, to give defined palladium(II) complexes. Consequently, the preparation, even in situ, of highly active monoligated palladium(II) precatalysts and/or palladium(II) catalysts starting from dimeric palladium(II) compounds according to formula VIII is possible in a simple and reproducible manner.

According to the present invention, the expression “unsaturated ring” means a non-aromatic carbocycle or heterocycle which has at least one double bond. In this case, the unsaturated ring can also be part of a ring system consisting of two or more fused rings, which can comprise aliphatic, aromatic and other unsaturated carbocycles and/or heterocycles.

A saturated ring is formed, for example, by the radicals R2 and R4 if for example an allyl halide derived from phenalene or indene was used as reactant for preparing the compound according to formula VIII.

A compound according to general formula VIII has two identical η³-bonded allyl ligands. The allyl ligand is derived in each case from a compound AH, used as reactant, according to general formula

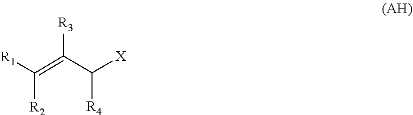

wherein X, R1, R2, R3 and R4 are as defined above.

For example, in order to prepare a compound according to formula VIII, a palladium(0) compound which in particular has a ligand L_{S} which is an organosilicon compound, in particular a cyclic or an acyclic siloxane, can be reacted with 1-naphthylmethyl chloride. For example, a molar ratio Pd:AH of at least 1:1 can be provided. A palladium(II) compound according to formula VIII which can be obtained in this way then has two identical allyl ligands derived from naphthalene, in particular η³-bonded allyl ligands. In other words: A complex according to formula VIII has no naphthyl ligands in the strict sense. This is because the electrons involved in the complexation of the palladium center are not conjugated with the ring electrons. The aromaticity of the bicyclic naphthalene is restricted to one of the two fused six-membered rings as a result of complex formation. However, for the sake of simplicity in the context of the present invention, a naphthalene-derived η¹-bonded ligand or η³-bonded allyl ligand is referred to as naphthyl ligand. The product of the above example reaction is therefore referred to as dimeric palladium(II) 1-methylnaphthyl chloride complex, wherein the chlorine atoms act as bridging ligands, i.e. two chlorine bridges are present, or as a chloride-bridged 1-methylnaphthylpalladium(II) dimer. The same applies in the present case, for example, to the designation of palladium(II) compounds according to formula VIII which are obtainable using an anthracenyl, phenanthrenyl, phenalenyl, fluorenyl, indenyl, tetracenyl or chrysenyl halide.

According to one embodiment of the compounds according to formula VIII claimed here, in particular obtained or obtainable by a method for preparing such a compound according to one of the exemplary embodiments described above, the anionic ligand X is a halide anion or a monovalent weakly coordinating anion.

The term “weakly coordinating” also covers the terms “very weakly coordinating” and “moderately strongly coordinating”. Chloride, bromide or iodide can advantageously be used as halide anions X, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

A further variant of the compounds according to general formula VIII claimed here, in particular obtained or obtainable by a method for preparing such a compound according to one of the exemplary embodiments described above, provides that the radicals R1, R2, R3 and R4 of the compound according to formula VIII are independently selected from the group consisting of hydrogen (H), straight-chain alkyl radicals having one to ten carbon atoms, i.e. also having two, three, four, five, six, seven, eight or nine carbon atoms, branched alkyl radicals having one to ten carbon atoms, i.e. also having two, three, four, five, six, seven, eight or nine carbon atoms, and cyclic alkyl radicals having three to eight carbon atoms, i.e. also having four, five, six or seven carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to fourteen carbon atoms, i.e. also having seven, eight, nine, ten, eleven, twelve or thirteen carbon atoms, unsubstituted mononuclear or polynuclear heteroaryl radicals having five to thirteen carbon atoms, i.e. also having six, seven, eight, nine, ten, eleven or twelve carbon atoms, and substituted mononuclear or polynuclear heteroaryl radicals having five to thirteen carbon atoms, i.e. also having six, seven, eight, nine, ten, eleven or twelve carbon atoms.

According to another embodiment of the compounds according to general formula VIII claimed here, in particular obtained or obtainable by a method for preparing such a compound according to one of the exemplary embodiments described above, the radicals R1, R2, R3 and R4 of the compound according to formula VIII are independently selected from the group consisting of hydrogen (H), straight-chain alkyl radicals having one to eight carbon atoms, branched alkyl radicals having one to eight carbon atoms, cyclic alkyl radicals having four, five or six carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to ten carbon atoms, unsubstituted mononuclear or polynuclear heteroaryl radicals having five to nine carbon atoms and substituted mononuclear or polynuclear heteroaryl radicals having five to nine carbon atoms.

The radicals R1, R2, R3 and R4 of the compounds according to general formula VIII claimed here, in particular obtained or obtainable by a method for preparing such a compound according to one of the exemplary embodiments described above, can be independently selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof. In an alternative or supplementary embodiment of the compounds according to formula VIII claimed here, in particular obtained or obtainable by a method for preparing such a compound according to one of the exemplary embodiments described above, two radicals of R1 to R4 can form a saturated or unsaturated carbocyclic ring which is unsubstituted or is substituted with one or more of the above-mentioned alkyl radicals or aryl radicals. In another embodiment of the compounds according to general VIII claimed here, in particular obtained or obtainable by a method for preparing such a compound according to one of the exemplary embodiments described above, R2 and R4 (apart from the required halogen atom) can form a substituted or unsubstituted carbocyclic, in particular saturated, ring having 5 to 8 carbon atoms. In the above-mentioned embodiments, the carbocyclic ring is advantageously a cyclopentenyl ring, cyclohexenyl ring, cycloheptenyl ring or cyclooctenyl ring or a cyclopentyl ring, cyclohexyl ring, cycloheptyl ring or cyclooctyl ring. For example, in the case of compound 9-Cl, the radicals R2 and R4 form a η³-bonded allyl ligand derived from a substituted cyclopentenyl ring, which allyl ligand is referred to as a cyclopentyl ligand for the sake of simplicity. Accordingly, the radicals R2 and R4 in the compounds 6-Cl and 6-Br shown below each form a cyclohexyl ring.

According to an alternative or supplementary embodiment, the radicals R2 and R4 together form the first, in particular carbocyclic, ring having five to eight carbon atoms, advantageously five or six carbon atoms, the first ring being unsaturated or saturated and being fused with at least one aromatic ring. In this case, R2 and R4 together can be part of a η³-bonded allyl ligand derived from a fluorenyl or indenyl system. An example of this is the compound 9-Cl.

In another embodiment of the compounds according to formula VIII claimed here, in particular obtained or obtainable by a method for preparing such a compound according to one of the exemplary embodiments described above, R1 and R3 together form the first, in particular carbocyclic, ring having five to eight carbon atoms, which is unsaturated or saturated and is fused with at least one aromatic ring. In an alternative variant, R1 and R3 of a compound according to formula VIII, in particular obtained or obtainable by a method for preparing such a compound according to one of the exemplary embodiments described above, together form the first, in particular carbocyclic, ring having five or six carbon atoms, which is unsaturated or saturated and is fused with at least one aromatic ring. In this case, R1 and R3 together can be part of a naphthyl, anthracenyl, phenanthrenyl, phenalenyl, tetracenyl or chrysenyl ring system. Examples of R1 and R3 together forming an unsaturated carbocyclic ring having six carbon atoms, wherein the unsaturated six-membered ring is fused with at least one aromatic ring, are the compounds 7-Cl, 7-Br, 8-Cl and 8-Br. At this point the following should be noted: In the case of the above-mentioned exemplary compounds, the electrons involved in the complexation of the palladium center are not conjugated with the ring electrons. The aromaticity of the bicyclic naphthalene is restricted to one of the two fused six-membered rings as a result of complex formation. However, for the sake of simplicity in the context of the present invention, a naphthalene-derived, in particular η³-bonded allyl ligand is referred to as naphthyl ligand. The above-mentioned exemplary compound 7-Cl is therefore referred to as dimeric palladium(II) 1-methylnaphthyl chloride complex, wherein the chlorine atoms act as bridging ligands, i.e. two chlorine bridges are present, or as a chloride-bridged 1-methylnaphthylpalladium(II) dimer. The same applies in the present case, for example, to the designation of palladium(II) compounds according to formula VIII which are obtainable using an anthracenyl, phenanthrenyl, phenalenyl, fluorenyl, indenyl, tetracenyl or chrysenyl halide.

In another embodiment of the compounds according to formula VIII claimed here, in particular obtained or obtainable by a method for preparing such a compound according to one of the exemplary embodiments described above,
the radicals R1 and R3 together form the first, in particular carbocyclic, ring which is unsaturated or saturated and is fused with at least one aromatic ring, and
the radicals R1 and R2 and/or R3 and R4 form a second, in particular carbocyclic, ring, having 5 to 8 carbon atoms, which is aromatic or unsaturated and is fused with the first ring and/or with the at least one aromatic ring.

In this case, the second ring can be unsubstituted or can optionally be substituted with one or more radicals selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof. The first ring is advantageously selected from the group consisting of a cyclopentenyl ring, cyclohexenyl ring, cycloheptenyl ring, cyclooctenyl ring, cyclopentyl ring, cyclohexyl ring, cycloheptyl ring and cyclooctyl ring. And the second ring is selected from the group consisting of a cyclopentadienyl ring, cyclohexadienyl ring, cycloheptadienyl ring, cyclooctadienyl ring and a benzene ring.

In a further embodiment of the compounds according to formula VIII claimed here, in particular obtained or obtainable by a method for preparing such a compound according to one of the exemplary embodiments described above, R1 is hydrogen (H), methyl or phenyl, or R1 together with R3 forms a cyclohexenyl ring fused with a benzene ring, so that R1 and R3 are part of a naphthyl ring.

In another embodiment of the compounds according to formula VIII claimed here, in particular obtained or obtainable by a method for preparing such a compound according to one of the exemplary embodiments described above, R2 is hydrogen (H), methyl or phenyl, or together with R4 forms a cyclohexyl ring.

In yet another embodiment of the compounds according to formula VIII claimed here, in particular obtained or obtainable by a method for preparing such a compound according to one of the exemplary embodiments described above, R3 is hydrogen (H), methyl or phenyl, or R3 together with R1 forms a cyclohexenyl ring fused with a benzene ring, so that R1 and R3 are part of a naphthyl ring.

In a yet further embodiment of the compounds according to formula VIII claimed here, in particular obtained or obtainable by a method for preparing such a compound according to one of the exemplary embodiments described above, R4 is hydrogen (H), methyl or phenyl, or R4 together with R2 forms a cyclohexyl ring.

In particular, R1 to R4 of a compound according to formula VIII obtained or obtainable by a method for preparing such a compound according to one of the exemplary embodiments described above can be the following radicals. Radicals marked with an asterisk * together form the indicated radical.

| No. | R1 | R2 | R3 | R4 |
|---|---|---|---|---|
| 1 | H | H | H | H |
| 2 | methyl | H | H | H |
| 3 | H | methyl | H | H |
| 4 | H | H | methyl | H |
| 5 | H | H | H | methyl |
| 6 | methyl | methyl | H | H |
| 7 | methyl | H | methyl | H |
| 8 | methyl | H | H | methyl |
| 9 | H | methyl | methyl | H |
| 10 | H | methyl | H | methyl |
| 11 | H | H | methyl | methyl |
| 12 | methyl | methyl | methyl | H |
| 13 | H | methyl | methyl | methyl |
| 14 | methyl | H | methyl | methyl |
| 15 | methyl | methyl | H | methyl |
| 16 | methyl | methyl | methyl | methyl |
| 17 | phenyl | H | H | H |
| 18 | phenyl | methyl | H | H |
| 19 | phenyl | H | methyl | H |
| 20 | phenyl | H | H | methyl |
| 21 | phenyl | methyl | methyl | H |
| 22 | phenyl | methyl | H | methyl |
| 23 | phenyl | H | methyl | methyl |
| 24 | phenyl | methyl | H | methyl |
| 25 | H | H | H | phenyl |
| 26 | methyl | H | H | phenyl |
| 27 | H | methyl | H | phenyl |
| 28 | H | H | methyl | phenyl |
| 29 | methyl | methyl | H | phenyl |
| 30 | methyl | H | methyl | phenyl |
| 31 | H | methyl | methyl | phenyl |
| 32 | methyl | H | methyl | phenyl |
| 33 | phenyl | methyl | H | phenyl |
| 34 | phenyl | H | methyl | phenyl |
| 35 | phenyl | methyl | methyl | phenyl |
| 36 | phenyl | H | H | phenyl |
| 37 | H | cyclohexyl*^{a)} | H | cyclohexyl*^{a)} |
| 38 | methyl | cyclohexyl* | H | cyclohexyl* |
| 39 | methyl | cyclohexyl* | methyl | cyclohexyl* |
| 40 | H | cyclohexyl* | methyl | cyclohexyl* |
| 41 | phenyl | cyclohexyl* | methyl | cyclohexyl* |
| 42 | phenyl | cyclohexyl* | H | cyclohexyl* |
| 43 | cyclohexyl* | H | cyclohexyl* | H |
| 44 | cyclohexyl* | methyl | cyclohexyl* | H |
| 45 | cyclohexyl* | methyl | cyclohexyl* | methyl |
| 46 | cyclohexyl* | H | cyclohexyl* | methyl |
| 47 | cyclohexyl* | phenyl | cyclohexyl* | methyl |
| 48 | cyclohexyl* | phenyl | cyclohexyl* | H |
| 49 | cyclohexenyl*^{b)} | H | cyclohexenyl*^{b)} | H |
| 50 | cyclohexenyl*^{b)} | methyl | cyclohexenyl*^{b)} | H |
| 51 | cyclohexenyl*^{b)} | H | cyclohexenyl*^{b)} | methyl |
| 52 | cyclohexenyl*^{b)} | methyl | cyclohexenyl*^{b)} | methyl |
| 53 | cyclohexenyl*^{b)} | H | cyclohexenyl*^{b)} | phenyl |
| 54 | cyclohexenyl*^{b)} | methyl | cyclohexenyl*^{b)} | phenyl |
| 55 | cyclohexenyl*^{b)} | cyclohexenyl* | cyclohexenyl*^{b)} | cyclohexenyl* |

^{a)}See e.g. the compounds 6-Cl and 6-Br shown below.
^{b)}R1 and R3 together form a first unsaturated ring, namely a cyclohexenyl ring, which is fused with at least one aromatic ring, namely a benzene ring. Thus, R1 and R3 are part of a naphthalene-derived, in particular η³-bonded, allyl ligand, which for the sake of simplicity is referred to as a naphthyl ligand. Examples of such compounds according to formula VIII are the compounds 7-Cl, 7-Br, 8-Cl and 8-Br shown below.

In particular, the following compounds can be prepared as compounds of formula VIII:

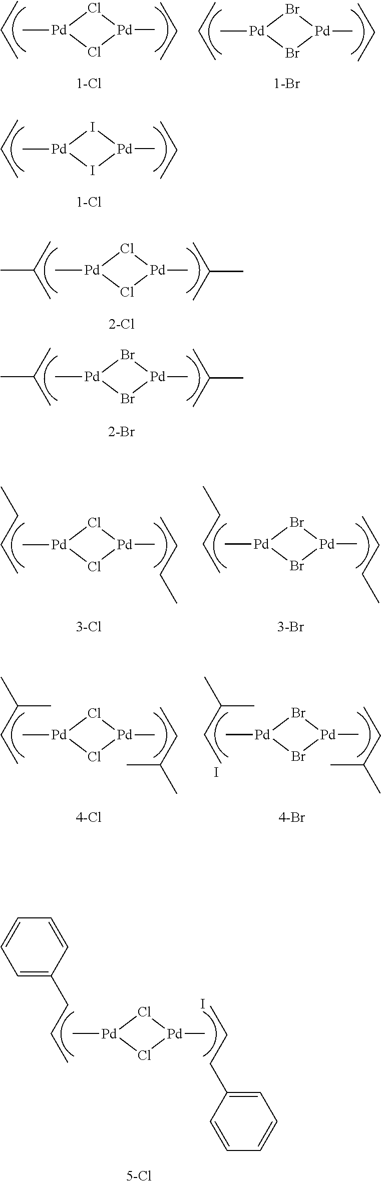

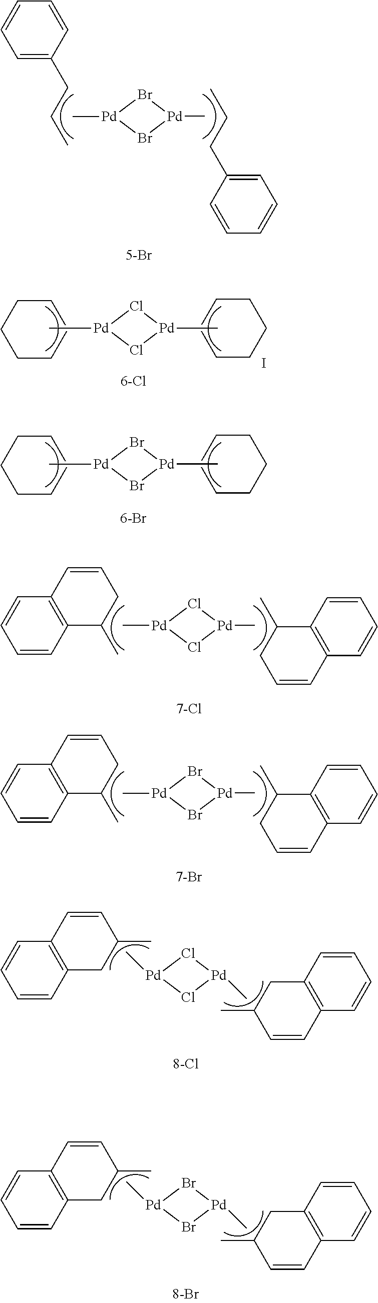

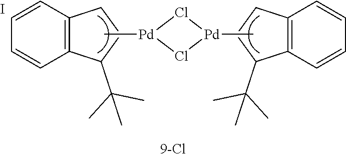

The object is also achieved by a compound according to formula

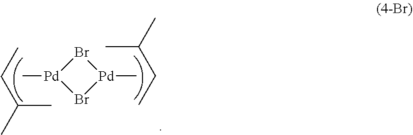

Advantageously, this new compound can also be obtained by means of the method described here for preparing compounds according to general formula VIII, in good yields and high purity. The palladium(II) compound according to formula 4-Br can be used, for example, as a catalyst and/or precatalyst, in particular as a precatalyst in palladium-catalyzed cross-coupling reactions.

The object is further achieved by new compounds according to general formula

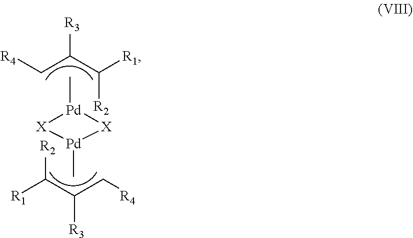

wherein
   X is an anionic ligand,
and
   two radicals of R1, R2, R3 and R4, advantageously R1 and R3 or R2 and R4, together form a first ring which is unsaturated or saturated and is fused with at least one aromatic ring,
with the exception of compounds according to formula

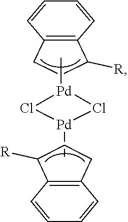

wherein R=alkyl, cycloalkyl or aryl.

The new compounds according to formula VIII claimed here, in particular according to one of the exemplary embodiments of the method described above for preparing such compounds, are generally obtainable in yields of usually more than 90%, often more than 97%, in particular more than 99%. These palladium(II) compounds according to general formula VIII can be used, for example, as catalysts and/or precatalysts, in particular as precatalysts in palladium-catalyzed cross-coupling reactions. Advantageously, they are suitable as precatalysts and/or catalysts for the reactions given below. The new palladium(II) dimers according to formula VIII claimed here are easy-to-use catalyst precursors with excellent catalytic performance.

Advantageously, they are easily accessible in one step from commercially available precursors and react unproblematically with a large number of electron donor ligands, in particular phosphine and NHC ligands, to give defined palladium(II) complexes. Consequently, the preparation, even in situ, of highly active monoligated palladium(II) precatalysts and/or palladium(II) catalysts starting from the new dimeric palladium(II) compounds according to formula VIII is possible in a simple and reproducible manner.

The broad applicability of the new compounds according to formula VIII claimed here as palladium sources, in particular in coupling reactions, was demonstrated using the example of dimeric palladium(II)-1-methylnaphthyl halide complexes in Buchwald-Hartwig aminations, Heck vinylations, α-arylations of ketones and in Negishi and Suzuki-Miyaura couplings. In the case of Buchwald-Hartwig amination and Suzuki-Miyaura coupling, the effect of the new palladium(II) compounds 7-Cl, 7-Br, 8-Cl and 8-Br, which can be prepared starting from 1-methylnaphthyl halides, on the catalyst activity was particularly pronounced. In the case of Suzuki-Miyaura coupling, it was surprisingly possible to extend the reaction to a new class of substrates. In most cases, the bromide complex 7-Br was the most efficient, but in ketone arylation the best results were obtained with the chloride complex 7-Cl.

According to the present invention, the expression “unsaturated ring” means a non-aromatic carbocycle or heterocycle which has at least one double bond. In this case, the unsaturated ring can also be part of a ring system consisting of two or more fused rings, which can comprise aliphatic, aromatic and other unsaturated carbocycles and/or heterocycles.

A saturated ring is formed, for example, by the radicals R2 and R4 if for example an allyl halide derived from phenal or indene was used as reactant for preparing the compound according to formula VIII.

A compound according to general formula VIII has two identical η³-bonded allyl ligands. The allyl ligand is derived in each case from a compound AH, used as reactant, according to general formula

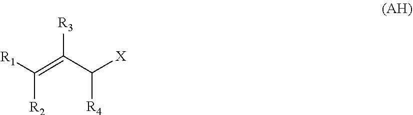

wherein X, R1, R2, R3 and R4 are as defined above.

For example, in order to prepare a compound according to formula VIII, a palladium(0) compound which in particular has a ligand L_{S} which is an organosilicon compound, in particular a cyclic or an acyclic siloxane, can be reacted with 1-naphthylmethyl chloride. For example, a molar ratio Pd:AH of at least 1:1 can be provided. A palladium(II) compound according to formula VIII which can be obtained in this way then has two identical allyl ligands derived from naphthalene, in particular η³-bonded allyl ligands. In other words: A complex according to formula VIII has no naphthyl ligands in the strict sense. This is because the electrons involved in the complexation of the palladium center are not conjugated with the ring electrons. The aromaticity of the bicyclic naphthalene is restricted to one of the two fused six-membered rings as a result of complex formation. However, for the sake of simplicity in the context of the present invention, a naphthalene-derived η¹-bonded ligand or η³-bonded allyl ligand is referred to as naphthyl ligand. The product of the above example reaction is therefore referred to as dimeric palladium(II) 1-methylnaphthyl chloride complex, wherein the chlorine atoms act as bridging ligands, i.e. two chlorine bridges are present, or as a chloride-bridged 1-methylnaphthylpalladium(II) dimer. The same applies in the present case, for example, to the designation of palladium(II) compounds according to formula VIII which are obtainable using an anthracenyl, phenanthrenyl, phenalenyl, fluorenyl, indenyl, tetracenyl or chrysenyl halide.

According to one embodiment of the compounds according to formula VIII claimed here, the anionic ligand X is a halide anion or a monovalent weakly coordinating anion.

The term “weakly coordinating” also covers the terms “very weakly coordinating” and “moderately strongly coordinating”. Chloride, bromide or iodide can advantageously be used as halide anions X, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

In one embodiment of the compounds according to formula VIII claimed here, R1 and R3 together form the first, in particular carbocyclic, ring having five to eight carbon atoms, which is unsaturated or saturated and fused with at least one aromatic ring. In an alternative variant, R1 and R3 of a compound according to formula VIII form the first, in particular carbocyclic, ring having five or six carbon atoms, which is unsaturated or saturated and fused with at least one aromatic ring. In this case, R1 and R3 together can be part of a naphthyl, anthracenyl, phenanthrenyl, phenalenyl, tetracenyl or chrysenyl ring system. Examples of R1 and R3 together forming an unsaturated carbocyclic ring having six carbon atoms, wherein the unsaturated six-membered ring is fused with at least one aromatic ring, are the compounds 7-Cl, 7-Br, 8-Cl and 8-Br. At this point the following should be noted: In the case of the above-mentioned exemplary compounds, the electrons involved in the complexation of the palladium center are not conjugated with the ring electrons. The aromaticity of the bicyclic naphthalene is restricted to one of the two fused six-membered rings as a result of complex formation. However, for the sake of simplicity in the context of the present invention, a naphthalene-derived, in particular η³-bonded allyl ligand is referred to as naphthyl ligand. The above-mentioned exemplary compound 7-Cl is therefore referred to as dimeric palladium(II) 1-methylnaphthyl chloride complex, wherein the chlorine atoms act as bridging ligands, i.e. two chlorine bridges are present, or as a chloride-bridged 1-methylnaphthylpalladium(II) dimer. The same applies in the present case, for example, to the designation of palladium(II) compounds according to formula VIII which are obtainable using an anthracenyl, phenanthrenyl, phenalenyl, fluorenyl, indenyl, tetracenyl or chrysenyl halide.

In another embodiment of the compounds according to formula VIII claimed here,
the radicals R1 and R3 together form the first, in particular carbocyclic, ring which is unsaturated or saturated and is fused with at least one aromatic ring, and
the radicals R1 and R2 and/or R3 and R4 form a second, in particular carbocyclic, ring, having 5 to 8 carbon atoms, which
   is aromatic or unsaturated and is fused with the first ring and/or with the at least one aromatic ring, wherein
   the second aromatic or unsaturated ring is unsubstituted or can optionally be substituted with one or more radicals selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof.

Advantageously, the first unsaturated or saturated ring is selected from the group consisting of a cyclopentenyl ring, cyclohexenyl ring, cycloheptenyl ring, cyclooctenyl ring, cyclopentyl ring, cyclohexyl ring, cycloheptyl ring and cyclooctyl ring and the second unsaturated or aromatic ring is selected from the group consisting of a cyclopentadienyl ring, cyclohexadienyl ring, cycloheptadienyl ring, cyclooctadienyl ring and a benzene ring.

According to another embodiment of the compounds according to formula VIII claimed here, the radicals R2 and R4 together form the first, in particular carbocyclic, ring having five to eight carbon atoms, advantageously five or six carbon atoms, which is unsaturated or saturated and fused with at least one aromatic ring. An example of this is the compound 9-Cl shown above, in which R2 and R4 together form part of a η³-bonded allyl ligand derived from an indenyl system. R2 and R4 can together, for example, also be part of a η³-bonded allyl ligand derived from a fluorenyl system.

In a further embodiment of the compounds according to formula VIII claimed here, R1 together with R3 forms a cyclohexenyl ring which is fused with a benzene ring, so that R1 and R3 are part of a naphthyl ring.

In particular, R1 to R4 of a compound according to formula VIII claimed here can be the following radicals. Radicals marked with an asterisk * together form the indicated radical.

| No. | R1 | R2 | R3 | R4 |
|---|---|---|---|---|
| 1 | cyclohexenyl* | H | cyclohexenyl* | H |
| 2 | cyclohexenyl* | methyl | cyclohexenyl* | H |
| 3 | cyclohexenyl* | methyl | cyclohexenyl* | methyl |
| 4 | cyclohexenyl* | H | cyclohexenyl* | methyl |
| 5 | cyclohexenyl* | phenyl | cyclohexenyl* | methyl |
| 6 | cyclohexenyl* | phenyl | cyclohexenyl* | H |
| 7 | cyclohexyl* | H | cyclohexyl* | H |
| 8 | cyclohexyl* | methyl | cyclohexyl* | H |
| 9 | cyclohexyl* | methyl | cyclohexyl* | methyl |
| 10 | cyclohexyl* | H | cyclohexyl* | methyl |
| 11 | cyclohexyl* | phenyl | cyclohexyl* | methyl |
| 12 | cyclohexyl* | phenyl | cyclohexyl* | H |
| 13 | cyclohexenyl*^{a)} | H | cyclohexenyl*^{a)} | H |
| 14 | cyclohexenyl*^{a)} | methyl | cyclohexenyl*^{a)} | H |
| 15 | cyclohexenyl*^{a)} | H | cyclohexenyl*^{a)} | methyl |
| 16 | cyclohexenyl*^{a)} | methyl | cyclohexenyl*^{a)} | methyl |
| 17 | cyclohexenyl*^{a)} | H | cyclohexenyl*^{a)} | phenyl |
| 18 | cyclohexenyl*^{a)} | methyl | cyclohexenyl*^{a)} | phenyl |

^{a)}R1 and R3 together form a first unsaturated ring, namely a cyclohexenyl ring, which is fused with at least one aromatic ring, namely a benzene ring. Thus, R1 and R3 are part of a naphthalene-derived, in particular η³-bonded, allyl ligand, which for the sake of simplicity is referred to as a naphthyl ligand. Examples of such compounds according to formula VIII are the compounds 7-Cl, 7-Br, 8-Cl and 8-Br shown below.

The object is furthermore achieved by a compound according to general formula VIII.a

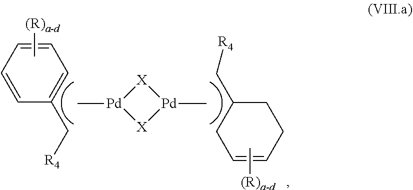

wherein
   X is an anionic ligand,
   R4 is selected from the group consisting of hydrogen (H) and branched, straight-chain or cyclic alkyl radicals
and
   a radical Rₐ is an aromatic radical, wherein at least one ring of the respective aromatic radical Rₐ is fused with the cyclohexenyl ring,
and
a radical R_{b}, a radical R_{c} and a radical R_{d} are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals.

The new compounds according to formula VIII.a, in particular according to one of the exemplary embodiments of the method described above for preparing such compounds, are generally obtainable in yields of usually more than 90%, often more than 97%, in particular more than 99%. These palladium(II) compounds according to formula VIII.a can be used, for example, as catalysts and/or precatalysts, in particular as precatalysts in palladium-catalyzed cross-coupling reactions. Advantageously, they are suitable as precatalysts and/or catalysts for the reactions given below.

The new palladium(II) dimers according to formula VIII.a claimed here are easy-to-use catalyst precursors with excellent catalytic performance. Advantageously, they are easily accessible in one step from commercially available precursors and react unproblematically with a large number of electron donor ligands, in particular phosphine and NHC ligands, to give defined palladium(II) complexes. Consequently, the preparation, even in situ, of highly active monoligated palladium(II) precatalysts and/or palladium(II) catalysts starting from the new dimeric palladium(II) compounds according to formula VIII is possible in a simple and reproducible manner.

The broad applicability of the new compounds according to formula VIII.a claimed here as palladium sources, in particular in coupling reactions, was demonstrated using the example of dimeric palladium(II)-1-methylnaphthyl halide complexes in Buchwald-Hartwig aminations, Heck vinylations, α-arylations of ketones and in Negishi and Suzuki-Miyaura couplings. In the case of Buchwald-Hartwig amination and Suzuki-Miyaura coupling, the effect of the new palladium(II) compounds 7-Cl, 7-Br, 8-Cl and 8-Br, which can be prepared starting from 1-methylnaphthyl halides, on the catalyst activity was particularly pronounced. In the case of Suzuki-Miyaura coupling, it was surprisingly possible to extend the reaction to a new class of substrates. In most cases, the bromide complex 7-Br was the most efficient, but in ketone arylation the best results were obtained with the chloride complex 7-Cl.

According to one embodiment of the compounds according to formula VIII.a claimed here, the anionic ligand X is a halide anion or a monovalent weakly coordinating anion.

The term “weakly coordinating” also covers the terms “very weakly coordinating” and “moderately strongly coordinating”. Chloride, bromide or iodide can advantageously be used as halide anions X, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

According to another embodiment of the compounds according to formula VIII.a claimed here, the radical R4 is selected from the group consisting of hydrogen (H), straight-chain alkyl radicals having one to ten carbon atoms, i.e. also having two, three, four, five, six, seven, eight or nine carbon atoms, branched alkyl radicals having one to ten carbon atoms, i.e. also having two, three, four, five, six, seven, eight or nine carbon atoms, and cyclic alkyl radicals having three to eight carbon atoms, i.e. also with four, five, six or seven carbon atoms.

In another variant embodiment of the compounds according to formula VIII.a, the radical R4 is selected from the group consisting of hydrogen (H), straight-chain alkyl radicals having one to eight carbon atoms, branched alkyl radicals having one to eight carbon atoms and cyclic alkyl radicals having four, five or six carbon atoms. For example, the radical R1 is selected from the group consisting of hydrogen (H), methyl, ethyl, n-propyl, isopropyl, n-butyl, isobutyl, tert-butyl, and combinations thereof.

In one embodiment of the compounds according to formula VIII.a described here, the radical Rₐ is selected from the group consisting of unsubstituted or substituted mononuclear aromatics, unsubstituted or substituted mononuclear heteroaromatics, unsubstituted or substituted polynuclear aromatics, and unsubstituted or substituted polynuclear heteroaromatics.

According to an alternative or supplementary variant of the compounds according to formula VIII.a claimed here, the radical Rₐ is a mononuclear aromatic or heteroaromatic, which is fused with the cyclohexenyl ring at the ortho-position or meta-position relative to the tertiary carbon atom of the cyclohexenyl ring. For example, the mononuclear aromatic or heteroaromatic can be selected from the group consisting of benzene, toluene, xylene, pyrazine, pyridine, pyrimidine, pyrrole, furan, thiophene and imidazole. If Rₐ is benzene, for example, then a naphthalene-derived η³-bonded allyl ligand is present.

Another embodiment of the compounds according to formula VIII.a claimed here provides that the radical Rₐ is a polynuclear aromatic or heteroaromatic, which is fused with the cyclohexenyl ring at the ortho-position and/or meta-position relative to the tertiary carbon atom of the cyclohexenyl ring.

In other words: If the radical Rₐ is a polynuclear aromatic or heteroaromatic, the respective η³-bonded allyl ligand can be an ortho-fused ring system or an ortho-peri-fused ring system. In the case of an ortho-fused ring system, the η³-bonded allyl ligand can be present as a linear ring system or as a bent (angular) ring system. For example, the polynuclear aromatic can be selected from the group consisting of naphthalene, anthracene and phenanthrene. If the radical Rₐ is for example naphthalene, an anthracene-derived or phenanthrene-derived or phenalene-derived η³-bonded allyl ligand can be present. If the radical Rₐ is anthracene, then a tetracene-derived η³-bonded allyl ligand is present. If the radical Rₐ is phenanthrene, then for example a chrysene-derived η³-bonded allyl ligand can be present.

A further variant of the claimed compounds according to formula VIII.a provides that the radical R_{b}, the radical R_{c} and the radical R_{d} are independently selected from the group consisting of hydrogen (H), straight-chain alkyl radicals having one to ten carbon atoms, i.e. also having two, three, four, five, six, seven, eight or nine carbon atoms, branched alkyl radicals having one to ten carbon atoms, i.e. also having two, three, four, five, six, seven, eight or nine carbon atoms, and cyclic alkyl radicals having three to eight carbon atoms, i.e. also having four, five, six or seven carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to fourteen carbon atoms, i.e. also having seven, eight, nine, ten, eleven, twelve or thirteen carbon atoms, unsubstituted mononuclear or polynuclear heteroaryl radicals having five to thirteen carbon atoms, i.e. also having six, seven, eight, nine, ten, eleven or twelve carbon atoms, and substituted mononuclear or polynuclear heteroaryl radicals having five to thirteen carbon atoms, i.e. also having six, seven, eight, nine, ten, eleven or twelve carbon atoms.

According to another embodiment, the radical R_{b}, the radical R_{c} and the radical R_{d} are independently selected from the group consisting of hydrogen (H), straight-chain alkyl radicals having one to eight carbon atoms, branched alkyl radicals having one to eight carbon atoms, cyclic alkyl radicals having four, five or six carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to ten carbon atoms, unsubstituted mononuclear or polynuclear heteroaryl radicals having five to nine carbon atoms and substituted mononuclear or polynuclear heteroaryl radicals having five to nine carbon atoms.

For example, the radical R_{b}, the radical R_{c} and the radical R_{d} are independently selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof.

According to a further advantageous embodiment of the compounds according to formula VIII or formula VIII.a claimed here, the compound is selected from the compounds shown below:

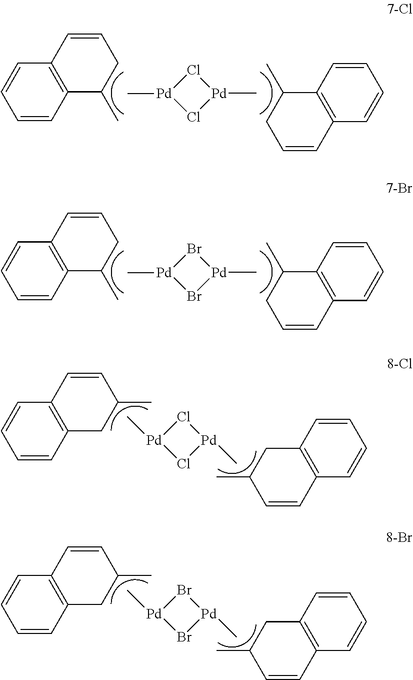

Furthermore, the object is achieved by a preparation containing
i. a compound according to general formula

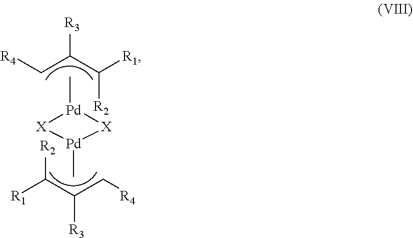

wherein X and the radicals R1, R2, R3 and R4 are as defined above,
or
according to general formula VIII.a

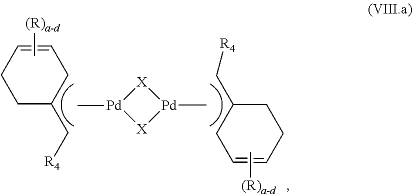

wherein X, (R)_{a-d} and R4 are as defined above,
and
ii. at least one organosilicon compound.

The term organosilicon compound has already been defined above.

The compound according to general formula VIII or VII.a contained in the preparation, or the preparation claimed here itself, are in particular obtained or obtainable by the method described above for preparing a compound according to formula VIII, advantageously according to one of the exemplary embodiments described above.

Palladium(II) dimers according to formula VIII or formula VIII.a are easy-to-use catalyst precursors with excellent catalytic performance. Advantageously, they are easily accessible in one step from commercially available precursors and react unproblematically with a large number of electron donor ligands, in particular phosphine and NHC ligands, to give defined palladium(II) complexes. Consequently, the preparation, even in situ, of highly active monoligated palladium(II) precatalysts and/or palladium(II) catalysts starting from dimeric palladium(II) compounds according to formula VIII or formula VIII.a is possible in a simple and reproducible manner.

According to one embodiment of the preparation, a silicon content, which is present in particular in the form of the at least one organosilicon compound, is ≥100 ppm and ≤1000 ppm, advantageously ≥110 ppm and ≤900 ppm, in particular ≥120 ppm and ≤800 ppm. The silicon content, which is present in particular in the form of the at least one organosilicon compound, can be determined using analysis methods which are known to those skilled in the art, in particular using quantitative ¹H NMR spectroscopy and/or atomic emission spectrometry with inductively coupled plasma (Inductively Coupled Plasma Atomic Emission Spectrometers, ICP-AES).

In an alternative or supplementary embodiment of the preparation claimed here, the preparation contains a solvent S_{Z}. The preparation can be in the form of a solution, suspension, dispersion or gel, in particular depending on the organosilicon compound present and/or on the solvent S_{Z} used. The solvent S_{Z} can also be a mixture of solvents. It is advantageously selected from the group consisting of alkanes, aromatic hydrocarbons and polar solvents, advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited. In particular, if the solvent S_{Z} comprises or is a solvent which is selected from the group consisting of alcohols, alkanes, aromatic hydrocarbons, ketones, e.g. acetone, ethers, and combinations thereof, in particular alcohols having 2 to 6 carbon atoms, aromatic hydrocarbons having 6 to 9 carbon atoms, alkanes or cycloalkanes having 5 to 8 carbon atoms, alkane mixtures such as petroleum ethers, ethers having 4 to 8 carbon atoms or ketones having 2 to 6 carbon atoms, and mixtures thereof, the preparation is in the form of a solution or suspension. For example, the solvent S_{Z} can be selected from the group consisting of diethyl ether, MTBE (methyl tert-butyl ether), THF, 2-methyltetrahydrofuran, toluene, benzene, o-xylene, m-xylene, p-xylene, mesitylene, acetone, methanol and isopropanol, and mixtures thereof.

Another variant of the preparation provides that the solvent S_{Z} is miscible with or identical to the solvent S_{C}, which is used in the method for preparing the compound according to formula VIII.

According to a variant of the claimed preparation, the at least one organosilicon compound contains at least one terminal, in particular vinyl, double bond. In particular, the at least one organosilicon compound comprises or is a cyclic or an acyclic siloxane. According to an alternative or supplementary embodiment of the preparation, the preparation contains, in addition to the palladium compound according to general formula VIII, at least one palladium compound according to general formula [Pd(L_{S})₂] (III). The general formula [Pd(L_{S})₂] (III) also comprises multinuclear complexes, in particular dinuclear complexes according to general formula [Pd₂(L_{S})₃]. In this case, the ligand L_{S} is in particular identical to the at least one organosilicon compound, in particular a cyclic or an acyclic siloxane, and the at least one organosilicon compound contains at least one terminal double bond.

In particular, the ligand L_{S} is identical to the organosilicon compound, wherein the ligand L_{S} is in particular a cyclic or an acyclic siloxane which has at least one terminal, in particular vinyl, double bond. The ligand L_{S} is then advantageously coordinated or bonded via at least one pi-directed bond to the palladium center of the compound according to general formula [Pd(L_{S})₂] (III).

Yet another variant embodiment of the claimed preparation provides that one of the organosilicon compounds comprises or is a cyclic or an acyclic siloxane and/or one of the ligands L_{S} is a cyclic or an acyclic siloxane selected from the group consisting of 1,1,3,3-tetramethyl-1,3-divinyldisiloxane, 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. Advantageously, one of the organosilicon compounds comprises or is 1,1,3,3-tetramethyl-1,3-divinyldisiloxane (dvds) and/or one of the ligands L_{S} is 1,1,3,3-tetramethyl-1,3-divinyldisiloxane (dvds). In particular, one of the organosilicon compounds and/or one of the ligands L_{S} is dvds.

The object is also achieved by a compound according to general formula IX

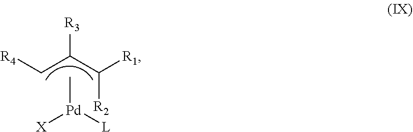

wherein
   X is an anionic ligand,
and
   two radicals of R1, R2, R3 and R4, advantageously R1 and R3 or R2 and R4, together form a first ring which is unsaturated or saturated and is fused with at least one aromatic ring,
and
   L is a neutral electron donor ligand,
with the exception
of a compound according to formula

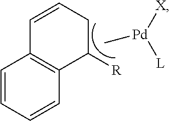

wherein R=Me, X═Cl and L=1,3-bis(2,6-di-isopropylphenyl)imidazolin-2-ylidene,
and
of compounds according to formula

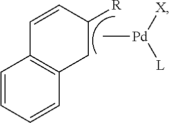

wherein R═H or methyl, X=TfO⁻ and L=racemic 2,2′-bis(diphenylphosphino)-1,1′-binaphthyl (rac-BINAP), (S)-2,2′-bis(diphenylphosphino)-1,1′-binaphthyl or (R)-2,2′-bis(diphenylphosphino)-1,1′-binaphthyl.

The new compounds according to formula IX claimed here, in particular according to one of the exemplary embodiments of the method described below for preparing such compounds, are generally obtainable in yields of usually more than 90%, often more than 97%, in particular more than 99%. These palladium(II) compounds according to general formula IX can be used, for example, as catalysts and/or precatalysts, in particular as precatalysts in palladium-catalyzed cross-coupling reactions. Advantageously, they are suitable as precatalysts and/or catalysts for the reactions given below.

In one embodiment of the compounds according to formula IX claimed here, the anionic ligand X and the radicals R1, R2, R3 and R4 are as defined in a compound according to formula VIII according to one of the embodiments described above, and the neutral electron donor ligand L is a phosphine ligand or an NHC ligand.

According to another embodiment of the compounds according to formula IX claimed here, the neutral electron donor ligand L is
a tertiary phosphine according to general formula P—R10R20R30, wherein R10 and R20 are independently selected from the group consisting of substituted and unsubstituted straight-chain alkyl radicals, substituted and unsubstituted branched alkyl radicals, substituted and unsubstituted cycloalkyl radicals, substituted and unsubstituted aryl radicals, and substituted and unsubstituted heteroaryl radicals, wherein the heteroatoms are selected from the group consisting of sulfur, nitrogen and oxygen, and R30 is defined as R10 and R20 or is a metallocenyl radical,
   or
is a phosphine ligand selected from the group consisting of 2-(dicyclohexylphosphino)-2′-(N,N-dimethylamino))-1,1′-biphenyl (DavePhos), 2-(dicyclohexylphosphino)-2′,4′,6′-tri-isopropyl-1,1′-biphenyl (XPhos), 2-dicyclohexylphosphino-2′,6′-dimethoxy-1,1′-biphenyl (SPhos), 2-dicyclohexylphosphino-2′,6′-di-isopropoxy-1,1′-biphenyl (RuPhos), 2-(dicyclohexylphosphino)-3,6-dimethoxy-2′,4′,6′-tri-isopropyl-1,1′-biphenyl (BrettPhos), [4-(N,N-dimethylamino)phenyl]di-tert-butylphosphine (Amphos), 9,9-dimethyl-4,5-bis(diphenylphosphino)xanthene (Xantphos), 2-dicyclohexylphosphino-2′,6′-bis(dimethylamino)-1,1′-biphenyl (CPhos), tricyclohexylphosphine (PCy₃), di-(1-adamantyl)-n-butylphosphine (cataCXium® A), 2-di-tert-butylphosphino-2′,4′,6′-tri-isopropyl-1,1′-biphenyl (t-BuXPhos), 2-(di-tert-butylphosphino)-3,6-dimethoxy-2′,4′,6′-tri-isopropyl-1,1′-biphenyl (tert-BuBrettPhos), 2-(di-tert-butylphosphino)-3-methoxy-6-methyl-2′,4′,6′-tri-isopropyl-1,1′-biphenyl (RockPhos), 2-di[3,5-bis(trifluoromethyl)phenylphosphino]-3,6-dimethoxy-2′,4′,6′-tri-iso-propyl-1,1′-biphenyl (JackiePhos), 2-(di-tert-butylphosphino)-biphenyl (JohnPhos), (R)-(−)-1-[(S)-2-(dicyclohexylphosphino)ferrocenyl]ethyldi-tert-butylphosphine, di-tert-butyl(n-butyl)phosphine, 2-(di-1-adamantylphosphino)-3,6-dimethoxy-2′,4′,6′-tri-isopropyl-1,1′-biphenyl (AdBrettPhos), 2-diethylphosphino-2′,6′-bis(dimethylamino)-1,1′-biphenyl, racemic 2-di-tert-butylphosphino-1,1′-binaphthyl (TrixiePhos), tri-tert-butylphosphine (PtBu₃), triisopropylphosphine (PiPr₃), di-tert-butyl(isopropyl)phosphine (P(iPr)tBu₂), tert-butyl-di(isopropyl)phosphine (P(iPr)₂tBu), 1,3,5,7-tetramethyl-8-phenyl-2,4,6-trioxa-8-phosphaadamantane (MeCgPPh), N-[2-(di-1-adamantylphosphino)phenyl]morpholine (MorDalPhos), 4,6-bis(diphenylphosphino)phenoxazine (NiXantphos), 1,1′-bis(diphenylphosphino)ferrocene (dppf), 2-di-tert-butylphosphino-2′-(N,N-dimethylamino))-1,1′-biphenyl (tBuDavePhos), racemic 2,2′-bis(diphenylphosphino)-1,1′-binaphthyl (rac-BINAP), 1,1′-bis(di-tert-butylphosphino)ferrocene (DTBPF), 2-di-tert-butylphosphino-3,4,5,6-tetramethyl-2′,4′,6′-triisopropyl)-1,1′-biphenyl (Me₄t-BuXPhos), 2-dicyclohexylphosphino-4-(N,N-dimethylamino)-1,1′-biphenyl, trimethylphosphine (PMe₃), tris-p-tolylphosphine (P(p-tolyl)₃), tris-o-tolylphosphine (P(o-tolyl)₃), methyldiphenylphosphine, triphenylphosphine (PPh₃), tris-(pentafluorophenyl)phosphine (P(C₆F₅)₃), trifluorophosphine, 1-adamantyl-di-(tert-butyl)phosphine (P(1-Ad)tBu₂), di(1-adamantyl)-tert-butylphosphine (P(1-Ad)₂tBu), 1-adamantyl-di(isopropyl)phosphine (P(1-Ad)iPr₂), di(1-adamantyl)-isopropylphosphine (P(1-Ad)₂iPr), 1,3-bis-(diphenylphosphino)propane (dppp), 1,2-bis(diphenylphosphino)ethane (dppe), tert-butyldiphenylphosphine (P(tBu)Ph₂), phenyl-di-tert-butylphosphine, di-tert-butyl-neopentylphosphine, 1,2,3,4,5-pentaphenyl-1′-(di-tert-butylphosphino)ferrocene, tris(p-methoxyphenyl)phosphine, tris(p-trifluoromethylphenyl)phosphine, tris(2,4,6-trimethoxyphenyl)phosphine, tris(2,4,6,-trimethyl)phosphine, tris(2,6-dimethylphenyl)phosphine, benzyldi-1-adamantylphosphine, cyclohexyldi-tert-butylphosphine, cyclohexyldiphenylphosphine, 2-di-tert-butylphosphino-1,1′-binaphthyl, 2-(di-tert-butylphosphino)biphenyl, 2-di-tert-butylphosphino-2′-methylbiphenyl, 2-di-tert-butylphosphino-2′,4′,6′-tri-iso-propyl-1,1′-biphenyl, 2-di-tert-butylphosphino-3,4,5,6-tetramethyl-2′,4′,6′-tri-iso-propylbiphenyl, 2-(dicyclohexylphosphino)biphenyl (Cyclohexyl-JohnPhos), 2-(dicyclohexylphosphino)-2′,6′-dimethoxy-1,1′-biphenyl, 2-di-tert-cyclohexylphosphino-2′-(N,N-dimethylamino)biphenyl, 2-di-tert-cyclohexylphosphino-2′,6′-diisopropoxy-1,1′-biphenyl, 2-(dicyclohexylphosphino)-2′,4′,6′-triisopropyl-1,1′-biphenyl, 2-di-cyclohexylphosphino-2′-methylbiphenyl, 2-diphenylphosphino-2′-(N,N-dimethylamino)biphenyl, (4-dimethyl-aminophenyl)(tert-butyl)₂-phosphine, 1,2-bis(di-tert-butylphosphinomethyl)benzene, 1,3-bis(di-tert-butylphosphinomethyl)propane, 1,2-bis(diphenylphosphinomethyl)benzene, 1,2-bis(di-phenylphosphino)ethane, 1,2-bis(diphenylphosphino)propane, 1,2-bis(diphenylphosphino)butane, N-(2-methoxyphenyl)-2-(di-tert-butylphosphino)pyrrole, 1-(2-methoxyphenyl)-2-(di-cyclohexylphosphino)pyrrole, N-phenyl-2-(di-tert-butylphosphino)indole, N-phenyl-2-(di-tert-butylphosphino)pyrrole, N-phenyl-2-(dicyclohexylphosphino)indole, N-phenyl-2-(dicyclohexylphosphino)pyrrole, 1-(2,4,6-trimethylphenyl)-2(dicyclohexylphosphino)imidazole and (S)-7,7′-bis(diphenylphosphino)-3,3′,4,4′-tetrahydro-4,4′-dimethyl-8,8′-bi(2H-1,4-benzoxazine) (Solphos)
   or
is a phosphine ligand according to general formula YPR¹R² (V.a) or Y₂PR¹ (V.b) or Y₃P (VI)

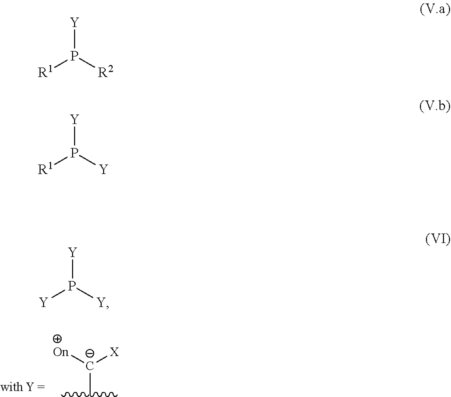

wherein
Y is an ylide substituent bonded to the phosphorus atom via the carbanionic center, which ylide substituent has onium groups On and an X group,
On, independently of the onium groups in further ylide substituents, is selected from phosphonium groups —PR³R⁴R⁵, ammonium groups —NR³R⁴R⁵, sulfoxonium groups —SOR³R⁴, and sulfonium groups —SR³R⁴,
X, independently of the X groups in further ylide substituents, is selected from H, primary, secondary, tertiary alkyl, alkenyl and alkynyl radicals having 1 to 10 carbon atoms, cyclic alkyl radicals having 3 to 10 carbon atoms, a benzyl radical, mononuclear aryl radicals, polynuclear aryl radicals, mononuclear heteroaryl radicals, polynuclear heteroaryl radicals, silyl groups —SiR³R⁴R⁵, sulfonyl groups —SO₂R³, phosphoryl groups —P(O)R³R⁴, —P(S)R³R⁴, —P(NO₃)r⁴R⁵, a cyano group —CN, alkoxy groups —OR³ and amino groups —NR³R⁴,
   wherein
   R¹, R², R³, R⁴ and R⁵, where present, are independently selected from alkyl, aryl and heteroaryl groups which may be unsubstituted or substituted with functional groups,
   or
an NHC ligand according to general formula X

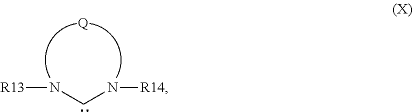

wherein
R¹³ and R¹⁴ are the same or different and are independently substituted or unsubstituted C1 to C20 alkyl, substituted or unsubstituted C1 to C20 alkenyl, substituted or unsubstituted C1 to C20 heteroalkyl, substituted or unsubstituted C1 to C20 alkynyl, substituted or unsubstituted alicyclic or aromatic rings or ring systems having one to five rings, and optionally have one or more heteroatoms and/or substituents
   and
Q is a substituted or unsubstituted hydrocarbon bridge, which is saturated or unsaturated, or a substituted or unsubstituted heteroatom-containing hydrocarbon bridge,
   wherein optionally two or more substituents on adjacent atoms are connected to other cyclic structures and there is a fused cyclic structure having two to five cyclic structures.

In the tertiary phosphine according to general formula P—R10R20R30, R10 and R20 can independently be substituted and unsubstituted branched or straight-chain alkyl groups, for example methyl, ethyl, n-propyl, isopropyl, n-butyl, isobutyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantyl, or aryl groups such as phenyl, naphthyl or anthracyl.

In one embodiment, the alkyl groups of the tertiary phosphine according to general formula P—R10R20R30 can be optionally substituted with one or more substituents such as halide (F, Cl, Br or I) or alkoxy groups, e.g. methoxy, ethoxy or propoxy. The aryl groups may be optionally substituted with one or more (e.g. 1, 2, 3, 4 or 5) substituents such as halide (F, Cl, Br or I), straight-chain or branched alkyl groups (e.g. C1-C10 alkyl), alkoxy (e.g. C1-C10 alkoxy), straight-chain or branched (dialkyl)amino groups (e.g. C1-C10 dialkylamino), heterocycloalkyl (e.g. C3-C10 heterocycloalkyl groups such as morpholinyl and piperadinyl) or trihalomethyl (e.g. trifluoromethyl). Suitable substituted aryl groups include, but are not limited to, 4-dimethylaminophenyl, 4-methylphenyl, 3,5-dimethylphenyl, 4-methoxyphenyl, and 4-methoxy-3,5-dimethylphenyl. Substituted and unsubstituted heteroaryl groups such as pyridyl, furanyl, thiophenyl, pyrrolyl, or quinolinyl can also be used. In an alternative embodiment, R10 and R20 of the tertiary phosphine according to general formula P—R10R20R30 are joined together and form a ring structure with the phosphorus atom, in particular a four- to seven-membered ring. In particular, R10 and R20 are the same and are tert-butyl, cyclohexyl, phenyl or substituted phenyl groups. In particular, R10 and R20 are tert-butyl. In addition, R10 and R20 may independently be alkoxy (e.g. C1-C10 alkoxy) or aryloxy (e.g. C1-C10 aryloxy).

R30 is defined like R10 and R20, but can also be a metallocenyl radical. In the latter embodiment, R30 is a substituted or unsubstituted metallocenyl group. In this case, the metallocenyl group has a first cyclopentadienyl radical and a second cyclopentadienyl radical. A number p of radicals R40 can optionally be provided on the first cyclopentadienyl radical via which the tertiary phosphine according to general formula P—R10R20R30 is bonded or coordinated to the palladium center, and a number q of radicals R41 can optionally be provided on the second cyclopentadienyl radical. R40 and R41 are independently organic groups having 1 to 20 carbon atoms. R40 and R41 can independently be defined like R10 and R20.

p can assume the values 0, 1, 2, 3 or 4 and q can assume the values 0, 1, 2, 3, 4 or 5. In one possible embodiment, q=5 and R41 is methyl or phenyl.

In another embodiment, p=0.

In a specific embodiment, p=0, q=5, R10 is methyl or phenyl, and R10 and R20 are tert-butyl (QPhos), or R10 and R20 are tert-butyl and R30 is 4-dimethylaminophenyl (AmPhos), or R10 and R20 are tert-butyl and R30 is phenyl.

In another embodiment, R10, R20 and R30 are the same and are 1-adamantyl, 2-adamantyl, phenyl, ortho-tolyl, cyclohexyl, tert-butyl, or R10 and R20 are 1-adamantyl or 2-adamantyl and R30 is n-butyl.

According to another variant embodiment of the claimed compounds according to general formula IX, the electron donor ligand L is a phosphine ligand according to general formula YPR¹R² (V.a) or Y₂PR¹ (V.b) or Y₃P (VI), wherein Y is as defined above, and wherein
the alkyl groups are selected from straight-chain, branched or cyclic alkyl groups having 1 to 10 carbon atoms, advantageously from straight-chain, branched or cyclic alkyl groups having 1 to 6 carbon atoms and cycloalkyl groups having 4 to 10 carbon atoms,
the aryl groups are selected from aryl groups having 6 to 14 carbon atoms, advantageously from aryl groups having 6 to 10 carbon atoms,
the alkenyl groups are selected from monounsaturated, polyunsaturated, straight-chain, branched and cyclic alkenyl groups having 2 to 10 carbon atoms, advantageously from monounsaturated, polyunsaturated, straight-chain, branched and cyclic alkenyl groups having 2 to 6 carbon atoms
the heteroaryl groups are selected from heteroaryl groups having 6 to 14 carbon atoms, advantageously from heteroaryl groups having 6 to 10 carbon atoms and having 1 to 5 heteroatoms selected from N, O and S,
   and/or
the functional groups are selected from alkyl groups —R¹¹, advantageously alkyl groups —R¹¹ having 1 to 6 carbon atoms, aryl groups —R¹², halogens -Hal, a hydroxy group —OH, a cyano group —CN, an alkoxy group —OR³, amino groups —N(R¹¹)₂, —NHR¹¹ and —NH₂, mercapto groups —SH and —SR¹¹, wherein R¹¹, independently of other radicals R¹¹, is selected from alkyl radicals having 1 to 6 carbon atoms.

Yet another embodiment of the compounds according to general formula IX claimed here provides that the electron donor ligand L is a phosphine ligand according to general formula

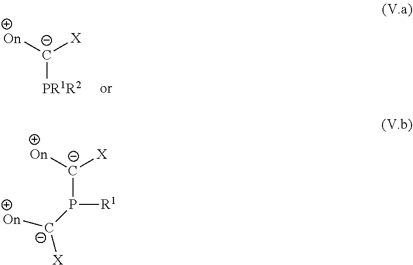

wherein
   On is a phosphonium group —PR³R⁴R⁵,
wherein R³, R⁴ and R⁵ are independently selected from the group consisting of alkyl groups having 1 to 6 carbon atoms, cycloalkyl groups having 4 to 10 carbon atoms, aryl groups having 6 to 10 carbon atoms,
   X is selected from the group consisting of straight-chain, branched and cyclic alkyl groups having 1 to 6 carbon atoms, aryl groups having 3 to 10 carbon atoms, monosaturated, polyunsaturated, straight-chain, branched and cyclic alkenyl groups having 2 to 6 carbon atoms, trialkylsilyl groups —SiR³R⁴R⁵, arylsulfonyl groups R¹²—SO₂R³
and
   R¹ and R² are aryl groups having 6 to 10 carbon atoms or alkyl or cycloalkyl groups having 1 to 6 carbon atoms.

In a further embodiment of the compounds according to general formula IX claimed here, the electron donor ligand L is a phosphine ligand according to general formula YPR¹R² (V.a) or Y₂PR¹ (V.b) or Y₃P (VI), wherein Y is as defined above, and wherein R³, R⁴ and R⁵
a) are independently selected from the group consisting of methyl, ethyl, butyl, cyclohexyl, phenyl, and combinations thereof
or
b) are the same and are selected from the group consisting of methyl, ethyl, butyl, cyclohexyl, phenyl, and combinations thereof, advantageously cyclohexyl and phenyl.

According to another variant of the claimed compounds according to formula IX, the electron donor ligand L is a phosphine ligand according to general formula YPR¹R² (V.a) or Y₂PR¹ (V.b) or Y₃P (VI), wherein Y is as defined above and wherein X is selected from the group consisting of methyl, ethyl, cyclohexyl, phenyl, p-tolyl, trimethylsilyl, p-tolylsulfonyl, and combinations thereof.

In a yet further embodiment of the compounds according to general formula IX claimed here, the electron donor ligand L is a phosphine ligand according to general formula YPR¹R² (V.a) or Y₂PR¹ (V.b) or Y₃P (VI), wherein Y is as defined above, and wherein R¹ and R² are independently selected from the group consisting of phenyl, cyclohexyl, methyl and combinations thereof.

In another embodiment, the neutral electron donor ligand L is cyclohexylphosphine, triphenylphosphine, tri-ortho-tolylphosphine. Also suitable are phosphines such as XPhos, JohnPhos, SPhos, Bophos, Josiphos, Taniaphos, Walphos and phosphine ligands having the following illustrated structures

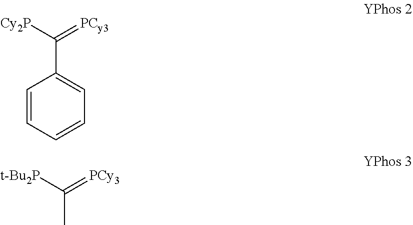

or other ligands described in patent application WO 2019/030304 or ligands according to the structures shown below

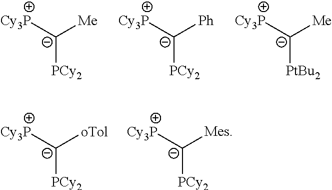

If the neutral electron donor ligand L is an NHC ligand according to general formula X, R13 and R14 can in particular be identical or different and independently substituted or unsubstituted phenyl, or phenyl substituted with one or more substituents selected from the group consisting of C₁-C₂₀ alkyl, substituted C₁-C₂₀ alkyl, C₁-C₂₀ heteroalkyl, substituted C₁-C₂₀ heteroalkyl, C₅—C₂₄ aryl, substituted C₅-C₂₄ aryl, C₅-C₂₄ heteroaryl, C₆-C₂₄ aralkyl, C₆-C₂₄ alkaryl or halogen.

For example, Q can be a bridge of two or three atoms and can be saturated or unsaturated.

In another embodiment, Q is a two-atom bridge having the structure —CR21R22-CR23R24—or —CR21═CR23-, in particular —CR21 R22-CR23R24-, wherein R21, R22, R23 and R24 are independently selected from hydrogen (H), hydrocarbyl, substituted hydrocarbyl, heteroatom-containing hydrocarbyl, substituted heteroatom-containing hydrocarbyl, and functional groups. Examples of functional groups are carboxyl, C₁-C₂₀ alkoxy, C₅-C₂₄ aryloxy, C₂-C₂₀ alkoxycarbonyl, C₅-C₂₄ alkoxycarbonyl, C₂-C₂₄ acyloxy, C₁-C₂₀ alkylthio, C₅-C₂₄ arylthio, C₁-C₂₀ alkylsulfonyl, and C₁-C₂₀ alkylsulfinyl, optionally substituted with one or more substituents selected from C₁-C₁₂ alkyl, C₁-C₁₂ alkoxy, C₅-C₁₄ aryl, hydroxyl, sulfhydryl, formyl, and halogen (F, Cl, Br, I). R21, R11, R23 and R24 are in particular selected from hydrogen (H), C₁-C₁₂ alkyl, substituted C₁-C₁₂ alkyl, C₁-C₁₂ heteroalkyl, substituted C₁-C₁₂ heteroalkyl, phenyl and substituted phenyl. Alternatively, two radicals selected from R21, R22, R23 and R24 can be joined together to form a substituted or unsubstituted, saturated or unsaturated ring structure, e.g. a C₄-C₁₂ alicyclic ring or a C₅ or C₆ aryl group, which itself may be substituted, for example with aromatic groups or other substituents.

In an alternative or supplementary embodiment, the radicals R21, R22, R23 and R24 are independently selected from the group consisting of hydrogen (H), a branched or straight-chain alkyl, alkylene or alkynyl radical having one to ten carbon atoms, a cyclic alkyl, alkylene or alkynyl radical having three to ten carbon atoms, a substituted or unsubstituted mononuclear or polynuclear aryl radical having six to fourteen carbon atoms and a substituted or unsubstituted mononuclear or polynuclear heteroaryl radical having five to thirteen carbon atoms, —O-alkyl, —O—C(O)-alkyl, —O-(aryl), —O—C(O)-aryl, —F, —Cl, —OH, —NO₂, —Si(alkyl)₃, —CF₃, —CN, —CO₂H, —C(O)H, —SO₃H, —NH₂, —NH(alkyl), —N(alkyl)₂, —P(alkyl)₂, —SO₂(alkyl), —SO(alkyl), —SO(aryl), —SO₂(aryl), —SO₃(alkyl), —SO₃(aryl), —S-alkyl, —S-aryl, —S-alkenyl, —NH—CO(alkyl), —CO₂(alkyl), —CONH₂, —CO(alkyl), —NHCOH, —NHCO₂(alkyl), —CO(aryl), —CO₂(aryl), —CH═CH—CO₂(alkyl), —CH═CH—CO₂H, —P(aryl)₂, —PO(aryl)₂, —PO(alkyl)₂, —PO₃H, —PO(O-alkyl)₂ and groups of any fused ring system wherein alkyl and aryl are as defined for R21, R22, R23 and R24.

The alkyl, alkylene or alkynyl radicals can each be substituted for example with F, Cl, Br, I, alkyl, O-alkyl, phenyl, O-phenyl, OH, NH₂ and/or CF₃, the aryl and heteroaryl radicals e.g. with F, Cl, Br, I, alkyl, O-alkyl, phenyl and/or O-phenyl.

Examples of suitable N-heterocyclic carbene (NHC) ligands and acyclic diaminocarbene ligands suitable as the neutral electron donor ligand L contain, for example, the following structures:

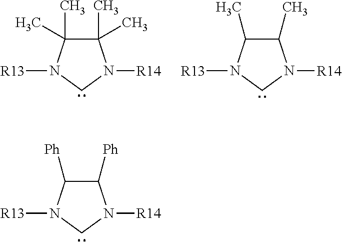

In the above structures, R13 and R14 can independently be for example DIPP, Mes, 3,5-di-tert-butylphenyl, 2-methylphenyl and combinations thereof, wherein DIPP or DiPP is 2,6-diisopropylphenyl and Mes is 2,4,6-trimethylphenyl (mesityl).

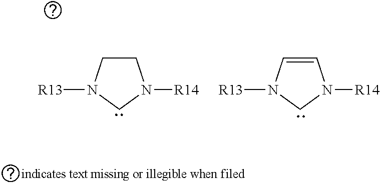

In the above structures, R13 and R14 can independently be for example DIPP, Mes, 3,5-di-tert-butylphenyl, 2-methylphenyl and combinations thereof.

Further examples of suitable N-heterocyclic carbene (NHC) ligands and acyclic diaminocarbene ligands suitable as the neutral electron donor ligand L contain, for example, the following structures:

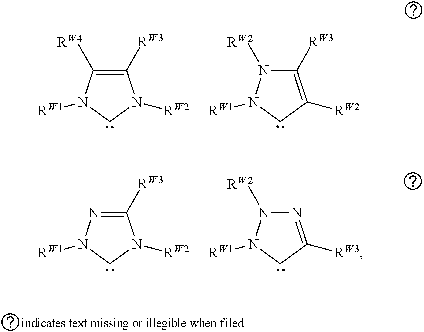

wherein R^{W1}, R^{W2}, R^{W3}, R^{W4} can independently be hydrogen (H), unsubstituted hydrocarbyl, substituted hydrocarbyl, or heteroatom-containing hydrocarbyl and wherein one or both of R^{W3} and/or R^{W4} can be independently selected from halogen, nitro, amido, carboxyl, alkoxy, aryloxy, sulfonyl, carbonyl, thio or nitroso groups. Further examples of N-heterocyclic carbene (NHC) ligands suitable as the neutral electron donor ligand L are disclosed, for example, in U.S. Pat. Nos. 7,378,528; 7,652,145; 7,294,717; 6,787,620; 6,635,768; and 6,552,139.

According to a further variant embodiment of the compounds according to general formula IX claimed here, the neutral electron donor ligand L is selected from the group consisting of tri-tert-butylphosphine, tricyclohexylphosphine, tri-1-adamantylphosphine, tri-2-adamantylphosphine, di-(1-adamantyl)-n-butylphosphine (cataCXium® A), 2-(dicyclohexylphosphino)-2′,4′,6′-triisopropyl-1,1′-biphenyl (XPhos), 2-dicyclohexylphosphino-2′,6′-diisopropoxy-1,1′-biphenyl (RuPhos), di-1,3-bis-(2,4,6-trimethylphenyl)-imidazolidin-2-ylidene (“SIMes”), 1,3-bis-(2,6-diisopropylphenyl)-imidazolidin-2-ylidene (“SIPr”), 1,3-bis-(2,6-diisopropylphenyl)-imidazolin-2-ylidene (unsaturated NHC ligand, “IPr”) and 1,3-bis-(2,4,6-trimethylphenyl)-imidazolin-2-ylidene (unsaturated NHC ligand, “IMes”).

In particular, as has been surprisingly found, a compound according to formula IX can be a compound of the following formula IX.N or IX.P

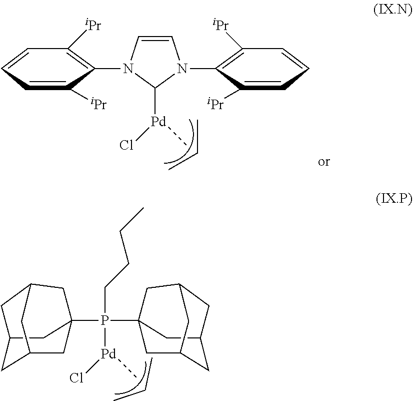

The object is also achieved by a compound according to general formula IX.a

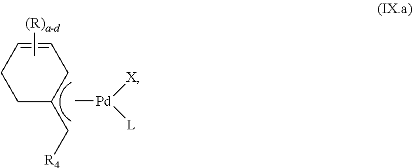

wherein
   X and L are as defined in a compound according to formula IX,
   R4 is selected from the group consisting of hydrogen (H) and branched, straight-chain or cyclic alkyl radicals
and
   a radical Rₐ is an aromatic radical, wherein at least one ring of the respective aromatic radical Rₐ is fused with the cyclohexenyl ring,
and
a radical R_{b}, a radical R_{c} and a radical R_{d} are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals,
with the exception
of a compound according to formula

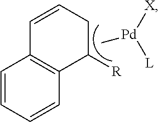

wherein R=Me, X═Cl and L=1,3-bis(2,6-di-isopropylphenyl)imidazolin-2-ylidene,
and
of compounds according to formula

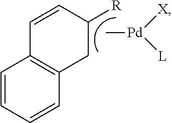

wherein R═H or methyl, X=TfO⁻ and L=racemic 2,2′-bis(diphenylphosphino)-1,1′-binaphthyl (rac-BINAP), (S)-2,2′-bis(diphenylphosphino)-1,1′-binaphthyl or (R)-2,2′-bis(diphenylphosphino)-1,1′-binaphthyl.

The new compounds according to formula IX.a claimed here, in particular according to one of the exemplary embodiments of the method described above for preparing compounds according to formula IX, are generally obtainable in yields of usually more than 90%, often more than 97%, in particular more than 99%. The palladium(II) compounds according to formula IX can be used, for example, as catalysts and/or precatalysts, in particular as precatalysts in palladium-catalyzed cross-coupling reactions. Advantageously, they are suitable as precatalysts and/or catalysts for the reactions given below.

According to an embodiment of the compounds according to formula IX.a claimed here, the radical R4 is selected from the group consisting of hydrogen (H), straight-chain alkyl radicals having one to ten carbon atoms, i.e. also having two, three, four, five, six, seven, eight or nine carbon atoms, branched alkyl radicals having one to ten carbon atoms, i.e. also having two, three, four, five, six, seven, eight or nine carbon atoms, and cyclic alkyl radicals having three to eight carbon atoms, i.e. also with four, five, six or seven carbon atoms.

In another variant embodiment of the compounds according to formula IX.a, the radical R4 is selected from the group consisting of hydrogen (H), straight-chain alkyl radicals having one to eight carbon atoms, branched alkyl radicals having one to eight carbon atoms and cyclic alkyl radicals having four, five or six carbon atoms. For example, the radical R1 is selected from the group consisting of hydrogen (H), methyl, ethyl, n-propyl, isopropyl, n-butyl, isobutyl, tert-butyl, and combinations thereof.

In one embodiment of the compounds according to formula IX.a described here, the radical Rₐ is selected from the group consisting of unsubstituted or substituted mononuclear aromatics, unsubstituted or substituted mononuclear heteroaromatics, unsubstituted or substituted polynuclear aromatics, and unsubstituted or substituted polynuclear heteroaromatics.

According to an alternative or supplementary variant of the compounds according to formula IX.a claimed here, the radical Rₐ is a mononuclear aromatic or heteroaromatic, which is fused with the cyclohexenyl ring at the ortho-position or meta-position relative to the tertiary carbon atom of the cyclohexenyl ring. For example, the mononuclear aromatic or heteroaromatic can be selected from the group consisting of benzene, toluene, xylene, pyrazine, pyridine, pyrimidine, pyrrole, furan, thiophene and imidazole. If R2 is benzene, for example, then a naphthalene-derived η³-bonded allyl ligand is present.

Another embodiment of the compounds according to formula IX.a claimed here provides that the radical Rₐ is a polynuclear aromatic or heteroaromatic, which is fused with the cyclohexenyl ring at the ortho-position and/or meta-position relative to the tertiary carbon atom of the cyclohexenyl ring. In other words: If the radical Rₐ is a polynuclear aromatic or heteroaromatic, the respective η³-bonded allyl ligand can be an ortho-fused ring system or an ortho-peri-fused ring system. In the case of an ortho-fused ring system, the η³-bonded allyl ligand can be present as a linear ring system or as a bent (angular) ring system. For example, the polynuclear aromatic can be selected from the group consisting of naphthalene, anthracene and phenanthrene. If the radical Rₐ is for example naphthalene, an anthracene-derived or phenanthrene-derived or phenalene-derived η³-bonded allyl ligand can be present. If the radical Rₐ is anthracene, then a tetracene-derived η³-bonded allyl ligand is present. If the radical Rₐ is phenanthrene, then for example a chrysene-derived η³-bonded allyl ligand can be present.

A further variant of the claimed compounds according to formula IX.a provides that the radical R_{b}, the radical R_{c} and the radical R_{d} are independently selected from the group consisting of hydrogen (H), straight-chain alkyl radicals having one to ten carbon atoms, i.e. also having two, three, four, five, six, seven, eight or nine carbon atoms, branched alkyl radicals having one to ten carbon atoms, i.e. also having two, three, four, five, six, seven, eight or nine carbon atoms, and cyclic alkyl radicals having three to eight carbon atoms, i.e. also having four, five, six or seven carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to fourteen carbon atoms, i.e. also having seven, eight, nine, ten, eleven, twelve or thirteen carbon atoms, unsubstituted mononuclear or polynuclear heteroaryl radicals having five to thirteen carbon atoms, i.e. also having six, seven, eight, nine, ten, eleven or twelve carbon atoms, and substituted mononuclear or polynuclear heteroaryl radicals having five to thirteen carbon atoms, i.e. also having six, seven, eight, nine, ten, eleven or twelve carbon atoms.

According to another embodiment of the compounds according to formula IX.a described here, the radical R_{b}, the radical R_{c} and the radical R_{d} are independently selected from the group consisting of hydrogen (H), straight-chain alkyl radicals having one to eight carbon atoms, branched alkyl radicals having one to eight carbon atoms, cyclic alkyl radicals having four, five or six carbon atoms, unsubstituted mononuclear or polynuclear aryl radicals having six to fourteen carbon atoms, i.e. also having seven, eight, nine, ten, eleven, twelve or thirteen carbon atoms, substituted mononuclear or polynuclear aryl radicals having six to ten carbon atoms, unsubstituted mononuclear or polynuclear heteroaryl radicals having five to nine carbon atoms and substituted mononuclear or polynuclear heteroaryl radicals having five to nine carbon atoms.

For example, the radical R_{b}, the radical R_{c} and the radical R_{d} are independently selected from the group consisting of hydrogen (H), methyl, ethyl, n-propyl, isopropyl, n-butyl, isobutyl, tert-butyl, cyclopentyl, cyclohexyl, benzyl, tolyl, xylyl, pyridinyl, and combinations thereof.

According to a variant embodiment of the compounds according to formula IX.a claimed here, the compound has the formula IX.b or IX.c

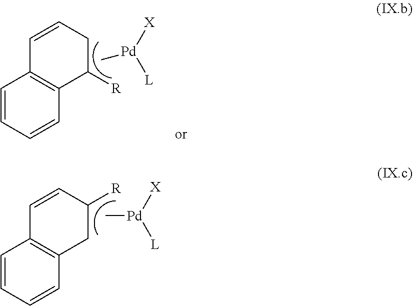

wherein X and L are as defined in a compound according to formula IX. The compound according to formula IX.b, wherein R=Me, X═Cl and L=1,3-bis(2,6-diisopropylphenyl)-imidazolin-2-ylidene, and the compounds according to formula IX.c, wherein R═H or methyl, X=TfO⁻ and L=racemic 2,2′-bis(diphenylphosphino)-1,1′-binaphthyl (rac-BINAP), (S)-2,2′-bis(diphenylphosphino)-1,1′-binaphthyl or (R)-2,2′-bis(diphenylphosphino)-1,1′-binaphthyl are not a subject of this invention.

A compound according to formula IX.b may for example be selected from the following compounds:

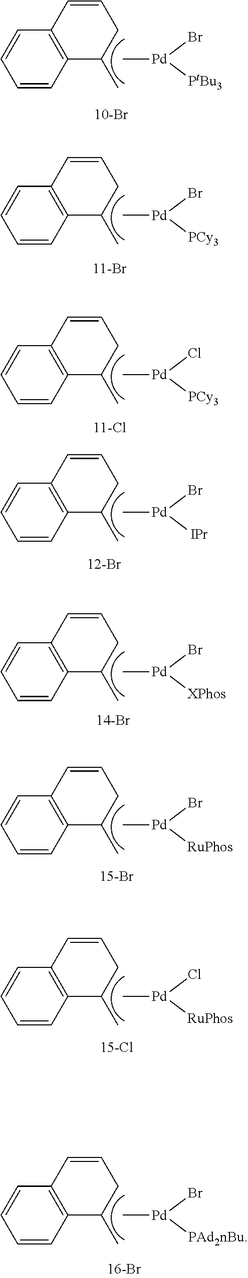

A compound according to formula IX.c may for example be selected from the following compounds:

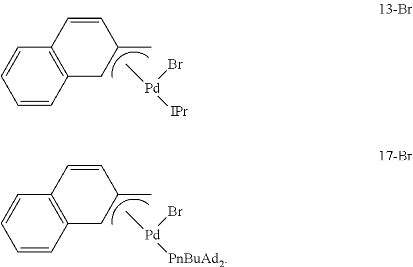

The object is also achieved by a compound according to general formula IX.d

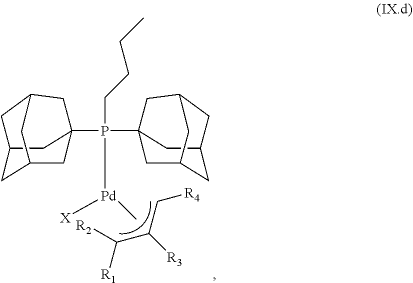

wherein
   X is an anionic ligand,
and
   the radicals R1, R2, R3 and R4 are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals
or
   two radicals of R1, R1, R3 and R4, advantageously R1 and R3 or R2 and R4, together form an unsaturated or aliphatic ring
or
   two radicals of R1, R2, R3 and R4, advantageously R1 and R3 or R2 and R4, together form a first ring which is unsaturated or saturated and is fused with at least one aromatic ring.

The new compounds according to formula IX.d claimed here, in particular according to one of the exemplary embodiments of the method described above for preparing compounds according to formula IX, are generally obtainable in yields of usually more than 90%, often more than 97%, in particular more than 99%. These palladium(II) compounds according to formula IX.d can be used, for example, as catalysts and/or precatalysts, in particular as precatalysts in palladium-catalyzed cross-coupling reactions. Advantageously, they are suitable as precatalysts and/or catalysts for the reactions given below.

According to the present invention, the expression “unsaturated ring” means a non-aromatic carbocycle or heterocycle which has at least one double bond. In this case, the unsaturated ring can also be part of a ring system consisting of two or more fused rings, which can comprise aliphatic, aromatic and other unsaturated carbocycles and/or heterocycles.

A saturated ring is formed, for example, by the radicals R2 and R4 if for example an allyl halide derived from phenal or indene was used as reactant for preparing the compound according to formula IX.d.

According to one embodiment of the compounds according to formula IX.d claimed here, the anionic ligand X is a halide anion or a monovalent weakly coordinating anion. The term “weakly coordinating” also covers the terms “very weakly coordinating” and “moderately strongly coordinating”. Chloride, bromide or iodide can advantageously be used as halide anions X, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

According to one embodiment of the compounds according to formula IX.d claimed here, the radicals R1, R2, R3 and R4 are as defined in a compound according to formula VIII.

In particular, a compound according to formula IX.d can surprisingly be a heteroleptic palladium complex of the following formula IX.P

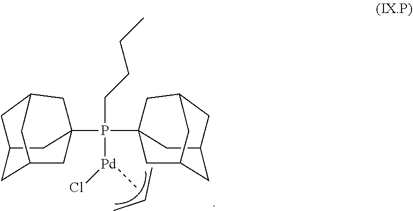

The object is also achieved by a compound according to formula XI

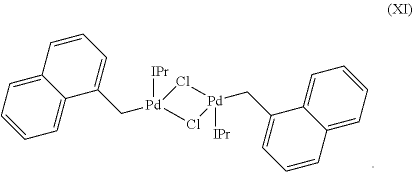

This compound is obtained in particular by reacting the compound 8-Cl with 1,3-bis(2,6-diisopropylphenyl)-imidazolin-2-ylidene (unsaturated NHC ligand, “IPr”), advantageously in a polar aprotic solvent, in particular in an ether, for example in diethyl ether, MTBE (methyl tert-butyl ether), THF, 2-methyltetrahydrofuran or 1,4-dioxane. The molar ratio of 8-Cl:IPr is for example 1:1. The reaction can advantageously be carried out at room temperature, wherein the reaction time is usually between 10 minutes and 3 hours, depending on the choice of the other reaction conditions, e.g. choice of solvent or mixture of solvents, concentration of the reactants, molar ratio of the reactants. Single crystals of the compound XI ● toluene suitable for a crystal structure analysis were obtained from toluene/hexane. The compound according to formula XI can be used, for example, as a catalyst and/or precatalyst, in particular as a precatalyst in palladium-catalyzed cross-coupling reactions. Advantageously, it is suitable as precatalyst and/or catalyst for the reactions given below.

The object is also achieved by a method for preparing a compound according to general formula

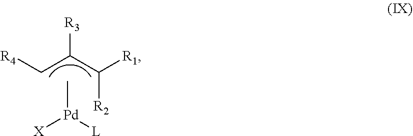

wherein
   X is an anionic ligand,
   the radicals R1, R2, R3 and R4 are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals
or
two radicals of R1, R1, R3 and R4, advantageously R1 and R3 or R2 and R4, together form an unsaturated or aliphatic ring
or
two radicals of R1, R2, R3 and R4, advantageously R1 and R3 or R2 and R4, together form a first ring which is unsaturated or saturated and is fused with at least one aromatic ring,
and
   L is a neutral electron donor ligand,
with the exception of a compound according to formula

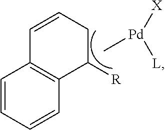

wherein R=Me, X═Cl and L=1,3-bis(2,6-di-isopropylphenyl)imidazolin-2-ylidene.

The method comprises the steps of:
A. providing
i. a palladium compound, in particular a mononuclear or multinuclear palladium(0) compound, wherein at least one palladium center bears a ligand L_{S}, which is an organosilicon compound, wherein the ligand L_{S} is in particular a cyclic or an acyclic siloxane,
ii. a compound AH according to general formula

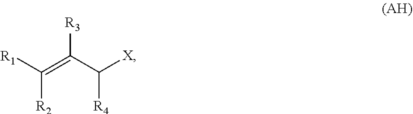

wherein
   X is an anionic ligand,
   the radicals R1, R2, R3 and R4 are independently selected from the group consisting of hydrogen (H), branched, straight-chain and cyclic alkyl radicals, branched, straight-chain and cyclic alkylene radicals, branched, straight-chain and cyclic alkynyl radicals, unsubstituted mononuclear or polynuclear aryl radicals, substituted mononuclear or polynuclear aryl radicals, unsubstituted mononuclear or polynuclear heteroaryl radicals and substituted mononuclear or polynuclear heteroaryl radicals
or
   two radicals of R1, R1, R3 and R4, advantageously R1 and R3 or R2 and R4, together form an unsaturated or aromatic ring
or
   two radicals of R1, R2, R3 and R4, advantageously R1 and R3 or R2 and R4, together form a first ring which is aromatic or unsaturated and is fused with at least one aromatic ring,
and
iii. a neutral electron donor ligand L,
B. reacting the reactants provided in step A. according to i., ii. and iii. and
C. optionally isolating the compound according to formula IX produced in step B.

A definition of the term organosilicon compound has already been given above.

The method claimed here makes it possible to prepare compounds according to formula IX, usually with high purity, in particular with high NMR purity, and generally in yields of mostly more than 90%, often more than 97%, in particular more than 99%.

The palladium compound to be provided in step A., which is in particular a palladium(0) compound, can be present in mononuclear or multinuclear, in particular dinuclear, form, as a monomer or oligomer, in particular dimer, and/or as a solvent adduct.

In one embodiment of the method claimed here for preparing a compound according to general formula IX, the anionic ligand X is a halide anion or a monovalent weakly coordinating anion.

The term “weakly coordinating” also covers the terms “very weakly coordinating” and “moderately strongly coordinating”. Chloride, bromide or iodide can advantageously be used as halide anions X, particularly advantageously chloride or bromide, in particular chloride. The monovalent weakly coordinating anions are in particular perfluorinated anions, for example PF₆⁻, BF₄⁻, F₃CSO₃⁻ (TfO⁻, triflate) and [(F₃CSO₂)₂N]⁻ (TFSI), or non-fluorinated anions, for example H₃CSO₃⁻ (mesylate) or tosylate.

According to the present invention, the expression “unsaturated ring” means a non-aromatic carbocycle or heterocycle which has at least one double bond. The unsaturated ring can also be part of a ring system consisting of two or more fused rings, which can comprise aliphatic, aromatic and other unsaturated carbocycles and/or heterocycles. A saturated ring is formed, for example, by the radicals R1 and R3 if for example an allyl halide AH derived from phenalene or indene was used as reactant for preparing the compound according to formula IX.

One embodiment of the method claimed here for preparing a compound according to general formula IX provides that
R1 to R4 and X are as defined in the embodiments of the method for preparing a compound according to general formula VIII described above and
the neutral electron donor ligand L is a phosphine ligand or an NHC ligand.

According to another embodiment of the method claimed here for preparing a compound according to formula IX, the neutral electron donor ligand L is
a tertiary phosphine according to general formula P—R10R20R30, wherein R10 and R20 are independently selected from the group consisting of substituted and unsubstituted straight-chain alkyl radicals, substituted and unsubstituted branched alkyl radicals, substituted and unsubstituted cycloalkyl radicals, substituted and unsubstituted aryl radicals, and substituted and unsubstituted heteroaryl radicals, wherein the heteroatoms are selected from the group consisting of sulfur, nitrogen and oxygen, and R30 is defined as R10 and R20 or is a metallocenyl radical,
   or
is a phosphine ligand selected from the group consisting of 2-(dicyclohexylphosphino)-2′-(N,N-dimethylamino))-1,1′-biphenyl (DavePhos), 2-(dicyclohexylphosphino)-2′,4′,6′-tri-isopropyl-1,1′-biphenyl (XPhos), 2-dicyclohexylphosphino-2′,6′-dimethoxy-1,1′-biphenyl (SPhos), 2-dicyclohexylphosphino-2′,6′-di-isopropoxy-1,1′-biphenyl (RuPhos), 2-(dicyclohexylphosphino)-3,6-dimethoxy-2′,4′,6′-tri-isopropyl-1,1′-biphenyl (BrettPhos), [4-(N,N-dimethylamino)phenyl]di-tert-butylphosphine (Amphos), 9,9-dimethyl-4,5-bis(diphenylphosphino)xanthene (Xantphos), 2-dicyclohexylphosphino-2′,6′-bis(dimethylamino)-1,1′-biphenyl (CPhos), tricyclohexylphosphine (PCy₃), di-(1-adamantyl)-n-butylphosphine (cataCXium® A), 2-di-tert-butylphosphino-2′,4′,6′-tri-isopropyl-1,1′-biphenyl (t-BuXPhos), 2-(di-tert-butylphosphino)-3,6-dimethoxy-2′,4′,6′-tri-isopropyl-1,1′-biphenyl (tert-BuBrettPhos), 2-(di-tert-butylphosphino)-3-methoxy-6-methyl-2′,4,6-tri-isopropyl-1,1′-biphenyl (RockPhos), 2-di[3,5-bis(trifluoromethyl)phenylphosphino]-3,6-dimethoxy-2′,4′,6′-tri-iso-propyl-1,1′-biphenyl (JackiePhos), 2-(di-tert-butylphosphino)-biphenyl (JohnPhos), (R)-(−)-1-[(S)-2-(dicyclohexylphosphino)ferrocenyl]ethyldi-tert-butylphosphine, di-tert-butyl(n-butyl)phosphine, 2-(di-1-adamantylphosphino)-3,6-dimethoxy-2′,4′,6′-tri-isopropyl-1,1′-biphenyl (AdBrettPhos), 2-diethylphosphino-2′,6′-bis(dimethylamino)-1,1′-biphenyl, racemic 2-di-tert-butylphosphino-1,1′-binaphthyl (TrixiePhos), tri-tert-butylphosphine (PtBu₃), triisopropylphosphine (PiPr₃), di-tert-butyl(isopropyl)phosphine (P(iPr)tBu₂), tert-butyl-di(isopropyl)phosphine (P(iPr)₂tBu), 1,3,5,7-tetramethyl-8-phenyl-2,4,6-trioxa-8-phosphaadamantane (MeCgPPh), N-[2-(di-1-adamantylphosphino)phenyl]morpholine (MorDalPhos), 4,6-bis(diphenylphosphino)phenoxazine (NiXantphos), 1,1′-bis(diphenylphosphino)ferrocene (dppf), 2-di-tert-butylphosphino-2′-(N,N-dimethylamino))-1,1′-biphenyl (tBuDavePhos), racemic 2,2′-bis(diphenylphosphino)-1,1′-binaphthyl (rac-BINAP), 1,1′-bis(di-tert-butylphosphino)ferrocene (DTBPF), 2-di-tert-butylphosphino-3,4,5,6-tetramethyl-2′,4′,6′-triisopropyl)-1,1′-biphenyl (Me₄t-BuXPhos), 2-dicyclohexylphosphino-4-(N,N-dimethylamino)-1,1′-biphenyl, trimethylphosphine (PMe₃), tris-p-tolylphosphine (P(p-tolyl)₃), tris-o-tolylphosphine (P(o-tolyl)₃), methyldiphenylphosphine, triphenylphosphine (PPh₃), tris-(pentafluorophenyl)phosphine (P(C₆F₅)₃), trifluorophosphine, 1-adamantyl-di-(tert-butyl)phosphine (P(1-Ad)tBu₂), di(1-adamantyl)-tert-butylphosphine (P(1-Ad)₂tBu), 1-adamantyl-di(isopropyl)phosphine (P(1-Ad)iPr₂), di(1-adamantyl)-isopropylphosphine (P(1-Ad)₂iPr), 1,3-bis-(diphenylphosphino)propane (dppp), 1,2-bis(diphenylphosphino)ethane (dppe), tert-butyldiphenylphosphine (P(tBu)Ph₂), phenyl-di-tert-butylphosphine, di-tert-butyl-neopentylphosphine, 1,2,3,4,5-pentaphenyl-1′-(di-tert-butylphosphino)ferrocene, tris(p-methoxyphenyl)phosphine, tris(p-trifluoromethylphenyl)phosphine, tris(2,4,6-trimethoxyphenyl)phosphine, tris(2,4,6,-trimethyl)phosphine, tris(2,6-dimethylphenyl)phosphine, benzyldi-1-adamantylphosphine, cyclohexyldi-tert-butylphosphine, cyclohexyldiphenylphosphine, 2-di-tert-butylphosphino-1,1′-binaphthyl, 2-(di-tert-butylphosphino)biphenyl, 2-di-tert-butylphosphino-2′-methylbiphenyl, 2-di-tert-butylphosphino-2′,4′,6′-tri-iso-propyl-1,1′-biphenyl, 2-di-tert-butylphosphino-3,4,5,6-tetramethyl-2′,4′,6′-tri-iso-propylbiphenyl, 2-(dicyclohexylphosphino)biphenyl (Cyclohexyl-JohnPhos), 2-(dicyclohexylphosphino)-2′,6′-dimethoxy-1,1′-biphenyl, 2-di-tert-cyclohexylphosphino-2′-(N,N-dimethylamino)biphenyl, 2-di-tert-cyclohexylphosphino-2′,6′-diisopropoxy-1,1′-biphenyl, 2-(dicyclohexylphosphino)-2′,4′,6′-triisopropyl-1,1′-biphenyl, 2-di-cyclohexylphosphino-2′-methylbiphenyl, 2-diphenylphosphino-2′-(N,N-dimethylamino)biphenyl, (4-dimethyl-aminophenyl)(tert-butyl)₂-phosphine, 1,2-bis(di-tert-butylphosphinomethyl)benzene, 1,3-bis(di-tert-butylphosphinomethyl)propane, 1,2-bis(diphenylphosphinomethyl)benzene, 1,2-bis(di-phenylphosphino)ethane, 1,2-bis(diphenylphosphino)propane, 1,2-bis(diphenylphosphino)butane, N-(2-methoxyphenyl)-2-(di-tert-butylphosphino)pyrrole, 1-(2-methoxyphenyl)-2-(di-cyclohexylphosphino)pyrrole, N-phenyl-2-(di-tert-butylphosphino)indole, N-phenyl-2-(di-tert-butylphosphino)pyrrole, N-phenyl-2-(dicyclohexylphosphino)indole, N-phenyl-2-(dicyclohexylphosphino)pyrrole, 1-(2,4,6-trimethylphenyl)-2(dicyclohexylphosphino)imidazole and (S)-7,7′-bis(diphenylphosphino)-3,3′,4,4′-tetrahydro-4,4′-dimethyl-8,8′-bi(2H-1,4-benzoxazine) (Solphos)
   or
a phosphine ligand according to general formula YPR¹R² (V.a) or Y²PR¹ (V.b) or Y³P (VI)

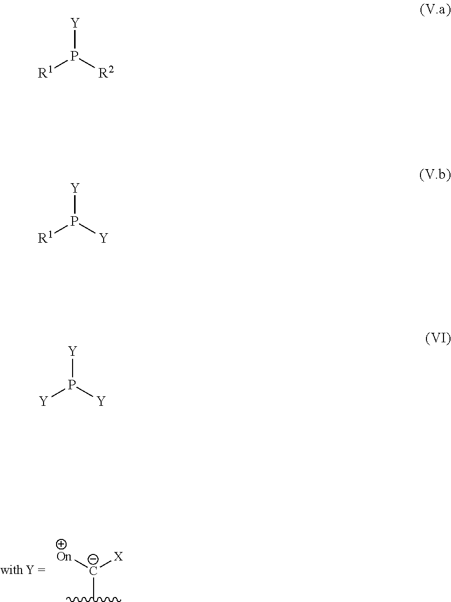

wherein
Y is an ylide substituent bonded to the phosphorus atom via the carbanionic center, which ylide substituent has onium groups On and an X group,
On, independently of the onium groups in further ylide substituents, is selected from phosphonium groups —PR³R⁴R⁵, ammonium groups —NR³R⁴R⁵, sulfoxonium groups —SOR³R⁴, and sulfonium groups —SR³R⁴,
X, independently of the X groups in further ylide substituents, is selected from H, primary, secondary, tertiary alkyl, alkenyl and alkynyl radicals having 1 to 10 carbon atoms, cyclic alkyl radicals having 3 to 10 carbon atoms, a benzyl radical, mononuclear aryl radicals, polynuclear aryl radicals, mononuclear heteroaryl radicals, polynuclear heteroaryl radicals, silyl groups —SiR³R⁴R⁵, sulfonyl groups —SO₂R³, phosphoryl groups —P(O)R³R⁴, —P(S)R³R⁴, —P(NO₃)r⁴R⁵, a cyano group —CN, alkoxy groups —OR³ and amino groups —NR³R⁴,
   wherein
R¹, R², R³, R⁴ and R⁵, where present, are independently selected from alkyl, aryl and heteroaryl groups which may be unsubstituted or substituted with functional groups,
   or
an NHC ligand according to general formula X

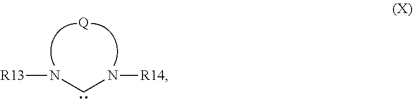

wherein
R13 and R14 are the same or different and are independently substituted or unsubstituted C1 to C20 alkyl, substituted or unsubstituted C1 to C20 alkenyl, substituted or unsubstituted C1 to C20 heteroalkyl, substituted or unsubstituted C1 to C20 alkynyl, substituted or unsubstituted alicyclic or aromatic rings or ring systems having one to five rings, and optionally have one or more heteroatoms and/or substituents
   and
Q is a substituted or unsubstituted hydrocarbon bridge, which is saturated or unsaturated, or a substituted or unsubstituted heteroatom-containing hydrocarbon bridge,
   wherein optionally two or more substituents on adjacent atoms are connected to other cyclic structures and there is a fused cyclic structure having two to five cyclic structures.

In the tertiary phosphine according to general formula P—R10R20R30, R10 and R20 can independently be substituted and unsubstituted branched or straight-chain alkyl groups, for example methyl, ethyl, n-propyl, isopropyl, n-butyl, isobutyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantyl, or aryl groups such as phenyl, naphthyl or anthracyl.

In one embodiment, the alkyl groups of the tertiary phosphine according to general formula P—R10R20R30 can be optionally substituted with one or more substituents such as halide (F, Cl, Br or I) or alkoxy groups, e.g. methoxy, ethoxy or propoxy. The aryl groups may be optionally substituted with one or more (e.g. 1, 2, 3, 4 or 5) substituents such as halide (F, Cl, Br or I), straight-chain or branched alkyl groups (e.g. C1-C10 alkyl), alkoxy (e.g. C1-C10 alkoxy), straight-chain or branched (dialkyl)amino groups (e.g. C1-C10 dialkylamino), heterocycloalkyl (e.g. C3-C10 heterocycloalkyl groups such as morpholinyl and piperadinyl) or trihalomethyl (e.g. trifluoromethyl). Suitable substituted aryl groups include, but are not limited to, 4-dimethylaminophenyl, 4-methylphenyl, 3,5-dimethylphenyl, 4-methoxyphenyl, and 4-methoxy-3,5-dimethylphenyl. Substituted and unsubstituted heteroaryl groups such as pyridyl, furanyl, thiophenyl, pyrrolyl, or quinolinyl can also be used. In an alternative embodiment, R10 and R20 of the tertiary phosphine according to general formula P—R10R20R30 are joined together and form a ring structure with the phosphorus atom, in particular a four- to seven-membered ring. In particular, R10 and R20 are the same and are tert-butyl, cyclohexyl, phenyl or substituted phenyl groups. In particular, R10 and R20 are tert-butyl. In addition, R10 and R20 may independently be alkoxy (e.g. C1-C10 alkoxy) or aryloxy (e.g. C1-C10 aryloxy).

R30 is defined like R10 and R20, but can also be a metallocenyl radical. In the latter embodiment, R30 is a substituted or unsubstituted metallocenyl group. In this case, the metallocenyl group has a first cyclopentadienyl radical and a second cyclopentadienyl radical. A number p of radicals R40 can optionally be provided on the first cyclopentadienyl radical via which the tertiary phosphine according to general formula P—R10R20R30 is bonded or coordinated to the palladium center, and a number q of radicals R41 can optionally be provided on the second cyclopentadienyl radical. R40 and R41 are independently organic groups having 1 to 20 carbon atoms. R40 and R41 can independently be defined like R10 and R20.

p can assume the values 0, 1, 2, 3 or 4 and q can assume the values 0, 1, 2, 3, 4 or 5. In one possible embodiment, q=5 and R41 is methyl or phenyl. In another embodiment, p=0.

In a specific embodiment, p=0, q=5, R10 is methyl or phenyl, and R10 and R20 are tert-butyl (QPhos), or R10 and R20 are tert-butyl and R30 is 4-dimethylaminophenyl (AmPhos), or R10 and R20 are tert-butyl and R30 is phenyl.

In another embodiment, R10, R20 and R30 are the same and are 1-adamantyl, 2-adamantyl, phenyl, ortho-tolyl, cyclohexyl, tert-butyl, or R10 and R20 are 1-adamantyl or 2-adamantyl and R30 is n-butyl.

According to another variant embodiment of the method for preparing a compound according to formula IX, the electron donor ligand L is a phosphine ligand according to general formula YPR¹R² (V.a) or Y₂PR¹ (V.b) or Y₃P (VI), wherein Y is as defined above, and wherein
the alkyl groups are selected from straight-chain, branched or cyclic alkyl groups having 1 to 10 carbon atoms, advantageously from straight-chain, branched or cyclic alkyl groups having 1 to 6 carbon atoms and cycloalkyl groups having 4 to 10 carbon atoms,
the aryl groups are selected from aryl groups having 6 to 14 carbon atoms, advantageously from aryl groups having 6 to 10 carbon atoms,
the alkenyl groups are selected from monounsaturated, polyunsaturated, straight-chain, branched and cyclic alkenyl groups having 2 to 10 carbon atoms, advantageously from monounsaturated, polyunsaturated, straight-chain, branched and cyclic alkenyl groups having 2 to 6 carbon atoms
the heteroaryl groups are selected from heteroaryl groups having 6 to 14 carbon atoms, advantageously from heteroaryl groups having 6 to 10 carbon atoms and having 1 to 5 heteroatoms selected from N, O and S,
   and/or
the functional groups are selected from alkyl groups —R¹¹, advantageously alkyl groups —R¹¹ having 1 to 6 carbon atoms, aryl groups —R¹², halogens -Hal, a hydroxy group —OH, a cyano group —CN, an alkoxy group —OR³, amino groups —N(R¹¹)₂, —NHR¹¹ and —NH₂, mercapto groups —SH and —SR¹¹, wherein R¹¹, independently of other radicals R11, is selected from alkyl radicals having 1 to 6 carbon atoms.

Yet another embodiment of the method claimed here for preparing a compound according to formula IX provides that the electron donor ligand L is a phosphine ligand according to general formula

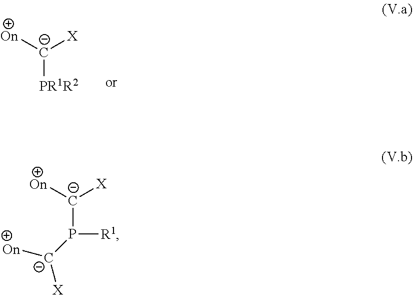

wherein
   On is a phosphonium group —PR³R⁴R⁵,
wherein R³, R⁴ and R⁵ are independently selected from the group consisting of alkyl groups having 1 to 6 carbon atoms, cycloalkyl groups having 4 to 10 carbon atoms, aryl groups having 6 to 10 carbon atoms,
X is selected from the group consisting of straight-chain, branched and cyclic alkyl groups having 1 to 6 carbon atoms, aryl groups having 3 to 10 carbon atoms, monosaturated, polyunsaturated, straight-chain, branched and cyclic alkenyl groups having 2 to 6 carbon atoms, trialkylsilyl groups —SiR³R⁴R⁵, arylsulfonyl groups R¹²—SO₂R³
and
   R¹ and R² are aryl groups having 6 to 10 carbon atoms or alkyl or cycloalkyl groups having 1 to 6 carbon atoms.

In a further embodiment of the method claimed here for preparing a compound according to formula IX, the electron donor ligand L is a phosphine ligand according to general formula YPR¹R² (V.a) or Y₂PR¹ (V.b) or Y₃P (VI), wherein Y is as defined above, and wherein R³, R⁴ and R⁵
c) are independently selected from the group consisting of methyl, ethyl, butyl, cyclohexyl, phenyl, and combinations thereof
or
d) are the same and are selected from the group consisting of methyl, ethyl, butyl, cyclohexyl, phenyl, and combinations thereof, advantageously cyclohexyl and phenyl.

According to another variant of the method claimed here for preparing a compound according to formula IX, the electron donor ligand L is a phosphine ligand according to general formula YPR¹R² (V.a) or Y₂PR¹ (V.b) or Y₃P (VI), wherein Y is as defined above and wherein X is selected from the group consisting of methyl, ethyl, cyclohexyl, phenyl, p-tolyl, trimethylsilyl, p-tolylsulfonyl, and combinations thereof.

In yet another embodiment of the method described here for preparing a compound according to formula IX, the electron donor ligand L is a phosphine ligand according to general formula YPR¹R² (V.a) or Y₂PR¹ (V.b) or Y₃P (VI), wherein Y is as defined above, and wherein R¹ and R² are independently selected from the group consisting of phenyl, cyclohexyl, methyl and combinations thereof.

In another embodiment, the neutral electron donor ligand L is cyclohexylphosphine, triphenylphosphine, tri-ortho-tolylphosphine. Also suitable are phosphines such as XPhos, JohnPhos, SPhos, Bophos, Josiphos, Taniaphos, Walphos and phosphine ligands having the following illustrated structures

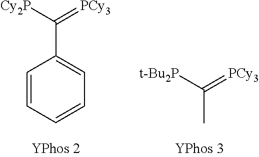

or other ligands described in patent application WO 2019/030304 or ligands according to the structures shown below

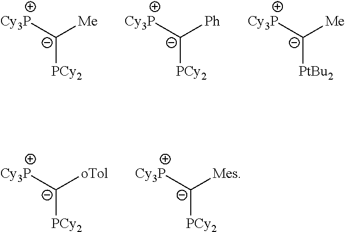

If the neutral electron donor ligand L is an NHC ligand according to general formula X, R13 and R14 can in particular be identical or different and independently substituted or unsubstituted phenyl, or phenyl substituted with one or more substituents selected from the group consisting of C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, C₆-C₂₄ aralkyl, C₆-C₂₄ alkaryl or halogen.

For example, Q can be a bridge of two or three atoms and can be saturated or unsaturated.

In another embodiment, Q is a two-atom bridge having the structure —CR21R22-CR23R24—or —CR21═CR23-, in particular —CR21 R22-CR23R24-, wherein R21, R22, R23 and R24 are independently selected from hydrogen (H), hydrocarbyl, substituted hydrocarbyl, heteroatom-containing hydrocarbyl, substituted heteroatom-containing hydrocarbyl, and functional groups. Examples of functional groups are carboxyl, C₁-C₂₀ alkoxy, C₅-C₂₄ aryloxy, C₂-C₂₀ alkoxycarbonyl, C₅-C₂₄ alkoxycarbonyl, C₂-C₂₄ acyloxy, C₁-C₂₀ alkylthio, C₅-C₂₄ arylthio, C₁-C₂₀ alkylsulfonyl, and C₁-C₂₀ alkylsulfinyl, optionally substituted with one or more substituents selected from C₁-C₁₂ alkyl, C₁-C₁₂ alkoxy, C₅-C₁₄ aryl, hydroxyl, sulfhydryl, formyl, and halogen (F, Cl, Br, I). R21, R11, R23 and R24 are in particular selected from hydrogen (H), C₁-C₁₂ alkyl, substituted C₁-C₁₂ alkyl, C₁-C₁₂ heteroalkyl, substituted C₁-C₁₂ heteroalkyl, phenyl and substituted phenyl. Alternatively, two radicals selected from R21, R22, R23 and R24 can be joined together to form a substituted or unsubstituted, saturated or unsaturated ring structure, e.g. a C₄-C₁₂ alicyclic ring or a C₅ or c₆ aryl group, which itself may be substituted, for example with aromatic groups or other substituents.

In an alternative or supplementary embodiment, the radicals R21, R22, R23 and R24 are independently selected from the group consisting of hydrogen (H), a branched or straight-chain alkyl, alkylene or alkynyl radical having one to ten carbon atoms, a cyclic alkyl, alkylene or alkynyl radical having three to ten carbon atoms, a substituted or unsubstituted mononuclear or polynuclear aryl radical having six to fourteen carbon atoms and a substituted or unsubstituted mononuclear or polynuclear heteroaryl radical having five to thirteen carbon atoms, —O-alkyl, —O—C(O)-alkyl, —O-(aryl), —O—C(O)-aryl, —F, —Cl, —OH, —NO₂, —Si(alkyl)₃, —CF₃, —CN, —CO₂H, —C(O)H, —SO₃H, —NH₂, —NH(alkyl), —N(alkyl)₂, —P(alkyl)₂, —SO₂(alkyl), —SO(alkyl), —SO(aryl), —SO₂(aryl), —SO₃(alkyl), —SO₃(aryl), —S-alkyl, —S-aryl, —S-alkenyl, —NH—CO(alkyl), —CO₂(alkyl), —CONH₂, —CO(alkyl), —NHCOH, —NHCO₂(alkyl), —CO(aryl), —CO₂(aryl), —CH═CH—CO₂(alkyl), —CH═CH—CO₂H, —P(aryl)₂, —PO(aryl)₂, —PO(alkyl)₂, —PO₃H, —PO(O-alkyl)₂ and groups of any fused ring system wherein alkyl and aryl are as defined for R21, R22, R23 and R24.

The alkyl, alkylene or alkynyl radicals can each be substituted for example with F, Cl, Br, I, alkyl, O-alkyl, phenyl, O-phenyl, OH, NH₂ and/or CF₃, the aryl and heteroaryl radicals e.g. with F, Cl, Br, I, alkyl, O-alkyl, phenyl and/or O-phenyl.

Examples of suitable N-heterocyclic carbene (NHC) ligands and acyclic diaminocarbene ligands suitable as the neutral electron donor ligand L contain, for example, the following structures:

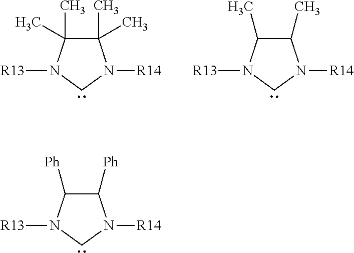

In the above structures, R13 and R14 can independently be for example DIPP, Mes, 3,5-di-tert-butylphenyl, 2-methylphenyl and combinations thereof, wherein DIPP or DiPP is 2,6-diisopropylphenyl and Mes is 2,4,6-trimethylphenyl (mesityl).

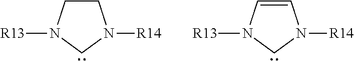

In the above structures, R13 and R14 can independently be for example DIPP, Mes, 3,5-di-tert-butylphenyl, 2-methylphenyl and combinations thereof.

Further examples of suitable N-heterocyclic carbene (NHC) ligands and acyclic diaminocarbene ligands suitable as the neutral electron donor ligand L contain, for example, the following structures:

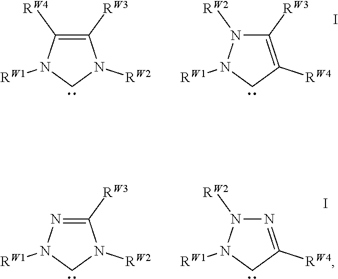

wherein R^{W1}, R^{W2}, R^{W3}, R^{W4} can independently be hydrogen (H), unsubstituted hydrocarbyl, substituted hydrocarbyl, or heteroatom-containing hydrocarbyl and wherein one or both of R^{W3} and/or R^{W4} can be independently selected from halogen, nitro, amido, carboxyl, alkoxy, aryloxy, sulfonyl, carbonyl, thio or nitroso groups. Further examples of N-heterocyclic carbene (NHC) ligands suitable as the neutral electron donor ligand L are disclosed, for example, in U.S. Pat. Nos. 7,378,528; 7,652,145; 7,294,717; 6,787,620; 6,635,768; and 6,552,139.

According to a further variant embodiment of the method claimed here for preparing a compound according to formula IX, the neutral electron donor ligand L is selected from the group consisting of tri-tert-butylphosphine, tricyclohexylphosphine, tri-1-adamantylphosphine, tri-2-adamantylphosphine, di-(1-adamantyl)-n-butylphosphine (cataCXium® A), 2-(dicyclohexylphosphino)-2′,4′,6′-triisopropyl-1,1′-biphenyl (XPhos), 2-dicyclohexylphosphino-2′,6′-diisopropoxy-1,1′-biphenyl (RuPhos), di-1,3-bis-(2,4,6-trimethylphenyl)-imidazolidin-2-ylidene (“SIMes”), 1,3-bis-(2,6-diisopropylphenyl)-imidazolidin-2-ylidene (“SIPr”), 1,3-bis-(2,6-diisopropylphenyl)-imidazolin-2-ylidene (unsaturated NHC ligand, “IPr”) and 1,3-bis-(2,4,6-trimethylphenyl)-imidazolin-2-ylidene (unsaturated NHC ligand, “IMes”).

The order in which a reaction vessel is charged with the reactants, i.e. with the palladium compound, the compound AH and the neutral electron donor ligand L, can be freely selected. This also includes the possibility of carrying out steps A. and B. and the optional step C., i.e. all the steps relating to the preparation of the respective target compound, in a single step, i.e. introducing all reactants and solvents simultaneously or virtually simultaneously into the reaction vessel. A definition of the term “reaction vessel” has already been given above.

According to one embodiment of the method claimed here for preparing a compound according to general formula IX, the reaction in step B. comprises the following steps:
B.1. Initially charging the palladium compound as a solid, solution or suspension,
B.2. Adding compound AH as a solid, solution or suspension, and
B.3. Adding the neutral electron donor ligand L as a solid, solution or suspension,
or
B.1. Initially charging the palladium compound as a solid, solution or suspension,
B.2. Adding the neutral electron donor ligand L as a solid, solution or suspension, and
B.3. Adding compound AH as a solid, solution or suspension,
or
B.1. Initially charging compound AH as a solid, solution or suspension,
B.2. Adding the palladium compound as a solid, solution or suspension, and
B.3. Adding the neutral electron donor ligand L as a solid, solution or suspension,
or
B.1. Initially charging compound AH as a solid, solution or suspension,
B.2. Adding the neutral electron donor ligand L as a solid, solution or suspension, and
B.3. Adding the palladium compound as a solid, solution or suspension,
or
B.1. Initially charging the neutral electron donor ligand L as a solid, solution or suspension,
B.2. Adding the palladium compound as a solid, solution or suspension, and
B.3. Adding compound AH as a solid, solution or suspension,
or
B.1. Initially charging the neutral electron donor ligand L as a solid, solution or suspension,
B.2. Adding compound AH as a solid, solution or suspension, and
B.3. Adding the palladium compound as a solid, solution or suspension.

In one embodiment of the method described here, a molar ratio of Pd AH is at least 1:1, advantageously between 1.0:1.0 and 1.0:5.0, more advantageously between 1.0:1.1 and 1.0:4.0, particularly advantageously between 1.0:1.2 and 1.0:3.0, in particular between 1.0:1.3 and 1.0:2.0, for example 1.0:1.4 or 1.0:1.5 or 1.0:1.6 or 1.0:1.7 or 1.0:1.8 or 1.0:1.9 or 1.0:2.1 or 1.0:2.2 or 1.0:2.3 or 1.0:2.4 or 1.0:2.5 or 1.0:2.6 or 1.0:2.7 or 1.0:2.8 or 1.0:2.9 or 1.0:3.1 or 1.0:3.2 or 1.0:3.3 or 1.0:3.4 or 1.0:3.5 or 1.0:3.6 or 1.0:3.7 or 1.0:3.8 or 1.0:3.9 or 1.0:4.1 or 1.0:4.2 or 1.0:4.3 or 1.0:4.4 or 1.0:4.5 or 1.0:4.6 or 1.0:4.7 or 1.0:4.8 or 1.0:4.9.

According to an alternative or supplementary variant embodiment, a molar ratio of Pd:L is at least 1:1, advantageously between 1.0:1.0 and 1.0:1.5, more advantageously between 1.00:1.01 and 1.00:1.49, particularly advantageously between 1.00:1.02 and 1.00:1.48, in particular between 1.00:1.03 and 1.00:1.47, for example 1.00:1.04 or 1.00:1.05 or 1.00:1.06 or 1.00:1.07 or 1.00:1.08 or 1.00:1.09 or 1.00:1.10 or 1.00:1.11 or 1.00:1.12 or 1.00:1.13 or 1.00:1.14 or 1.00:1.15 or 1.00:1.16 or 1.00:1.17 or 1.00:1.18 or 1.00:1.19 or 1.00:1.20 or 1.00:1.25 or 1.00:1.30 or 1.00:1.35 or 1.00:1.40 or 1.00:1.45.

Another embodiment of the method claimed here provides that the reaction in step B. is carried out in at least one solvent SL. In another variant of the method, the solvent SL is selected from the group consisting of alcohols, alkanes, aromatic hydrocarbons, ketones, ethers and combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, and mixtures thereof. For example, diethyl ether, MTBE (methyl tert-butyl ether), THF, 2-methyltetrahydrofuran, 1,4-dioxane, toluene, benzene, o-xylene, m-xylene, p-xylene, mesitylene, acetone, methanol, isopropanol, and mixtures thereof are well-suited. If the palladium compound and/or the compound AH and/or the neutral electron donor ligand L is initially charged or introduced as a solution or suspension, the solvent of the solution or suspension in question is in particular identical to or miscible with the above-mentioned solvent SL.

According to yet another embodiment of the method described here for preparing a compound according to general formula IX, the provision of the palladium compound in step A. comprises reacting a palladium(II) compound which advantageously consists of a palladium(II) cation and two monovalent anions or a divalent anion, with a ligand L_{S}, which is an organosilicon compound, advantageously a cyclic or an acyclic siloxane, in the presence of a base. The palladium compound to be provided in step A. can therefore advantageously be prepared in situ, advantageously in a solvent S_{L1}.

The palladium(II) compound can have two different or two identical monovalent anions or one divalent anion. A neutral ligand, for example COD, is not provided. Consequently, inexpensive commercially available palladium(II) compounds, such as PdCl₂, can advantageously be used. It is therefore possible to dispense with a time-consuming and costly preparation of a palladium(II) compound of the type [Pd(ligand)Y₂], wherein e.g. ligand=COD, as a reactant for the in situ production of the mononuclear or multinuclear palladium compound. This is particularly advantageous from an economical (in terms of atoms) and ecological perspective. In addition, this reduces the number of possible impurities in the end product according to general formula IX.

In a further advantageous embodiment, the palladium(II) compound to be used as reactant in the context of the above-mentioned in situ preparation comprises two identical monovalent anions which are in particular selected from the group consisting of halides and monovalent weakly coordinating anions. The expressions “produced/prepared in situ” or “in situ production/preparation” and the term “weakly coordinating” have already been defined above.

In the context of the reaction described here, the term “bases” means inorganic and organic bases, in particular inorganic bases, but not organometallic bases. The bases should not decompose in water. Suitable bases are e.g. salts of Brønsted acids. Carbonates, hydrogen carbonates, acetates, formates, ascorbates, oxalates and hydroxides are advantageously used. These can be used in the form of their ammonium salts (Brønsted acid)NR₄, wherein R is for example H or alkyl, alkali metal salts, for example sodium or potassium salts, and alkaline-earth metal salts.

The reaction of the palladium(II) compound with a ligand L_{S}, which is an organosilicon compound, in step A. usually takes place in a solvent S_{L1}. The solvents S_{L1} are not particularly limited. Examples of possible solvents S_{L1} are polar solvents such as water, alcohols, ketones, hydrocarbons, e.g. aromatic hydrocarbons such as benzene and toluene, or aliphatic hydrocarbons such as pentane, hexane and heptane, open-chain or cyclic ethers, amides and esters. However, preference is given to water, alcohols, e.g. methanol, ethanol, propanol and butanol, and mixtures thereof, ketones e.g. acetone, and ethers, e.g. diethyl ether, MTBE (methyl tert-butyl ether), THF, 2-methyltetrahydrofuran, 1,4-dioxane, and mixtures thereof, as solvents. Mixtures of these solvents can also be used. In particular, the solvent S_{L1} provided for the provision or reaction in step A. and the solvent SL provided for the reaction in step B. are miscible with or identical to one another. There is then no need to change solvent, which is particularly advantageous from an economical and ecological perspective.

A definition of the expression “two miscible solvents” has already been given above.

In one embodiment of the method claimed here for preparing a compound according to general formula IX, one of the ligands L_{S} is a cyclic or an acyclic siloxane selected from the group consisting of 1,1,3,3-tetramethyl-1,3-divinyldisiloxane (dvds), 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. Advantageously, one of the ligands L_{S} is 1,1,3,3-tetramethyl-1,3-divinyldisiloxane (dvds). In particular, one of the ligands L_{S} is dvds. Surprisingly, it has been found that 1,3-divinyl-1,1,3,3-tetramethyldisiloxanepalladium(0)—in the context of the present invention abbreviated to [Pd₂(dvds)₃], [Pd(dvds)], Pd(vs), Pd—VS or Palladium-VS—is an excellent starting material for preparing compounds according to formula IX, for example from π-allylpalladium halide complexes such as π-allylpalladium chloride complexes, which, in particular by means of the method described here, are usually obtained in yields of more than 90%, often more than 97%, in particular more than 99%. In addition, by means of the method claimed here, it was possible to synthesize compounds of this type which have not previously been obtained, that is to say have not been described in the prior art.

According to a further variant embodiment of the method claimed here for preparing a compound according to general formula IX, the reaction temperature in step A. and/or step B., in particular in step B., is 10° C. to 60° C., in particular 15° C. to 45° C. or 20° C. to 30° C. An alternative or supplementary embodiment of the method provides that the reaction time in step A. and/or step B., in particular in step B., is 10 minutes to 48 hours, in particular 1 hour to 36 hours or 2 to 24 hours or 3 to 12 hours.

The object is moreover achieved by a compound according to general formula

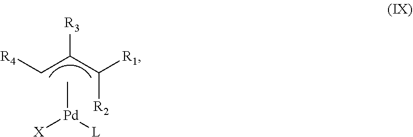

wherein R1 to R4, X and L are as defined above, in particular obtained or obtainable by a method for preparing such compounds according to one of the exemplary embodiments described above,
with the exception
of a compound according to formula

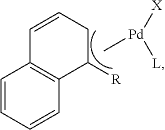

wherein R=Me, X═Cl and L=1,3-bis(2,6-di-isopropylphenyl)imidazolin-2-ylidene,
and
of compounds according to formula

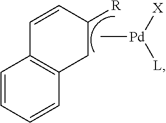

wherein R═H or methyl, X=TfO⁻ and L=racemic 2,2′-bis(diphenylphosphino)-1,1′-binaphthyl (rac-BINAP), (S)-2,2′-bis(diphenylphosphino)-1,1′-binaphthyl or (R)-2,2′-bis(diphenylphosphino)-1,1′-binaphthyl.

The compounds according to formula IX claimed here, in particular according to one of the exemplary embodiments of the method described above for preparing such compounds, are generally obtainable with high purity, in particular with high NMR purity, and generally in yields of usually more than 90%, often more than 97%, in particular more than 99%. These palladium(II) compounds according to general formula IX can be used, for example, as catalysts and/or precatalysts, in particular as precatalysts in palladium-catalyzed cross-coupling reactions. Advantageously, they are suitable as precatalysts and/or catalysts for the reactions given below.

In particular, as has surprisingly been found, the compound according to formula IX obtained or obtainable by a method for preparing such compounds according to one of the exemplary embodiments described above can have the following formula IX.N or IX.P

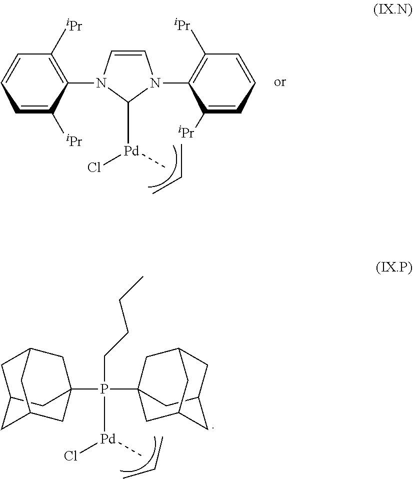

In particular, the following compounds can be prepared as compounds of formula IX:

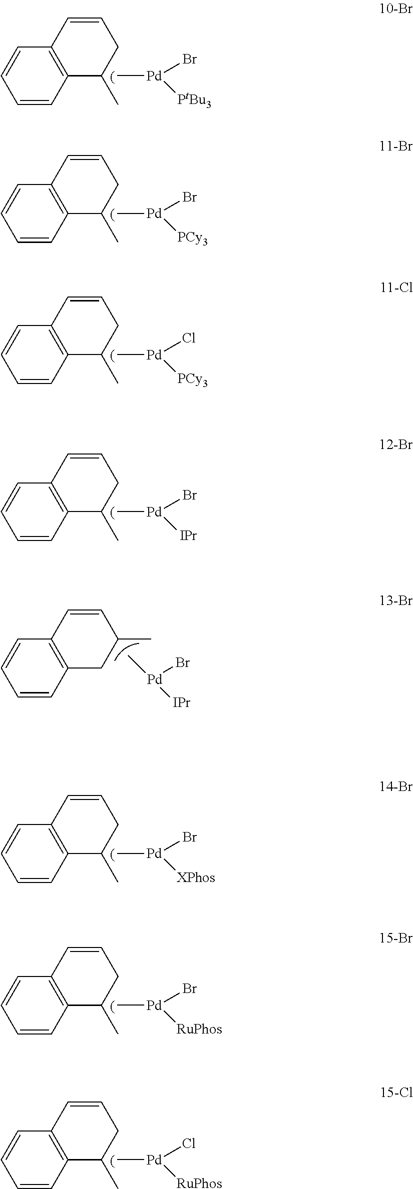

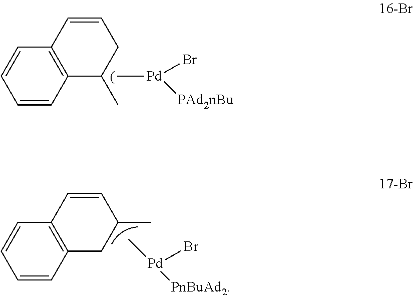

Furthermore, the object is achieved by a preparation containing
i. a compound according to general formula IX

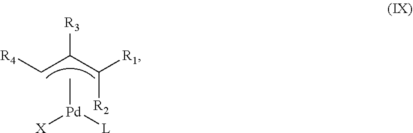

wherein X, R1, R2, R3, R4 and L are as defined above,
or
according to general formula IX.a

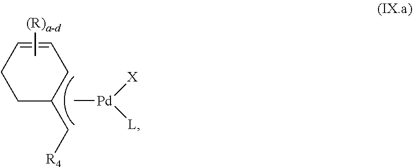

wherein X, Rₐ, R_{b}, R_{c}, R_{d}, R4 and L are as defined above,
and
ii. at least one organosilicon compound.

The term organosilicon compound has already been defined above.

The compound according to general formula IX or IX.a contained in the preparation, or the preparation claimed here itself, are in particular obtained or obtainable by the method described above for preparing a compound according to formula IX, advantageously according to one of the exemplary embodiments described above.

According to one embodiment of the preparation, a silicon content, which is present in particular in the form of the at least one organosilicon compound, is ≥100 ppm and ≤1000 ppm, advantageously ≥110 ppm and ≤900 ppm, in particular ≥120 ppm and ≤800 ppm. The silicon content, which is present in particular in the form of the at least one organosilicon compound, can be determined using analysis methods which are known to those skilled in the art, in particular using quantitative ¹H NMR spectroscopy and/or atomic emission spectrometry with inductively coupled plasma (Inductively Coupled Plasma Atomic Emission Spectrometers, ICP-AES).

In an alternative or supplementary embodiment of the preparation claimed here, the preparation contains a solvent S_{Z}. The preparation can be in the form of a solution, suspension, dispersion or gel, in particular depending on the organosilicon compound present and/or on the solvent S_{Z} used. The solvent S_{Z} can also be a mixture of solvents. It is advantageously selected from the group consisting of alkanes, aromatic hydrocarbons and polar solvents, advantageously selected from the group consisting of alcohols, alkanes, ketones, ethers or combinations thereof, in particular alcohols having 2 to 6 carbon atoms, alkanes or cycloalkanes having 5 to 8 carbon atoms, alkane mixtures such as petroleum ethers, aromatic hydrocarbons having 6 to 9 carbon atoms, ethers having 4 to 8 carbon atoms or ketones having 2 to 6 carbon atoms, or mixtures thereof. For example, diethyl ether, MTBE (methyl tert-butyl ether), THF, 2-methyltetrahydrofuran, 1,4-dioxane, benzene, toluene, o-xylene, m-xylene, p-xylene, mesitylene, acetone, methanol, ethanol, isopropanol, and mixtures or combinations thereof are well-suited. In particular, if the solvent S_{Z} comprises or is a solvent which is selected from the group consisting of alcohols, alkanes, aromatic hydrocarbons, ketones, e.g. acetone, ethers, and combinations thereof, in particular alcohols having 2 to 6 carbon atoms, aromatic hydrocarbons having 6 to 9 carbon atoms, alkanes or cycloalkanes having 5 to 8 carbon atoms, alkane mixtures such as petroleum ethers, ethers having 4 to 8 carbon atoms or ketones having 2 to 6 carbon atoms, and mixtures thereof, the preparation is in the form of a solution or suspension. For example, the solvent S_{Z} can be selected from the group consisting of diethyl ether, MTBE (methyl tert-butyl ether), THF, 2-methyltetrahydrofuran, 1,4-dioxane, toluene, benzene, o-xylene, m-xylene, p-xylene, mesitylene, acetone, methanol and isopropanol, and mixtures thereof.

Another variant of the preparation provides that the solvent S_{Z} is miscible with or identical to the solvent SL, which is used in the method for preparing the compound according to formula IX.

According to a variant of the claimed preparation, the at least one organosilicon compound contains at least one terminal, in particular vinyl, double bond. In particular, the at least one organosilicon compound comprises or is a cyclic or an acyclic siloxane. According to an alternative or supplementary embodiment of the preparation, the preparation contains, in addition to the palladium compound according to general formula VIII, at least one palladium compound according to general formula [Pd(L_{S})₂] (III). The general formula [Pd(L_{S})₂] (III) also comprises multinuclear complexes, in particular dinuclear complexes according to general formula [Pd₂(L_{S})₃]. In this case, the ligand L_{S} is in particular in each case identical to the at least one organosilicon compound, in particular a cyclic or an acyclic siloxane, and the at least one organosilicon compound contains at least one terminal double bond.

In particular, the ligand L_{S} is identical to the organosilicon compound, wherein the ligand L_{S} is in particular a cyclic or an acyclic siloxane which has at least one terminal, in particular vinyl, double bond. The ligand L_{S} is then advantageously coordinated or bonded via at least one pi-directed bond to the palladium center of the compound according to general formula [Pd(L_{S})₂] (III).

Yet another variant embodiment of the claimed preparation provides that one of the organosilicon compounds comprises or is a cyclic or an acyclic siloxane and/or one of the ligands L_{S} is a cyclic or an acyclic siloxane selected from the group consisting of 1,1,3,3-tetramethyl-1,3-divinyldisiloxane, 1,1,3,3-tetramethyl-1,3-dithien-2-yldisiloxane, 1,1,3,3-tetramethoxy-1,3-divinyldisiloxane, 1,3-dimethyl-1,3-divinyldisiloxanediol and 2,4,6,8-tetravinyl-2,4,6,8-tetramethylcyclotetrasiloxane. Advantageously, one of the organosilicon compounds comprises or is 1,1,3,3-tetramethyl-1,3-divinyldisiloxane (dvds) and/or one of the ligands L_{S} is 1,1,3,3-tetramethyl-1,3-divinyldisiloxane (dvds). In particular, one of the organosilicon compounds and/or one of the ligands L_{S} is dvds.

The object is also achieved by a method for cross-coupling a first reactant and a second reactant, comprising the steps:
A. providing a reaction mixture containing a first reactant, a second reactant and at least one compound or preparation according to one or more of the embodiments described above;
and
B. reacting the first reactant with the second reactant in the presence of at least one compound or preparation according to one or more of the embodiments described above, a reaction product being produced.

The cross-coupling can be a carbon-carbon coupling reaction or a carbon-heteroatom coupling reaction. The latter comprise carbon-nitrogen coupling reactions, i.e. Buchwald-Hartwig couplings, carbon-oxygen and carbon-sulfur coupling reactions.

Furthermore, the object is achieved by a method for catalyzing a reaction of a first reactant and a second reactant, wherein the method involves bringing the first reactant into contact with the second reactant in the presence of at least one compound or preparation according to one or more of the embodiments described above.

In one embodiment of the method for cross-coupling a first reactant and a second reactant or the method for catalyzing a reaction of a first reactant and a second reactant, the first reactant and the second reactant are selected from the group consisting of:
(i) the first reactant is an aromatic or heteroaromatic boronic acid or the ester thereof and the second reactant is an aromatic or heteroaromatic halide, tosylate, triflate, mesylate, sulfamate or carbamate;
(ii) the first reactant is an aromatic or heteroaromatic amine and the second reactant is an aromatic or heteroaromatic halide, tosylate, triflate, mesylate, sulfamate or carbamate;
(iii) the first reactant is an aromatic or heteroaromatic zinc halide and the second reactant is an aromatic, heteroaromatic or vinyl halide, tosylate, triflate, mesylate, sulfamate or carbamate;
(iv) the first reactant is an aromatic or heteroaromatic Grignard compound and the second reactant is an aromatic, heteroaromatic or vinyl halide, tosylate, triflate, mesylate, sulfamate or carbamate;
(v) the first reactant is an aromatic or heteroaromatic tin halide and the second reactant is an aromatic, heteroaromatic or vinyl halide, tosylate, triflate, mesylate, sulfamate or carbamate;
(vi) the first reactant is a ketone, aldehyde, imine, amide or ester and the second reactant is an aromatic, heteroaromatic or vinyl halide, tosylate, triflate, mesylate, sulfamate or carbamate;
(vii) the first reactant is an alcohol or thiol and the second reactant is an aromatic, heteroaromatic or vinyl halide, tosylate, triflate, mesylate, sulfamate or carbamate;
(viii) the first reactant is an aromatic or heteroaromatic silanol, siloxane or silane and the second reactant is an aromatic, heteroaromatic or vinyl halide, tosylate, triflate, mesylate, sulfamate or carbamate.

According to another variant of the method for cross-coupling a first reactant and a second reactant or the method for catalyzing a reaction of a first reactant and a second reactant, it is a Stille coupling, Kumada coupling, Negishi coupling, Suzuki coupling, Suzuki-Miyaura coupling, Sonogashira coupling, Hiyama coupling, Heck reaction, α-arylation of an enolizable ketone, α-arylation of an aldehyde, arylation of a primary amine, arylation of a secondary amine, arylation of a primary amide, arylation of an aliphatic alcohol, allylic substitution reaction or trifluoromethylation reaction.

In addition, the object is achieved by a method for catalyzing an anaerobic oxidation of a primary or secondary alcohol, wherein the method involves bringing the primary or secondary alcohol into contact with at least one compound or preparation according to one or more of the embodiments described above.

Other features, details, and advantages of the invention follow from the wording of the claims as well as from the following description of exemplary embodiments.

### EXEMPLARY EMBODIMENTS

A. Pd(0) complexes [Pd(phosphine)₂] and [Pd(dvds)(phosphine)]

Here, dvds=1,3-divinyl-1,1,3,3-tetramethyldisiloxane.

### Examples 1: Preparation of Pd Complexes

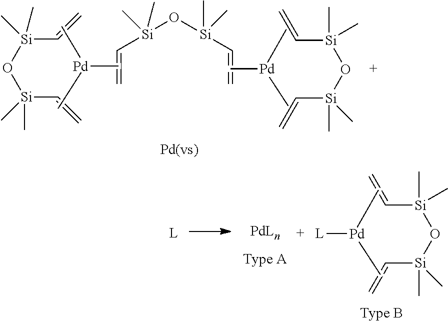

TABLE B-0
Other complexes and type of compounds obtained

| No. | Ligand (L) | Type A | Type B |
|---|---|---|---|
| 1 | P^{t}Bu₃ | ✓ | x |
| 2 | PCy₃ | x | ✓ |
| 3 | PⁱPr₃ | x | ✓ |
| 4 | PAd₂Bu | x | ✓ |
| 5 | CyJohnPhos | x | ✓ |
| 6 | YPhos1 | x | ✓ |
| | (Cy₂PCH₂MePCy₃)* | | |
| 7 | P^{t}Bu₂Ph | x | ✓ |
| 8 | P^{t}Bu₂ⁱPr | x | ✓ |
| 9 | P^{t}BuPh₂ | x | ✓ |
| 10 | P(o-Tol)₃ | x | ✓ |
| 11 | P(C₆F₅)₃ | x | ✓ |

*Comparative example

### General Procedure:

422 μl (434 mg, 0.5 mmol, 1 eq.) of 1,3-divinyl-1,1,3,3-tetramethyldisiloxanepalladium (Pd-VS, or palladium-VS) were initially charged in an inertized Schlenk tube (heated three times with evacuation and loaded with argon), followed by 2 equivalents (1 mmol) of the corresponding phosphine, dissolved in a sufficient amount (usually approx. 3-4 ml) of toluene (unless otherwise stated). After the specified reaction time at room temperature, the volume was reduced to half, the precipitate formed was filtered off and washed with 3×2 ml methanol and dried under vacuum.

### Example 1-1

Ligand: Tri-tert-butylphosphine, 2 ml ethanol as solvent.
Reaction time: 4 h
Yield: 92% colorless solid.

¹H NMR (250 MHz, C₆D₆) δ=1.52 (t, J=5.5 Hz, 54H) ppm.

¹³C NMR (63 MHz, C₆D₆) δ=37.9, 33.7 ppm.

³¹P{¹H} NMR (101 MHz, C₆D₆) δ=85.14 (s) ppm.

Silicon content by means of ICP-AES=340 ppm.

### Example 1-2

Ligand: Tricyclohexylphosphine
Reaction time: 3 h, then addition of 3 ml of methanol
Yield: 163 mg (54%) colorless solid.

¹H NMR (250 MHz, C₆D₆) δ=3.43-3.69 (m, 2H), 3.12-3.42 (m, 4H), 1.92-2.14 (m, 3H), 1.51-1.92 (m, 16H), 0.94-1.48 (m, 15H), 0.58 (s, 6H), 0.07 (s, 6H) ppm.

¹³C NMR (63 MHz, C₆D₆) δ=64.4, 63.2, 37.0, 31.3, 28.4, 27.4, 2.4, −0.3 ppm. ³¹P{¹H} NMR (101 MHz, C₆D₆) δ=34.85 (s) ppm.

### Example 1-3

Ligand: Triisopropylphosphine (1.2 equivalents)
Reaction time: 16 h.
Yield: 246 mg (51%) colorless solid

¹H NMR (250 MHz, C₆D₆) δ=3.48-3.60 (m, 2H), 3.18-3.29 (m, 4H), 1.96 (spt, J=14.4 Hz, 3H), 0.99 (dd, J=13.0, 7.1 Hz, 18H), 0.56 (s, 6H), 0.04 (s, 6H) ppm.

¹³C NMR (63 MHz, C₆D₆) δ=64.3, 63.0, 26.8, 20.5, 2.4, −0.2 ppm.

³¹P{¹H} NMR (101 MHz, C₆D₆) δ=47.79 (s) ppm.

### Example 1-4

Ligand: Butyldi-1-adamantylphosphine
Reaction time: 3 h, toluene
Yield: 193 mg (55%) colorless solid; with acetone as solvent >80%.

¹H NMR (250 MHz, C₆D₆) δ=3.76 (ddd, J=12.2, 5.1, 1.7 Hz, 2H), 3.14-3.53 (m, 4H), 1.97-2.12 (m, 12H), 1.86 (br. s., 8H), 1.55-1.75 (m, 14H), 1.42-1.55 (m, 2H), 0.97 (t, J=7.2 Hz, 3H), 0.58 (br. s., 6H), −0.12-0.31 (m, 6H) ppm.

¹³C NMR (63 MHz, C₆D₆) δ=64.5, 64.0, 41.1, 40.0, 37.6, 31.1, 29.6, 26.8, 21.9, 14.8, 0.9 ppm.

³¹P{¹H} NMR (101 MHz, C₆D₆) δ=49.78 (s) ppm.

Observation: Reaction Product

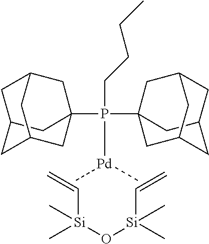

### Example 1-5

Ligand: 2-(dicyclohexylphosphino)biphenyl
Reaction time: 16 h, addition of 3 ml of methanol after the reaction time
Yield: 91 mg (45%) colorless solid

¹H NMR (250 MHz, C₆D₆) δ=7.57 (t, J=7.1 Hz, 1H), 7.17-7.24 (m, 6H because of overlap with solvent signal), 7.03-7.09 (m, 2H), 6.94-7.03 (m, 3H), 3.12-3.39 (m, 4H), 2.90-3.10 (m, 2H), 1.81-2.08 (m, 6H), 1.51-1.78 (m, 6H), 1.23-1.51 (m, 4H), 0.97-1.23 (m, 6H), 0.57 (br. s., 6H), 0.12 (br. s, 6H) ppm.

¹³C NMR (63 MHz, C₆D₆) δ=146.8, 142.3, 133.5, 132.6, 132.2, 129.3, 127.2, 127.1, 126.4, 65.2, 64.3, 39.1, 30.9, 30.7, 27.8, 27.5, 26.5, 1.7, −1.2 ppm.

³¹P{¹H} NMR (101 MHz, C₆D₆) δ=32.83 ppm.

### Comparative Example 1-6

Ligand: YPhos 1
Reaction time: 3 h
Yield: 45 mg (56%) colorless solid.

³¹P NMR (101 MHz, C₆D₆) δ=30.96 (d, J=78.0 Hz), 15.76 (d, J=79.0 Hz) ppm.

### Example 1-7

Ligand: Di-tert-butylphenylphosphine
Reaction time: 3 h; after concentration, addition of 15 ml of methanol
Yield: 123 mg (48%) colorless solid.

¹H NMR (250 MHz, C₆D₆) δ=7.52-7.69 (m, 2H), 7.05-7.14 (m, 3H), 3.65 (s, 2H), 3.27-3.46 (m, 4H), 1.20 (d, J=12.6 Hz, 18H), 0.19 (br. s., 12H) ppm.

³¹P{¹H} NMR (101 MHz, C₆D₆) δ=69.85 ppm.

### Example 1-8

Ligand: Di-tert-butylisopropylphosphine, addition of 6 ml of toluene
Reaction time: 3 h; after concentration, addition of 15 ml of methanol
Yield: 153 mg (64%) colorless solid.

¹H NMR (250 MHz, C₆D₆) δ=3.45-3.68 (m, 2H), 3.14-3.39 (m, 4H), 2.42-2.70 (m, 1H), 1.05-1.37 (m, 24H), 0.53 (br. s., 6H), −0.19-0.24 (br. s., 6H) ppm

¹³C NMR (63 MHz, C₆D₆) δ=66.2, 65.9, 37.2, 31.8, 31.0, 22.2, 1.8 ppm.

³¹P{¹H} NMR (101 MHz, C₆D₆) δ=71.27 ppm.

### Example 1-9

Ligand: tert-butyldiphenylphosphine, addition of 2 ml of toluene
Reaction time: 3 h; after concentration, addition of 15 ml of methanol
Yield: 110 mg (41%) colorless solid.

¹H NMR (400 MHz, C₆D₆) δ=7.51-7.73 (m, 4H), 6.95-7.13 (m, 6H), 3.38-3.67 (m, 4H), 3.15-3.31 (m, 2H), 1.19 (d, J=13.6 Hz, 9H), 0.50 (s, 6H), 0.03 (s, 6H) ppm.

¹³C NMR (101 MHz, C₆D₆) δ=137.2 (d, J=21.60 Hz) 134.8 (d, J=13.30 Hz) 129.6 (s) 69.0 (d, J=3.32 Hz) 68.1 (d, J=8.29) 34.2 (d, J=9.90 Hz) 29.3 (d, J=8.29 Hz) 2.2 (s) −0.4 (s) ppm.

³¹P{¹H} NMR (101 MHz, C₆D₆) δ=64.01 ppm.

### Example 1-10

Ligand: Tri-o-tolylphosphine, addition of 3 ml of toluene

63 mg of tri-o-tolylphosphine (0.2 mmol, 2 eq.) were added to an oven-dried vial, followed by 95 μl (98 mg, 0.1 mmol, 1 eq.) of 1,3-divinyl-1,1,3,3-tetramethyldisiloxane-palladium. 3 ml of toluene were added to this suspension and the resulting solution was analyzed by means of ³¹P{¹H} NMR.

³¹P{¹H} NMR (101 MHz, C₆D₆) δ=21.6 ppm.

### Example 1-11

Ligand: Tris(pentafluorophenyl)phosphine, addition of 3 ml of toluene

110 mg of tris(pentafluorophenyl)phosphine (0.2 mmol, 2 eq.) were added to an oven-dried vial, followed by 95 μl (98 mg, 0.1 mmol, 1 eq.) of 1,3-divinyl-1,1,3,3-tetramethyldisiloxane-palladium. 3 ml of toluene were added to this suspension and the resulting solution was analyzed by means of ¹⁹F-NMR.

### Example 2: Catalytic Activity of Example 1-4

In the following example, the catalytic activity of example 1-4 of the compound

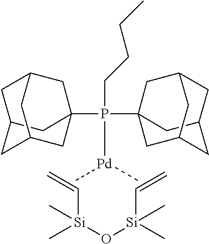

was tested. This was carried out partly in comparison to other similar compounds. The activity was tested in a Suzuki-Myaura cross-coupling with p-chlorotoluene and phenylboronic acid as reactants.

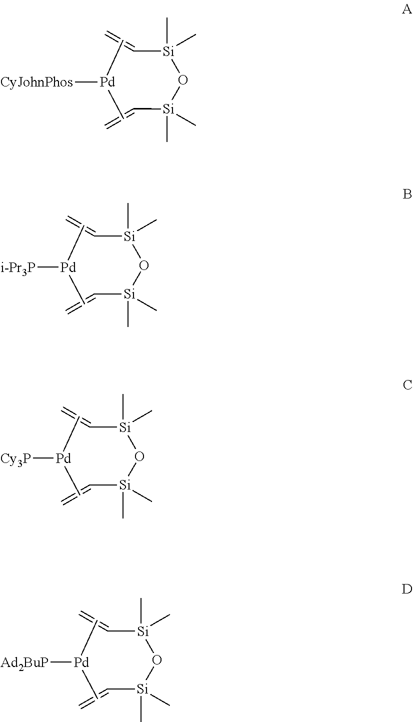

A: Example 1-5
B: Example 1-3
C: Example 1-2
D: Example 1-4

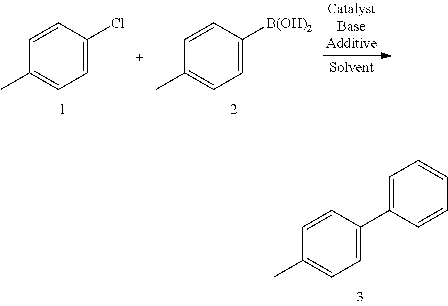

TABLE 2-1
Comparison of catalysts A-D.

| | | Unreacted reactant | Yield at 3 |
|---|---|---|---|
| No. | Catalyst | 1 [%] | [%] |
| 1 | A | 41 | 61 |
| 2 | B | 37 | 31 |
| 3 | C | 34 | 43 |
| 4 | D | 23 | 79 |

Reactions performed on 1.5 mmol scale. 2 mmol of phenylboronic acid, 1.5 mmol of K3P04 and 1.5 mmol of potassium fluoride were initially charged in an injection vial, 0.0075 mmol of catalyst was added in a nitrogen-filled glove box. Solvent: 4 ml THF. 1.5 mmol of p-chlorotoluene were added with a syringe. The reaction time was 22 h, and the temperature was 100° C. Yields determined via gas chromatography with tetradecane as internal standard.

The solvent tolerance was carried out analogously to the procedure under 2-1, with 3 ml of the specified solvent.

TABLE 2-2
Solvent tolerance of catalyst D.

| | | Unreacted | Yield of product |
|---|---|---|---|
| No. | Solvent | reactant 1 [%] | 3 [%] |
| 1 | THF | 13 | 95 |
| 2 | MeOH | 53 | 40 |
| 3 | EtOH | 45 | 46 |
| 4 | ^{t}AmylOH | 0 | 94 |
| 5 | Toluene | 28 | 77 |
| 6 | Water | 0 | 94 |
| 7 | Water/THF (1:1) | 11 | 99 |
| 8 | Acetone | 17 | 64 |

Furthermore, different bases were tested in suitable solvents. 1 mmol of base was used in each case.

TABLE 2-3
Base screening with catalyst D.

| | | | Unreacted | Yield of |
|---|---|---|---|---|
| No. | Base | Solvent | reactant 1 [%] | product 3 [%] |
| 1 | K₃PO₄ | Water | 8 | >99 |
| 2 | Cs₂CO₃ | Water | 8 | >99 |
| 3 | Li₂CO₃ | Water | 0 | >99 |
| 4 | K₂CO₃ | Water | 7 | >99 |
| 5 | Na₂CO₃ | Water | 7 | 98 |
| 6 | NaOH | Water | 8 | >99 |
| 7 | KOH | Water | 0 | >99 |
| 8 | ^{t}BuOK | THF | 0 | >99 |
| 9 | ^{t}BuONa | THF | 0 | >99 |
| 10 | ^{t}BuOLi | THF | 15 | 85 |

The suitability of different reaction temperatures was tested analogously to 2-1. 3 mmol of lithium carbonate were used as the base, and THE was used as the solvent. At temperatures below 80° C. no reaction product was observed, at 80° C. the yield was only 25%.

### Example 3-1 [Pd(Ph₂P(CH₂)₃PPh₂)₂]

Under argon, 213 mg of 1,3-bis(diphenylphosphino)propane (0.5 mmol, 2 eq.) were dissolved in 3 ml of toluene and 251 μl (244 mg, 0.25 mmol, 1 eq.) of 1,3-divinyl-1,1,3,3-tetramethyldisiloxane-palladium were added. The solution was stirred for 2 h, whereupon a yellow solid precipitated. 5 ml of methanol were added to the suspension and the supernatant was removed with a syringe. The solid was washed with methanol (2×10 ml) and dried under vacuum.
Yield: 230 mg (99%).

³¹P{¹H} NMR (101 MHz, C₆D₆) δ=3.97 ppm.

### Example 3-2 [Pd(Ph₂P(CH₂)₂PPh₂)₂]

Under argon, 203 mg of 1,3-bis(diphenylphosphino)ethane (0.5 mmol, 2 eq.) were dissolved in 3 ml of toluene and 251 μl (244 mg, 0.25 mmol, 1 eq.) of 1,3-divinyl-1,1,3,3-tetramethyldisiloxane-palladium were added. The solution was stirred for 2 h, whereupon a solid precipitated. 5 ml of methanol were added to the suspension and the supernatant was removed with a syringe. The solid was washed with methanol (2×10 ml) and dried under vacuum.
Yield: 215 mg (95%).

³¹P{¹H} NMR (101 MHz, C₆D₆) δ=29.59 ppm.

B. Pd(I) Dimers [Pd(μ-X)(PR^{A}R^{B}R^{C})]₂, Wherein X═Br, I

### Example 1-1 [Pd(μ-Br)(PtBu₃)]₂ Starting from [Pd(acac)₂] and acetyl bromide

A mixture of [Pd(acac)₂] (31 g, 100 mmol) and acetyl bromide (25 g, 200 mmol) in 500 ml of acetone was stirred at room temperature for 2.5 hours. Then [Pd(PtBu₃)₂] (55 g, 105 mmol, 1.05 eq.) and 400 ml of acetone were added and the reaction mixture was stirred at room temperature for 2 hours. The precipitated solid was filtered off, washed and then dried under vacuum.
Yield: 71.58 g (92%) dark green-blue solid.

¹H NMR (400 MHz, C₆D₆) δ=1.32 ppm.

³¹P{¹H} NMR (101 MHz, C₆D₆) δ=86.3 ppm. Pd content: 28.1%.

Reversing the order of addition of acetyl bromide and [Pd(PtBu₃)₂] gives the product in a yield of approx. 60%.

### Example 1-2 [Pd(μ-Br)(PtBu₃)]₂ Starting from [Pd₂(dvds)₃] and Acetyl Bromide or N-Bromosuccinimide

A mixture of [Pd₂(dvds)₃] and acetyl bromide (2 eq.) in methanol was stirred at room temperature for 2.5 hours. PtBu₃ (2 eq.) was then added and stirring was carried out for 2.5 hours at room temperature. The precipitated solid was filtered off, washed and then dried under vacuum.
Yield: 32% dark green-blue solid.

¹H NMR (400 MHz, C₆D₆) δ=1.32 ppm.

³¹P{¹H} NMR (101 MHz, C₆D₆) δ=86.3 ppm.

Using N-bromosuccinimide as the Br donor and acetone as the solvent, and otherwise carrying out the reaction analogously, gave the product in a yield of 16%.

### Example 1-3 [Pd(μ-Br)(PtBu₃)]₂ Starting from [Pd₂(dvds)₃] and Br₂ in 1,4-Dioxane

[Pd₂(dvds)₃] (868 mg, 1 mmol) was added to a Schlenk tube, followed by tri-tert-butylphosphine (413 mg, 2 mmol, 98%, 2 eq.). A solution of bromine (Br₂) (4 ml, 0.25 M, 1 mmol, 1 eq.) in 1,4-dioxane was then added. The mixture was stirred for 2 h at 40° C. The solvent was removed under reduced pressure, the residue extracted with toluene, and the toluene removed under reduced pressure. The solid obtained was dissolved in acetone. The solution was stored at −20° C., whereupon dark green crystals were obtained, which were separated from the solution and washed with small portions of acetone and dried under reduced pressure.
Yield: 55% dark green crystals.

¹H NMR (400 MHz, C₆D₆) δ=1.32 ppm.

³¹P{¹H} NMR (101 MHz, C₆D₆) δ=86.3 ppm.

### Example 2-1 [Pd(μ-I)(PtBu₃)]₂ Starting from [Pd₂(dvds)₃] and 12

A mixture of [Pd₂(dvds)₃] (0.5 g Pd, 2.4 mmol) and PtBu₃ as a solution in toluene (1 eq.) in acetone was stirred at room temperature for 2.5 hours. Iodine (I₂) (0.62 g, 2.4 mmol, 1 eq.) was then added and stirring was carried out for 2.5 hours at room temperature. The precipitated solid was filtered off, washed and then dried under vacuum.
Yield: 83% dark purple solid.

¹H NMR (400 MHz, C₆D₆) δ=1.29 ppm.

³¹P{¹H} NMR (101 MHz, C₆D₆) δ=102.3 ppm.

### C. π-Allylpalladium Halide Complexes

### C.1 General Procedure for Preparing Dimeric Allylpalladium Halides According to General Formula VIII

An allyl halide (1.2 equivalents, 0.6 mmol; or 5 equivalents, 2.5 mmol; or 10 equivalents, 5 mmol) was added to a solution of Pd(vs) in a Schlenk flask under an argon atmosphere. (1 equivalent, palladium content 5.35%, 993 mg, 0.5 mmol or palladium content 10.9%, 488 mg, 0.5 mmol). A yellow solid formed rapidly. The mixture continued to be stirred for one hour and hexane (3 ml) was added. The liquid supernatant was decanted and the solid washed twice with 3 ml of hexane. The solid was dried under vacuum.

### Example 1-1: Di-μ-chlorobis(η³-allyl)dipalladium (1-Cl) [CAS Number: 12012-95-2]

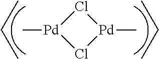

Yellow solid, melting point: 149° C. Proportion of insoluble components in dichloromethane: <0.1% (PTFE membrane filter (0.45 μm pore width)).

| | | |
|---|---|---|
| Pd(vs) | Palladium content 5.35%, | Palladium content 10.9%, |
| | 993 mg, 0.5 mmol | 488 mg, 0.5 mmol |
| Allyl chloride | 46.9 mg, 50 μl, 0.6 mmol | 46.9 mg, 50 μl, 0.6 mmol |
| Yield | 91 mg, >99% | 91 mg, >99% |

¹H NMR (CDCl₃, 400 MHz): δ=5.46 (tt, J=12.1, 6.7 Hz, 2H), 4.12 (d, J=6.6 Hz, 4H), 3.05 (d, J=12.1 Hz, 4H).

¹³C NMR (CDCl₃, 101 MHz) δ=111.1, 62.9.

### Example 1-2: Di-μ-bromobis(η³-allyl)dipalladium (1-Br) [CAS Number: 12077-82-6]

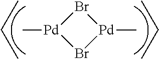 [0774] Yellow solid, melting point: 158° C.

| | |
|---|---|
| Pd(vs) | Palladium content 5.35%, 993 mg, 0.5 mmol |
| Allyl bromide | 598 mg, 0.43 ml, 5 mmol |
| Yield | 113 mg, >99% |

¹H NMR (CDCl₃, 400 MHz): δ=5.43 (tt, J=12.1, 6.8 Hz, 2H), 4.20 (d, J=6.8 Hz, 4H), 3.08 (d, J=12.1 Hz, 4H).

¹³C NMR (CDCl₃, 101 MHz): δ=110.6, 64.8.

### Example 1-3: Di-μ-iodobis(η³-allyl)dipalladium (1-1) [CAS Number: 12013-04-6]

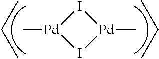 [0778] Orange solid, melting point: 180° C.

| | |
|---|---|
| Pd(vs) | Palladium content 5.35%, 993 mg, |
| | 0.5 mmol |
| Allyl iodide | 860 mg, 0.47 ml, 5 mmol |
| Yield | 137 mg, >99% |

¹H NMR (CDCl₃, 250 MHz): δ=5.31 (tt, J=12.5, 6.8 Hz, 2H), 4.39 (dt, J=6.8, 0.7 Hz, 4H), 3.09 (dt, J=12.5, 0.7 Hz, 4H).

¹³C NMR (CDCl₃, 63 MHz): δ=109.5, 67.6.

### Example 1-4: Di-μ-chlorobis[η³-2-methylallyl]dipalladium (2-Cl) [CAS Number: 12081-18-4]

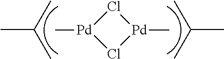 [0782] Yellow solid, melting point: 145° C.

| | |
|---|---|
| Pd(vs) | Palladium content 5.35%, 993 mg, |
| | 0.5 mmol |
| 3-chloro-2-methylpropene | 503 mg, 0.54 ml, 5 mmol |
| Yield | 98 mg, >99% |

¹H NMR (CDCl₃, 400 MHz): δ=3.86 (s, 4H), 2.89 (s, 4H), 2.15 (s, 6H).

¹³C NMR (CDCl₃, 101 MHz): δ=127.0, 61.8, 22.7.

### Example 1-5: Di-μ-bromobis[η³-2-methylallyl]dipalladium (2-Br) [CAS Number: 12080-98-7]

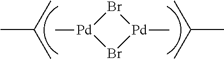 [0786] Yellow solid, melting point: 153-154° C.

| | |
|---|---|
| Pd(vs) | Palladium content 5.35%, 993 mg, |
| | 0.5 mmol |
| 3-bromo-2-methylpropene | 348 mg, 0.26 ml, 2.5 mmol |
| Yield | 111 mg, 92.0% |

¹H NMR (CDCl₃, 400 MHz): δ=3.94 (s, 4H), 2.92 (s, 4H), 2.09 (s, 6H).

¹³C NMR (CDCl₃, 101 MHz): δ=126.2, 63.9, 22.9.

### Example 1-6: Bis[(1,2,3-η)-2-buten-1-yl]di-μ-chlorodipalladium (3-Cl) [CAS Number: 12081-22-0]

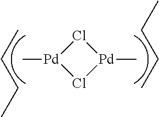 [0790] Yellow solid, melting point: 148° C.

| | | |
|---|---|---|
| Pd(vs) | Palladium content 5.35%, | Palladium content 10.9%, |
| | 993 mg, 0.5 mmol | 9.76 g, 10 mmol |
| Crotyl chloride | 477 mg, 0.51 ml, 5 mmol | 1.14 g, 1.23 ml, 12 mmol |
| Yield | 98 mg, >99% | 1.84 mg, 93.5% |

Ratio of syn/anti isomers 97:3

SYN isomer:

¹H NMR (CDCl₃, 400 MHz): δ=5.30 (td, J=11.6, 6.7 Hz, 2H), 3.78-4.01 (m, 4H), 2.82 (d, J=11.9 Hz, 2H), 1.34 (d, J=6.3 Hz, 6H).

¹³C NMR (CDCl₃, 101 MHz): δ=111.4, 79.0, 59.2, 15.8.

### Anti Isomer:

¹H NMR (CDCl₃, 400 MHz): δ=4.86 (quin, J=6.8 Hz, 2H), 4.10 (d, J=7.3 Hz, 2H), 3.37 (d, J=12.9 Hz, 2H), 1.13 ppm (d, J=6.6 Hz, 6H) a proton overlaps with the syn isomer.

¹³C NMR (CDCl₃, 101 MHz): δ=106.4, 81.5, 58.3, 18.0.

### Example 1-7: Bis[(1,2,3-η)-2-buten-1-yl]di-μ-chlorodipalladium (3-Br) [CAS Number: 12081-43-5]

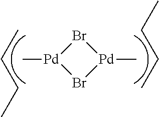 [0796] Yellow solid, melting point: 169° C.

| | |
|---|---|
| Pd(vs) | Palladium content 5.35%, 993 |
| | mg, 0.5 mmol |
| Crotyl bromide | Purity 85%, 394 mg, 0.30 ml, 2.48 |
| | mmol |
| Yield | 121 mg, >99% |

¹H NMR (CDCl₃, 250 MHz): δ=5.29 (td, J=11.6, 6.8 Hz, 2H), 3.89-4.09 (m, 4H), 2.85 (d, J=12.0 Hz, 2H), 1.50 (d, J=6.3 Hz, 6H).

¹³C NMR (CDCl₃, 63 MHz): δ=111.2, 83.8, 59.7, 18.5.

### Example 1-8: Di-μ-chlorobis[(1,2,3-η)-3-methyl-2-butenyl]dipalladium (4-Cl) [CAS Number: 12288-41-4]

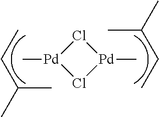 [0800] Yellow solid, melting point: 116-117° C.

| | |
|---|---|
| Pd(vs) | Palladium content 5.35%, 993 mg, |
| | 0.5 mmol |
| 3,3-dimethylallyl chloride | 278 mg, 0.30 ml, 2.5 mmol |
| Yield | 97 mg, 91.9% |

¹H NMR (CDCl₃, 250 MHz): δ=5.08 (dd, J=12.6, 7.4 Hz, 2H), 3.85 (dd, J=7.4, 1.3 Hz, 2H), 3.10 (dd, J=12.6, 1.3 Hz, 2H), 1.45 (s, 6H), 1.25 (s, 6H).

¹³C NMR (CDCl₃, 63 MHz): δ=106.3, 95.1, 55.7, 27.1, 21.8.

### Example 1-9: Di-μ-bromobis[(1,2,3-η)-3-methyl-2-butenyl]dipalladium (4-Br)

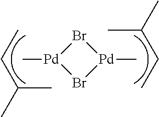 [0804] Yellow solid, melting point: 119-120° C.

| | |
|---|---|
| Pd(vs) | Palladium content 5.35%, 993 mg, |
| | 0.5 mmol |
| 3,3-dimethylallyl bromide | 373 mg, 0,29 ml, 2.5 mmol |
| Yield | 82 mg, 64.2% |

¹H NMR (CDCl₃, 300 MHz): δ=5.08 (dd, J=12.7, 7.3 Hz, 2H), 3.92 (dd, J=7.3, 1.5 Hz, 2H), 3.14 (dd, J=12.7, 1.5 Hz, 2H), 1.60 (s, 6H), 1.29 (s, 6H).

¹³C NMR (CDCl₃, 101 MHz): δ=106.4, 97.7, 57.1, 27.7, 22.1.

### Example 1-10: Di-μ-chlorobis[(1,2,3-η)-1-phenyl-2-propen-1-yl]dipalladium (5-Cl) [CAS Number: 12131-44-1]

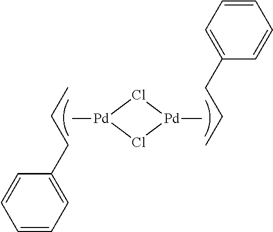 [0808] Yellow solid, melting point: 201° C.

| | |
|---|---|
| Pd(vs) | Palladium content 5.35%, 993 mg, |
| | 0.5 mmol |
| Cinnamyl chloride | 803 mg, 0.73 ml, 5 mmol |
| Yield | 129 mg, >99% |

¹H NMR (CDCl₃, 400 MHz): δ=7.44-7.56 (m, 4H), 7.31-7.40 (m, 2H), 7.22-7.31 (m, 4H), 5.80 (td, ddd, J=11.9, 11.4, 6.7 Hz, 2H), 4.62 (d, J=11.4 Hz, 2H), 3.97 (dd, J=6.7, 0.6 Hz, 2H), 3.04 (dt, J=11.9, 0.9 Hz, 2H).

¹³C NMR (CDCl₃, 101 MHz): δ=136.9, 129.0, 128.5, 127.9, 105.9, 81.8, 59.4.

### Example 1-11: Di-μ-bromobis[(1,2,3-η)-1-phenyl-2-propen-1-yl]dipalladium (5-Br) [CAS Number: 32876-05-4]

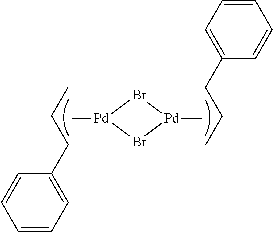 [0812] Orange solid, melting point: 173° C.

| | |
|---|---|
| Pd(vs) | Palladium content 5.35%, 993 mg, |
| | 0.5 mmol |
| Cinnamyl | 1011 mg, 0.76 ml, 5 mmol |
| bromide | |
| Yield | 151 mg, >99% |

¹H NMR (CDCl₃, 400 MHz): δ=7.44-7.56 (m, 4H), 7.23-7.38 (m, 6H), 5.83 (ddd, J=11.9, 11.6, 6.8 Hz, 2H), 4.73 (d, J=11.6 Hz, 2H), 4.05 (d, J=6.8 Hz, 2H), 3.08 (d, J=11.9 Hz, 2H). ¹³C NMR (CDCl₃, 101 MHz): δ=137.0, 129.0, 128.5, 128.1, 105.5, 84.3, 60.6.

### Example 1-12: Di-μ-chlorobis[(1,2,3-η)-2-cyclohexen-1-yl]dipalladium (6-Cl) [CAS Number: 12090-09-4]

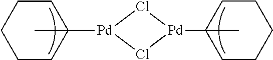 [0815] Yellow solid, melting point: 108° C.

| | | |
|---|---|---|
| Pd(vs) | Palladium content | Palladium content 10.9%, |
| | 5.35%, 993 mg, | 1.953 g, 2 mmol |
| | 0.5 mmol | |
| 3-chlorocyclohexene | 609 mg, 0.58 ml, 5 | 295 mg, 0.28 ml, 2.4 |
| | mmol | mmol |
| Yield | 111 mg, >99% | 439 mg, 98.4% |

¹H NMR (CDCl₃, 250 MHz): δ=5.48 (t, J=6.3 Hz, 2H), 5.18 (t, J=5.3 Hz, 4H), 1.63-1.95 (m, 10H), 0.91-1.17 (m, 2H).

¹³C NMR (CDCl₃, 63 MHz): δ=101.7, 78.8, 28.7, 19.4.

### Example 1-13: Di-μ-bromobis[(1,2,3-η)-2-cyclohexen-1-yl]dipalladium (6-Br) [CAS Number: 35284-31-2]

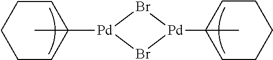 [0819] Yellow solid, melting point: 129° C.

| | |
|---|---|
| Pd(vs) | Palladium content 10.9%, 1.953 g, |
| | 2 mmol |
| 3-bromocyclohexene | 392 mg, 0.28 ml, 2.43 mmol |
| Yield | 534 mg, 90.9% |

¹H NMR (CDCl₃, 400 MHz): δ=5.47 (t, J=6.5 Hz, 2H), 5.30 (t, J=5.1 Hz, 4H), 1.70-1.99 (m, 10H), 1.02-1.20 (m, 2H).

¹³C NMR (CDCl₃, 101 MHz): δ=101.7, 81.1, 28.7, 19.5.

### Example 1-14: Reaction of Pd(vs) with 1-(chloromethyl)naphthalene (Preparation of 7-Cl)

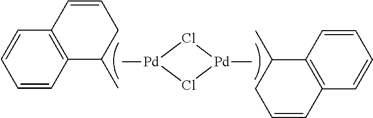

A solution of Pd(vs) (palladium content 10.9%, 1945 mg, 2 mmol) was added to a solution of 1-(chloromethyl)naphthalene (446 mg, 2.4 mmol, 1.2 equiv.) in 3 ml of dried and degassed acetone in an injection vial under an argon atmosphere. After one hour, a yellow solution began to form, which continued to be stirred for 24 hours and 3 ml of hexane were added thereto. The supernatant liquid was decanted and the solid obtained was washed three times with 5 ml of acetone and dried under vacuum. 196 mg (yield: 34.6%) of a yellow solid were isolated.

¹H NMR (400 MHz, DMSO-d₆) δ=8.47 (d, J=8.1 Hz, 2H), 7.91 (dd, J=19.0, 8.1 Hz, 2H), 7.53-7.73 (m, 2H), 7.36 (t, J=7.6 Hz, 1H), 7.05 (d, J=5.5 Hz, 1H), 3.88-3.88 (m, 1H), 3.90 (s, 2H) ppm.

¹³C NMR (101 MHz, DMSO-d₆) δ=133.99, 130.03, 128.27, 128.20, 127.47, 127.45, 126.35, 125.34 ppm.

mp: >160° C. (decomposition)

IR (ATR): 950 (vw), 876 (vw), 795 (vw), 772 (w), 753 (w), 709 (vw), 644 (vw), 571 (vw), 509 (vw) cm-1.

EA Anal. Calcd for C₂₂H₁₈Cl₂Pd₂: C, 46.68, H, 3.20; N, 0.00 Found: C, 46.99H, 3.171 N, 0.00.

### Example 1-15: Reaction of Pd(vs) with 2-(chloromethyl)naphthalene (Preparation of 8-Cl)

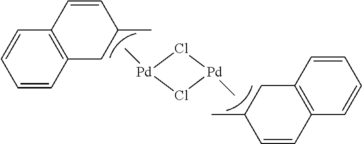

1,3-divinyl-1,1,3,3-tetramethyldisiloxanepalladium Pd(vs) (1 equiv., 1945 mg, 2 mmol, 10.9% Pd) was dissolved in 3 ml of dried and degassed acetone in an injection vial containing 2-(chloromethyl)naphthalene (1.2 eq, 437 mg, 2.4 mmol, 97%). The mixture was stirred for 16h. The orange precipitate was filtered off and the solid was washed three times with 6 ml of acetone. 135 mg of product were isolated.

¹H NMR (400 MHz, DMSO-d₆) δ=7.88 (s, 2H), 7.78 (t, J=6.9 Hz, 4H), 7.60-7.73 (m, 4H), 7.37-7.49 (m, 4H), 3.56 (s, 4H) ppm.

¹³C NMR (101 MHz, DMSO-d₆) δ=125.00, 126.31, 127.20, 127.79, 127.94, 131.19, 134.01 ppm.

mp: >179° C. (decomposition).

IR (ATR): 855 (vw), 816 (w), 746 (w), 648 (vw), 614 (vw), 544 (vw), 501 (vw), 571 (vw), 509 (vw) cm-1.

EA Anal. Calcd for C₂₂H₁₈Cl₂Pd₂: C, 46.68, H, 3.20; N, 0.00 Found: C, 46.96 H, 3.380 N, 0.00.

### Example 1-16: Reaction of Pd(vs) with 1-(bromomethyl)naphthalene (Preparation of 7-Br)

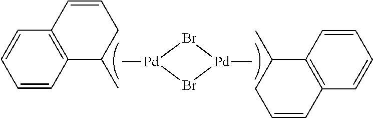

1592 mg (7.2 mmol, 1.2 equiv.) of 1-(bromomethyl)naphthalene dissolved in 3 ml of dried and degassed acetone were initially charged in an injection vial and, under anhydrous and oxygen-free conditions, 5210 mg (10.9% Pd, 6 mmol, 1 equiv.) of Pd(vs) were added and stored at 4-6° C. overnight. The orange precipitate was filtered off in air and washed five times with 5 ml of acetone and dried under vacuum. 1632 mg (yield 83%) of 7-Br were obtained as an orange solid.

¹H NMR (400 MHz, DMSO-d₆) 6=8.32-8.40 (m, 2H), 7.87-8.02 (m, 4H), 7.64-7.77 (m, 4H), 7.47 (dd, J=8.7, 6.4 Hz, 2H), 6.44 (d, J=6.2 Hz, 2H), 4.12 (s, 4H) ppm.

¹³C NMR (101 MHz, DMSO-d₆) δ=124.80, 127.58, 128.57, 128.69, 129.02, 129.18, 130.31, 134.04 ppm.

Mp: >147° C. (decomposition)

IR (ATR): 1504 (vw), 1329 (vw), 1235 (vw), 951 (vw), 876 (vw), 794 (w), 772 (w), 754 (vw), 643 (vw), 571 (vw), 510 (vw) cm-1.

### Example 1-17: Reaction of Pd(vs) with 2-(bromomethyl)naphthalene (Preparation of 8-Br)

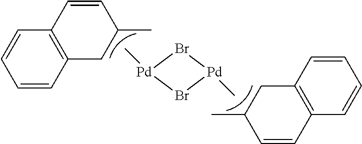

921 mg (4 mmol, 1 equiv.) of 2-(bromomethyl)naphthalene dissolved in 3 ml of dried and degassed acetone were initially charged in an injection vial and, under anhydrous and oxygen-free conditions, 4168 mg (10.9% Pd, 4.8 mmol, 1 equiv.) of Pd(vs) were added. The solution was stirred for 2 h. The orange precipitate was filtered off in air and washed three times with 5 ml of acetone. The solid was dried under vacuum, giving 540 mg (41% yield) as an orange solid.

¹H NMR (400 MHz, DMSO-d₆) δ=7.85 (d, J=7.9 Hz, 2H), 7.80 (d, J=7.8 Hz, 2H), 7.74 (d, J=8.7 Hz, 2H), 7.56-7.67 (m, 4H), 7.42-7.55 (m, 4H), 3.71 (s, 4H) ppm.

¹³C NMR (101 MHz, DMSO-d₆) δ=125.71, 126.70, 127.05, 127.83, 127.98, 129.05, 131.41, 134.50 ppm.

mp: >171° C. (decomposition)

IR (ATR): 855 (vw), 813 (vw), 766 (w), 747 (w), 650 (vw), 614 (w), 542 (w) cm⁻¹.

EA Anal. Calcd for C₂₂H₁₈Br₂Pd₂: C, 40.34, H, 2.77; N, 0.00 Found: C, 40.35 H, 2.652 N, 0.00.

### Example 1-18: Reaction of Pd(vs) with 3-(tert-butyl)-1-chloro-1H-indene (Preparation of 9-Cl)

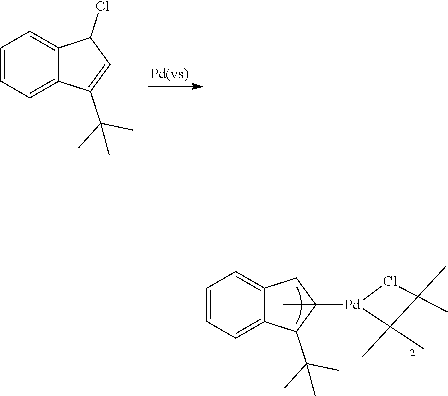

3-(tert-butyl)-1-chloro-1H-indene (1 equiv, 30 mg, 0.145 mmol) dissolved in 0.1 ml acetone was initially charged and Pd(vs) (1.2 equiv, 151 mg, 0.174 mmol) was added and shaken. The mixture was stored overnight at 4° C. The crystals that formed were carefully separated off and washed with a few drops of water and acetone, and dried. 29 mg (64%) of dark brown crystals were obtained.

¹H NMR (400 MHz, CDCl₃) δ=7.09-7.19 (m, 2H), 6.83 (d, J=4.3 Hz, 8H), 5.53 (d, J=2.9 Hz, 2H), 1.32 (s, 18H) ppm.

¹³C NMR (101 MHz, CDCl₃) δ=141.91, 140.70, 127.45, 127.15, 120.08, 120.05, 118.64, 118.56, 107.43, 107.37, 73.01, 34.19, 28.65 ppm.

### C.2 Preparation of Palladium(II) Compounds According to Formula IX, Formula IX.a or IX.b and IX.c, Formula IX.d or Formula IX.P and Formula IX.N

### Example 2-1 1-methylnaphthyl[tris(tert-butyl)phosphine]bromopalladium(II) (10-Br)

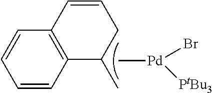

7-Br (1 eq, 164 mg, 0.25 mmol) was added to a vial and the air was replaced with argon. The solid was dissolved in 20 ml of dry and degassed THE and the vial was transferred to the glove box. Tri-tert-butylphosphine, (2 eq, 103 mg, 0.5 mmol, 98%) was then added and the reaction mixture was stirred for 30 min at room temperature. The suspension was filtered with a syringe filter and the filtrate reduced to 90% of the volume. Hexane was then added and the sample was stored in the freezer (−20° C.) to precipitate the product. The crude reaction mixture was washed with pentane and the remaining solid was dissolved in toluene and filtered over Celite®. The solvent was removed under reduced pressure to give 216 mg (82%) of an orange solid.

¹H NMR (400 MHz, C₆D₆) δ=7.73 (s, 2H), 7.57 (t, J=7.6 Hz, 1H), 7.41 (d, J=7.8 Hz, 1H), 7.31 (t, J=7.1 Hz, 1H), 7.23 (t, J=8.1 Hz, 1H), 6.32 (t, J=5.4 Hz, 1H), 3.35 (br. s, 2H), 1.31 (d, J=12.5 Hz, 27H) ppm.

¹³C NMR (101 MHz, CD₂Cl₂) δ=131.85 (d, J=3.70 Hz), 130.77 (d, J=4.40 Hz), 129.55, 128.72, 127.96, 123.63, 109.58 (d, J=13.91 Hz), 40.24 (d, J=5.80 Hz), 37.87, 33.11 ppm.

³¹P NMR (162 MHz, C₆D₆) δ=99.92 ppm;

Elemental analysis calculated C₂₃H₃₆BrPPd: C, 52.14, H, 6.85, N, 0.00; found: C, 51.86 H, 6.28 N, 0.00.

### Example 2-2 1-methylnaphthyl[tris(cyclohexyl)phosphine]bromopalladium(II) (11-Br)

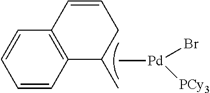

7-Br (1 eq, 164 mg, 0.25 mmol) was added to a vial, the air was replaced with argon and the vial was transferred to the glove box. Tricyclohexylphosphine (2 eq, 140 mg, 0.5 mmol) was then added, followed by 20 ml of THF. The reaction mixture was stirred for 90 min at room temperature. 90% of the solvent was evaporated and 10 ml of pentane was added. The sample was stored overnight at −20° C. to crystallize the product. The mother liquor was decanted and the solid was dried under high vacuum to give 192 mg (63%) of a yellow solid.

¹H NMR (400 MHz, CD₂Cl₂) δ=7.87 (d, J=7.8 Hz, 1H), 7.78 (d, J=7.6 Hz, 1H), 7.71 (d, J=7.3 Hz, 1H), 7.40-7.61 (m, 3H), 6.12 (t, J=5.6 Hz, 1H), 3.71-4.05 (br. s, 1H), 2.54 (br. s, J=1.2 Hz, 1H), 2.00-2.18 (m, 3H), 1.53-1.96 (m, 15H), 1.02-1.44 (m, 15H) ppm.

¹³C NMR (101 MHz, CD₂Cl₂) δ=135.3 (d, J=2.9 Hz), 131.0 (d, J=5.1 Hz), 129.6 (s), 129.1 (s), 129.0 (s), 127.5 (s), 124.0 (s), 120.5 (d. J=3.7 Hz), 100.3 (s), 100.2 (s), 37.5 (d, J=4.4 Hz), 35.7 (d, J=19.8 Hz), 30.8 (d, J=25.7 Hz), 28.1 (d, J=11 Hz), 26.9 (s) ppm.

³¹P NMR (162 MHz, CD₂Cl₂) δ=53.91 ppm.

Elemental analysis calculated C₂₉H₄₂BrPPd*THF(C₄H₈ₜₕO): C, 58.28, H, 7.41, N, 0.00; found: C, 58.65 H, 6.32 N, 0.00.

### Example 2-3 1-methylnaphthyl[tris(cyclohexyl)phosphine]chloropalladium(II) (11-Cl)

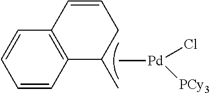

7-Cl (1 eq, 142 mg, 0.25 mmol) was added to a vial, the air was replaced with argon and the vial was transferred to the glove box. Tricyclohexylphosphine (2 eq, 140 mg, 0.5 mmol) was then added, followed by 20 ml of THF. The reaction mixture was stirred for 90 min at room temperature. 90% of the solvent was evaporated and 10 ml of pentane was added. The sample was stored overnight at −20° C. to precipitate the product. The solution was decanted from the solid and the remaining solid was washed with pentane (3×5 ml) and dried under high vacuum to afford 91 mg (32%) of a yellow solid.

¹H NMR (400 MHz, CD₂Cl₂): δ=7.96 (d, J=7.6 Hz, 1H), 7.88 (d, J=7.3 Hz, 1H), 7.84 (dd, J=8.8, 3.2 Hz, 1H), 7.57-7.68 (m, 2H), 7.53 (t, J=7.6 Hz, 1H), 6.26 (t, J=5.7 Hz, 1H), 3.82 (br. s., 1H), 2.57 (br. s., 1H), 2.05-2.21 (m, 3H), 1.65-1.97 (m, 15H), 1.16-1.51 (m, 15H).

¹³C NMR (101 MHz, CD₂Cl₂): δ=135.43 (d, J=2.93 Hz), 130.4, 130.4, 129.5, 129.1, 129.0, 127.5, 124.1, 120.81 (d, J=3.67 Hz), 100.67 (d, J=19.07 Hz), 35.35, 35.16, 28.13, 28.02, 26.93 (d, J=1.50 Hz) ppm.

³¹P NMR (162 MHz, C₆D₆): δ=53.53 ppm.

HRMS (TOF-EI): m/z calculated for C₁₄H₁₈O₃: 562.1747 [M]⁺; found 562.1772.

### Example 2-4 1-methylnaphthyl[1,3-bis(2,6-diisopropylphenyl)imidazol-2-ylidene]bromopalladium(II) (12-Br)

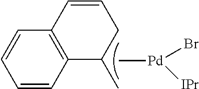

In a glove box filled with nitrogen, 164 mg of 7-Br (1 eq., 0.25 mmol) and 224 mg of IPr (2 eq., 0.5 mmol) were added into a crimp-cap vial. 20 ml of diethyl ether were then added and the reaction mixture was stirred for 90 min under a nitrogen atmosphere. 90% of the solvent was evaporated and 20 ml of pentane was added. The sample was stored overnight at −20° C. to crystallize the product. The mother liquor was decanted and the remaining solid was washed with pentane (3×2 ml) and dried under high vacuum to afford 325 mg (91%) of a yellow solid.

¹H NMR (400 MHz, C₆D₆; 283K) δ=7.32-7.43 (m, 2H), 7.21-7.32 (m, 4H), 7.07-7.21 (m, 3H, overlap with solvent signal), 6.99 (br. s, 2H), 6.86 (d, J=8.1 Hz, 1H), 6.55 (s, 2H), 5.40 (d, J=6.5 Hz, 1H), 3.52-3.64 (m, 2H), 3.38 (br. s., 1H), 1.88 (br. s., 1H), 1.44-1.64 (m, 6H), 1.39 (dt, J=6.6, 3.3 Hz, 2H), 0.78-1.25 (m, 18H) ppm.

¹³C NMR (101 MHz, C₆D₆; 283K) δ=184.63, 146.76, 136.94, 135.42, 132.92, 130.49, 130.04, 128.97, 127.21, 124.79, 124.41, 119.00, 91.88, 68.14, 33.85, 26.38, 23.09, 14.59 ppm.

HRMS (TOF-EI) m/z calculated C₃₈H₄₅BrN₂Pd [M]⁺ 714.1800, found 714.1786.

### Example 2-5 2-methylnaphthyl[1,3-bis(2,6-diisopropylphenyl)imidazol-2-ylidene]bromopalladium(II) (13-Br)

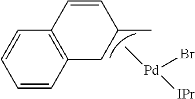

In a glove box filled with nitrogen, 164 mg of 8-Br (1 eq., 0.25 mmol) and 224 mg of IPr (2 eq., 0.5 mmol) were added into a crimp-cap vial. 20 ml of diethyl ether were then added and the reaction mixture was stirred for 90 min under a nitrogen atmosphere. 90% of the solvent was evaporated and 20 ml of pentane was added. The sample was stored overnight at −20° C. to crystallize the product. The mother liquor was decanted and the remaining solid was washed with pentane (3×2 ml) and dried under high vacuum to afford 344 mg (96%) of a yellow solid.

¹H NMR (300 MHz, C₆D₆) δ=7.69 (d, J=7.9 Hz, 1H), 7.18-7.30 (m, 4H), 7.08-7.17 (m, 6H, overlap with solvent signal), 6.63 (s, 2H), 6.11 (dd, J=8.8, 1.7 Hz, 1H), 5.59 (s, 1H), 3.22 (spt, J=7.0 Hz, 4H), 2.52 (br. s., 2H), 1.30-1.50 (m, 12H, overlap with THE signal), 1.01 (d, J=7.0 Hz, 12H) ppm.

¹³C NMR (75 MHz, THF-d8) δ=184.19, 147.37, 138.61, 137.78, 132.66, 132.54, 130.53, 130.48, 128.48, 127.51, 126.45, 126.09, 124.75, 124.26, 119.41, 91.88, 40.14, 29.50, 27.93, 26.50, 23.54 ppm.

Elemental analysis calculated for C₃₈H₄₅BrN₂Pd: C, 63.74, H, 6.33, N, 3.76 found: C, 64.14 H, 6.46, N, 3.91.

HRMS (TOF-EI) m/z calculated for C₃₈H₄₅BrN₂Pd [M]⁺ 714.1800, found 714.1802.

### Example 2-6 1-methylnaphthyl[2-(dicyclohexylphosphino)-2′,4′,6′-triisopropylbiphenyl]bromopalladium(II) (14-Br)

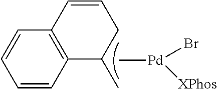

7-Br (1 eq, 164 mg, 0.25 mmol) and 2-(dicyclohexylphosphino)-2′,4′,6′-triisopropylbiphenyl (2 eq, 246 mg, 0.5 mmol, 97%) were added to a vial and the air was replaced with argon. 10 ml of THE were then added. The reaction mixture was stirred for 90 min at room temperature. The solution was concentrated to 90% volume and was overlayed with 10 ml of hexane. The vial was then stored in the freezer (−20° C.) to precipitate the product. The mother liquor was decanted and the remaining solid was washed with pentane (3×5 ml) and dried under high vacuum to afford 322 mg (80%) of a yellow solid.

¹H NMR (400 MHz, CD₂Cl₂) δ=7.77-7.97 (m, 4H), 7.51-7.70 (m, 3H), 7.33-7.47 (m, 2H), 7.08-7.28 (m, 3H), 6.19 (t, J=5.7 Hz, 1H), 2.96 (spt, J=6.8 Hz, 1H), 2.66 (br. s., 2H), 2.04-2.17 (m, 2 h), 0.63-1.79 (m, 40H) ppm.

¹³C NMR (101 MHz, CD₂Cl₂) δ=149.6, 147.0, 142.3, 138.4, 138.2, 136.8, 135.2, 134.4 (two peaks), 130.8 (two peaks), 129.4, 128.7-129.2 (m, complex coupling pattern), 127.4, 126.0, 125.9, 124.1, 121.6, 120.9 (two peaks), 34.8, 31.2, 27.6 (two peaks), 27.2 (two peaks), 26.2, 26.1, 24.2, 22.8 (br. s.) ppm.

³¹P NMR (162 MHz, CD₂Cl₂) δ=63.74 (br. S) ppm.

Elemental analysis calculated for C₄₄H₅₈BrPPd: C, 65.71, H, 7.27, N, 0.00, found: C, 65.73 H, 7.384, N, 0.62.

### Example 2-7 1-methylnaphthyl[2-dicyclohexylphosphino-2′,6′-di-i-propoxy-1,1′-biphenyl]bromopalladium(II) (15-Br)

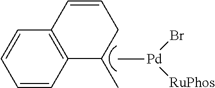

7-Br (1 eq, 164 mg, 0.25 mmol) was added to a vial, the air was replaced with argon and the vial was transferred to the glove box. 2-dicyclohexylphosphino-2′,6′-di-i-propoxy-1,1′-biphenyl (2 eq, 238 mg, 0.5 mmol, 98%) was then added, followed by 20 ml of THF. The reaction mixture was stirred for 90 min at room temperature. 90% of the solvent was evaporated and 10 ml of pentane was added. The sample was stored overnight at −20° C. to crystallize the product. The mother liquor was decanted and the remaining solid was washed with pentane (3×5 ml) and dried under high vacuum to afford 315 mg (79%) of a yellow solid.

¹H NMR (400 MHz, CD₂Cl₂) δ=7.86 (d, J=7.8 Hz, 1H), 7.78 (d, J=8.1 Hz, 2H), 7.60-7.72 (m, 2H), 7.48-7.60 (m, 2H), 7.37-7.47 (m, 1H), 7.24-7.35 (m, 2H), 6.95 (d, J=6.1 Hz, 1H), 6.64 (d, J=8.3 Hz, 2H), 6.07 (br. s., 1H), 4.36-4.66 (m, 2H), 3.27 (br. s, 2H), 2.00-2.17 (m, 2H), 1.39-1.97 (m, 10H), 0.67-1.37 (m, 22H) ppm.

¹³C NMR (101 MHz, CD₂Cl₂) δ=157.5, 139.6, 137.8, 137.6, 135.2, 133.3 (two peaks), 132.0, 131.7, 130.9 (two peaks), 129.5, 129.2, 128.8, 128.5 (two peaks), 127.1, 125.5 (two peaks), 124.6, 121.3, 107.0, 99.4 (two peaks), 71.5, 44.3 (two peaks), 35.2, 34.9, 29.4, 27.6, 27.4, 27.0, 26.9, 26.4, 22.5, 22.3 ppm.

³¹P NMR (162 MHz, CD₂C₁₂) δ=60.62 (br. s.) ppm.

Elemental analysis calculated for C₄₁H₅₂BrO₂PPd: C, 62.01, H, 6.60, N, 0.00; found: C, 61.59, H, 6.49, N, 0.00.

### Example 2-8 1-methylnaphthyl[2-dicyclohexylphosphino-2′,6′-di-i-propoxy-1,1′-biphenyl]chloropalladium(II) (15-Cl)

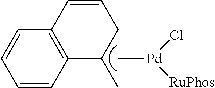

7-Cl (1 eq, 142 mg, 0.25 mmol) was added to a vial, the air was replaced with argon and the vial was transferred to the glove box. 2-dicyclohexylphosphino-2′,6′-di-i-propoxy-1,1′-biphenyl (2 eq, 238 mg, 0.5 mmol, 98%) was then added, followed by 20 ml of THF. The reaction mixture was stirred for 90 min at room temperature. 90% of the solvent was evaporated and 10 ml of pentane was added. The sample was stored overnight at −20° C. to crystallize the product. The mother liquor was decanted and the remaining solid was washed with pentane (3×5 ml) and dried under high vacuum to afford 311 mg (83%) of a yellow solid.

¹H NMR (400 MHz, CD₂Cl₂) δ=7.66-7.84 (m, 3H), 7.45-7.66 (m, 3H), 7.41 (t, J=7.5 Hz, 1H), 7.29-7.37 (m, 1H), 7.16-7.28 (m, 2H), 6.87 (d, J=7.1 Hz, 1H), 6.55 (d, J=8.3 Hz, 2H), 6.00 (t, J=5.8 Hz, 1H), 4.41 (spt, J=12.0 Hz, 2H), 2.99 (br. s., 2H), 1.98 (q, J=10.9 Hz, 2H), 1.69 (br. s., 4H), 1.31-1.59 (m, 7H), 0.66-1.29 (m, 21H) ppm.

¹³C NMR (101 MHz, CD₂Cl₂) δ=157.5, 139.7, 137.6 (two peaks), 135.4, 133.3 (two peaks), 131.9, 131.5, 130.3 (two peaks), 129.4, 129.2, 129.1, 128.8, 128.4 (two peaks), 127.0, 125.5 (two peaks), 124.6, 121.7, 107.0, 100.0 (two peaks), 71.4, 41.3, 34.7 (two peaks), 31.5, 29.4, 27.5 (two peaks), 27.0 (two peaks), 26.4, 22.6, 22.2 ppm.

³¹P NMR (162 MHz, CD₂Cl₂) δ=59.08 (br. s.) ppm.

Elemental analysis calculated for C₄₁H₅₂ClO₂PPd: C, 65.69, H, 6.99, N, 0.00; found: C, 65.73 H, 6.57, N, 0.00.

### Example 2-9 1-methylnaphthyl[bis(1-adamantyl)butyl]bromopalladium(II) (16-Br)

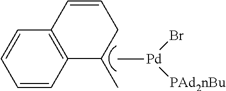

In a glove box filled with nitrogen, 7-Br (1 eq, 82 mg, 0.125 mmol) and butyldi-1-adamantylphosphine (2 eq, 90 mg, 0.25 mmol) were added to a 40 ml crimp-cap vessel. The vial was capped and removed from the glove box. 20 ml of dry and degassed THE were added and the reaction mixture was stirred for 1.5 h at room temperature. 90% of the solvent was removed under high vacuum and 15 ml of hexane were added. The vial was then stored for 16 h at −20° C. The solution was separated from the solid and the remaining solid was washed with pentane (3×5 ml). After drying under high vacuum, 131 mg (76%) of a light yellow solid were obtained.

¹H NMR (400 MHz, C₄OD₈) δ=8.02 (d, J=8.1 Hz, 1H), 7.82 (d, J=7.7 Hz, 1H), 7.66-7.74 (m, 1H), 7.44-7.62 (m, 3H), 6.09-6.21 (m, 1H), 2.47 (br. s, 1H), 2.14-2.34 (m, 3H), 1.83-2.09 (m, 6H), 1.59-1.82 (m, 14H), 1.39-1.58 (m, 7H), 1.08-1.38 (m, 10H) ppm.

¹³C NMR (101 MHz, C₄OD₈) δ=136.11 (s), 132.12 (d, J=4.98 Hz), 130.15 (s), 129.93 (s), 129.12 (d, J=4.98 Hz), 129.04 (s), 127.49 (s), 124.61 (s), 121.41 (s), 99.30 (d, J=19.90 Hz), 37.73 (s), 36.17 (d, J=19.90 Hz), 31.27 (s), 28.51 (d, J=11.61 Hz), 27.43 (s), 26.01 (s, overlap with solvent signal) ppm.

³¹P NMR (162 MHz, C₄OD₈) δ=52.02 ppm.

HRMS (TOF-EI) m/z calculated for C₃₅H₄₇BrPPd [M]⁺ 684.1712, found 684.1729.

### Example 2-10 2-methylnaphthyl[bis(1-adamantyl)butyl]bromopalladium(II) (17-Br)

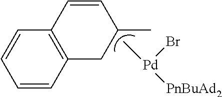

In a glove box filled with nitrogen, 8-Br (1 eq, 164 mg, 0.25 mmol) and butyldi-1-adamantylphosphine (2 eq, 179 mg, 0.5 mmol) were added to a 40 ml crimp-cap vial. The vial was capped and removed from the glove box. 20 ml of dry and degassed THE were added and the reaction mixture was stirred for 1.5 h at room temperature. The solvent was removed under reduced pressure and the remaining solid was washed with small portions of pentane. After drying under high vacuum, 276 mg (78%) of a light yellow solid were obtained.

¹H NMR (400 MHz, C₆D₆) δ=8.06 (d, J=8.1 Hz, 1H), 7.33-7.50 (m, 3H), 7.24 (t, J=7.6 Hz, 1H), 6.80 (d, J=8.8 Hz, 1H), 6.37 (d, J=4.9 Hz, 1H), 3.17-3.72 (m, 1H), 2.37-2.82 (m, 1H), 1.97-2.29 (m, 15H), 1.84 (br. s., 6H), 1.44-1.70 (m, 15H), 0.97 (t, J=7.2 Hz, 3H).

¹³C NMR (101 MHz, CD₂Cl₂) δ=136.66, 133.06 (d, J=1.50 Hz), 130.37 (d, J=2.20 Hz), 128.67 (d, J=2.20 Hz), 127.93 (d, J=1.50 Hz), 127.58 (d, J=2.20 Hz), 124.67, 118.46, 103.37, 103.04, 41.37 (d, J=3.66 Hz), 40.62, 37.76 (d, J=2.93 Hz), 36.97, 35.95, 30.08, 29.31 (d, J=8.80 Hz), 28.36 (d, J=8.80 Hz), 25.82 (d, J=13.91 Hz), 20.82 (d, J=18.30 Hz), 14.22 ppm.

³¹P NMR (162 MHz, C₆D₆) δ=64.44 ppm.

HRMS (TOF-EI) m/z calculated for C₃₅H₄₇PPd [M]⁺ 684.1712, found 684.1740.

### Example 2-11 Preparation of [Pd(cataCXium® A)(allyl)Cl], [(Di(1-adamantyl)-n-butylphosphine)(η³-allyl)chloro]palladium (IX.P)

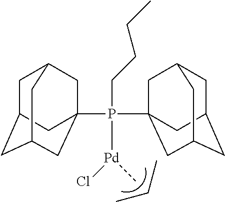

22.5 ml of degassed acetone were initially charged in a three-necked flask inertized with argon and then 1.00 g of [Pd(allyl)Cl]₂, bis(η³-allyl)di(μ-chloro)dipalladium(II), (2.73 mmol, 1.0 eq) and 1.96 g of cataCXium® A, di(1-adamantyl)-n-butylphosphine, (5.47 mmol; 2.0 eq) were added in succession. A whitish solid already precipitated out about a minute after everything was mixed together. The reaction mixture was stirred for 20 hours at room temperature under an inert atmosphere and filtered over a D4 frit the next morning. The isolated solid was washed twice with 7 ml methanol each time in suspension and then dried overnight at room temperature in a vacuum drying cabinet. In this case, it was possible to isolate 2.77 g of whitish product [(di(1-adamantyl)-n-butylphosphine)(η³-allyl)chloro]palladium at a yield of 93.0%. ³¹P{¹H} NMR (101 MHz, toluene): δ=53 ppm.

### Example 2-12 Preparation of [Pd(cataCXium® A)(allyl)Cl], [(Di(1-adamantyl)-n-butylphosphine)(η³-allyl)chloro]palladium (IX.P) using one-pot synthesis

5.15 g of Pd(vs), 1,3-divinyl-1,1,3,3-tetramethyldisiloxanepalladium(0) (1.21 mmol; 1 eq; CAS number: 252062-59-2), and 0.97 g of cataCXium® A, di(1-adamantyl)-n-butylphosphine (2.66 mmol, 2.20 eq) were initially charged in a 50 ml three-necked flask inertized with argon, and the containers used were flushed with 12 ml of acetone thereafter. The resulting suspension was stirred for one hour at room temperature under argon, during which time the color of the mother liquor changed from yellow to light beige to virtually colorless. 0.19 g of allyl chloride (2.42 mmol, 2 eq) were then added and the reaction mixture was stirred overnight at room temperature. A cream-colored suspension formed, which was filtered over an argon-blanketed D4 frit. The filter cake was washed three times in suspension with 5 ml methanol each time and dried overnight at room temperature in a vacuum drying cabinet. It was possible to isolate 1.18 g of cream-colored solid at a yield of 90%.

³¹P{¹H} NMR (101 MHz, toluene): δ=53 ppm.

Silicon content by means of ICP-AES=310 ppm.

### Example 2-13 Preparation of [Pd(cataCXium® A)(allyl)Cl], [(Di(1-adamantyl)-n-butylphosphine)(η³-allyl)chloro]palladium (IX.P) using one-pot synthesis

5.15 g of Pd(vs)c, 1,3-divinyl-1,1,3,3-tetramethyldisiloxanepalladium(0) (1.21 mmol; 1 eq; CAS number: 252062-59-2), and 0.19 g of allyl chloride (2.42 mmol, 2 eq) were initially charged in a 50 ml three-necked flask inertized with argon, and the containers used were flushed with 12 ml of acetone thereafter. The resulting suspension was stirred for one hour at room temperature under argon, during which time a light yellow solid precipitated. Subsequently, 0.97 g of cataCXium® A, di(1-adamantyl)-n-butylphosphine (2.66 mmol, 2.20 eq) was added. After stirring for approximately 10 minutes, a cream-colored solid precipitated. The reaction mixture was stirred overnight at room temperature. A cream-colored suspension formed, which was filtered over an argon-blanketed D4 frit. The filter cake was washed three times in suspension with 5 ml methanol each time and dried overnight at room temperature in a vacuum drying cabinet. It was possible to prepare 0.94 g of creamy-white [(di(1-adamantyl)-n-butylphosphine)(N³-allyl)chloro]palladium at a yield of 85%.

³¹P{¹H} NMR (101 MHz, toluene): δ=53 ppm.

Silicon content by means of ICP-AES=30 ppm.

### Example 2-14 Preparation of [Pd(cataCXium® A)(1-^{t}Bu-Ind)Cl], chloro[(1-tert-butyl-1H-inden-1-yl)(1-adamantyl)n-butylphosphine]palladium

1.15 g of cataCXium® A, di(1-adamantyl)-n-butylphosphine (3.20 mmol; 2.0 eq) were initially charged in a three-necked flask inertized with argon, and 25 ml of acetone were added thereto. 1.00 g of di-μ-chlorobis(1-tert-butyl-1H-inden-1-yl)dipalladium(II) (1.60 mmol; 1.0 eq) were then added, with stirring, and flushing was carried out with 25 ml of acetone. A dark brown suspension was briefly present, which changed color to reddish brown after stirring for about 1 minute. The reaction mixture was boiled at reflux temperature for four hours. In the process, the color changed from red-brown to orange-red. The product suspension was then cooled and the precipitated solid was filtered over a D4 frit, washed twice with 7.5 ml of methanol each time in suspension and dried under vacuum overnight at room temperature. It was possible to isolate 2.03 g of orange-red product chloro[(1-tert-butyl-1H-inden-1-yl)(1-adamantyl)n-butylphosphine]palladium. The yield was 94%.

³¹P{¹H} NMR (101 MHz, CD₂Cl₂): δ=60 ppm.

### Example 2-15 Preparation of [(IPr)Pd(allyl)Cl)], allylchloro[1,3-bis(2,6-diisopropylphenyl)imidazol-2-ylidene]palladium(II) (IX.N) using one-pot synthesis

200 ml of isopropanol were initially charged in a 500 ml reactor inertized with argon. 100 g of Pd(vs), 1,3-divinyl-1,1,3,3-tetramethyldisiloxanepalladium(0) (24.18 mmol; 1 eq; CAS number: 252062-59-2) were added and the container used was flushed with 50 ml of isopropanol. 4.9 g of allyl chloride (98%; 62.75 mmol; 2.60 eq) were then added dropwise within 2 minutes using a dropping funnel. A light yellow, fine solid precipitated. The internal temperature increased slightly from 18.5° C. to 19.7° C. The dropping funnel was flushed with 20 ml of isopropanol and the reaction mixture was stirred for a further hour at room temperature. 23.14 g of IPr*HCl, 1,3-bis(2,6-diisopropylphenyl)imidazolium chloride (53.20 mmol; 2.20 eq) and 2.2 eq of base (for example an alkali metal hydroxide or alkoxide) were then added to the reaction mixture and the containers used were flushed with 30 ml of isopropanol. The mixture was stirred overnight at room temperature under an argon blanket, and a clear orange solution formed after one hour. The next morning, the reaction mixture was concentrated on a rotary evaporator. 55 ml of petroleum ether were added to the resulting suspension and the solid was filtered over a D4 frit in air. The filter cake was washed twice in suspension with 60 ml of petroleum ether 50-70 and dried overnight in a vacuum drying cabinet at room temperature. It was possible to isolate 25.46 g of cream-colored allylchloro[1,3-bis(2,6-diisopropylphenyl)imidazol-2-ylidene]palladium(II) at a yield of 92.1%.

Silicon content by means of ICP-AES=190 ppm.

### C.3 Examples Relating to Catalytic Activity

### 3.1 Test of the Dimeric Allylpalladium Halide Complexes According to General Formula VIII in Suzuki-Miyaura Cross-Coupling Reactions

A. Suzuki-Miyaura Coupling of 3-Chloropyridine with p-Tolylboronic Acid

The Suzuki-Miyaura coupling of 3-chloropyridine with p-tolylboronic acid was chosen as a model reaction to verify the catalytic activity of the allylpalladium precatalysts. This reaction was investigated by Colacot et al. and yields of the coupling product of 91% were found after 30 minutes reaction time with the precatalyst 3-Cl-Xphos (Colacot T. J. et al., Journal of Organic Chemistry, 2015, 80, 6794).

The use of only 0.5 mol % of 3-Cl-Xphos led to yields of 39-62% of the expected biaryl compound (table 1, no. 3). This condition was used to compare different precatalysts. The allylpalladium halide-phosphine complexes were produced in situ—stirring the allylpalladium halide with the phosphine Xphos prior to addition of the reaction partners. The unsubstituted allylpalladium halide was less active than 3-Cl-Xphos (see tables 1 and 2 below). Allylpalladium chlorides (1 Cl) generally resulted in yields of 50-65%, even at catalyst loadings of 1 mol %; (Pd 2 mol %). Allylpalladium bromide (1 Br) was less active than comparable chlorides. Other precatalysts, with the exception of 6-Cl and 6-Br, gave comparable reactivities to L1 with slight differences in chloride and bromide complexes. The Hazari precatalyst was also tested and also showed activity.

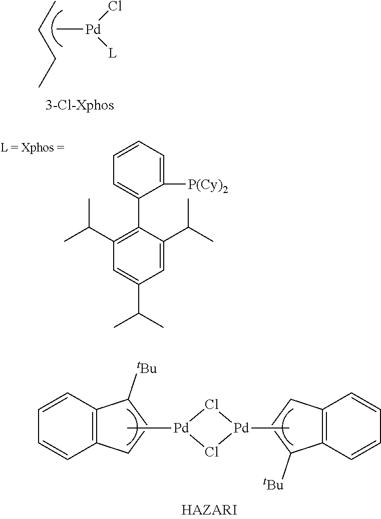

TABLE B-1
Suzuki-Miyaura cross-couplings.

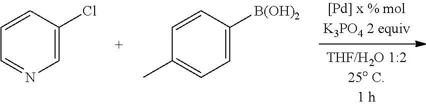

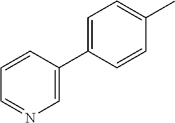

| | | Catalyst | | |
|---|---|---|---|---|
| | | loading | Ligand | |
| No. | Catalyst | [mol %] | [mol %] | Yield [%]^{a)} |
| 1 | 3-Cl-Xphos | 2 | — | 89 |
| 2 | 3-Cl-Xphos | 1 | — | 76^{b)} |
| 3 | 3-Cl-Xphos | 0.5 | — | 60 |
| 4 | 1-Cl | 1 | 2 | 60 |
| 5 | 1-Br | 1 | 2 | 49 |
| 6 | 1-I | 1 | 2 | 0 |
| 7 | 2-Cl | 1 | 2 | 97^{b)} |
| 8 | 2-Cl | 0.25 | 0.5 | 59 |
| 9 | 2-Br | 1 | 2 | 95^{b)} |
| 10 | 2-Br | 0.25 | 0.5 | 60 |
| 11 | 3-Cl | 1 | 2 | 93^{b)} |
| 12 | 3-Cl | 0.25 | 0.5 | 65 |
| 13 | 3-Br | 0.25 | 0.5 | 59 |
| 14 | 4-Cl | 1 | 2 | 91^{b)} |
| 15 | 4-Cl | 0.25 | 0.5 | 63 |
| 16 | 4-Br | 0.25 | 0.5 | 56 |
| 17 | 5-Cl | 0.25 | 0.5 | 65 |
| 18 | 5-Br | 0.25 | 0.5 | 58 |
| 19 | 6-Cl | 0.25 | 0.5 | 55 |
| 20 | 6-Br | 0.25 | 0.5 | 49 |
| 21 | 9-Cl | 0.5 | 0.5 | 55 |

A dried injection vial was charged with the allyl palladium halide dimer (x eq, x mmol) and Xphos (x eq, x mmol) and the air therein was removed by evacuating and flushing with argon three times. 1 ml of dried, degassed THE (tetrahydrofuran) was then added and the mixture was stirred for 30 minutes. 3-chloropyridine (1 eq, 115 mg, 1 mmol) and p-tolylboronic acid (1.5 eq, 204 mg, 1.5 mmol) dissolved in 1 ml of THE were then added, followed by 4 ml of K3P04, 0.5 M solution. Stirring was carried out for 1 hour at 25° C., the yield was determined by gas chromatography (n-tetradecane as internal standard).
a) Yield determined by gas chromatography, average of two measurements, unless otherwise stated.
b) Only one measurement performed.

TABLE B-2
Direct comparison of the new systems with different catalyst
loadings in Suzuki-Miyaura cross-coupling.

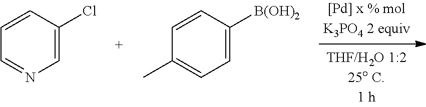

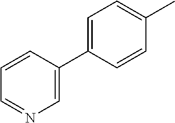

| Catalyst/ | | | |
|---|---|---|---|
| Catalyst | 1 mol % | 0.5 mol % | 0.25 mol % |
| loading | Yield [%]^{a)} | Yield [%]^{a)} | Yield [%]^{a)} |
| 7-Cl | 71 | 49 | 34 |
| 8-Cl | 92 | 79 | 65 |
| 7-Br | 73 | 45 | 34 |
| 8-Br | 92 | 76 | 69 |

^{a)}Yield determined by gas chromatography, average of two measurements, unless otherwise stated.

A dried injection vial was charged with the allyl palladium halide dimer (x eq, x mmol) and Xphos (x eq, x mmol) and the air therein was removed by evacuating and flushing with argon three times. 1 ml of dried, degassed THE (tetrahydrofuran) was then added and the mixture was stirred for 30 minutes. 3-chloropyridine (1 eq, 115 mg, 1 mmol) and p-tolylboronic acid (1.5 eq, 204 mg, 1.5 mmol) dissolved in 1 ml of THE were then added, followed by 4 ml of K3P04, 0.5 M solution. Stirring was carried out for 1 hour at 25° C., and the yield was determined by gas chromatography (n-tetradecane as internal standard, average of two measurements).

### B. Suzuki-Miyaura Cross-Coupling of 4-Chloroanisole and Isopropylboronic Acid

The above palladium-naphthyl catalysts (7-8 Cl/Br) were also tested for activity in Suzuki-Miyaura cross-coupling reactions of 4-chloroanisole and isopropylboronic acid as model compounds. Under the following reaction conditions, catalysts 7-Cl and 7-Br (substitution in the 1-position) were equally reactive and showed higher activity than catalysts 8-Cl and 8-Br (substitution in the 2-position).

TABLE B-3
Use in Suzuki-Miyaura coupling of secondary boronic acids.

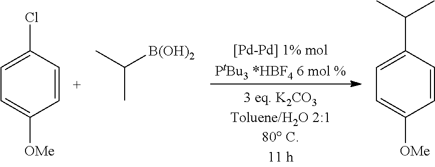

| Entry | Catalyst | Yield [%] |
|---|---|---|
| 1 | 7-Cl | 87 |
| 2 | 7-Br | 89 |
| 3 | 8-Cl | 61 |
| 4 | 8-Br | 65 |

The reactions were carried out analogously to the conditions under B-1 and B₂ above, but on a 0.25 mmol scale, also under an inert gas atmosphere, using 1 equivalent of 4-chloroanisole and 1.5 equivalents of isopropylboronic acid in 0.5 ml of toluene and 0.25 ml of water as solvents. Yields were determined by gas chromatography using n-tetradecane as internal standard, also analogously to B-1 and B-2.

Further examples for Suzuki-Miyaura coupling reactions of secondary boronic acids without catalyst activation

General Procedure:

A vial was filled with the respective catalyst (0.005 mmol, 0.01 eq.), 5.86 mg of PtBu₃*HBF₄ (0.02 mmol, 0.04 eq.), 208 mg of K₂CO₃ (1.5 mmol, 3.0 eq.) and the boronic acid (0.75 mmol, 1.5 eq.), under air. After three alternating vacuum/argon cycles, a solution of the aryl chloride (0.5 mmol, 1.0 eq.) and 30 μl of n-tetradecane in 1 ml of toluene was added with a syringe, followed by 0.5 ml of water. The resulting homogeneous solution was stirred for 11 hours at 80° C. After completion of the reaction, the mixture was diluted with diethyl ether (10 ml) and washed with water (2×10 ml). The combined organic phases were dried over MgSO₄, filtered, and the volatile components were removed at 300 mbar. The residue was purified by flash column chromatography (SiO2, pentane/diethyl ether gradient), giving the desired product.

### a) 4-isopropyltoluene [CAS: 99-87-6]

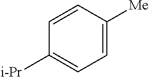 [0937] Catalyst/Pd source: 1 mol % 7-Br
Aryl chloride: 64.6 mg of 4-chlorotoluene
Boronic acid: 65.9 mg of isopropylboronic acid
Yield: 66.0 mg (98%) colorless liquid.

¹H NMR (300 MHz, CDCl₃) δ=7.12-7.24 (m, 4H), 2.94 (spt, J=6.8 Hz, 1H), 2.39 (s, 3H), 1.31 ppm (d, J=6.8 Hz, 6H).

¹³C NMR (75 MHz, CDCl₃) δ=145.9, 135.1, 129.0, 126.3, 33.7, 24.1, 20.9 ppm.

MS (EI) m/z (%) 134.1 (33) [M+], 119.1 (100), 103.0 (5), 91.0 (22), 77.0 (6), 65.0 (5), 57.8 (2).

The NMR data is in agreement with the data in the literature (D.-H. Liu, H.-L. He, Y.-B. Zhang, Z. Li, Chem. Eur. J. 2020, 38, 14322-14329).

### b) 4-isopropylacetophenone [CAS: 645-13-6]

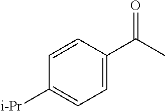 [0946] Catalyst/Pd source: 1 mol % 7-Br
Aryl chloride: 79.7 mg of 4-chloroacetophenone
Boronic acid: 65.9 mg of isopropylboronic acid
Yield: 68.2 mg (84%) colorless liquid.

¹H NMR (300 MHz, CDCl₃) δ=7.89 (d, J=8.8 Hz, 1H), 7.30 (d, J=6.6 Hz, 2H), 2.95 (spt, J=6.9 Hz, 1H), 2.51-2.59 (m, 3H), 1.26 ppm (d, J=7.0 Hz, 6H).

¹³C NMR (75 MHz, CDCl₃) δ=197.5, 154.3, 134.8, 128.4, 126.4, 34.0, 26.3, 23.4 ppm.

HRMS (TOF-EI) m/z calculated for C₁₁H₁₄O 162.1045 [M]⁺; found 162.1041.

The NMR data is in agreement with the data in the literature (Z.-L. Shen, K. K. K. Goh, Y.-S. Yang, Y.-C. Lai, C. H. A. Wong, H.-L. Cheong, T.-P. Loh, Angew. Chem. Int. Ed. 2011, 50, 511-514).

### c) Ethyl-4-isopropylbenzoate [CAS: 19024-50-1]

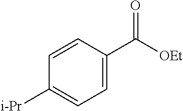 [SMILES: CCOC(=O)c1ccc(C(C)C)cc1] [0955] Catalyst/Pd source: 1 mol % 7-Br
Aryl chloride: 94.2 mg of ethyl-4-chlorobenzoate
Boronic acid: 65.9 mg of isopropylboronic acid
Yield: 74.6 mg (78%) colorless liquid.

¹H NMR (300 MHz, CDCl₃) δ=7.98 (d, J=8.4 Hz, 2H), 7.29 (d, J=8.4 Hz, 2H), 4.38 (q, J=7.3 Hz, 2H), 2.97 (spt, J=7.0 Hz, 1H), 1.40 (d, J=7.3 Hz, 3H), 1.27 ppm (d, J=6.9 Hz, 6H).

¹³C NMR (75 MHz, CDCl₃) δ=166.7, 154.2, 129.7, 128.1, 126.4, 60.7, 34.2, 23.7, 14.3 ppm.

MS (EI) m/z (%) 192.1 (46) [M+], 177.1 (99), 164.1 (22), 147.1 (100),131.0. (14), 119.1 (50), 105.0 (27).

The NMR data is in agreement with the data in the literature (G. Cahiez, L. Foulgoc, A. Moyeux, Angewandte Chemie International Edition 2009, 48, 2969-2972).

### d) 4-isopropylnitrobenzene [CAS: 1817-47-6]

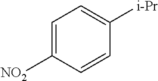 [SMILES: CC(C)c1ccc([N+](=O)[O-])cc1] [0964] Catalyst/Pd source: 1 mol % 7-Br
Aryl chloride: 72.7 mg of 4-chloroanisole
Boronic acid: 65.9 mg of isopropylboronic acid
Yield: 66.8 mg (88%) colorless liquid.

¹H NMR (300 MHz, CDCl₃) δ=8.14 (d, J=8.1 Hz, 2H), 7.37 (d, J=8.1 Hz, 2H), 3.01 (spt, J=6.8 Hz, 1H), 1.29 ppm (d, J=6.8 Hz, 6H).

¹³C NMR (75 MHz, CDCl₃) δ=156.5, 146.2, 127.2, 123.6, 34.2, 23.5 ppm.

HRMS (TOF-EI) m/z calculated for C₉H₁₂NO₂ 166.0868 [M+H]⁺, found 166.0862.

The NMR data is in agreement with the data in the literature (C. Han, S. L. Buchwald, J. Am. Chem. Soc. 2009, 131, 7532-7533).

### e) 4-isopropyl-N,N-dimethylaniline [CAS: 4139-78-0]

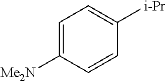 [SMILES: CC(C)c1ccc(N(C)C)cc1] [0973] Catalyst/Pd source: 1 mol % 7-Br
Aryl chloride: 79.4 mg of 4-chloroaniline
Boronic acid: 65.9 mg of isopropylboronic acid
Yield: 73.2 mg (82%) brown liquid.

¹H NMR (300 MHz, CDCl₃) δ=7.89 (d, J=8.8 Hz, 2H), 7.30 (d, J=6.6 Hz, 2H), 2.95 (spt, J=6.9 Hz, 1H), 2.55 (s, 3H), 1.26 ppm (d, J=7.0 Hz, 6H).

¹³C NMR (75 MHz, CDCl₃) δ=149.0, 137.3, 127.0, 113.0, 41.0, 33.1, 24.2 ppm.

MS (EI) m/z (%) 163.1 (30) [M+], 148.1 (100), 133.1 (8), 120.1 (5),104.0. (4), 91.0 (4), 77.0 (5).

The NMR data is in agreement with the data in the literature (S. Kanemura, A. Kondoh, H. Yorimitsu, K. Oshima, Synthesis 2008, 2008, 2659-2664).

### f) 4-isopropylphenyl-1H-pyrrole [CAS: 166963-93-5]

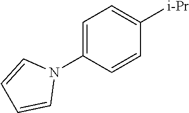 [SMILES: CC(C)c1ccc(-n2cccc2)cc1] [0982] Catalyst/Pd source: 1 mol % 7-Br
Aryl chloride: 91.6 mg of 1-(4-chlorophenyl)-1H-pyrrole
Boronic acid: 65.9 mg of isopropylboronic acid
Yield: 82.4 mg (89%) colorless liquid.

¹H NMR (300 MHz, CDCl₃) δ=7.19-7.24 (m, 4H), 7.00 (t, J=2.2 Hz, 2H), 6.27 (t, J=2.2 Hz, 2H), 2.87 (spt, J=6.9 Hz, 1H), 1.21 ppm (d, J=6.9 Hz, 6H).

¹³C NMR (75 MHz, CDCl₃) δ=146.4, 138.7, 127.5, 120.7, 119.5, 110.0, 33.6, 24.1 ppm.

MS (EI) m/z (%) 185.1 (62) [M+], 170.0 (100), 153.0 (8), 143.1 (8),128.0. (10), 115.0 (10), 103.0 (3).

The NMR data is in agreement with the data in the literature (L. Li, S. Zhao, A. Joshi-Pangu, M. Diane, M. R. Biscoe, J. Am. Chem. Soc. 2014, 136, 14027-14030).

### g) 4-isopropyltrifluorotoluene [CAS: 32445-99-1]

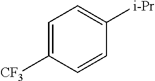 [SMILES: CC(C)c1ccc(C(F)(F)F)cc1] [0991] Catalyst/Pd source: 1 mol % 7-Br
Aryl chloride: 90.3 mg of 4-chlorotrifluorotoluene
Boronic acid: 65.9 mg of isopropylboronic acid
Yield: 92.4 mg (98%) yellow liquid.

¹H NMR (300 MHz, CDCl₃) δ=7.60 (d, J=8.1 Hz, 2H), 7.37 (dd, J=8.1, 0.5 Hz, 2H), 3.01 (spt, J=7.0 Hz, 1H), 1.32 ppm (d, J=6.8 Hz, 6H).

¹³C NMR (75 MHz, CDCl₃) δ=152.8, 129.0, 128.2, 126.7, 125.2 (q, J=3.9 Hz), 124.2 (q, J=270.1 Hz), 34.1, 23.7 ppm; ¹⁹F NMR (235 MHz, CDCl₃): δ=−62.2 ppm.

MS (EI) m/z (%) 188.1 (44) [M+], 173.1 (100), 169.1 (11), 159.0 (6),153.0 (24), 133.0 (34), 127.0 (11).

The NMR data is in agreement with the data in the literature (S. Mizuta, I. S. R. Stenhagen, M. O'Duill, J. Wolstenhulme, A. K. Kirjavainen, S. J. Forsback, M. Tredwell, G. Sandford, P. R. Moore, M. Huiban, S. K. Luthra, J. Passchier, O. Solin, V. Gouverneur, Org. Lett. 2013, 15, 2648-2651).

### h) 3-isopropylanisole [CAS: 6380-20-7]

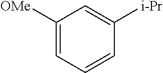 [SMILES: COc1cccc(C(C)C)c1] [1000] Catalyst/Pd source: 1 mol % 7-Br
Aryl chloride: 72.8 mg of 3-chloroanisole
Boronic acid: 65.9 mg of isopropylboronic acid
Yield: 72.0 mg (96%) colorless liquid.

¹H NMR (300 MHz, CDCl₃) δ=7.23 (t, J=7.8 Hz, 1H), 6.71-6.88 (m, 3H), 3.82 (s, 3H), 2.90 (spt, J=6.8 Hz, 1H), 1.26 ppm (d, J=6.8 Hz, 6H).

¹³C NMR (75 MHz, CDCl₃) δ=159.6, 150.6, 129.2, 118.9, 112.4, 110.7, 55.1, 34.2, 23.9 ppm.

MS (EI) m/z (%) 188.1 (44) [M+], 173.1 (100), 169.1 (11), 159.0 (6),153.0 (24), 133.0 (34), 127.0 (11).

The NMR data is in agreement with the data in the literature (A. Joshi-Pangu, M. Ganesh, MR Biscoe, Org. Lett. 2011, 13, 1218-1221).

### i) Fluoro-3-isopropyltoluene[CAS: 2193-38-6]

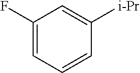 [1009] Catalyst/Pd source: 1 mol % 7-Br
Aryl chloride: 65.9 mg of 1-chloro-3-fluorobenzene
Boronic acid: 65.9 mg of isopropylboronic acid
Yield: 67.4 mg (98%) colorless liquid.

¹H NMR (300 MHz, CDCl₃) δ=7.04-7.14 (m, 1H), 6.98 (d, J=7.7 Hz, 1H), 6.80-6.95 (m, 2H), 2.88 (spt, J=7.0 Hz, 1H), 1.22 ppm (d, J=7.0 Hz, 6H).

¹³C NMR (75 MHz, CDCl₃) δ=164.5 (d, J=244.4 Hz), 137.8, 129.6 (d, J=8.3 Hz), 124.5 (d, J=3.3 Hz), 116.3 (d, J=24.4 Hz), 112.5 (d, J=21.0 Hz), 33.9, 23.8 ppm.

¹⁹F-NMR (235 MHz, CDCl₃) δ=−113.7 ppm.

MS (EI) m/z (%) 138.1 (38) [M+], 123.0 (100), 109.0 (8), 103.0 (41), 96.0 (7), 83.0 (3), 77.0 (8).

The NMR data is in agreement with the data in the literature (T. Krüger, K. Vorndran, T. Linker, Chem. Eur. J. 2009, 15, 12082-12091).

### j) Cumene [CAS: 98-82-8]

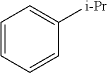 [1019] Catalyst/Pd source: 1 mol % 7-Br
Aryl chloride: 56.6 mg of chlorobenzene
Boronic acid: 65.9 mg of isopropylboronic acid
Yield: 57.2 mg (95%) colorless liquid.

¹H NMR (300 MHz, CDCl₃) δ=7.19-7.37 (m, 5H), 2.94 (d, J=7.0 Hz, 1H), 1.29 ppm (d, J=7.1 Hz, 6H).

¹³C NMR (75 MHz, CDCl₃) δ=148.8, 128.3, 126.4, 125.7, 34.1, 24.0 ppm.

HRMS (TOF-EI) m/z calculated for C₉H₁₂ 119.0859 [M−H]⁺; found 119.0857.

The NMR data is in agreement with the data in the literature (G. Cahiez, L. Foulgoc, A. Moyeux, Angewandte Chemie International Edition 2009, 48, 2969-2972).

### k) 2-isopropyltoluene [CAS: 527-84-4]

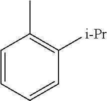 [1028] Catalyst/Pd source: 1 mol % 7-Br
Aryl chloride: 64.6 mg of 4-chlorotoluene
Boronic acid: 65.9 mg of isopropylboronic acid
Yield: 64.2 mg (96%) colorless liquid.

¹H NMR (300 MHz, CDCl₃) δ=7.05-7.26 (m, 4H), 3.15 (spt, J=6.9 Hz, 1H), 2.35 (s, 3H), 1.24 ppm (d, J=7.0 Hz, 6H).

¹³C NMR (75 MHz, CDCl₃) δ=146.8, 134.9, 130.2, 126.2, 125.5, 124.6, 29.2, 23.2, 19.3 ppm.

MS (EI) m/z (%) 134.1 (32) [M+], 119.0 (100), 103.0 (4), 93.1 (2), 91.0 (20), 77.0 (6), 65.0 (5).

The NMR data is in agreement with the data in the literature (T. Krüger, K. Vorndran, T. Linker, Chem. Eur. J. 2009, 15, 12082-12091).

### l) Fluoro-2-isopropylbenzene [CAS: 2022-67-5]

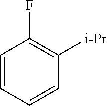 [1037] Catalyst/Pd source: 1 mol % 7-Br
Aryl chloride: 65.2 mg of chloro-2-fluorobenzene
Boronic acid: 65.9 mg of isopropylboronic acid
Yield: 67.8 mg (98%) yellow liquid.

¹H NMR (300 MHz, CDCl₃) δ=6.86-7.19 (m, 4H), 3.08-3.23 (spt, J=7.0 Hz, 1H), 1.17 ppm (d, J=7.0 Hz, 6H).

¹³C NMR (75 MHz, CDCl₃) δ=60.7 (d, J=245.5 Hz), 135.3 (d, J=14.4 Hz), 127.1 (m), 124.0 (d, J=3.9 Hz), 115.2 (d, J=23.2 Hz), 27.1(d, J=2.2 Hz), 22.6 ppm.

¹⁹F-NMR (235 MHz, CDCl₃) δ=−119.3 ppm.

IR (ATR): \tilde{v}=2965 (w), 2932 (vw), 2872 (vw), 1580(w), 1490 (m), 1454 (w), 1230 (m), 1185 (w), 1085 (w), 1025 (w), 893 (w), 819 (m), 751 (s), 747 (w), 650 (vw), 614 (w), 542 cm⁻¹ (w).

HRMS (TOF-EI) m/z calculated for C₁₀H₁₄O 124.0688 [M−Me]⁺, found 124.0648.
m) Isopropyl-3,5-dimethoxybenzene [CAS: 73109-76-9]

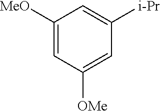 [SMILES: COc1cc(OC)cc(C(C)C)c1]

Catalyst/Pd source: 1 mol % 7-Br
Aryl chloride: 89.0 mg of 4-chloroanisole
Boronic acid: 65.9 mg of isopropylboronic acid
Yield: 81.4 mg (90%) colorless liquid.

¹H NMR (300 MHz, CDCl₃) δ=6.42 (dd, J=2.4, 0.4 Hz, 2H), 6.32 (t, J=2.2 Hz, 1H), 3.81 (s, 6H), 2.86 (spt, J=6.8 Hz, 1H), 1.26 ppm (d, J=6.8 Hz, 6H).

¹³C NMR (75 MHz, CDCl₃) δ=160.7, 151.5, 104.6, 97.4, 55.2, 34.4, 23.9 ppm.

MS (EI) m/z (%) 180.1 (77) [M+], 165.1 (100), 152.1 (48), 135.1 (7), 121.0 (7), 105.0 (16), 91.0 (13).

The NMR data is in agreement with the data in the literature (I. Y. EI-Deeb, T. Funakoshi, Y. Shimomoto, R. Matsubara, M. Hayashi, J. Org. Chem. 2017, 82, 2630-2640).

### n) Isopropyl-2,6-dimethylbenzene [CAS: 14411-75-7]

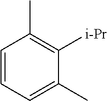 [1056] Catalyst/Pd source: 1 mol % 7-Br
Aryl chloride: 71.8 mg of 2-chloro-m-xylene
Boronic acid: 65.9 mg of isopropylboronic acid
Yield: 68.6 mg (93%) colorless liquid.

¹H NMR (300 MHz, CDCl₃) δ=6.88 (m, 3H), 3.35 (spt, J=7.0 Hz, 1H), 2.30 (s, 6H), 1.25 ppm (d, J=7.0 Hz, 6H).

¹³C NMR (75 MHz, CDCl₃) δ=144.1, 136.1, 128.0, 125.4, 29.5, 21.5, 20.8 ppm.

MS (EI) m/z (%) 148.1 (24) [M+], 133.1 (2), 119.1 (100), 115.0 (5), 103.0 (3), 91.0 (10), 77.0 (5).

The NMR data is in agreement with the data in the literature (T. Si, B. Li, W. Xiong, B. Xu, W. Tang, Org. Biomol. Chem. 2017, 15, 9903-9909).

### o) 5-isopropyl-3-methyl[b]benzothiophene [CAS: 18272-84-9]

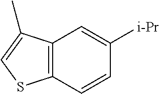 [1065] Catalyst/Pd source: 1 mol % 7-Br
Aryl chloride: 94.2 mg of 5-isopropyl-3-methylbenzo[b]thiophene
Boronic acid: 65.9 mg of isopropylboronic acid
Yield: 76.4 mg (80%) white solid.

¹H NMR (300 MHz, CDCl₃) δ=7.79 (d, J=8.3 Hz, 1H), 7.58 (s, 1H), 7.28 (dd, J=8.3, 1.2 Hz, 1H), 7.07 (s, 1H), 3.09 (spt, J=6.8 Hz, 1H), 2.47 (d, J=1.1 Hz, 3H), 1.36 ppm (d, J=6.8 Hz, 6H).

¹³C NMR (75 MHz, CDCl₃) δ=145.3, 140.2, 138.2, 132.4, 123.8, 122.9, 122.0, 119.4, 34.7, 24.8, 14.3 ppm.

HRMS (TOF-EI) m/z calculated for C₁₂H₁₄S 190.0816 [M]⁺; found 190.0807.

The NMR data is in agreement with the data in the literature (L. Li, S. Zhao, A. Joshi-Pangu, M. Diane, M. R. Biscoe, J. Am. Chem. Soc. 2014, 136, 14027-14030).

### p) 4-butylanisole [CAS: 18272-84-9]

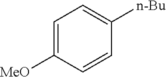 [1074] Catalyst/Pd source: 1 mol % 7-Br
Aryl chloride: 72.7 mg of 4-chloroanisole
Boronic acid: 79.6 mg of n-butylboronic acid
Yield: 63.7 mg (78%) colorless liquid.

¹H NMR (300 MHz, CDCl₃) δ=7.14 (d, J=7.8 Hz, 2H), 6.87 (d, J=7.8 Hz, 2H), 3.82 (s, 3H), 2.59 (t, J=7.8 Hz, 2H), 1.61 (dt, J=7.8, 7.3 Hz, 2H), 1.39 (dq, J=7.8, 7.3 Hz, 2H), 0.96 ppm (t, J=7.3 Hz, 3H).

¹³C NMR (75 MHz, CDCl₃) δ=157.6, 135.0, 129.2, 113.6, 55.2, 34,7, 33.9, 22.3, 14.0 ppm.

MS (EI) m/z (%) 164.1 (19) [M+], 121.1 (100), 103.0 (1), 91.0 (6), 77.0 (6), 65.0 (3).

The NMR data is in agreement with the data in the literature (G. Cahiez, L. Foulgoc, A. Moyeux, Angewandte Chemie International Edition 2009, 48, 2969-2972).

### q) 4-isobutylanisole [CAS: 91967-52-1]

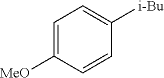 [1083] Catalyst/Pd source: 1 mol % 7-Br
Aryl chloride: 72.7 mg of 4-chloroanisole
Boronic acid: 80.5 mg of isobutylboronic acid
Yield: 67.3 mg (82%) colorless liquid.

¹H NMR (300 MHz, CDCl₃) δ=7.07 (d, J=8.6 Hz, 2H), 6.84 (d, J=8.6 Hz, 2H), 3.80 (s, 3H), 2.43 (d, J=7.2 Hz, 2H), 1.82 (spt, J=6.8 Hz, 1H), 0.91 ppm (s, 6H).

¹³C NMR (75 MHz, CDCl₃) δ=157.6, 133.8, 130.0, 113.5, 55.2, 44.5, 30.4, 22.7 ppm.

MS (EI) m/z (%) 164.1 (25) [M+], 149.1 (1), 121.1 (100), 115.0 (2), 91.0 (6), 77.0 (7), 65.0 (2).

The NMR data is in agreement with the data in the literature (S. D. Dreher, S.-E. Lim, D. L. Sandrock, G. A. Molander, J. Org. Chem. 2009, 74, 3626-3631).

### r) 4-sec-butylanisole [CAS: 4917-90-2]

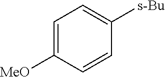 [1092] Catalyst/Pd source: 1 mol % 7-Br
Aryl chloride: 72.7 mg of 4-chloroanisole
Boronic acid: 76.5 mg of sec-butylboronic acid
Yield: 64.5 mg (79%) colorless liquid.

¹H NMR (300 MHz, CDCl₃) δ=7.11 (d, J=7.8 Hz, 2H), 6.86 (d, J=7.8 Hz, 2H), 3.81 (s, 3H), 2.51-2.66 (m, 1H), 1.54-1.63 (m, 2H), 1.23 (d, J=7.3 Hz, 3H), 0.83 ppm (t, J=7.3 Hz, 3H).

¹³C NMR (75 MHz, CDCl₃) δ=157.6, 139.8, 127.8, 113.6, 65.8, 55.2, 40.8, 31.3, 22.0, 12.2 ppm.

MS (EI) m/z (%) 164.1 (21) [M+], 149.1 (5), 135.1 (100), 121.0 (9), 105.0 (13), 91.0 (10), 77.0 (6).

The NMR data is in agreement with the data in the literature (L. Li, S. Zhao, A. Joshi-Pangu, M. Diane, M. R. Biscoe, J. Am. Chem. Soc. 2014, 136, 14027-14030).

### s) 4-octylanisole [CAS: 3307-19-5]

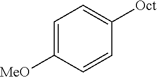 [1101] Catalyst/Pd source: 1 mol % 7-Br
Aryl chloride: 72.7 mg of 4-chloroanisole
Boronic acid: 119 mg of octylboronic acid
Yield: 90.2 mg (82%) colorless liquid.

¹H NMR (300 MHz, CDCl₃) δ=7.15 (d, J=8.7 Hz, 2H), 6.73 (d, J=8.7 Hz, 2H), 3.68 (s, 3H), 2.38-2.53 (m, 2H), 1.48 (quin, J=7.8 Hz, 2H), 1.10-1.34 (m, 10H), 0.79 ppm (t, J=6.9 Hz, 3H).

¹³C NMR (75 MHz, CDCl₃) δ=157.6, 135.0, 129.3, 113.6, 55.4, 35.0, 31.9, 31.7, 29.5, 29.3, 22.6, 14.1 ppm.

MS (EI) m/z (%) 220.2 (13) [M+], 121.0 (100), 91.0 (4), 77.0 (4).

The NMR data is in agreement with the data in the literature (G. Cahiez, C. Chaboche, C. Duplais, A. Moyeux, Org. Lett. 2009, 11, 277-280).

### t) 4-cyclopropylanisole [CAS:4030-17-5]

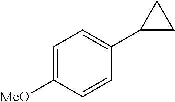 [SMILES: COc1ccc(C2CC2)cc1] [1110] Catalyst/Pd source: 1 mol % 7-Br
Aryl chloride: 72.7 mg of 4-chloroanisole
Boronic acid: 67.1 mg of cyclopropylboronic acid
Yield: 71.8 mg (97%) colorless liquid.

¹H NMR (300 MHz, CDCl₃) δ=7.00-7.10 (m, 2H), 6.79-6.89 (m, 2H), 3.81 (s, 3H), 1.79-1.99 (m, 1H), 0.89-0.97 (m, 2H), 0.57-0.71 ppm (m, 2H).

¹³C NMR (75 MHz, CDCl₃) δ=157.5, 135.8, 126.8, 113.7, 55.2, 14.6, 8.5 ppm.

MS (EI) m/z (%) 148.1 (100) [M+], 133.0 (26), 117.1 (38), 105.0 (22), 91.0 (19), 77.0 (27), 63.0 (6).

The NMR data is in agreement with the data in the literature (G. A. Molander, P. E. Gormisky, J. Org. Chem. 2008, 73, 7481-7485).

### u) 4-cyclobutylanisole [CAS:39868-68-3]

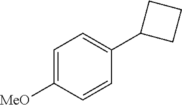 [SMILES: COc1ccc(C2CCC2)cc1] [1119] Catalyst/Pd source: 1 mol % 7-Br
Aryl chloride: 72.7 mg of 4-chloroanisole
Boronic acid: 78.9 mg of cyclobutylboronic acid
Yield: 62.1 mg (77%) pale yellow solid.

¹H NMR (300 MHz, CDCl₃) δ=7.07 (d, J=8.3 Hz, 2H), 6.76 (d, J=8.3 Hz, 2H), 3.72-3.74 (m, 1H), 3.71 (s, 3H), 2.18-2.30 (m, 2H), 1.96-2.08 (m, 2H), 1.80-1.94 (m, 1H), 1.72-1.77 ppm (m, 1H).

¹³C NMR (75 MHz, CDCl₃) δ=157.7, 127.2, 113.6, 55.3, 39.8, 30.1, 18.2 ppm.

MS (EI) m/z (%) 162.1 (19) [M+], 134.0 (100), 131.1 (2), 119.0 (23), 115.0 (2), 91.0 (15), 77.0 (4).

The NMR data is in agreement with the data in the literature (P. C. Too, G. H. Chan, Y. L. Tnay, H. Hirao, S. Chiba, Angew. Chem. Int. Ed. 2016, 55, 3719-3723).

### v) 4-cyclopentylanisole [CAS:1507-97-7]

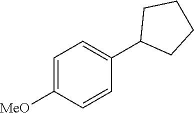 [SMILES: COc1ccc(C2CCCC2)cc1] [1128] Catalyst/Pd source: 1 mol % 7-Br
Aryl chloride: 72.7 mg of 4-chloroanisole
Boronic acid: 88.1 mg of cyclopentylboronic acid
Yield: 57.3 mg (65%) colorless liquid.

¹H NMR (300 MHz, CDCl₃) δ=7.02 (d, J=8.0 Hz, 2H), 6.69 (d, J=7.7 Hz, 2H), 3.63 (s, 3H), 2.71-2.88 (m, 1H), 1.82-1.99 (m, 2H), 1.32-1.71 ppm (m, 6H).

¹³C NMR (75 MHz, CDCl₃) δ=157.6, 138.4, 127.8, 113.5, 55.1, 45.1, 34.6, 25.3 ppm.

MS (EI) m/z (%) 176.1 (59) [M+], 161.1 (6), 147.1 (100), 134.0 (29), 129.0 (29), 121.0 (33), 115.0 (9).

The NMR data is in agreement with the data in the literature (S. D. Dreher, P. G. Dormer, D. L. Sandrock, G. A. Molander, J. Am. Chem. Soc. 2008, 130, 9257-9259).

### w) 4-cyclohexylanisole [CAS:613-36-5]

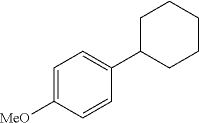 [SMILES: COc1ccc(C2CCCCC2)cc1] [1137] Catalyst/Pd source: 1 mol % 7-Br
Aryl chloride: 72.7 mg of 4-chloroanisole
Boronic acid: 99.0 mg of cyclohexylboronic acid
Yield: 75.6 mg (80%) pale yellow crystals.

¹H NMR (300 MHz, CDCl₃) δ=7.17 (d, J=8.4 Hz, 2H), 6.88 (d, J=8.4 Hz, 2H), 3.82 (s, 3H), 2.43-2.56 (m, 1H), 1.84-1.93 (m, 4H), 1.74-1.82 (m, 1H), 1.38-1.51 (m, 4H), 1.18-1.37 ppm (m, 1H).

¹³C NMR (75 MHz, CDCl₃) δ=157.6, 140.3, 127.6, 113.6, 55.2, 43.7, 34.7, 26.9, 26.2 ppm.

MS (EI) m/z (%) 190.1 (70) [M+], 147.1 (100), 134.0 (22), 121.0 (40), 115.0 (7), 91.0 (18), 77.0 (6).

The NMR data is in agreement with the data in the literature (P. C. Too, G. H. Chan, Y. L. Tnay, H. Hirao, S. Chiba, Angew. Chem. Int. Ed. 2016, 55, 3719-3723).

### C. Suzuki-Miyaura Cross-Coupling of Sterically Hindered Substrates

The above-mentioned palladium-naphthyl catalysts (7-8 Cl/Br) were also tested for activity in room-temperature Suzuki-Miyaura couplings of aryl chlorides which lead to the formation of extremely sterically shielded tetra-ortho-substituted compounds.

### General Procedure for Suzuki-Miyaura Cross-Coupling of Sterically Hindered Substrates

A vial was filled with the respective catalyst (0.005 mol, 0.01 eq.) in the absence of air and transferred to the glove box. 4.72 mg of the ligand IPr*OMe, (0.01 mmol, 0.02 eq. CAS: 1416368-06-3), 66 mg of KOH (1.0 mmol, 2.0 eq.) and the boronic acid (0.75 mmol, 1.5 eq.) were weighed out and the vial was sealed. A solution of the aryl chloride (0.5 mmol, 1.0 eq.) and 30 μl of n-tetradecane in 2 ml of THE was added using a syringe. The resulting homogeneous solution was stirred for 12 hours at room temperature. After completion of the reaction, the mixture was diluted with EtOAc (10 ml) and washed with water (2×10 ml). The combined organic phases were dried over MgSO₄, filtered, and the volatile components were removed under reduced pressure. The residue was purified by flash column chromatography (SiO2, cyclohexane), giving the corresponding biphenyl.

The coupling of 2-chloro-m-xylene with 2,4,6-trimethylphenylboronic acid was chosen as model reaction. The various Pd sources were investigated under the conditions described by Nolan (A. Chartoire, M. Lesieur, L. Falivene, A. M. Z. Slawin, L. Cavallo, C. S. J. Cazin, S. P. Nolan, Chem. Eur. J. 2012, 18, 4517-4521; G. Bastug, S. P. Nolan, Organometallics 2014, 33, 1253-1258). Nolan's protocol is based on the electron-rich, highly sterically demanding NHC ligand IPr*OMe in combination with [Pd(cinnamyl)Cl]2 and has achieved record highs in this regard. The only adjustment made here to Nolan's protocol was the use of THE instead of DME (1,2-dimethoxyethane) as solvent, due to the low solubility of the dimeric palladium-naphthyl catalysts in DME.

### Model Reaction Preparation of 2,2′,4,6,6′-pentamethylbiphenyl [CAS: 76411-12-6]

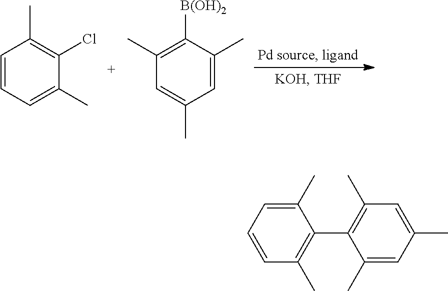 [1149] Catalyst/Pd source: 0.5 mol % 7-Cl or 7-Br or 8-Cl or 8-Br or 0.5 mol %
[Pd(cinnamyl)Cl]₂*
Aryl chloride: 71.7 mg of 2-chloro-m-xylene
Boronic acid: 123.0 mg of 2,4,6-trimethylboronic acid
* for comparative purposes

TABLE B-4
Use in the Suzuki-Miyaura coupling of sterically hindered
substrates using the example of the preparation of 2,2′,4,6,6′-
pentamethylbiphenyl

| Entry | Catalyst | Yield [%]^{a)} |
|---|---|---|
| 1 | 7-Cl | >99 |
| 2 | 7-Br | >99 |
| 3 | 8-Cl | >99 |
| 4 | 8-Br | >99 |

^{a)}Yields determined by GC analysis with n-tetradecane as internal standard

With all four palladium-naphthyl catalysts (7-8 Cl/Br) in combination with the NHC ligand IPr*OMe, the desired product was formed in a quantitative yield within 12 h at room temperature under the reaction conditions given above. In comparison, the use of [Pd(cinnamyl)Cl]2 and the NHC ligand IPr*OMe, with DME chosen as the solvent, led to a 95% yield of the expected biaryl compound after a reaction time of 22 hours at room temperature. Consequently, the four palladium-naphthyl catalysts (7-8 Cl/Br) performed well compared to the catalyst precursor described by Nolan.

Analytical data from 2,2′,4,6,6′-pentamethylbiphenyl prepared using 7-Br:

¹H NMR (300 MHz, CDCl₃) δ=7.08-7.22 (m, 3H), 6.99 (s, 2H), 2.38 (s, 3H), 1.94 (s, 6H), 1.90 ppm (s, 6H).

¹³C NMR (75 MHz, CDCl₃) δ=140.0, 136.9, 136.1, 135.7, 135.2, 128.2, 127.3, 126.7, 21.1, 19.9, 19.7 ppm.

MS (EI) m/z (%) 224.1 (70) [M+], 209.1 (100), 194.0 (39), 188.9 (7), 179.0 (34), 165.0 (12), 152.9 (6).

The NMR data is in agreement with the data in the literature (A. Chartoire, M. Lesieur, L. Falivene, A. M. Z. Slawin, L. Cavallo, C. S. J. Cazin, S. P. Nolan, Chem. Eur. J. 2012, 18, 4517-4521).

Further examples for Suzuki-Miyaura cross-coupling of sterically hindered substrates

### a) 2,6-dimethoxy-2′,4′,6′-trimethylbiphenyl [CAS: 471290-69-4]

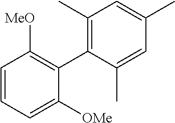 [SMILES: COc1cccc(OC)c1-c1c(C)cc(C)cc1C] [1162] Catalyst/Pd source: 0.5 mol % 7-Br
Aryl chloride: 88.1 mg of 2-chloro-1,3-dimethoxybenzene
Boronic acid: 123.0 mg of 2,4,6-trimethylboronic acid
Yield: 126 mg (97%) off-white solid.

¹H NMR (300 MHz, CDCl₃) δ=7.28-7.36 (m, 1H), 6.91-6.99 (s, 2H), 6.62-6.71 (m, 2H), 3.70-3.77 (s, 6H), 2.31-2.37 (s, 3H), 1.94-2.02 ppm (s, 6H).

¹³C NMR (75 MHz, CDCl₃) δ=157.7, 136.9, 136.3, 130.9, 135.2, 128.5, 127.9, 117.7, 103.9, 55.8, 21.3, 20.3 ppm.

MS (EI) m/z (%) 224.1 (70) [M+], 209.1 (100), 194.0 (39), 188.9 (7), 179.0 (34), 165.0 (12), 152.9 (6).

The NMR data is in agreement with the data in the literature (A. Chartoire, M. Lesieur, L. Falivene, A. M. Z. Slawin, L. Cavallo, C. S. J. Cazin, S. P. Nolan, Chem. Eur. J. 2012, 18, 4517-4521).

### b) 1-(2,6-dimethylphenyl)naphthalene [CAS: 471290-69-4]

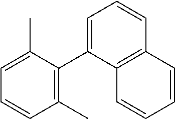 [SMILES: Cc1cccc(C)c1-c1cccc2ccccc12] [1171] Catalyst/Pd source: 0.5 mol % 7-Br
Aryl chloride: 71.7 mg of 2-chloro-m-xylene
Boronic acid: 136.0 mg of 1-naphthylboronic acid
Yield: 114 mg (98%) off-white solid.

¹H NMR (300 MHz, CDCl₃) δ=7.75-7.86 (m, 2H), 7.35-7.51 (m, 2H), 7.08-7.28 (m, 6H), 1.83 ppm (s, 6H).

¹³C NMR (75 MHz, CDCl₃) δ=139.6, 138.7, 137.0, 133.7, 131.7, 128.3, 127.3, 127.2, 126.4, 126.0, 125.8, 125.7, 125.4, 20.4 ppm.

MS (EI) m/z (%) 232.1 (100) [M+], 226.1 (4), 217.1 (89), 202.1 (30), 189.1 (7), 176.0 (2), 165.1 (3).

The NMR data is in agreement with the data in the literature (B. H. Lipshutz, T. B. Petersen, A. R. Abela, Org. Lett. 2008, 10, 1333-1336).

### 3.2 Test of the Dimeric Allylpalladium Halide Complexes According to General Formula VIII in Buchwald-Hartwig Couplings, Heck Reactions, α-Arylation of Ketones and Negishi Couplings

The allylpalladium halide phosphine complexes were produced in situ.

### A. General Procedure for Buchwald-Hartwig Aminations

A vial was filled with the catalyst (0.005 mmol, 0.005 eq.) and the ligand RuPhos (0.01 mmol, 0.01 eq.) in the absence of air and then transferred to the glove box, where 1 ml of THE was added. The resulting homogeneous solution was stirred for 20 minutes at room temperature. Thereafter, a solution of aryl chloride (1.0 mmol, 1 eq.), amine (1.1 mmol, 1.1 eq.), 168 mg of potassium tert-butoxide (1.5 mmol, 1.5 eq.) and 50 μl of n-undecane (0.191 mmol, 0.191 eq.) in 1 ml of THE was added to the catalyst solution. The vial was then capped and the reaction stirred for 12 hours at room temperature outside the glove box. After completion of the reaction, it was diluted with EtOAc (10 ml) and washed with water (2×10 ml). The combined organic phases were dried over MgSO₄, filtered and the volatile components removed under reduced pressure. The residue was purified by column chromatography (SiO2, cyclohexane), giving the corresponding amine.

As a model reaction, the preparation of N-tert-butyl-2,6-dimethylaniline [CAS: 395116-77-5] was chosen:

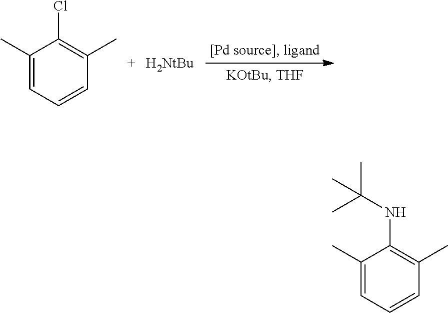

Catalyst/Pd source: 0.5 mol % 7-Cl or 7-Br or 8-Cl or 8-Br or 0.5 mol % [Pd(tBu-indenyl)Cl]₂*
Aryl chloride: 143 mg of 2,6-dimethylphenyl chloride
Amine: 82.1 mg of N-tert-butylamine
* for comparative purposes

TABLE B-5
Use in Buchwald-Hartwig amination using the example of the
preparation of N-tert-butyl-2,6-dimethylaniline

| Entry | Catalyst | Yield [%]^{a)} |
|---|---|---|
| 1 | 7-Cl | >99 |
| 2 | 7-Br | >99 |
| 3 | 8-Cl | 88 |
| 4 | 8-Br | 82 |

^{a)}Yields determined by GC analysis with n-undecane as internal standard.

With all four palladium-naphthyl catalysts (7-8 Cl/Br) in combination with the phosphine ligand RuPhos, the desired product was formed at a good to excellent yield under the reaction conditions given above. Under the above-mentioned reaction conditions, catalysts 7-Cl and 7-Br (substitution in the 1-position) were equally reactive and showed higher activity than catalysts 8-Cl and 8-Br (substitution in the 2-position). In comparison, the use of the Hazari catalyst [Pd(t-Bu-indenyl)Cl]2 and of the phosphine ligand RuPhos under otherwise identical reaction conditions led to a 93% yield of the expected compound. Consequently, the two palladium-naphthyl catalysts 7-Cl and 7-Br performed better than the Hazari catalyst.

Analytical data from N-tert-butyl-2,6-dimethylaniline prepared using 7-Br:

¹H NMR (300 MHz, CDCl₃) δ=7.02-7.07 (m, 2H), 6.93 (d, J=7.3 Hz, 1H), 2.36 (s, 6H), 1.23 ppm (s, 9H).

¹³C NMR (75 MHz, CDCl₃) δ=144.0, 134.8, 128.6, 123.2, 55.3, 31.2, 20.4 ppm.

MS (EI) m/z (%) 177.1 (34) [M+], 162.1 (62), 121.0 (100), 106.1 (43), 91.0 (14), 77.0 (14), 57.1 (13).

The NMR data is in agreement with the data in the literature (W. I. Lai, M. P. Leung, P. Y. Choy, F. Y. Kwong, Synthesis 2019, 51, 2678-2686).

Further examples for Buchwald-Hartwig aminations a) N,N-dibutyl-4-toluidine [CAS: 31144-33-9]

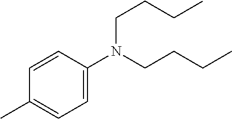 [SMILES: CCCCN(CCCC)c1ccc(C)cc1]

Catalyst/Pd source: 0.5 mol % 7-Br
Aryl chloride: 129 mg of 4-chlorotoluene
Amine: 142 mg of N,N-dibutylamine
Yield: 216 mg (99%) colorless liquid.

¹H NMR (300 MHz, CDCl₃) δ=7.07 (d, J=8.3 Hz, 2H), 6.63 (d, J=8.4 Hz, 2H), 3.23-3.33 (m, 4H), 2.29 (s, 3H), 1.53-1.66 (m, 4H), 1.31-1.47 (m, 4H), 1.00 ppm (t, J=7.3 Hz, 6H).

¹³C NMR (75 MHz, CDCl₃) δ=146.2, 129.7, 124.3, 112.1, 51.0, 29.4, 20.4, 20.1, 14.0 ppm.

MS (EI) m/z (%) 291.2 (31) [M+], 176.2 (100), 160.1 (2), 146.1 (1), 134.1 (78), 120.1 (44), 91.1 (20), 77.0 (13).

The NMR data is in agreement with the data in the literature (R. Pratap, D. Parrish, P. Gunda, D. Venkataraman, M. K. Lakshman, J. Am. Chem. Soc. 2009, 131, 12240-12249).

### b)N-butyl-2,6-dimethylaniline [41115-22-4]

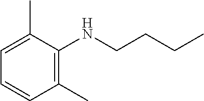 [1202] Catalyst/Pd source: 0.5 mol % 7-Br
Aryl chloride: 143 mg of 2,6-dimethylphenyl chloride
Amine: 80.5 mg of N-butylamine
Yield: 172 mg (97%) yellow liquid.

¹H NMR (400 MHz, CDCl₃) δ=7.03 (d, J=7.5 Hz, 2H), 6.85 (t, J=7.5 Hz, 1H), 3.03 (t, J=7.5 Hz, 2H), 2.97 (br s, 1H), 2.34 (s, 6H), 1.55-1.70 (m, 2H), 1.47 (sxt, J=7.4 Hz, 2H), 1.00 ppm (t, J=7.5 Hz, 3H).

¹³C NMR (101 MHz, CDCl₃) δ=146.1, 128.7, 128.4, 121.2, 48.0, 33.0, 20.0, 18.2, 13.6 ppm.

MS (EI) m/z (%) 291.2 (31) [M+], 176.2 (100), 160.1 (2), 146.1 (1), 134.1 (78), 120.1 (44), 91.1 (20), 77.0 (13).

The NMR data is in agreement with the data in the literature (L. Ackermann, J. H. Spatz, C. J. Gschrei, R. Born, A. Althammer, Angew. Chem. Int. Ed. 2006, 45, 7627-7630).

### B. General Procedure for Heck Reactions

A solution of the catalyst (0.01 mmol, 0.01 eq.) and of the ligand PAd₂nBu (0.02 mmol, 0.02 eq.) in 0.5 ml of dioxane was stirred for 20 minutes at room temperature in the glove box. The stock solution was then added to a vial containing aryl chloride (0.5 mmol, 1 eq), 71 mg of tert-butyl acrylate (0.55 mmol, 1.1 eq) and 461 mg of tetrabutylammonium acetate (1.25 mmol, 2.5 eq) in 1 ml of dioxane. The vials were then capped and stirring was carried out for 16 hours at 120° C. outside the glove box. After completion of the reaction, the vial was opened and the solution was diluted with 3 ml of EtOAc. The reaction solution was filtered using a pipette containing MgSO₄ and SiO2. The pipette was washed with more EtOAc until the filtrate became colorless. The solvent was removed under reduced pressure and the sample was purified by flash column chromatography (SiO2, cyclohexane/EtOAc 0%→20%) to obtain the desired product.

The preparation of tert-butyl-3-(3-quinolinyl)acrylate [CAS: 259232-14-9] was chosen as model reaction:

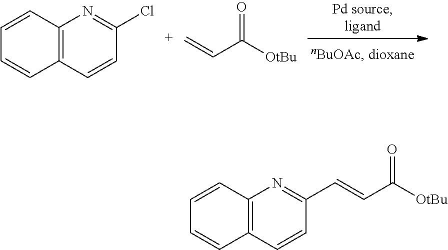

Catalyst/Pd source: 1 mol % 7-Cl or 7-Br or 8-Cl or 8-Br or 1 mol % [Pd(tBu-indenyl)Cl]₂*
Aryl chloride: 82.6 mg of 2-chloroquinoline
Yield: 110 mg (86%) yellow solid.
* for comparative purposes

TABLE B-6
Use in the Heck reaction using the example of the preparation of
tert-butyl-3-(3-quinolinyl)acrylate

| Entry | Catalyst | Yield [%]^{a)} |
|---|---|---|
| 1 | 7-Cl | 92 |
| 2 | 7-Br | 98 |
| 3 | 8-Cl | 84 |
| 4 | 8-Br | 98 |

^{a)}Yields were determined by GC analysis using n-undecane as internal standard.

With all four palladium-naphthyl catalysts (7-8 Cl/Br) in combination with the phosphine ligand PAd₂nBu, the desired product was formed at a good to very good yield under the reaction conditions given above. Under the above-mentioned reaction conditions, catalysts 7-Br and 8-Br were equally reactive and showed higher activity than catalysts 7-Cl and 8-Cl. In comparison, the use of the Hazari catalyst [Pd(t-Bu-indenyl)Cl]2 and of the phosphine ligand PAd₂nBu under otherwise identical reaction conditions led to a 95% yield of the expected compound. Consequently, the two palladium-naphthyl catalysts 7-Br and 8-Br performed somewhat better than the Hazari catalyst.

Analytical data from tert-butyl-3-(3-quinolinyl)acrylate prepared using 7-Br:

¹H NMR (400 MHz, CDCl₃) δ=8.17 (d, J=7.7 Hz, 1H), 8.10 (d, J=8.5 Hz, 1H), 7.77-7.84 (m, 2H), 7.73 (ddd, J=8.5, 6.9, 1.5 Hz, 1H), 7.61 (d, J=8.5 Hz, 1H), 7.52-7.59 (m, 1H), 6.89 (d, J=15.9 Hz, 1H), 1.56 ppm (s, 9H).

¹³C NMR (101 MHz, CDCl₃) δ=166.5, 154.4, 149.1, 144.1, 137.9, 130.4, 130.0, 128.3, 127.9, 127.5, 126.3, 120.5, 81.8, 29.4 ppm.

HRMS (ESI) m/z calculated for C₁₆H₁₇NO₂ [M+H]⁺ 256.1338, found 256.1328.

The NMR data is in agreement with the data in the literature (H. Xia, Y. Liu, P. Zhao, S. Gou, J. Wang, Org. Lett. 2016, 18, 1796-1799).

### Further Examples for Heck Reactions

### a) tert-butyl-3-(2-methoxyphenyl)acrylate [CAS: 1313193-50-8]

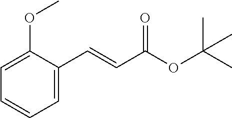 [SMILES: COc1ccccc1/C=C/C(=O)OC(C)(C)C] [1223] Catalyst/Pd source: 1 mol % 7-Br
Aryl chloride: 72.7 mg of 2-chloroanisole
Yield: 106 mg (91%) yellow liquid.

¹H NMR (400 MHz, CDCl₃) δ=7.91 (d, J=16.1 Hz, 1H), 7.49 (dd, J=7.7, 1.7 Hz, 1H), 7.29-7.37 (m, 1H), 6.86-6.99 (m, 2H), 6.44 (d, J=16.1 Hz, 1H), 3.88 (s, 3H), 1.55 (s, 9H) ppm.

¹³C NMR (101 MHz, CDCl₃) δ=164.6, 156.0, 136.6, 128.8, 126.5, 121.4, 118.3, 108.7, 77.9, 53.1, 25.9 ppm.

HRMS (ESI) m/z calculated for C₁₄H₁₈O₃ [M+Na]⁺ 257.1154, found 257.1142.

The NMR data is in agreement with the data in the literature (M. Lautens, J. Mancuso, H. Grover, Synthesis 2004, 2004, 2006-2014).

### b) tert-butyl-3-(3,5-dimethoxyphenyl)acrylate [CAS: 951174-15-5]

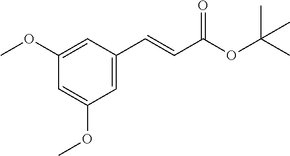 [SMILES: COc1cc(/C=C/C(=O)OC(C)(C)C)cc(OC)c1] [1231] Catalyst/Pd source: 1 mol % 7-Br
Aryl chloride: 89.0 mg of 3,5-dimethoxychlorobenzene
Yield: 124 mg (94%) yellow liquid.

¹H NMR (400 MHz, CDCl₃) δ=7.50 (d, J=15.9 Hz, 1H), 6.65 (d, J=2.2 Hz, 2H), 6.47 (t, J=2.3 Hz, 1H), 6.33 (d, J=15.9 Hz, 1H), 3.81 (s, 6H), 1.53 (s, 9H) ppm.

¹³C NMR (101 MHz, CDCl₃) δ=166.2, 161.0, 143.6, 136.6, 120.7, 105.8, 102.3, 80.6, 55.4, 28.2 ppm.

HRMS (ESI) m/z calculated for C₁₅H₂₀O₄ [M+H]⁺ 265.1440, found 265.1434.

The NMR data is in agreement with the data in the literature (S. G. Davies, A. W. Mulvaney, A. J. Russell, A. D. Smith, Tetrahedron: Asymmetry 2007, 18, 1554-1566).

### c) tert-butyl-3-(2,6-dimethylphenyl)acrylate [CAS: 780761-47-9]

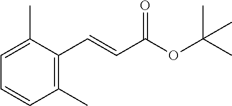 [SMILES: Cc1cccc(C)c1/C=C/C(=O)OC(C)(C)C] [1239] Catalyst/Pd source: 1 mol % 7-Br
Aryl chloride: 71.7 mg of 2-chloro-m-xylene
Yield: 111 mg (96%) off-white solid.

¹H NMR (400 MHz, CDCl₃) δ=7.74 (d, J=16.3 Hz, 1H), 7.01-7.17 (m, 3H), 5.99 (d, J=16.3 Hz, 1H), 2.35 (s, 6H), 1.55 (s, 9H) ppm.

¹³C NMR (101 MHz, CDCl₃) δ=166.3, 142.3, 136.8, 134.3, 128.3, 128.2, 125.8, 80.7, 28.4, 21.2 ppm

HRMS (ESI) m/z calculated for C₁₅H₂₀O₂ [M+Na]⁺ 255.1361, found 255.1352.

The NMR data is in agreement with the data in the literature (Q. Gao, Y. Shang, F. Song, J. Ye, Z.-S. Liu, L. Li, H.-G. Cheng, Q. Zhou, J. Am. Chem. Soc. 2019, 141, 15986-15993).

### d) tert-butyl-3-(2,6-dimethoxyphenyl)acrylate [CAS: 1478401-14-7]

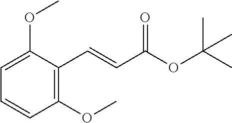 [SMILES: COc1cccc(OC)c1/C=C/C(=O)OC(C)(C)C] [1247] Catalyst/Pd source: 1 mol % 7-Br
Aryl chloride: 88.1 mg of 2,6-dimethoxychlorobenzene
Yield: 110 mg (83%) yellow oil.

¹H NMR (400 MHz, CDCl₃) δ=8.09 (d, J=16.3 Hz, 1H), 7.27-7.31 (m, 1H), 6.82 (d, J=16.3 Hz, 1H), 6.59 (d, J=8.4 Hz, 2H), 3.91 (s, 6H), 1.57 (s, 9H) ppm.

¹³C NMR (101 MHz, CDCl₃) δ=168.2, 160.1, 134.5, 130.9, 122.7, 112.6, 103.8, 79.9, 55.9, 28.4 ppm.

IR (ATR): 3001(w), 2958 (w), 2929 (w), 2835 (w), 1589 (s), 1472 (s), 1429 (s), 1299 (w), 1280 (w), 1244 (vs), 1171 (w), 1105 (vs), 1070 (w), 1036 (w), 1008 (w), 898 (w), 785 (w), 761 (w), 725 (w), 698 (s), 655 (w) cm-1.

HRMS (ESI) m/z calculated for C₁₅H₂₀O₄ [M+H]⁺ 265.1440, found 265.1436.

### e) tert-butyl-3-(2-formylphenyl)acrylate [CAS: 103890-69-3]

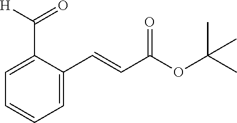 [SMILES: CC(C)(C)OC(=O)/C=C/c1ccccc1C=O] [1255] Catalyst/Pd source: 1 mol % 7-Br
Aryl chloride: 71.0 mg of 2-chlorobenzaldehyde
Yield: 111 mg (96%) pale yellow oil.

¹H NMR (400 MHz, CDCl₃) δ=10.33 (s, 1H), 8.41 (d, J=15.8 Hz, 1H), 7.82-7.92 (m, 1H), 7.50-7.68 (m, 3H), 6.31 (d, J=15.8 Hz, 1H), 1.55 (s, 9H) ppm.

¹³C NMR (101 MHz, CDCl₃) δ=191.7, 165.5, 139.6, 137.0, 133.9, 131.7, 129.7, 128.0, 125.3, 81.0, 28.2 ppm.

HRMS (ESI) m/z calculated for C₁₄H₁₆O₃ [M+H]⁺ 233.1177, found 233.1170.

The NMR data is in agreement with the data in the literature (C. S. Bryan, M. Lautens, Org. Lett. 2010, 12, 2754-2757).

### C. General Procedure for the α-Arylation of Ketones

A vial was filled with the respective catalyst (0.005 mol, 0.01 eq.) and the ligand RuPhos (0.01 mmol, 0.02 eq.) in the absence of air. After 3 alternating vacuum/argon cycles, 1 ml of THE was added with a syringe. The resulting homogeneous solution was stirred for 10 minutes at room temperature. Then, a solution of aryl chloride (0.5 mmol, 1.0 eq.), ketone (1.0 mmol, 2.0 eq.), 74.3 mg of sodium tert-butoxide (1.5 mmol, 1.5 eq.) and 30 μl of n-tetradecane (0.116 mmol, 0.232 eq.) in 1 ml of THE was added to the catalyst solution using a syringe. The reaction mixture was stirred for 16 hours at 60° C. After completion of the reaction, the mixture was diluted with EtOAc (10 ml) and washed with saline solution (3×10 ml), then the aqueous phases were extracted with EtOAc (3×10 ml). The combined organic phases were dried over MgSO₄, filtered and the volatile components removed under reduced pressure. The residue was purified by flash column chromatography (SiO₂,cyclohexane/ethyl acetate gradient), giving the corresponding arylated ketone.

The preparation of 2-(4-methylphenyl)-cyclohexanone [CAS: 52776-14-4] was chosen as model reaction:

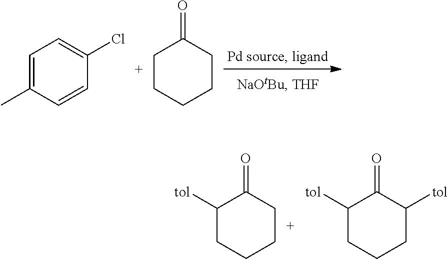

Catalyst/Pd source: 1 mol % 7-Cl or 7-Br or 8-Cl or 8-Br or 1 mol % [Pd(tBu-indenyl)Cl]₂*
Aryl chloride: 64.6 mg of 4-chlorotoluene
Ketone: 99.1 mg of cyclohexanone
* for comparative purposes

TABLE B-7
Use in the Heck reaction using the example of the preparation of
2-(4-methylphenyl)-cyclohexanone

| Entry | Catalyst | Yield [%]^{a)} |
|---|---|---|
| 1 | 7-Cl | 87 |
| 2 | 7-Br | 60 |
| 3 | 8-Cl | 83 |
| 4 | 8-Br | 77 |

^{a)}Yields were determined by GC analysis using n-tetradecane as internal standard.

With all four palladium-naphthyl catalysts (7-8 Cl/Br) in combination with the phosphine ligand RuPhos, the desired product was formed at a good to very good yield under the reaction conditions given above. Under the above-mentioned reaction conditions, catalysts 7-Cl and 8-Cl were approximately equally reactive and showed higher activity than catalysts 7-Br and 8-Br. In comparison, the use of the Hazari catalyst [Pd(t-bu-indenyl)Cl]2 and of the phosphine ligand RuPhos under otherwise identical reaction conditions led to a 75% yield of the expected compound. Consequently, the two palladium-naphthyl catalysts 7-Cl and 8-Cl performed better than the Hazari catalyst.

Analytical data from 2-(4-methylphenyl)-cyclohexanone prepared using 7-Cl:

¹H NMR (300 MHz, CDCl₃) δ=7.17 (d, J=8.0 Hz, 2H), 7.05 (d, J=8.0 Hz, 2H), 3.60 (dd, J=11.9, 5.5 Hz, 1H), 2.41-2.58 (m, 2H), 2.35 (s, 3H), 2.22-2.32 (m, 1H), 2.11-2.21 (m, 1H), 1.93-2.08 (m, 2H), 1.77-1.92 ppm (m, 2H).

¹³C NMR (75 MHz, CDCl₃) δ=210.5, 136.4, 135.7, 129.1, 128.3, 57.0, 42.1, 35.0, 27.8, 25.3, 21.0 ppm.

MS (EI) m/z (%) 188.1 (100) [M+], 172.1 (10), 144.1 (91), 131.1 (97), 117.1 (51), 105.1 (41), 91.1 (42).

The NMR data is in agreement with the data in the literature (X.-Q. Hu, D. Lichte, I. Rodstein, P. Weber, A.-K. Seitz, T. Scherpf, V. H. Gessner, L. J. Gooßen, Org. Lett. 2019, 21, 7558-7562).

### Further Examples for the α-Arylation of Ketones

### a) 1-(4-methylphenyl)-2-propanone [CAS: 2096-86-8]

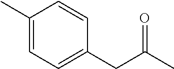 [1275] Catalyst/Pd source: 1 mol % 7-Cl
Aryl chloride: 64.6 mg of 4-chlorotoluene
Ketone: 58.1 mg of acetone
Yield: 51.0 mg (69%) colorless liquid.

¹H NMR (300 MHz, CDCl₃) δ=7.03-7.21 (m, 4H), 3.66 (s, 2H), 2.35 (s, 3H), 2.15 ppm (s, 3H).

¹³C NMR (75 MHz, CDCl₃) δ=206.7, 136.7, 131.2, 129.5, 129.2, 50.7, 29.1, 21.1 ppm.

MS (EI) m/z (%) 148.0 (28) [M+], 105.0 (100), 91.0 (5), 77.0 (14), 63.0 (3), 51.0 (4).

The NMR data is in agreement with the data in the literature (X.-Q. Hu, D. Lichte, I. Rodstein, P. Weber, A.-K. Seitz, T. Scherpf, V. H. Gessner, L. J. Gooßen, Org. Lett. 2019, 21, 7558-7562).

### b) 2-methyl-1-phenyl-2-(4-methylphenyl)-propanone [CAS: 14271-33-1]

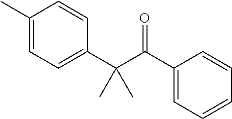 [SMILES: Cc1ccc(C(C)(C)C(=O)c2ccccc2)cc1]

Catalyst/Pd source: 1 mol % 7-Cl
Aryl chloride: 64.6 mg of 4-chlorotoluene
Ketone: 148 mg of isobutyrophenone
Yield: 110 mg (92%) yellow oil.

¹H NMR (300 MHz, CDCl₃) δ=7.50-7.53 (m, 1H), 7.47-7.50 (m, 1H), 7.33-7.40 (m, 1H), 7.13-7.26 (m, 6H), 2.35 (s, 3H), 1.59 ppm (s, 6H)

¹³C NMR (75 MHz, CDCl₃) δ=203.9, 142.2, 136.4, 129.7, 127.9, 125.6, 51.0, 27.8, 21.0 ppm

MS (EI) m/z (%) 238.1 (1) [M+], 207.0 (2), 133.1 (100), 115.1 (7), 105.0 (75), 91.4 (14), 77.0 (24).

The NMR data is in agreement with the data in the literature (X.-Q. Hu, D. Lichte, I. Rodstein, P. Weber, A.-K. Seitz, T. Scherpf, V. H. Gessner, L. J. Gooßen, Org. Lett. 2019, 21, 7558-7562).

### D. General Procedure for the Negishi Coupling

A solution of the catalyst (0.005 mmol, 0.01 eq.) and 4.76 mg of the ligand RuPhos (0.01 mmol, 0.02 eq.) in 0.5 ml of THE was stirred for 20 min at room temperature in the glove box. The aryl chloride (0.5 mmol, 1 eq.) and 152 μl of TMEDA (1 mmol, 2 eq.) were added to this solution. Outside the glove box, the arylzinc bromide solution was added to THE (0.75 mmol, 1.5 eq.) using a syringe and the resulting mixture was stirred for 16 h at room temperature. Upon completion, the solution was diluted with 3 ml of EtOAc and washed with 15 ml of water. The aqueous layer was extracted with EtOAc (3×15 ml) and the combined organic layers were washed with saline solution. The combined organic phases were dried over MgSO₄ and the volatile components removed under reduced pressure. The residue was purified by flash column chromatography to obtain the desired biphenyl.

The preparation of 2-methoxybiphenyl [CAS: 86-26-0] was chosen as model reaction:

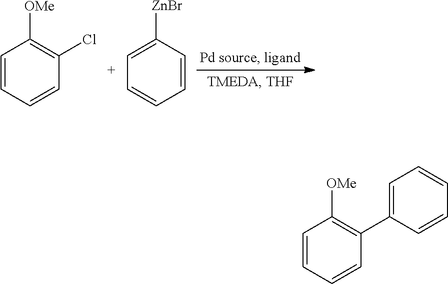

Catalyst/Pd source: 1 mol % 7-Br
Aryl chloride: 72.7 mg of 2-chloroanisole
Arylzinc bromide: 3.00 ml of phenylzinc bromide, solution in THE
* for comparative purposes

TABLE B-8
Use in Negishi coupling using the example of the preparation of 2-
methoxybiphenyl

| Entry | Catalyst | Yield [%]^{a)} |
|---|---|---|
| 1 | 7-Cl | >99 (42) |
| 2 | 7-Br | >99 (36) |
| 3 | 8-Cl | >99 (35) |
| 4 | 8-Br | >99 (7) |

^{a)}Value in brackets after 8 h at room temperature.

With all four palladium-naphthyl catalysts (7-8 Cl/Br) in combination with the phosphine ligand RuPhos, the desired product was formed at a quantitative yield under the reaction conditions given above. In comparison, the use of the Hazari catalyst [Pd(t-bu-indenyl)Cl]2 and of the phosphine ligand RuPhos under otherwise identical reaction conditions led to a 31% yield of the expected compound. Consequently, the four palladium-naphthyl catalysts (7-8 Cl/Br) performed markedly better than the Hazari catalyst.

Analytical data for 2-methoxybiphenyl prepared using 7-Br and purified by flash column chromatography (SiO2, cyclohexane/EtOAc gradient 0%→10%):

¹H NMR (400 MHz, CDCl₃) δ=7.56 (d, J=7.2 Hz, 2H), 7.44 (t, J=8.0 Hz, 2H), 7.30-7.38 (m, 3H), 6.97-7.11 (m, 2H), 3.83 (s, 3H) ppm.

¹³C NMR (101 MHz, CDCl₃) δ=156.6, 138.7, 131.0, 130.8, 129.7, 128.7, 128.1, 127.0, 121.0, 111.3, 55.7 ppm.

HRMS (ESI) m/z calculated for C₁₃H₁₂O [M+H]⁺ 185.0968, found 185.0961.

The NMR data is in agreement with the data in the literature (O. Diebolt, V. Jurčik, R. Correa da Costa, P. Braunstein, L. Cavallo, S. P. Nolan, A. M. Z. Slawin, C. S. J. Cazin, Organometallics 2010, 29, 1443-1450).

### Further Examples for Negishi Couplings

### a) 2,2′-dimethylbiphenyl [CAS: 605-39-0]

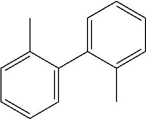 [1305] Catalyst/Pd source: 1 mol % 7-Br
Aryl chloride: 64.6 mg of 2-chlorotoluene
Arylzinc bromide: 0.18 ml of tolylzinc bromide, solution in THE
Yield: 112 mg (91%) colorless oil, after flash column chromatography (SiO2, pentane).

¹H NMR (400 MHz, CDCl₃) δ=7.17-7.21 (m, 4H), 7.11-7.17 (m, 2H), 6.99-7.06 (m, 2H), 1.98 ppm (s, 6H).

¹³C NMR (101 MHz, CDCl₃) δ=141.7, 136.0, 129.9, 129.4, 127.3, 125.7, 20.0 ppm.

MS (EI) m/z (%) 181.8. (86) [M+], 167.2 (100), 153.0 (4), 139.0 (2), 115.0 (6), 89.1 (5), 63.0 (6).

The NMR data is in agreement with the data in the literature (D.-H. Lee, M.-J. Jin, Org. Lett. 2011, 13, 252-255).

### b) 2-methoxyl-2′-methylbiphenyl [CAS: 19853-12-4]

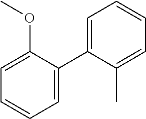 [1314] Catalyst/Pd source: 1 mol % 7-Br
Aryl chloride: 72.7 mg of 2-chloroanisole
Arylzinc bromide: 0.18 ml of tolylzinc bromide, solution in THE
Yield: 92 mg (93%) colorless oil, after flash column chromatography (SiO₂, pentane/EtOAc gradient 0% →10%).

¹H NMR (400 MHz, CDCl₃) δ=7.40-7.48 (m, 1H), 7.27-7.38 (m, 4H), 7.24 (dd, J=7.4, 1.8 Hz, 1H), 7.12 (dd, J=7.4, 1.1 Hz, 1H), 7.03-7.09 (m, 1H), 3.85 (s, 3H), 2.24 (s, 3H) ppm.

¹³C NMR (101 MHz, CDCl₃) δ=156.7, 138.8, 137.0, 131.1, 131.0, 130.1, 129.7, 128.7, 127.4, 125.6, 120.6, 110.8, 55.5, 20.1 ppm.

HRMS (ESI) m/z calculated for C₁₄H₁₄O [M+H]⁺ 199.1122, found 199.1123

The NMR data is in agreement with the data in the literature (S. E. Denmark, R. C. Smith, W.-T. T. Chang, J. M. Muhuhi, J. Am. Chem. Soc. 2009, 131, 3104-3118).

### c) 1,3-dimethoxy-2-phenylbenzene [CAS: 13732-86-0]

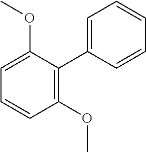 [SMILES: COc1cccc(OC)c1-c1ccccc1] [1323] Catalyst/Pd source: 1 mol % 7-Br
Aryl chloride: 88.1 mg of 2-chloro-1,3-dimethoxybenzene
Arylzinc bromide: 1.5 ml of tolylzinc bromide, solution in THE
Yield: 78 mg (73%), after flash column chromatography (SiO2, pentane/EtOAc gradient 0%→10%) and Kugelrohr distillation.

¹H NMR (400 MHz, CDCl₃) δ=7.37-7.44 (m, 2H), 7.32-7.37 (m, 2H), 7.28-7.32 (m, 1H), 7.25 (s, 1H), 6.66 (d, J=8.3 Hz, 2H), 3.73 (s, 6H) ppm.

¹³C NMR (101 MHz, CDCl₃) δ=157.5, 134.0, 130.7, 128.4, 127.5, 126.6, 119.5, 104.1, 55.8 ppm.

HRMS (ESI) m/z calculated for C₁₄H₁₄O₂ [M+H]⁺ 214.1074, found 214.1074

The NMR data is in agreement with the data in the literature (T. Truong, O. Daugulis, J. Am. Chem. Soc. 2011, 133, 4243-4245).

### d) 2,2′,6-trimethylbiphenyl [CAS10273-87-7]

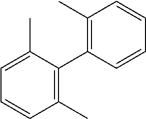 [1332] Catalyst/Pd source: 1 mol % 7-Br
Aryl chloride: 71.7 mg of 2-chloro-m-xylene
Arylzinc bromide: 0.18 ml of tolylzinc bromide, solution in THE
Yield: 55 mg (56%) colorless oil, after flash column chromatography (SiO₂, pentane).

¹H NMR (400 MHz, CDCl₃) δ=7.14-7.24 (m, 3H), 7.06-7.13 (m, 1H), 7.00-7.06 (m, 2H), 6.90-6.97 (m, 1H), 1.89 (s, 3H), 1.87 ppm (s, 6H).

¹³C NMR (101 MHz, CDCl₃) δ=141.2, 140.6, 135.9, 135.6, 130.0, 128.9, 127.2, 127.0, 126.9, 126.1, 20.4, 19.4 ppm.

MS (EI) m/z (%) 196.2. (63) [M+], 181.1 (2), 178.1 (14), 165.1 (49), 152.1 (9), 115.1 (7), 89.1 (11).

The NMR data is in agreement with the data in the literature (S. Chun To, F. Yee Kwong, Chem. Commun. 2011, 47, 5079).

### e) 5-phenylbenzoxazole [CAS: 201415-38-5]

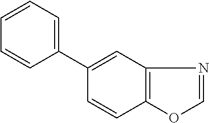 [SMILES: c1ccc(-c2ccc3ocnc3c2)cc1] [1341] Catalyst/Pd source: 1 mol % 7-Br
Aryl chloride: 80.8 mg of 5-chlorobenzoxazole
Arylzinc bromide: 1.25 ml of phenylzinc bromide, solution in THE
Yield: 71.0 mg (73%) off-white solid, after flash column chromatography (SiO₂, cyclohexane/EtOAc gradient 0% →20%).

¹H NMR (400 MHz, CDCl₃) δ=8.13 (s, 1H), 7.99 (br. s, 1H), 7.59-7.66 (m, 4H), 7.43-7.52 (m, 2H), 7.34-7.41 (m, 1H) ppm.

¹³C NMR (101 MHz, CDCl₃) δ=153.2, 149.7, 141.0, 140.8, 138.7, 129.0, 127.7, 127.5, 125.4, 119.2, 111.1 ppm.

HRMS (ESI) m/z calculated for C₁₃H₁₀NO [M+H]⁺ 196.0762, found 196.0751.

The NMR data is in agreement with the data in the literature (S. Guo, B. Qian, Y. Xie, C. Xia, H. Huang, Org. Lett. 2011, 13, 522-525).

The broad applicability of the new compounds according to formula VIII of formula VIII.a claimed here as palladium sources, in particular in coupling reactions, was demonstrated using the example of new dimeric palladium(II)-1-methylnaphthyl halide complexes in Buchwald-Hartwig aminations, Heck vinylations, α-arylations of ketones and in Negishi and Suzuki-Miyaura couplings. In the case of Buchwald-Hartwig amination and Suzuki-Miyaura coupling, the effect of the new palladium(II) compounds 7-Cl, 7-Br, 8-Cl and 8-Br, which can be prepared starting from 1-methylnaphthyl halides, on the catalyst activity was particularly pronounced. In the case of Suzuki-Miyaura coupling, it was surprisingly possible to extend the reaction to a new class of substrates. In most cases, the bromide complex 7-Br was the most efficient, but in ketone arylation the best results were obtained with the chloride complex 7-Cl.

The invention is not limited to one of the embodiments described above but may be modified in many ways.

It is clear that the invention relates to new methods for preparing palladium complexes which make it possible to prepare known products with high purity, in particular with high NMR purity, and in good yields. In addition, novel palladium complexes, which are usually not accessible or are only accessible with great effort using the methods described in the prior art, can be obtained with high purity, in particular with high NMR purity, and in good yields by means of the preparation methods described here. It has surprisingly been found that the compounds that can be prepared by means of the method described here do not contain impurities due to palladium-containing by-products, for example [Pd(dvds)PtBu₃)] and [Pd₂(dvds)₃], that are difficult or impossible to separate, in particular due to their solubility behavior, or only contain traces of said impurities (≤1000 ppm). The high purity of the end products is particularly advantageous in view of possible uses, for example as precatalysts and/or catalysts. The invention also relates to new palladium complexes that are suitable as precatalysts and/or catalysts, in particular for cross-coupling reactions.

Any features and advantages resulting from the claims and the description, including constructive details, spatial arrangements, and method steps, may be relevant to the invention, either alone or in the various combinations.

1.-43. (canceled)

44. A method for preparing a compound according to general formula
[PdZ^{A}Z^{B}] (I)
wherein the phosphine ligands Z^{A} and Z^{B} are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp), comprising the steps of:
A. providing
i. a mononuclear or multinuclear palladium compound, wherein at least one palladium center bears a ligand L_{S}, which is an organosilicon compound, and
ii. in each case one phosphine ligand Z^{A} and Z^{B}, wherein
Z^{A} and Z^{B} are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp),
B. reacting the palladium compound and the monophosphine ligand and/or the bisphosphine ligand from step A. in a non-ethereal solvent S_{C} and
C. optionally isolating the compound according to general formula [PdZ^{A}Z^{B}] (I) prepared in step B.

45. A compound according to general formula [PdZ^{A}Z^{B}] (I) obtained by the method according to claim 44, wherein the compound is of formula (I.1)

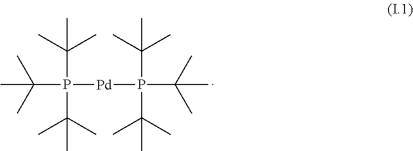

46. A compound according to general formula [PdZ^{A}Z^{B}] (I), wherein the compound is [Pd(PtBu₃)(P(1-Ad)tBu₂)], [Pd(PtBu₃)(P(1-Ad)iPr₂)], [Pd(P(1-Ad)₂tBu)₂], [Pd(P(1-Ad)₂iPr)₂], [Pd(P(1-Ad)tBu₂)(P(1-Ad)iPr₂)], [Pd(P(1-Ad)iPr₂)₂], [Pd(P(iPr)₂tBu)₂], [Pd(dppe)₂] or [Pd(dppp)₂].

47. A preparation containing
i. a compound according to general formula [PdZ^{A}Z^{B}] (I), wherein
Z^{A} and Z^{B} are independently selected from the group consisting of tri-tert-butylphosphine (PtBu₃), di-tert-butyl(iso-propyl)phosphine (P(iPr)tBu₂), tert-butyl-di-(isopropyl)phosphine (P(iPr)₂tBu), 1-adamantyl-di-(tert-butyl)phosphine (P(1-Ad)tBu₂), di(1-adamantyl)-tert-butylphosphine (P(1-Ad)₂tBu), 1-adamantyl-di-(isopropyl)phosphine (P(1-Ad)iPr₂), di(1-adamantyl)isopropylphosphine (P(1-Ad)₂iPr), 1,2-bis(diphenylphosphino)ethane (dppe) and 1,3-bis(diphenylphosphino)propane (dppp),
and
ii. an organosilicon compound.
